SEQUENCE LISTING (31 sequences)

SEQ ID NO: 1 - DNA, 26 bp, Artificial Sequence
  Description of Artificial Sequence Synthetic primer
ataactgagttcgatgcatgcccacg

SEQ ID NO: 2 - DNA, 36 bp, Artificial Sequence
  Description of Artificial Sequence Synthetic primer
gcctcgagactagtctggaaaaatggaaagccaagt

SEQ ID NO: 3 - DNA, 34 bp, Artificial Sequence
  Description of Artificial Sequence Synthetic primer
gctctagaataactgagttcgatgcatgcccacg

SEQ ID NO: 4 - DNA, 35 bp, Artificial Sequence
  Description of Artificial Sequence Synthetic primer
cactcgagactagtctgttttccaaccgctacgag

SEQ ID NO: 5 - DNA, 23 bp, Artificial Sequence
  Description of Artificial Sequence Synthetic primer
aggagcgggccaacgaggtgatg

SEQ ID NO: 6 - DNA, 40 bp, Artificial Sequence
  Description of Artificial Sequence Synthetic primer
gcctcgagactagtctgaaaaatggaggtgttgctatatg

SEQ ID NO: 7 - DNA, 31 bp, Artificial Sequence
  Description of Artificial Sequence Synthetic primer
attctagaaggagcgggccaacgaggtgatg

SEQ ID NO: 8 - DNA, 38 bp, Artificial Sequence
  Description of Artificial Sequence Synthetic primer
gcctcgagactagtcccatattgcagtattgactcatc

SEQ ID NO: 9 - protein, 48 aa, Homo sapiens
DNDGCTPLHYACRQGGNKCPITELLDFCMLHSKYLQCPLEFEYLLMKW

SEQ ID NO: 10 - protein, 48 aa, Mus Musculus
DNDGCTPLHYACRQGSNRCPIMELLDFCMIPSKYLQCPLSFEYLLMKW

SEQ ID NO: 11 - protein, 48 aa, Drosophila melanogatser
DSMGCSPLHYASRDGKHPCVTLAVQDKCITKAAFLQCPFMFKYLQMKW

SEQ ID NO: 12 - protein, 48 aa, Anopheles gambiae
DDAGCSPLHYASREGKHPCVTLAVQDNCITKASCLQCPALYKYLQMKW

SEQ ID NO: 13 - protein, 48 aa, Drosophila mojavesis
DNMGCSPLHYASRDGKHPCVTLAVQDKCITKAAFLQCPYMFKYLQMKW

SEQ ID NO: 14 - protein, 48 aa, Drosophila virlis; identical to SEQ ID NO: 13

SEQ ID NO: 15 - protein, 48 aa, Lottia gigantea
DKYSNDPLHIAAKQGVLDTPMRRVFDRCLSYGEFLDDAYARSLLTHKW

SEQ ID NO: 16 - protein, 48 aa, Lottia gigantea
DDFGCTPLHYASKEGSYGCPMLGVLDRCQIYSKYLRCERTYNFLKMKW

SEQ ID NO: 17 - protein, 48 aa, Caenohabditis elegans
DRDQNTPMHIVASNGKRRTPFRTVMDNCIEKSEFLDDTYMMALLKYKW

SEQ ID NO: 18 - protein, 46 aa, Drosophila melanogaster
DNQLNAHQEEYFGFGTLPIKDHFDSCITTNKNLMRQERDSFLFLKW

SEQ ID NO: 19 - protein, 48 aa, Monodelphis domestica
DIDGCTPLHYACRQGANKCAVLELLDICIVESKYLQSPVELEYLLMKW

SEQ ID NO: 20 - protein, 48 aa, Ornithorhynchus anatinus
DVEGCTPLHYACRQGTNKCPVLELLDSCMVDSRYLQCPLELEYLLMKW

SEQ ID NO: 21 - protein, 48 aa, Gallus gallus
DNEGCTPLHYACRQGANKCPVLEVLDNCIIESRYLQCPLALEYLLMKW

SEQ ID NO: 22 - protein, 48 aa, Danio rerio
DIEGCTPLHYACRLGTKRCIVMDLLDTCIRESRWLQHPLQNKYLEMKW

SEQ ID NO: 23 - protein, 48 aa, Danio rerio
DVEGCTPLHYACKLGKSRCVVLDLLDQCITESQWLQAFIQLKYLEMKW

SEQ ID NO: 24 - protein, 1196 aa, Drosophila melanogaster
MTSGDKETPKREDFASALRFLMGGCAREPEMTAMAPLNLPKKWARILRMSSTPKIPIVDYLEAAESGNLDDFKRLFMADNSRIALKDAKGRTAAHQAAARNRVNILRYIRDQNGDFNAKDNAGNTPLHIAVESDAYDALDYLLSIPVDTGVLNEKKQAPVHLATELNKVKSLRVMGQYRNVIDIQQGGEHGRTALHLAAIYDHEECARILITEFDACPRKPCNNGYYPIHEAAKNASSKTMEVFFQWGEQRGCTREEMISFYDSEGNVPLHSAVHGGDIKAVELCLKSGAKISTQQHDLSTPVHLACAQGAIDIVKLMFEMQPMEKRLCLSCTDVQKMTPLHCASMFDHPDIVSYLVAEGADINALDKEHRSPLLLAASRSGWKTVHLLIRLGACISVKDAAARNVLHFVIMNGGRLTDFAEQVANCQTQAQLKLLLNEKDSMGCSPLHYASRDGHIRSLENLIRLGACINLKNNNNESPLHFAARYGRYNTVRQLLDSEKGSFIINESDGAGMTPLHISSQQGHTRVVQLLLNRGALLHRDHTGRNPLQLAAMSGYTETIELLHSVHSHLLDQVDKDGNTALHLATMENKPHAISVLMSMGCKLVYNVLDMSAIDYAIYYKYPEAALAMVTHEERANEVMALRSDKHPCVTLALIASMPKVFEAVQDKCITKANCKKDSKSFYIKYSFWPYQKTPEQIEAKRKEFNDPKWRPAPLAVVNTMVTHGRVELLAHPLSQKYLQMKWNSYGKYFHLANLLIYSIFLVFVTIYSSLMMNNIELKAGDNKTMSQYCNMGWEQLTMNLSQNPSVASQIRLDSCEERINRTTAILFCAVVIVVYILLNSMRELIQIYQQKLHYILETVNLISWVLYISALVMVTPAFQPDGGINTIHYSAASIAVFLSWFRLLLFLQRFDQVGIYVVMFLEILQTLIKVLMVFSILIIAFGLAFYILLSKIIDPQPNHLSFSNIPMSLLRTFSMMLGELDFVGTYVNTYYRDQLKVPMTSFLILSVFMILMPILLMNLLIGLAVGDIESVRRNAQLKRLAMQVVLHTELERKLPHVWLQRVDKMELIEYPNETKCKLGFCDFILRKWFSNPFTEDSSMDVISFDNNDDYINAELERQRRKLRDISRMLEQQHHLVRLIVQKMEIKTEADDVDEGISPNELRSVVGLRSAGGNRWNSPRVRNKLRAALSFNKSM

SEQ ID NO: 25 - protein, 1248 aa, Anopheles gambiae
MPTPLYLIHSPRSVRSDTDHNHPTCEVNHEEEDLQQTQAFKNWLLSRLKLPTGHGIQNTKVNQINAHDNNELQAILTQPAEAEVCLLSDSPYRILRAAEAGNLEEFIRLYEGDNNRLSVKDSKGRTAAHQAAARNRVNILTFIHGQGGNLNAQDMVGNTPLHTAVENDSLDALEFLLKIPVATNVLNEKKLAPVHLATEQNKVHALQVMGKYREVIDIQQGGEHGRTALHLAAIYDNEECARILISEFGACPRKPCNNGYYPIHEAAKNASSKTMEVFFQWGESKGCTREEMISFYDSEGNVPLHSAVHGGDIKAVELCLKSGAKISTQQHDLSTPVHLAAAQGAIEIVKLMFRMQPLEKRISLNCTDIQKMTPLHCAAMFDHPEIVEYLVKEGADINAMDKEKRSPLLLSSSRGGWRTVMALIRLGANISLKDANSRNVLHLVIMNGGCLDEFAKEVCRTQSEIYLLQLLNEKDDAGCSPLHYASREGHIRSLENLIRLGACINLKNNNNESPLHFAARYGRYNTVRQLLDSEKGTFIINESDGEGLTPLHIASQQGHTRVVQLLLNRGALLHRDHNGRNPLHLAAMSGYRQTIELLHSVHSHLLDQVDKDGNTALHLATMENKPNAVILLLSLGCKLLHNYMDMSAIDYAIYYKYPEAALAMATHEERSSEVMALKSDKHPCVTLALIASMPRVFEAVQDNCITKANCKKDSKSFYIRYSFSCLQCPALYAQMDARTGEAVQISKPIPLPALNAMVAHGRVELLAHPLSQKYLQMKWNSYGKYFHLANLLFYSVFLFFVTLFTSQLMRNATPIGHTDGNHTQAAGTPVDSGQHILALRSTIARSKGYNLGTVANVSSSVAPPTIEEQMEVTTTTLVSGIGIIIYIVVNALRELVQVYQQKWHYLLEPNNFISWILYTSALIMIWPMFSSGMCFSINYSAASITVFLSWFNLLLFLQRFDQIGIYVVMFLEILQTLIKVLIVFSILIIAFGLAFYILLSKVSEPQVNHLSFSSIPMSLVRTFSMMLGEMDFVGTYVQPYHVGDLPFPFPSFVILCLFMILMPILLMNLLIGLAVGDIESVRRNAQLKRLAMQVVLHTELERKLPQMWLEMVDKMELIEYPNEKKCKLGFLDSVLRKWFCNPFTDDYKGGIDYVLENTEDYVAVELEKQKRKLRDIGTALDAQHQLLRLIVQKMEIKTEADDVDEGVSTSDLKASSGLLTGTRSSRWSSPRIRKKLGATLSFNKSIGK

SEQ ID NO: 26 - protein, 1123 aa, Aedes aegypti
MGSRALDTEEVYIGIRGNGVQVNDIRDKIAFFFKKRILPRLSLLTNGTTTVEELAVQLHHLSYCDFTAVFKQIDEPLQIQHQIKHRNLGMFNHSIFFLARPVATNILNDKKLAPVHLATELNKVKGLQVMGKYRETIDIQQGGEHGRTALHLAAIYDHEECARILSEFGACPRRPCNNGYYPIHEAAKNASSKTMEVFFQWGESKGCTREEMISFYDSEGNVPLHSAVHGGDIKAVELCLKSGAKISTQQHDLSTPVHLAAAQGAIEIVKLMFLMQPQEKRISLNCTDIQKMTPLHCAAMFDHPEIVEYLVQEGADINALDKENRSPLLLSASRGGWRTVMVLIRLGANISLKDVNSRNVLHLVIMNGGRLDEFAKEVSCTQSETYLLLLLNEKDETGCSPLHYASREGHIRSLENLIRLGACINLKNNNNESPLHFAARYGRYNTVRQLLDSEKGTFIINESDGEGLTPLHIASKEGHTRVVQLLLNRGALLHRDHNGRNPLHLAAMSGYTQTIELLHSVHSHLLDQVDKDDGNTALHLATMENKPNAVVLLLSLGCKLLHNYMDMSAIDYAIYYKYPEAALAMATHEERSAEVMALKSDKHPCVTLALIASMPRVFEAVQDNCISKANCKKDSKSFYIKYSFSCLQCPTMYAQMDSRTGEAVQIFKPIPLPALNAMVSHGRVELLAHPLSQKYLQMKWNSYGKYFHLANLLFYSVFLLFVTVFTSQLMTNTPNQTLLDEEHMPITTATLVSGIIIILYIFCNALREILQVYQQKWHYLIEPINLVSWILYLSALIMVWPMFNDGRCFSGNFSAASVTVFLSWFNLLLFLQRFDQVGIYVVMFLEILQTLIKVLTVFSILIIAFGLAFYILLSKVSDTQVNHLSFSSIPMSLLRTFSMMLGEMDILGTYVQPYYQNHLLYPIPSFAILCLFMILMPILLMNLLIGLAVGDIESVRRNAQLKRLAMQVVLHTELERKLPQMWLEMVDKMELIEYPNEKKCKLGFLDSVLRKWFCNPFTDDYKGGIDFVLDNNEDYVVTELEKQKRKLREISSALDNQHQLLRLIVQKMEIKTEADDVDEGVATSDVKGVGALRGPNGTTSRWSSPRIRKKLRAAMSFNKSISK

SEQ ID NO: 27 - protein, 1138 aa, Culex pipiens
MISRKSIRQMFRNYRTNPNHPLSIATPLKIPATWSRVLRLQPSTRINPEHLLQAAESGNLEEFVRLYEGDNGRLAIKDSRGRTATHQAAARNRVNILNYIYTQRGDLNEQDMFGNTPLHLAVENDSLDALEFLLKMPVATNILNDKKLAPVHLATELNKVKGLQVMGKYRDVFDIQQGGEHGRTALHLAAIYDNEECARILISEFGASPRKPCNNGYYPIHEAAKNASSKTMEVFFQWGESKGCTREEMISFYDSEGNVPLHSAVHGGDIKAVELCMKSGAKISTQQHDLSTPVHLAAAQGAIDIVKLMFLMQPLEKRISLNCTDIQKMTPLHCAANFDHPEIVEYLQEGADINALDKENRSPLLLSASRAGWRTVMILIRLGANIELKDVNSRNVLHLVIMNGGRLDEFAKQVSTTQSEKYLLQLMNEKDDTGCSPLHYASREGHIRSLENLIQLGACINLKNNNNESPLHFAARYGRFNTVRQLLDSEKGTFIINESDGEGLTPLHIASKEGHTRVVQLLLNRGALLHRDHNGRNPLHLAAMSGYTQTIELLHSVHSHLLDQVDKDDGNTALHLATMENRPSAVVLLLNLGCKLLHNYMDMNAIDYAIYYKYPEAALAMATHEERSPEIMALKSDKHPCVTLALIASMPRVFEAVQDNCITKANCKKDSKSFYIKYSFSCLQCPTMYAQMDSRTGEAVQIFKPIPLPALNAMVAHGRVELLAHPLSQKYLQMKWNSYGKYFHLANLLFYSVFLFFVTLFAAQLMESHMTVSTTTFVSGIGIIVYILGNAMREILQAYQQKWHYLIEPINLISWLYFSALVMIWPMFVQGRCESGNFSAASVTVFLSWFNLLLFLQRFDQVGLYVVMFLEILQTLIKVLTVFSILIIAFGLSFYILLSKVSHQAVNHQSFSSIPMSLVRTFSMMLGEMDFLGTYVQPYYSSELPYPIPSFIAILSLFMILMPILLMNLLIGLAVGDIESVRRNAQLKRLAMQVVLHTELERKLPQMWLEMVDRNELIEYPNEKKCKLGFMDSILRKWFCNPFSDEDAKGGIDFVLDSNEDYIVTELEKQKRKLREIGSALDSQHQLLRLIVQKMEIKTEADDVDEGVSTGDGKGSRWSSPRIRKKLRAAMSFNKSMS

SEQ ID NO: 28 - protein, 1040 aa, Culex pipiens
MYTMDEFKRLYEADNERLALKDHRGRTVMHQAALKNRINILEFIQAHGGDFHLQDLAGNTPLHVAVESEALDAVEFLLFSSVATNILNEKKQAPVHLATELNKVKSLQLMGKFRDLFDIQQGGEFGASPQLPCNNGYYPIHEAAKNASSKTMEVFFQWGESNGCTREEMISMHDSEGNVPLHSAVHGGDIQAVELCLKSGAKISTPQHDLSTPVHLAAAQGSIDIVKLMFEMQPSEKKHSLHRTDIQKMTPLHCAAIFDRPDLVEYLQEGADLNALDQENRSPLLLAASRGGWRTVMVLIRLGANISLKDANCRNVIHLIITNGGHLDEFAHEVSGTPSEFYFLQLLNAKDNTGCSPLHYASRDGHIQSLQHLIRFGASINVKNKYNESPLHFAARYGHINSLRQLLDSEKGIFIINEGDGEGLTPLHIASKEGHTKIVQFLLNRGALLHRDHKGRNPLHLAAMSGYTQTIELLHSVHSHLLDQVDKDDGNTALHLATMENRQSAVLLLLNLGCKLPHNYSDMSAIDYAIYFKYSAVALAMVTHEKRAAEIMALKSDKNPSVTLALIATMPQVFEAVQNNCITRAECKKDSMNFYIKYSFNAYQNSQEEAMVTHGRVELLAHPLSQKYLQMKWNSYGKYFHVAHLLFYSIFLFLVTVFASQMMHNDAMKAHPTQMVITTTTLASGLGVIAYIVCNALRELVQVYQQKWNYLIEPINLISWVYFSAIAMVWPIFVDGRCVSENFSSASVTVFLSWFNLLLFLQRFDQVGLYVVMFLEILQTLVKVLAVFSILIIAFGLAFYILLSKADSHQAVNHQSFSSIPMSLMRTFSMMLGEMDFLGTYVQPYYNSNLPFYPIPAFIALFMVLMPILLMNLLIGLAVGDIESVRRNAQLKRLAMQVQLHTELELKLPRIVLDKVDRMEVVEYPNEHKAKLGFLDTVLKKWFGNPFSEGGEADSMLDNNEDFVMMELGKQKRKLREIGNALDNQSQMLRLIVQKMDIKTETDDVDEGIALGEDGKASASSPKLRKKIRAAMVVTKSIRK

SEQ ID NO: 29 - protein, 1094 aa, Pediculus humanis
MQGKYMKNNDSTGKINKFNGELLCFLTESPFRILRAAESGNLEDFGRLFMADPNRLEIRDSKGRAAAHQAARNKVNILQFIHSHGGVNTSILNEKNQAPIHLITELNKVKALEVLSKHRSKIDIQQGGEHGRTALHLTAIYDYEECARILITEFGACPRKPCNNGYYPIHEAAKNASSKTMEVFLQWGESRGCSREEMMSFYDSEGNVPLHSAVHGGDIRAVELCLKSGAKISTQQHDLSTPVHLACAQGAIEIVRLMFKMQPHEKEICLTSCDVQKMTPLHCAAMFDHPEIVEYLISEGAEINPLDKENRSPLLLAASRAGWRTVLTLIRLKANILLKDSSYCRNILSLVVMNGGRLEDFAQEVLKVQSKKDLLLLLNEKDISGCSPLHYASREDGHIKSLESLIKLGACINLKNNNNESPLHFAARYGRYNTVKQLLDSEKGTFIINECDGEGLTPLHIASKNGHSRVVQLLLNRGALLHRDHYGRNPLHLAAMNGYTQTMELLHSVHSHLLDQVDKDDGNTTLHLASMENKPNAISLLLSLNCKLLYNYLEMSAIDYAIHYKFQEAALAMVTHPTRSCEVMALKSDKHPCVTLALIASMPKVFEAVQNGCITKANCKKDSKSFYVKYHSCLQCPTIYAQVDEKTGETLTITNPIPLPALNVQAMVSHGRVELLAHPLSQKYLQMKWNSYGKYFHLINLLFYTIFLTVVTTFTAHLMHHSNITTTCEESNQTEISLRLESSSNYTIIYTTAVAIAVYVSVQLFRETIQMYQQKWNYCMDPSNFISLGLYISSITMIVPIFMDKCTDDLQFSSAAITVFLSWFNLLLYLQRFDQVGIYIVMFLEILQTLIKVLLVFSILIIAFGLAFYILLSGVSHLSFSTVPMSLMRTFAMMLGEIDFLGTYVQPFLPFYPFPAFFILGIFMVLMPILLMNLLIGLAVGDIESVRRNAQLKRLAMQVVLHTELERKLPKCLLDRVDKMELIEYPNEKKCKLGFLDTLLGKWFFNPFSDDGNVVDNTEDYLTSEMAKQKKKLKEISSCLKMEIKTEADDVDEGISSPNAALKNLLNRSSSSYTSPYARKKLRSSLSITKSSNY

SEQ ID NO: 30 - protein, 1120 aa, Tibolium casteneum
PSLKKFQVAECGNLETFQRLYFADPTRLSIKDSRGRTAAHQAAAKNRITILQFILSQGGDLNNQDNAGNTPLHVAVEHEALDAVDFLLVKTNILNDKKQAAIHLVATELNKVSVLEVMGKHKDKIDILQGGEHGRTALHIAAIYDHEECARILISVFDACPRRPCNNGYYPIHEAAKNASSKTLEIFLQWGESRGCTREEMISFYDSEGNVPLHSAVHGGDIKAVELCLRSGAKISTQQHDLSTPVHLACAQGATDIVKLMFKMQPEEKLPCLASCDVQKMTPLHCAAMFDHPEIVEFLINEGADINPMDKEKRSPLLLAALSRGGWRTVHVLIRLGADINVKDVNRRNVLHLVVMNGGRLEQFASEVSKAKSQTSLLQLLNEKDINGCSPLHYASREGHIRSLENLIRLGATINLKNNNNESPLHFAARYGRYNTVRQLLDSEKGTFIINESDGEGLTPLHIASKQGHTRVVQLLLNRGALLHRDHNGRNPLHLAAMNGYTQTIELLLSVHSHLLDQTDKDDGNTALHLATMENKPNAIALLLSMNCKLLYNQMEMSAIDYAIYYKFPEAALAMVTHEDRAEEVMALKSSKHPYVTLALIASMPKVFEAVQDKCITKANCKKDSKSFYIKYNSALQCSQFYADMDHKTGDALAISKPIPLPALNAMVSHGRVELLAHPLSQKYLQMKWNSYGKYFHLTNVLFYSIFLTFVTCFAYEIMRHEDQIITYNATNLTHDITPMMYMSALAIITYIILNTIREMVQVYQQKFMYFLDPNNLVTWVLYTCAVVMVFPIFWGTMYELQFSCASVTVFLSWFNLLLLLQRFDQVGIYVVMFLEILQTLIKVLLVFSILIIAFGLAFYILLSRVSTLSGDHLSFKTIPMSLVRTFSMMLGEIDFLGTYVKQPYYLTEDEKSFLPFPLPAFFILGLFMVLMPILLMNLLIGLAVGDIESVRRNAQLKRLAMQVVVLHTELERKLPKMLLERVDKCELIEYPNDTKCKLGFFDSILRKWFGNPFSDEGLDMAMEGVEDYVVNELDKTKRKLKEITTALETQQQFLRLIVQKMEIKTEADDVDEGVSSPNDLKPITGHASKWTSPKIRKKLRSVVSFNVWTWRWKVSRITL

SEQ ID NO: 31 - protein, 1119 aa, Homo sapiens
MKCSLRKMWRPGEKKEPQGVVYEDVPDDTEDFKESLKVVFEGSAYGLQNFNKQKKLKTCDDMDTFFLHYAAAEGQIELMEKITRDSSLEVLHEMDDYGNTPLHCAVEKNQIESVKFLLSRGANPNLRNFNMMAPLHIAVQGMNNEVMKVLLEHRTIDVNLEGENGNTAVIIACTTNNSEALQILLNKGAKPCKSNKWGCFPIHQAAFSGSKECMEIILRFGEEHGYSRQLHINFMNNGKATPLHLAVQNGDLEMIKMCLDNGAQIDPVEKGRCTAIHFAATQGATEIVKLMISSYSGSVDIVNTTDGCHETMLHRASLFDHHELADYLISVGADINKIDSEGRSPLILATASASWNIVNLLLSKGAQVDIKDNFGRNFLHLTVQQPYGLKNLRPEFMQMQQIKELVMDEDNDGCTPLHYACRQGGPGSVNNLLGFNVSIHSKSKDKKSPLHFAASYGRINTCQRLLQDISDTRLLNEGDLHGMTPLHLAAKNGHDKVVQLLLKKGALFLSDHNGWTALHHASMGGYTQTMKVILDTNLKCTDRLDEDGNTALHFAAREGHAKAVALLLSHNADIVLNKQQASFLHLALHNKRKEVVLTIIRSKRWDECLKIFSHNSPGNKCPITEMIEYLPECMKVLLDFCMLHSTEDKSCRDYYIEYNFKYLQCPLEFTKKTPTQDVIYEPLTALNAMVQNNRIELLNHPVCKEYLLMKWLAYGFRAHMMNLGSYCLGLIPMTILVVNIKPGMAFNSTGIINETSDHSEILDTTNSYLIKTCMILVFLSSIFGYCKEAGQIFQQKRNYFMDISNVLEWIIYTTGIIFVLPLFVEIPAHLQWQCGAIAVYFYWMNFLLYLQRFENCGIFIVMLEVILKTLLRSTVVFIFLLLAFGLSFYILLNLQDPFSSPLLSIIQTFSMMLGDINYRESFLEPYLRNELAHPVLSFAQLVSFTIFVPIVLMNLLIGLAVGDIAEVQKHASLKRIAMQVELHTSLEKKLPLWFLRKVDQKSTIVYPNKPRSGGMLFHIFCFLFCTGEIRQEIPNADKSLEMEILKQKYRLKDLTFLLEKQHELIKLIIQKMEIISETEDDDSHCSFQDRFKKEQMEQRNSRWNTVLRAVKAKTHHLEP

(19) United States
(12) Patent Application Publication
(10) Pub. No.: US 2011/0151018 A1
(43) Pub. Date: Jun. 23, 2011

(54) METHODS OF INSECT CONTROL

(75) Inventors: Paul Garrity, Newton, MA (US); KyeongJin Kang, Lexington, MA (US)

(73) Assignee: BRANDEIS UNIVERSITY, Waltham, MA (US)

(21) Appl. No.: 12/965,290

(22) Filed: Dec. 10, 2010

Related U.S. Application Data
(63) Continuation of application No. PCT/US2009/046933, filed on Jun. 10, 2009.
(60) Provisional application No. 61/060,320, filed on Jun. 10, 2008.

(51) Int. Cl. A01N 43/90; A01N 59/16; A01N 43/40; A01P 7/04

(52) U.S. Cl. 424/617; 514/263.35; 514/263.2; 514/263.24; 514/263.22; 514/234.2; 514/217.06; 514/263.23; 514/323; 514/230.2

(57) ABSTRACT

The present invention is directed towards methods of inhibiting thermo- and chemo-sensing in insects and pests by inhibiting TRPA1 ion gated channel or family members. The present invention is also directed towards methods of insect control by modulating the TRPA1 ion gated channel or family members. The methods are applicable to a wide variety of insects and pests including agricultural and horticultural pests.

### RELATED APPLICATIONS

This application claims benefit under 35 U.S.C. §120 and is a Continuation of International Application No. PCT/US2009/046933 filed on Jun. 10, 2009, which claims the benefit under 35 U.S.C. §119(e) to U.S. Provisional Applications 61/060,320, filed Jun. 10, 2008, each of which is incorporated herein by reference in its entirety.

### GOVERNMENT SUPPORT

This invention was made with Government support under PO1 NS044232, P30 NS045713S10, RR16780, RO1 EY13874 and RO1 MH067284 awarded by the National Institute of Health. The Government has certain rights in the invention.

### SEQUENCE LISTING

The instant application contains a Sequence Listing which has been submitted in ASCII format via EFS-Web and is hereby incorporated by reference in its entirety. Said ASCII copy, created on Feb. 18, 2011, is named 47364062.txt and is 87,457 bytes in size.

### BACKGROUND OF INVENTION

Insects cause great losses and damages to human agriculture, food supply, post-harvest storage, horticulture, animal health and public health. While advances have been made in the control of these insects, these insects have been able to adapt and evade the control measures. Hence, there is an ongoing need in the development of alternative insect control strategies. For example, a better understanding of the biology and physiology of these insects can provide clues for potential targets for insect control.

Animals from flies to humans are able to distinguish subtle gradations in temperature and exhibit strong temperature preferences. Animals move to environments of optimal temperature and some manipulate the temperature of their surroundings, as humans do using clothing and shelter. Animals are equipped with biological sensors for sensing the environment and the changes, and help dictate the behavioral response to the environmental changes.

The Transient Receptor Potential (TRP) family of cation channels are biological sensors reportedly for sensing mechanical and temperature changes, and for pain and noxious chemicals. Ion channels play a central role in neurobiology as membrane-spanning proteins that regulate the flux of ions. Categorized according to their mechanism of gating, ion channels can be activated by signals such as specific ligands, voltage, or mechanical force. Temperature has been shown to activate certain members of the Transient Receptor Potential (TRP) family of cation channels (Patapoutian et al., Nature Reviews Neuroscience 4, 529-539, 2003). Members of two distinct subfamilies of TRP channels have been implicated in cold sensation: TRPM8 and TRPA1. TRPM8 is activated at 25° C. It is also the receptor for the compound menthol, providing a molecular explanation of why mint flavors are typically perceived as refreshingly cooling.

TRPA1, also termed ANKTM1, is activated at 17° C. and is also a noxious cold-activated ion channel specifically expressed in a subset of TRPV1-, CGRP-, and substance P-expressing nociceptive neurons (Story et al., Cell 112: 819-829, 2003). The TRPA1 ortholog in Drosophila melanogaster also acts as a temperature sensor. Together these temperature-activated channels represent a subset of TRP channels that are dubbed thermoTRPs. In agreement with a role in initiating temperature sensation, most of the thermoTRPs are expressed in subsets of Dorsal Root Ganglia (DRG) neurons that strikingly correlate with the physiological characteristics of thermosensitive DRG neurons. There are neurons that express only TRPV1 (hot), only TRPM8 (cool), or both TRPV1 and TRPA1 (polymodal nociceptors).

### SUMMARY OF THE INVENTION

Embodiments of the present invention are based on the discovery that the Transient Receptor Potential cation channel A1 (TRPA1) is the key thermosensor in the AC neurons of the fruit fly. TRPA1 ion channel is activated by increases in ambient temperature and necessary and sufficient for the fruit fly to respond to a non-preferred ambient temperature by avoidance behavior such as moving away from the non-preferred, higher ambient temperature. Other insects, such as flies and mosquitoes, also use this mechanism.

TRPA1 is expressed in many organisms, including insects, and TRPA1 functions in similarly in thermo and chemosensory in these organisms. Inhibiting TRPA1 provides an alternative strategy to control insects by disrupting the insects' thermo- and chemo-sensation of their environment. Accordingly, the invention provides a method of inhibiting thermosensing in an insect, the method comprising inhibiting a TRPA1 ion gated channel and/or family members.

Additionally, the invention provides a method of inhibiting the chemosensing in an insect, the method comprising inhibiting a TRPA1 ion gated channel and/or family members in the insect.

In another aspect, the invention provides a method of insect control comprising modulating the activation of TRPA1 ion gated channel or family members in the insect.

In one embodiment, the activation of TRPA1 is modulated with a TRPA1 inhibitor.

In another embodiment, the activation of TRPA1 is modulated with a TRPA1 agonist.

In another aspect the invention provides a method of insect control comprising activating TRPA1 ion gated channel or family members in the insect. Without wishing to be bound, activation of TRPA1 ion gated channel or family members in the insect leads to an increase in avoidance behavior of such insect. This increase in avoidance behavior can be used to repel insects away from a particular location and thus controlling such insects.

In one embodiment, the TRPA1 ion gated channel or family member is activated by an agent selected from the group consisting of 4-hydroxynonenal, capsaicin, 3′-carbamoylbiphenyl-3-yl-cyclohexyl carbamate, cinnamaldehyde, allicin, gingerol, 2-mercaptobenzoic acid, caffeine, quinine, benzoquinone, iodoacetamide, N-methyl maleimide, trinitrophenol, Carvacrol, Icilin, menthol, acrolein, 15-deoxy-Δ^{12,14}-prostaglandin J₂ (15d-PGJ₂), allyl thiocyanate, and 4-methyl-N-[2,2,2-trichloro-1-(4-nitro-phenyl sulfanyl)-ethyl]-benzamide, allyl isothiocyanate (AITC), acrolein, allicin, 1-cloroacetophenone, 2-chlorobenzyliden malonoitrile, 1,5-dichloro-3-thiapentane, and pharmaceutically acceptable salts thereof.

In one embodiment, the TRPA agonist is not allyl isothiocyanate (AITC), acrolein, allicin, cinnamaldehyde, 1-cloroacetophenone, 2-chlorobenzyliden malonoitrile, caffeine, quinine or 1,5-dichloro-3-thiapentane.

In yet another aspect, the invention provides a method of insect control comprising inhibiting a TRPA1 ion gated channel or family members in the insect.

In one aspect, the insects of concern in this invention are disease vectors such as mosquitoes, e.g., malarial-bearing mosquitoes.

In another aspect, the insects of concern in this invention are agricultural and/or horticultural pests.

In yet another aspect, the insects of concern in this invention are parasites.

In one embodiment, the agent for activating and/or inhibiting TRPA1 is applied as a spray.

In another embodiment, the agent for activating and/or inhibiting TRPA1 is applied topically.

### DETAILED DESCRIPTION OF THE DRAWINGS

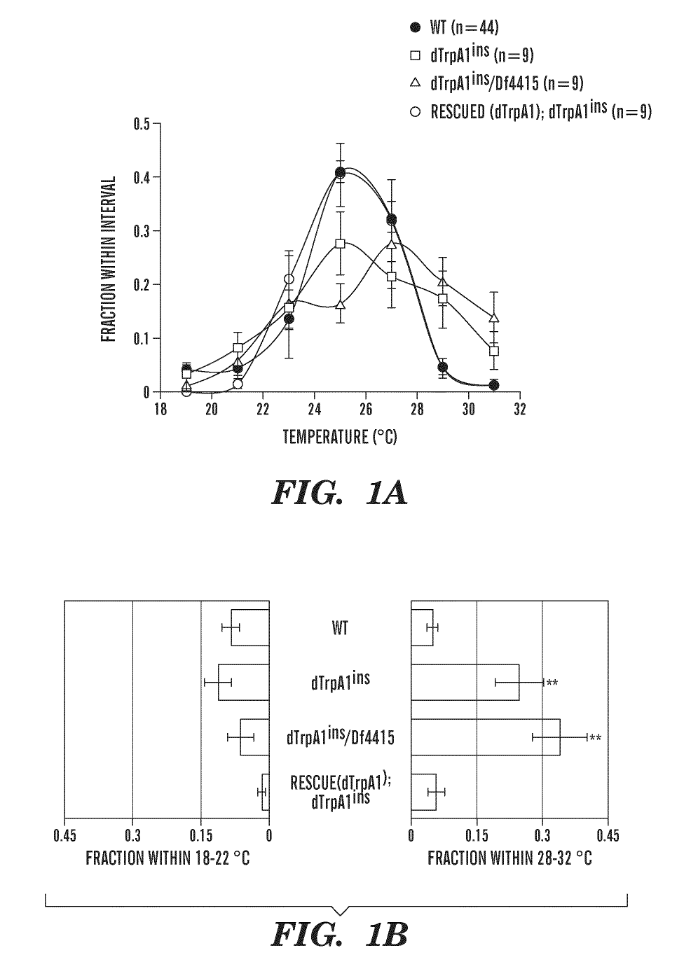

FIG. 1a is a line graph showing the distribution of animals of indicated genotypes on thermal gradient.

FIG. 1b is bar graph showing fraction of animals in 18-22° C. and 28-32° C. regions of thermal gradient. In FIGS. 1a and 1b, data are mean+/−SEM, n=number of assays, ** P≦0.0001 compared to wild type (unpaired t-test).

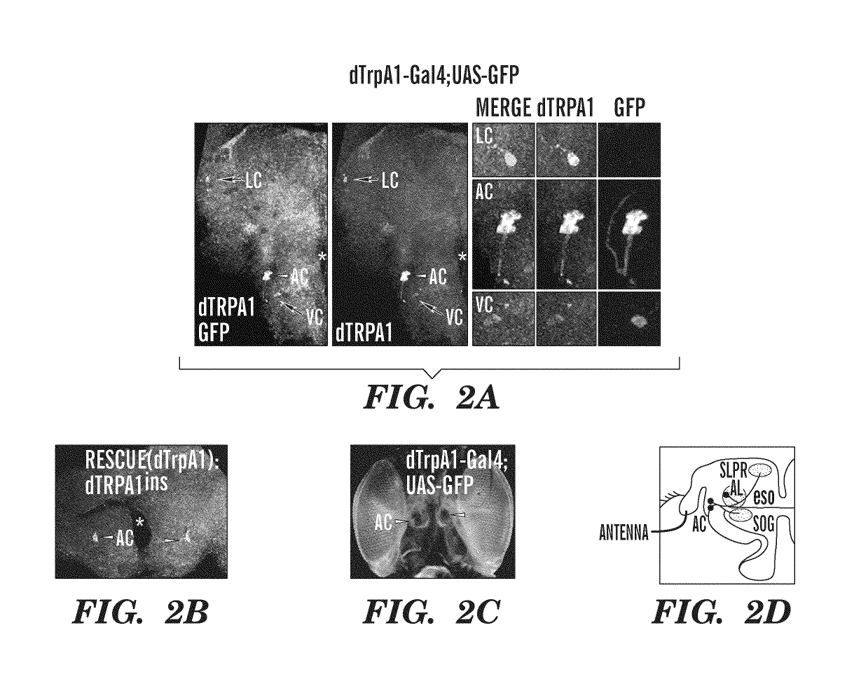

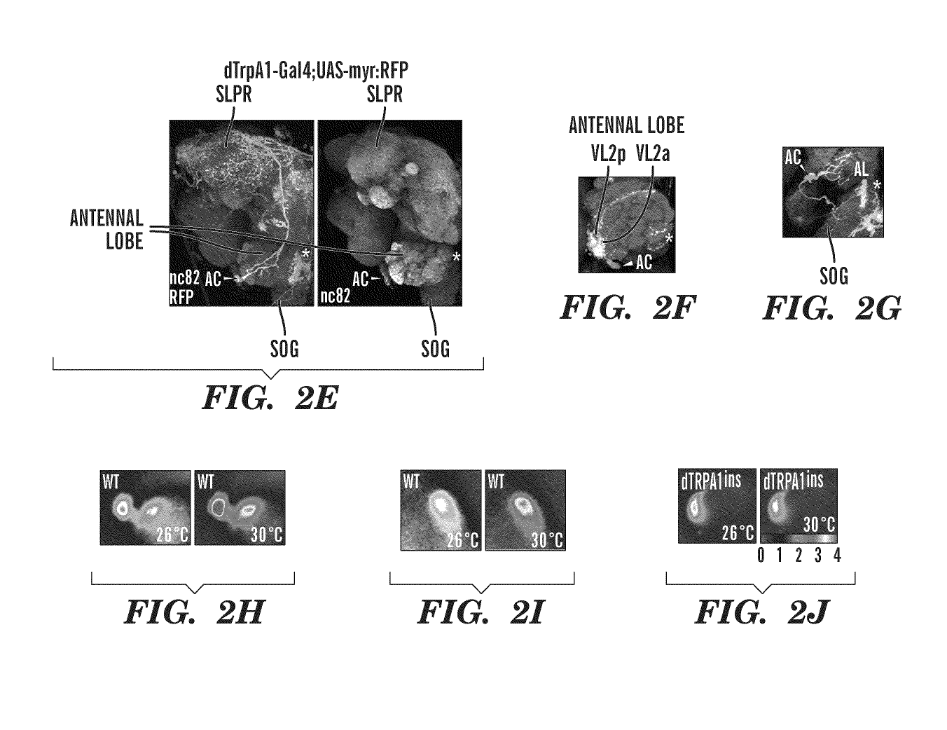

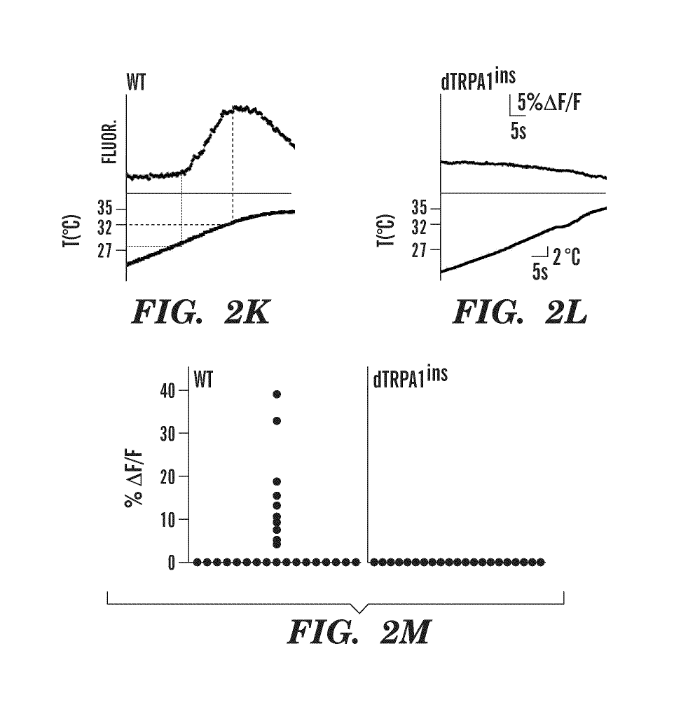

FIG. 2a is photomicrographs showing location of expression of dTrpA1-Gal4 and UAS-GFP constructs. Locations of AC (arrowhead), LC (arrow) and VC (double arrow) neurons are marked.

FIG. 2b is a photomicrograph showing the dTRPA1 minigene expression. Location of AC is marked.

FIG. 2c is a photomicrograph showing dTrpA1-Gal4 and UAS-GFP expression, antennae have been removed. Location of AC is marked.

FIG. 2d is a schematic showing the AC projections.

FIG. 2e is photomicrographs showing AC processes labeled using dTrpA1SH-Gal4;YAS-myr:RFp (left). Camera-lucida-style outline of AC projections (right). Cells that express dTrpA1SH-Gal4 but do not detectably express dTRPA1 protein are also labeled (see also FIG. 2a).

FIGS. 2e-f are photomicrograph showing AC projections to (f) AL and (g) SOG.

FIGS. 2h-j are photomicrograph showing G-CaMP labeled AC's. Simultaneous imaging of two ACs is seen in FIG. 2h.

FIGS. 2k-l are line graphs showing warmth responsive G-CaMP fluorescence of ACs.

FIG. 2m is a graph showing maximum ΔF/F of each AC imaged. In FIGS. 2a-m, AL is antennal lobe, SOG is subesophageal ganglion, SPLR is superior lateral protocerebrum and eso (asterisk) is esophagus.

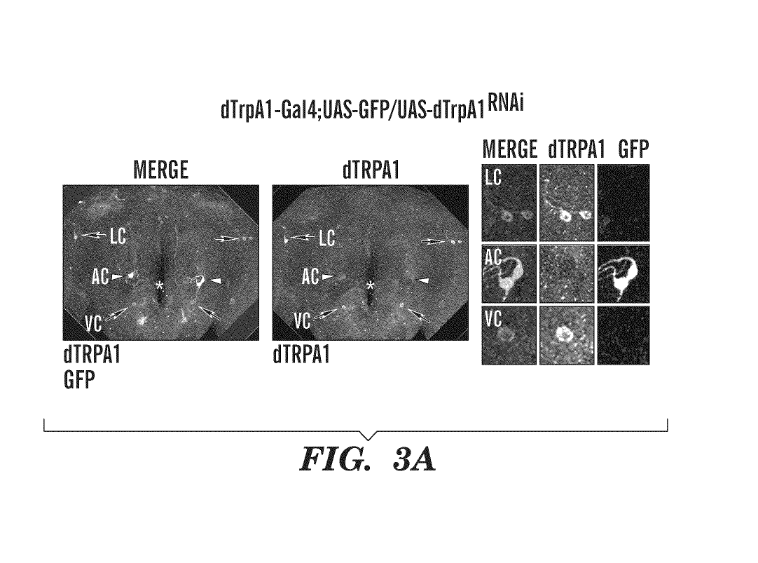

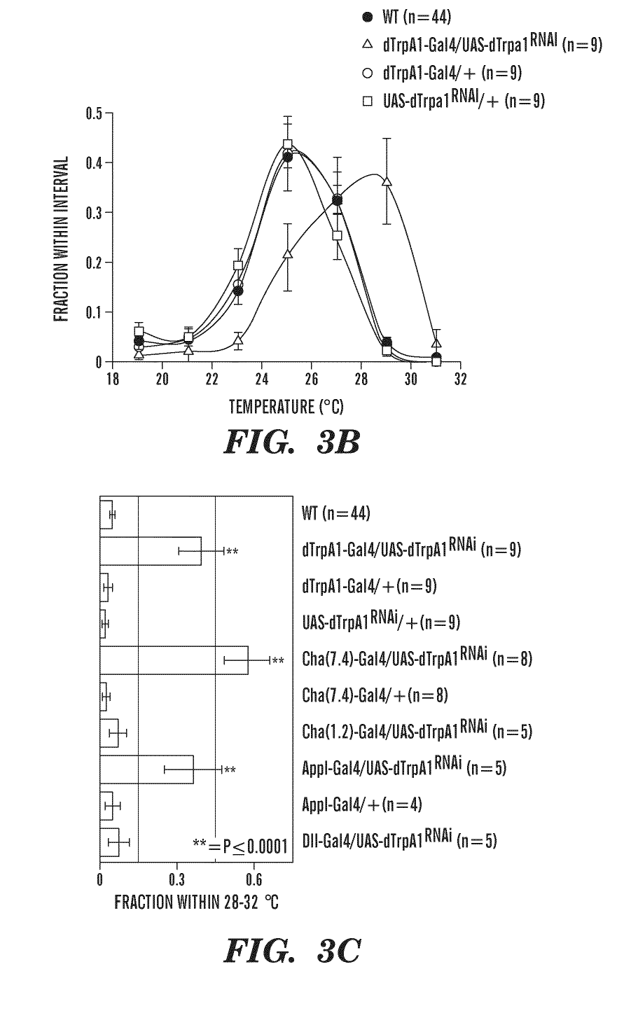

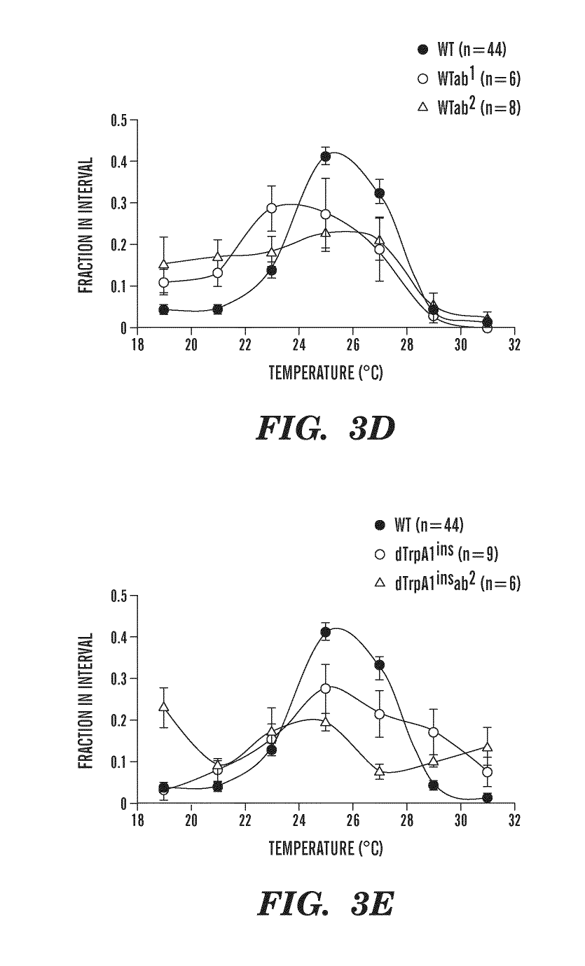

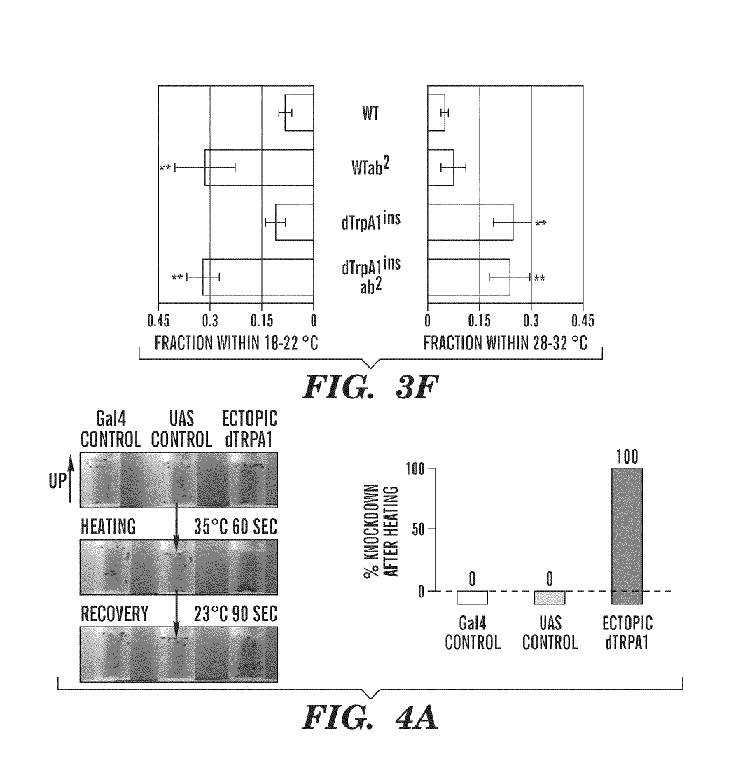

FIG. 3a is photomicrographs showing AC-specific knockdown of dTRPA1 protein expression in dTrpA 1 SH-Gal4; UAS-GFP; UAS [symbol] idTrpA1RNAi animals. dTRPA1 is expressed in LC (arrow) and VC (double arrow), but not AC neurons (arrowhead). GFP marks dsRNA-expressing cells. Two left panels show adult brain and right hand panels show close-ups of specific cells.

FIG. 3b is a line graph showing distribution of indicated genotypes along thermal gradient.

FIG. 3b is a bar graph showing fraction of RNAi animals of indicated genotypes in 28-32° C. region of gradient.

FIGS. 3c-d are line graphs showing animals of indicated genotypes along thermal gradient, WTab1, wild-type unilateral ablation and WTab2, wild-type bilateral ablation.

FIG. 3f is a bar graph showing fraction of animals of indicated genotypes in 18-22° C. and 28-32° C. regions of gradient.

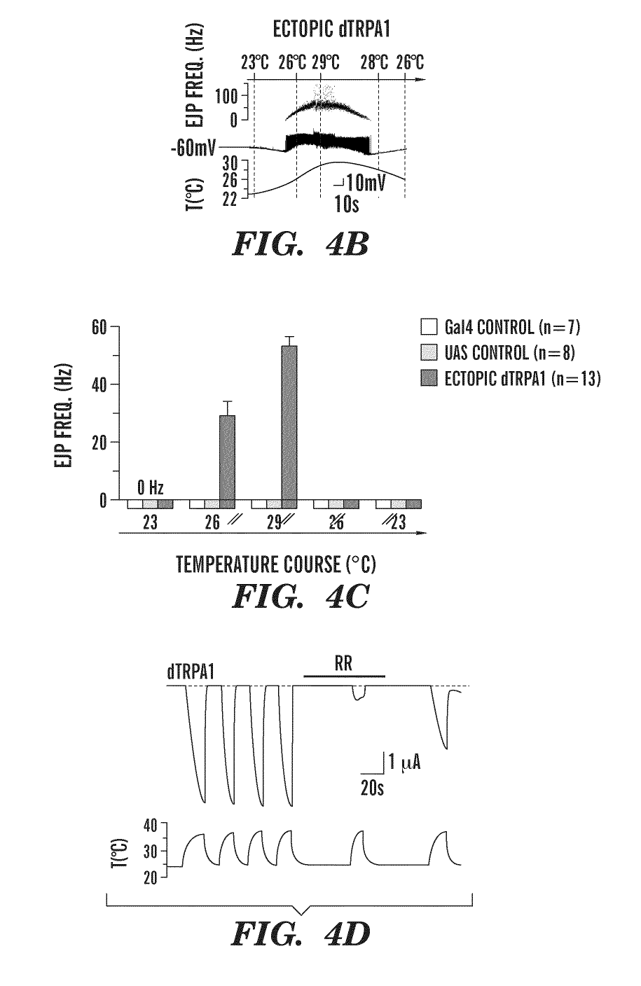

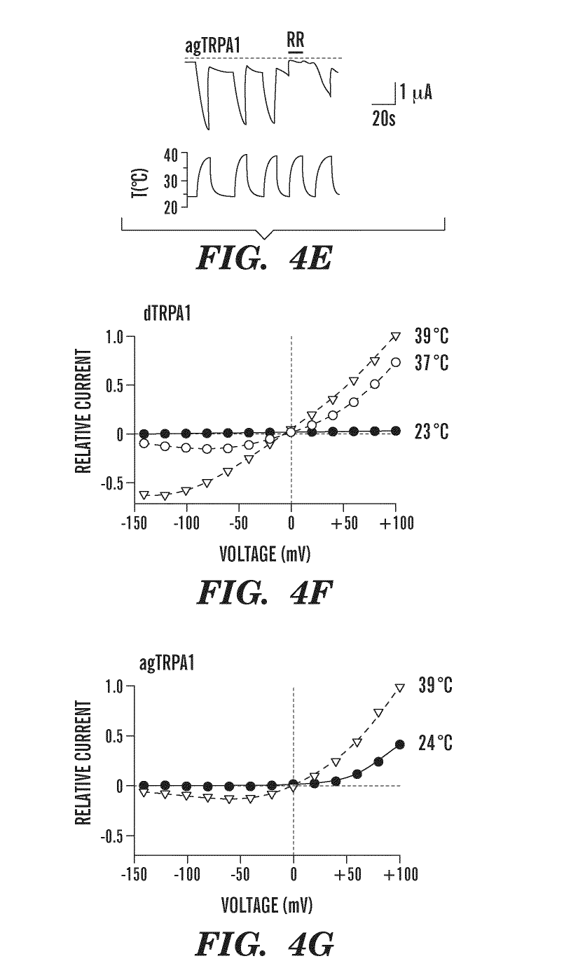

FIG. 4a is a photograph and bar graph showing incapacitation of animals expressing dTRPA1 in all neurons (c155-Gal4;UAS-dTRPA1) after 60 sec at 35° C., but recover at 23° C. Gal4 control, c155-Gal4. UAS control, UAS-dTRPA1. Ectopic dTRPA1, c155-Gal4;UAS-dTRPA1. Five experiments/genotype, 15 flies/experiment, SEM's=0.

FIGS. 4b-c are graph showing stimulation of transmission at neuromuscular junction in c155-Gal4;UAS-dTRPA1 upon warming (above ˜25° C.).

FIGS. 4d-e are graphs showing warmth-evoked currents in (d) dTRPA1 or (e) agTRPA1 expressing oocytes (−60 mV, n>14 each). Oocytes were injected with BAPTA 30 min prior to recording, minimizing cytosolic Calcium elevations. RR: 50 micromolar Ruthenium Red.

FIGS. 4f-g are line graphs showing current-voltage relationships of (f) dTRPA1 and (g) agTRPA1 at indicated temperatures.

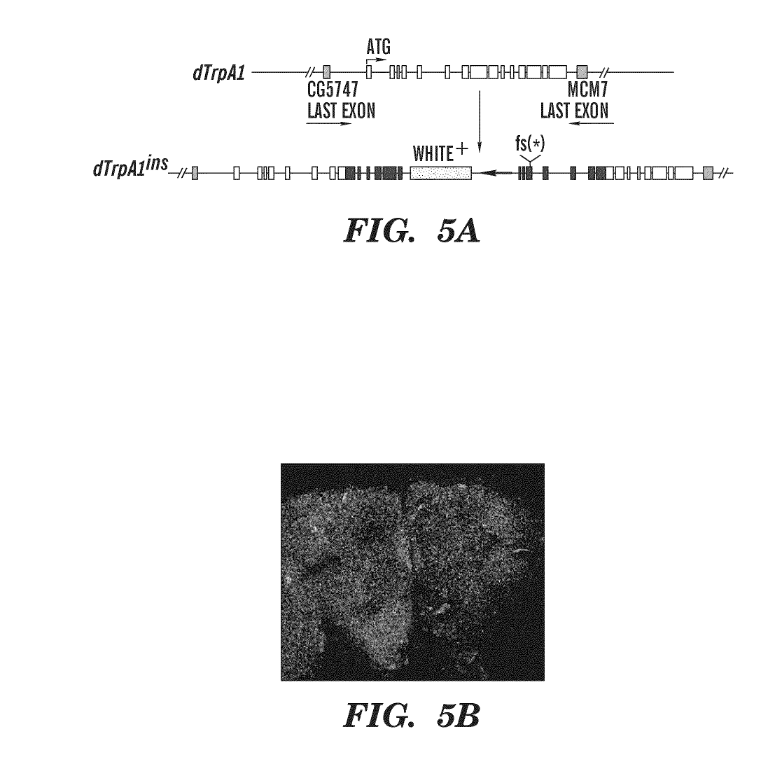

FIG. 5a is a schematic representation of dTrpA1^{ins} mutant construct. dTrpA1^{ins} was created via a site-directed insertional disruption. This “loop-in” created a partial duplication of exons 2 through 14 of the dTrpA 1 gene (duplicated region shown in gray) and the insertion of a white minigene flanked by an FRT site (arrowhead) between duplicated gene segments. In addition, a frame-shift mutation was introduced in the downstream copy of the dTrpA1 locus at amino acid 183. The upstream copy of dTrpA1 lacks sequences encoding the sixth transmembrane domain and C-terminus of dTRPA1, while the downstream copy lacks promoter sequences and the normal start codon and also contains the frame-shift mutation that is predicted to truncate the protein within the third ankyrin repeat.

FIG. 5b is a photographmicrograph showing lack of normal dTRPA1 in dTrpA1 mutant animals.

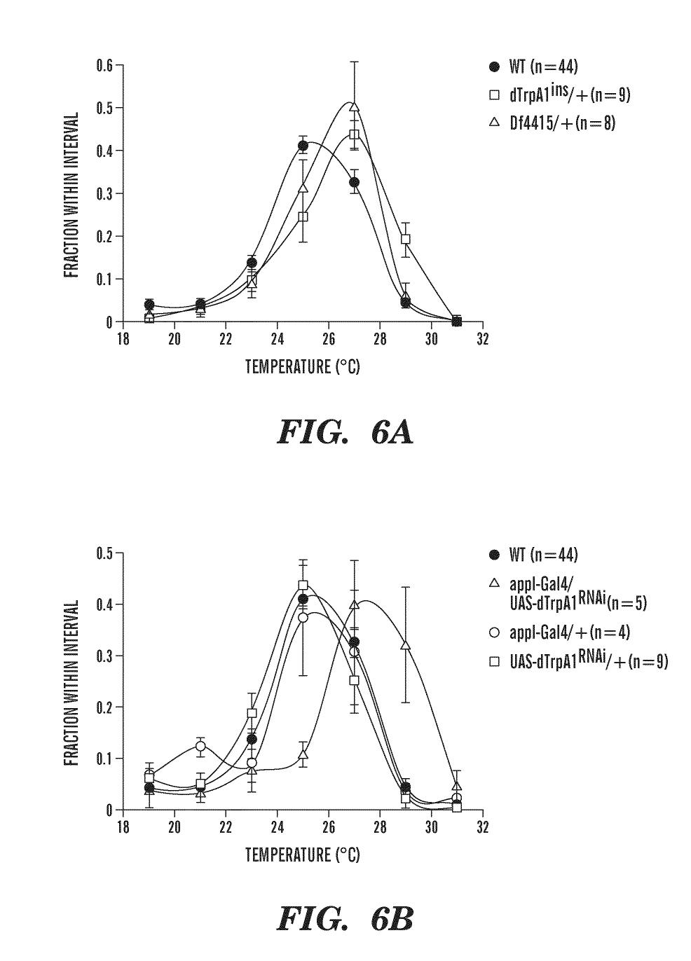

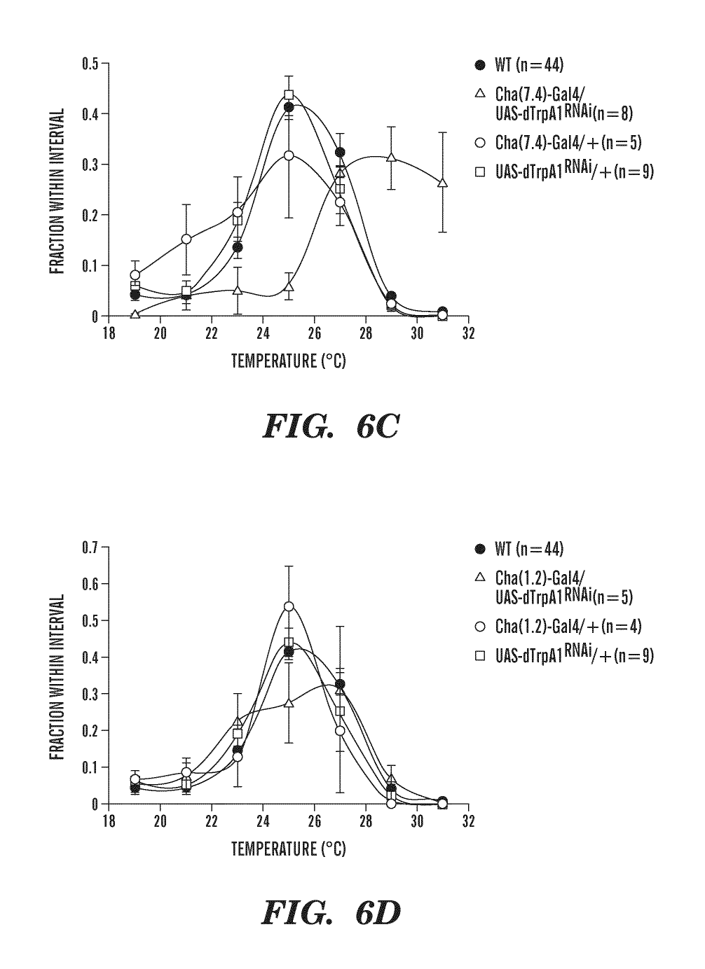

FIG. 6a-d are line graphs showing effects of partial loss of dTrpA1 function and dTrpA1 RNAi knockdown on thermal preference. Distribution of animals of indicated genotypes along the thermal gradient is shown.

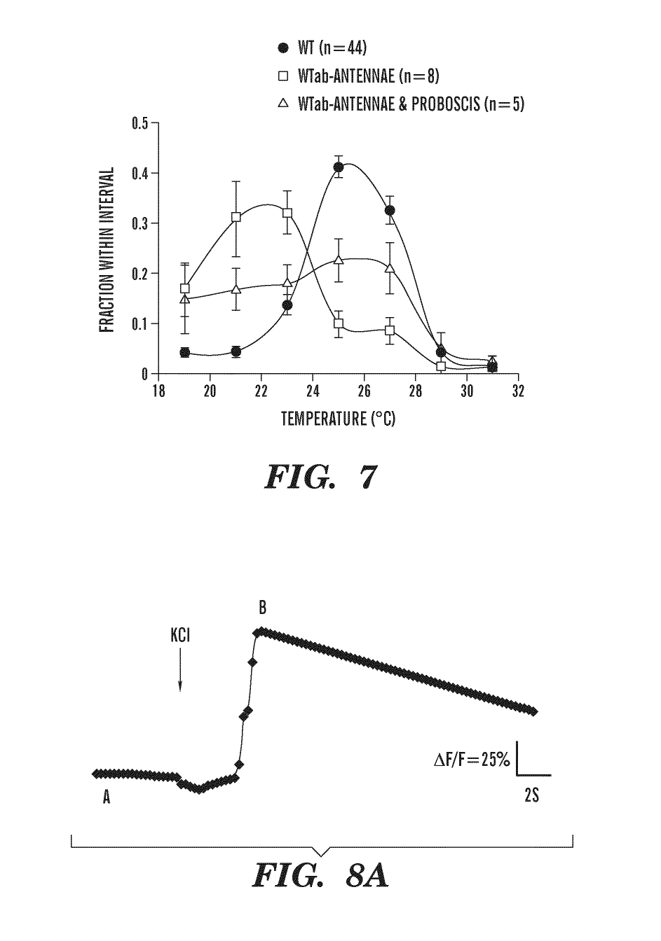

FIG. 7 is a line graph showing distribution of animals on thermal gradient after bilateral removal of third antennal segment and aristae (WTab-antennae) or after bilateral removal of third antennal segment and aristae as well as the proboscis (WTab-antennae and proboscis). Removal of the proboscis increases the cold avoidance defect of antennal ablation. n=number assays. Data are mean+/−SEM.

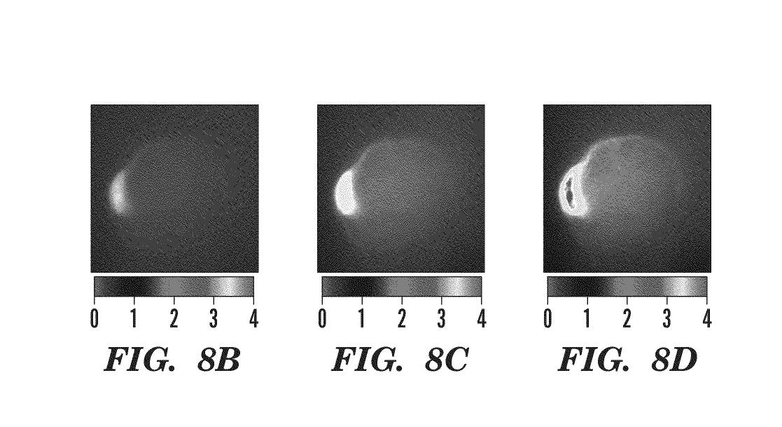

FIG. 8a is a trace of AC neuron in dTRPA1^{ins};dTrpA1SH-Gal4;UAS-GCaMP animal (dTRPA1^{ins}) after 10 μl of 3M KCl was added to the perfusion chamber. The trace and images are of the same cell shown in FIG. 2j and were obtained immediately after the temperature ramp shown. Fluorescence increased within ˜3 sec of KCl addition. Labels A and B in Figure Maximum ΔF/F was 100% in this cell.

FIGS. 8b-d are images of a neuron, (b) grayscale and (c) pseudo-color image prior to KCl addition and (d) pseudo-color image after KCl addition. FIGS. 8b and 8c were taken at the time point labeled A in FIG. 8a and FIG. 8d was taken at point B in FIG. 8a.

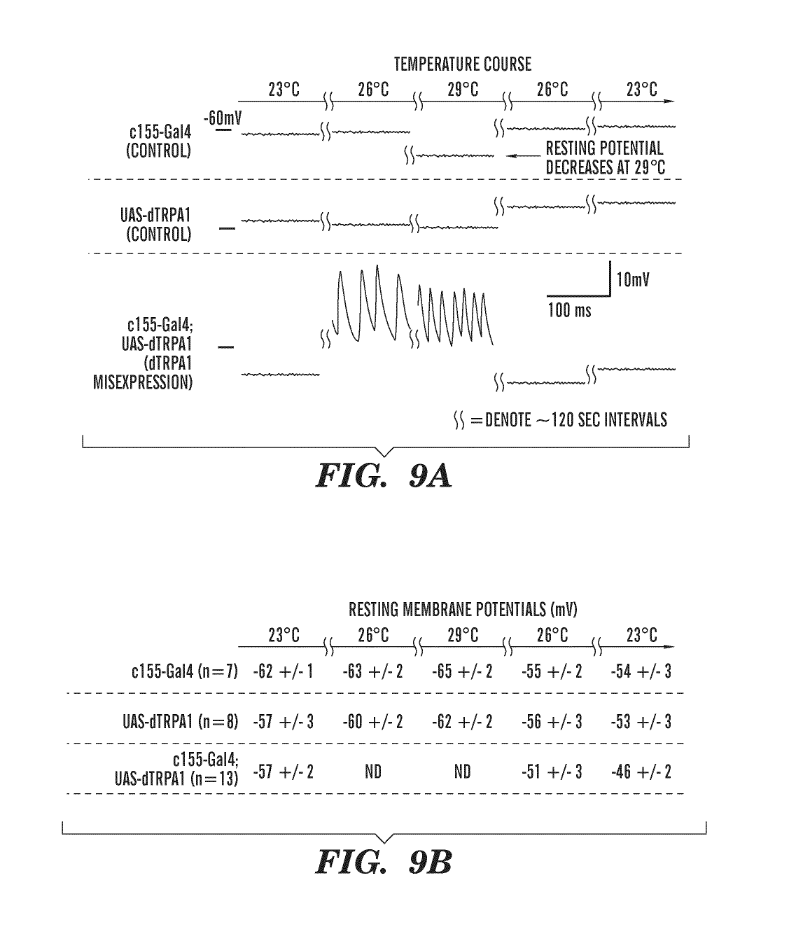

FIG. 9a shows representative recordings of temperature-responsive activity at the neuromuscular junctions of control and dTRPA1 mis-expressing flies. The overall temperature courses were as in FIG. 4b, but the time intervals depicted in these panels are much shorter, permitting the resolution of individual Excitatory Junction Potentials (EJPs). Note that warming to 29° C. slightly decreased the resting membrane potential of control muscles.

FIG. 9b shows the resting membrane potentials (in mV). Mean+/−SEM. ND=not determined; the high frequency of warmth-activated EJPs in these animals prevented accurate determination of muscle resting membrane potential.

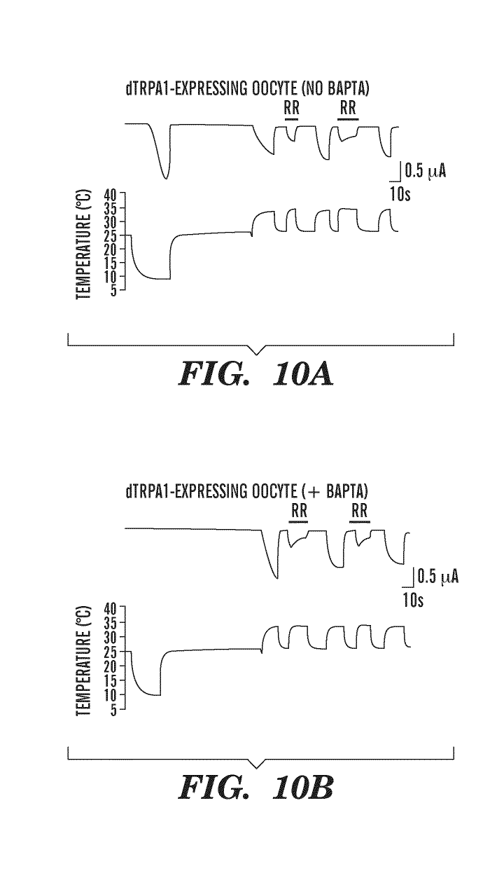

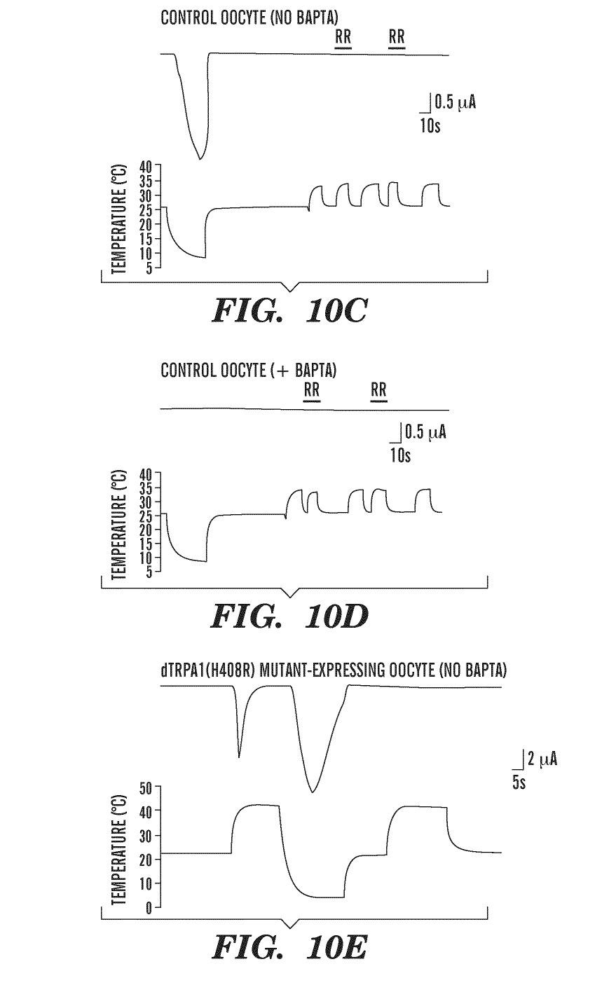

FIGS. 10a-d are traces of currents in dTRPA1 expressing and control oocytes. (a) Current from dTRPA1-expressing oocyte exposed to cooling and warming. (b) Current from dTRPA1-expressing oocyte injected with 50 ml of 20 mM BAPTA 30 min prior to recording, yielding an approximate final concentration of 1 mM within the oocyte. (c) Current from control oocyte that was not injected with dTRPA1 RNA. (c) Current from control oocyte injected with 50 ml of 20 mM BAPTA 30 min prior to recording. RR: 50 micromolar Ruthenium Red. (c) Current from oocyte expressing the H408R mutant dTRPA1 channel. The paper originally reporting warmth activation of dTRPA1 (ref. 12) unknowingly used this H408R mutant channel rather than a wild-type channel. Unlike the wild-type dTRPA1, the H408R mutant channel rapidly inactivates and does not respond to repeated warming. BAPTA is a calcium chelator.

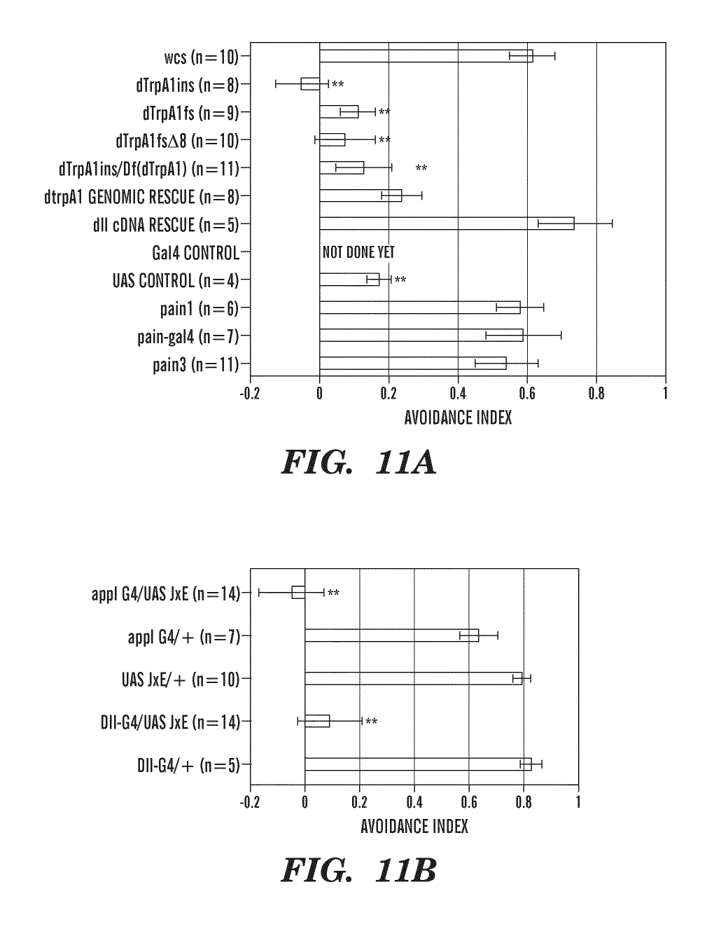

FIGS. 11a-b are bar graphs showing dTRPA1 is required for AITC vapor avoidance in Drosphila. (a) dTrpA1 loss-of-function mutants (dTrpA1ins, dTRPA1fs.ex8, and dTrpA1fs) showing a robust deficit in AITC avoidance, while dTrpA1 cDNA rescue animals and painless mutants are not significantly different from white; Canton-S control. Avoidance index was calculated by subtracting the fraction of flies entering the AITC+DMSO tube from the fraction of flies entering the DMSO side at the end of each choice test. (Flies remaining in the central chamber do not contribute to these numbers).

(b) Tissue-specific RNAi knockdown of dTRPA1 in neurons and in peripheral tissues decreases AITC avoidance. Appl>RNAi: Appl-Gal4/UASdTrpA1RNAi. Appl-Gal4 control: Appl-Gal4/+. Dll>RNAi: Dll-Gal4/UASdTrpA1RNAi. Dll-Gal4 control: Dll-Gal4/+. UAS-dTrpA1RNAi control: UASdTrpA1RNAi/+. **: p<0.01, with respect to controls, Tukey HSD. In all figures, data are mean+/−SEM, unless otherwise indicated. >20 adults/assay.

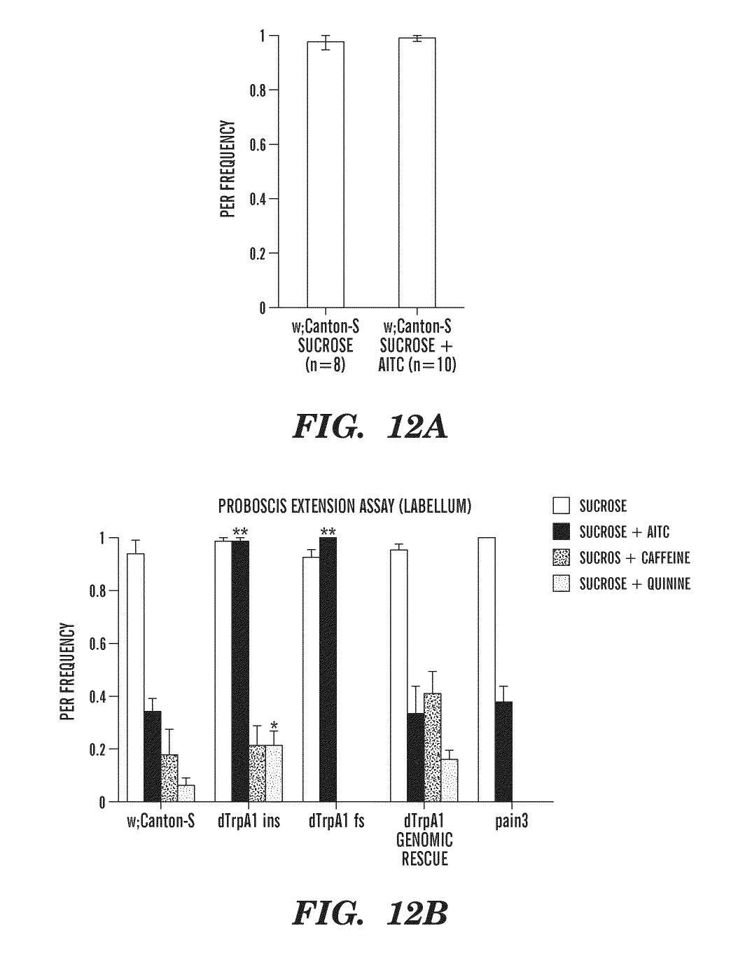

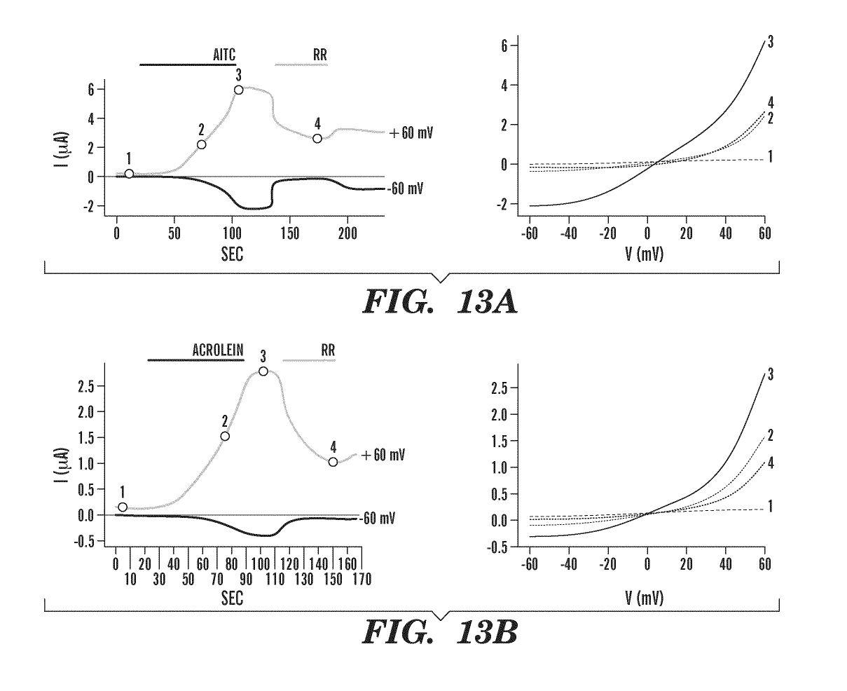

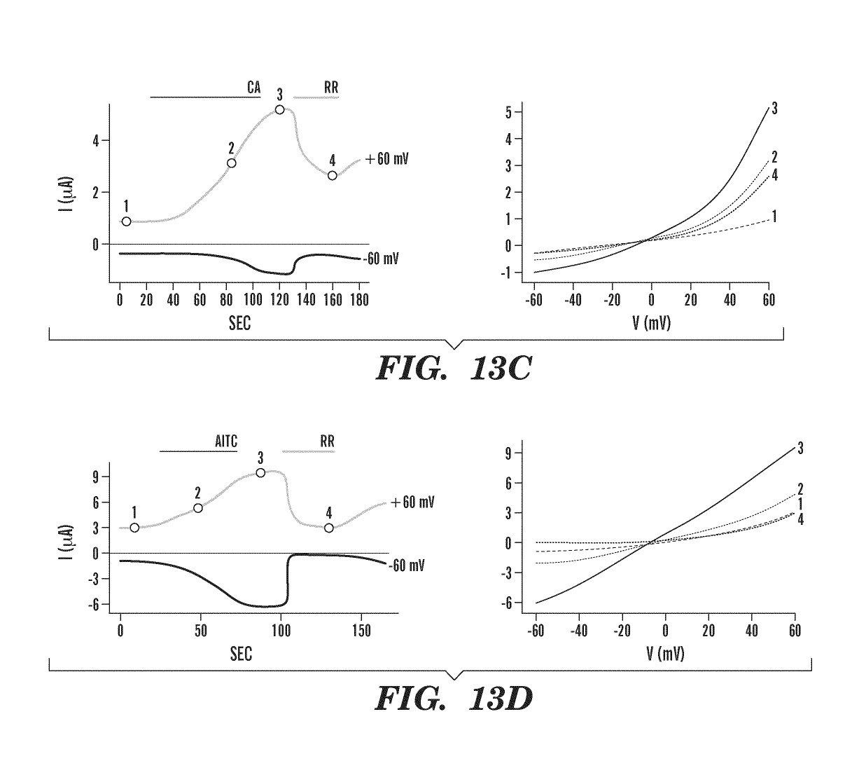

FIG. 12a-b are bar graphs showing dTRPA1 is required for AITC-dependent inhibition of proboscis extension response (PER). (a) AITC had no effect on PER elicited via solution contact with legs. (b) AITC decreased PER frequency elicited via solution contact with the labellum in control animals. dTrpA1 mutants showed a robust deficit in this AITC-mediated response. *: p<0.05, **: p<0.01, with respect to control strain, Tukey HSD.

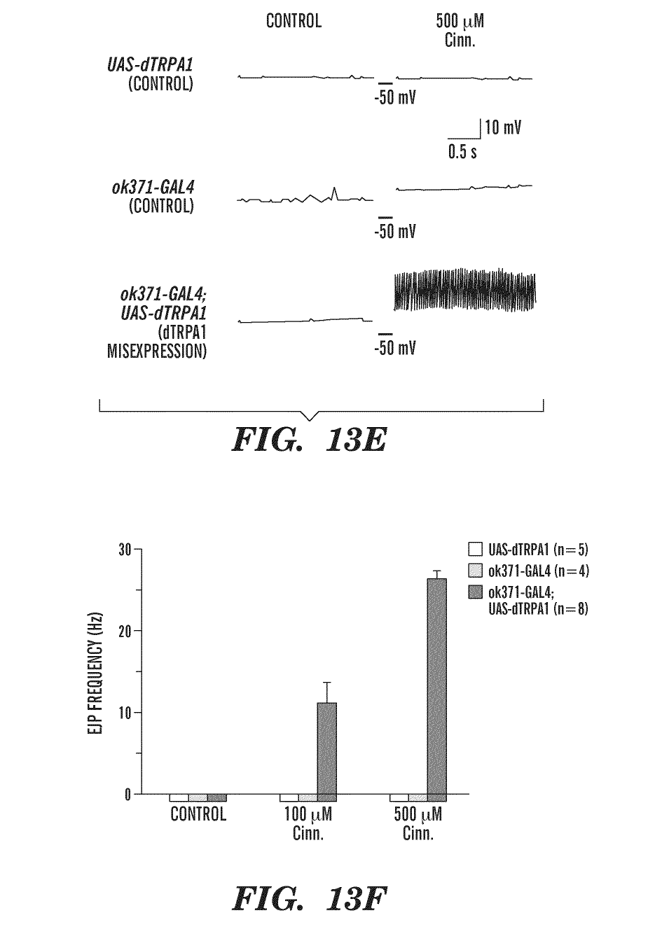

FIG. 13a-d show that insect TRPA1 channels are activated by reactive electrophiles. Responses of (a-c) dTRPA1 and (d) agTRPA1 (d) expressed in Xenopus laevis oocytes. Left panels show currents recorded at −60 and +60 mV as indicated. Perfusion buffers containing 100 μM of each indicated reactive chemical were applied for 60-80 sec. To inhibit activated channels, 100 μM RR was used. AITC: allyl isothiocyanate, CA: cinnamaldehyde, RR: ruthenium red. Right panels present I-V relationships at time points marked in the left panels. 1: current prior to perfusing reactive chemicals, 2: rising current in the middle of reactive chemical perfusion, 3: maximal current, and 4: residual current in presence of RR.

FIG. 13e-f show that motor neurons expressing dTRPA1 are activated by cinnamaldehyde (Cinn.). (e) Representative recordings of motor neuron-driven muscle excitatory junction potentials (EJPs) recorded from 3rd instar larval neuromuscular junctions (ok371-Gal4 drives motor neuron expression of UAS transgenes). (f) Mean EJP frequencies. In genetic controls, no EJPs were observed.

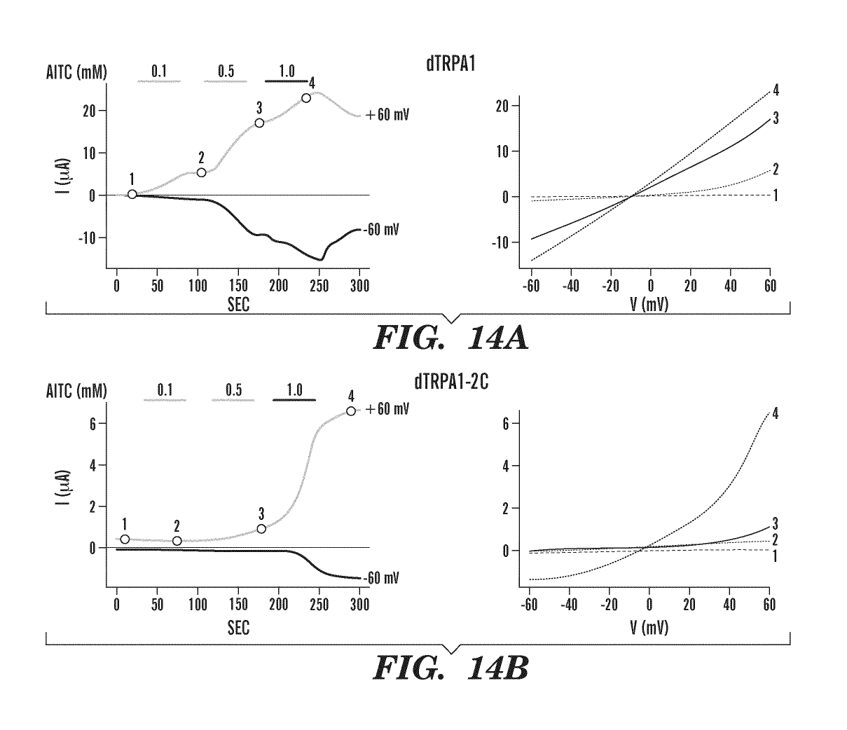

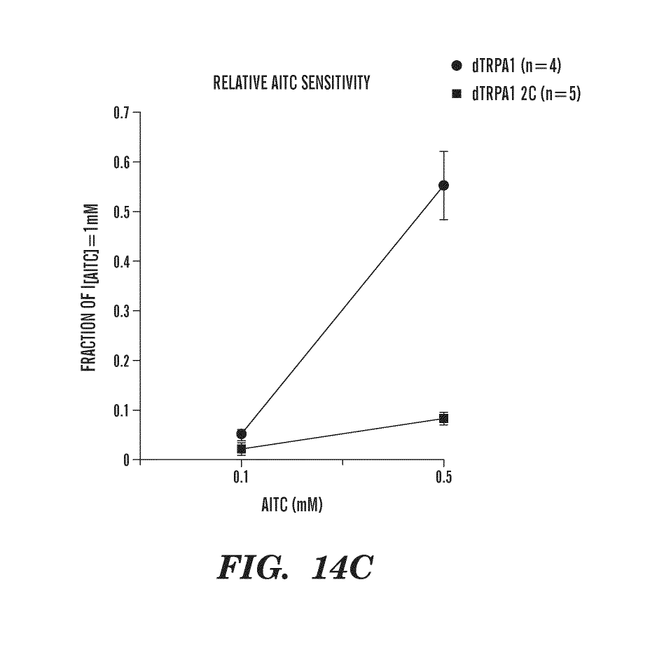

FIGS. 14a-b shows that dTrpA1 activation by chemicals on evolutionarily conserved residues. (a-b) Wild type TRPA1 (wt) (a) and dTRPA1-2c mutant (b) were expressed in oocytes and tested in parallel. Perfusion buffer containing 0.1, 0.5, or 1.0 mM AITC was applied sequentially for 60 sec with 25 sec intervals. Left panels show current recordings, right panels I-V curves at time points marked.

FIG. 14c is a line graph showing currents at −60 mV generated by applying 0.1 and 0.5 mM of AITC normalized with respect to the current amplitude elicited by 1.0 mM AITC. Relative sensitivity of dTRPA1-2C to lower doses of AITC was significantly reduced compared to wild type. p<0.05 at 0.1 mM, and p<0.001 at 0.5 mM of AITC. TRPA1-2C′ s reduced sensitivity meant that AITC reaches its solubility limit well before saturating dTRPA1-2C responses.

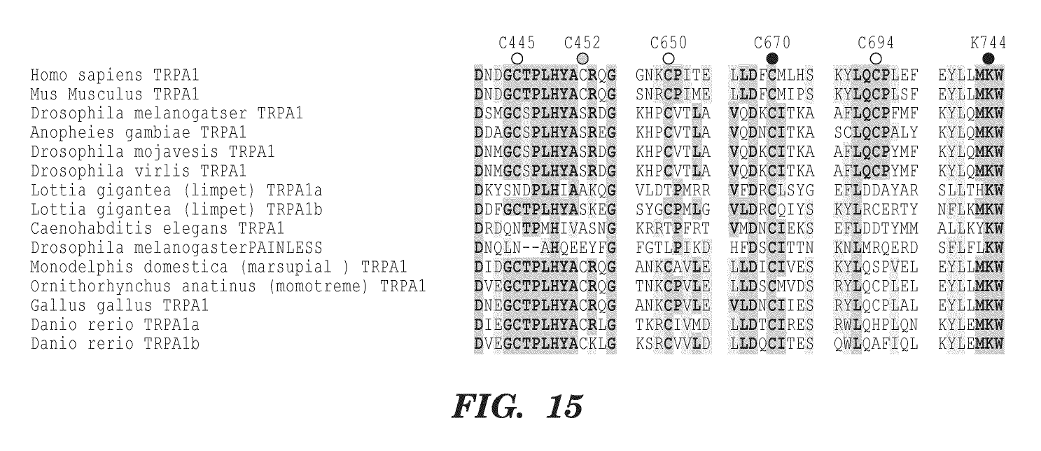

FIG. 15 sequence alignment showing evolutionary conservation of residues implicated in reactive electrophile detection (SEQ ID NOS 9-23, respectively in order of appearance).

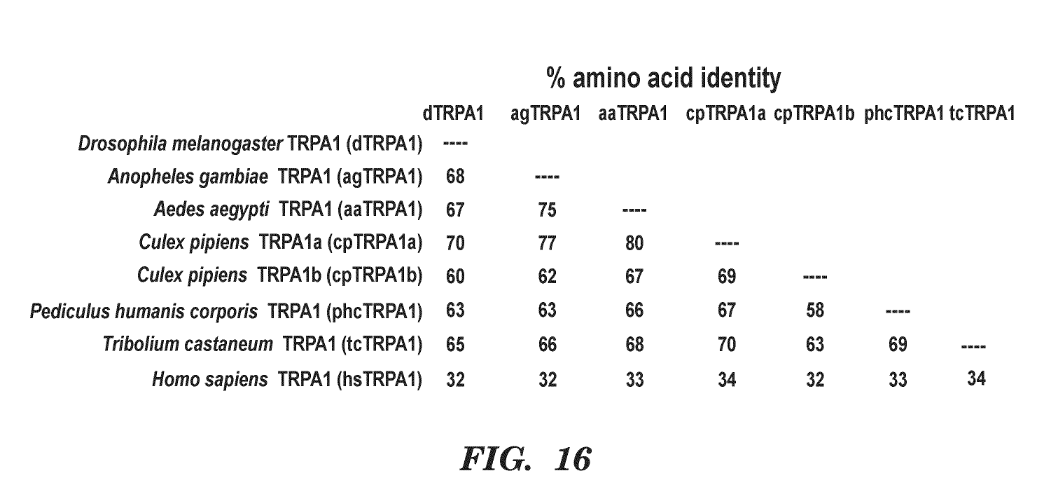

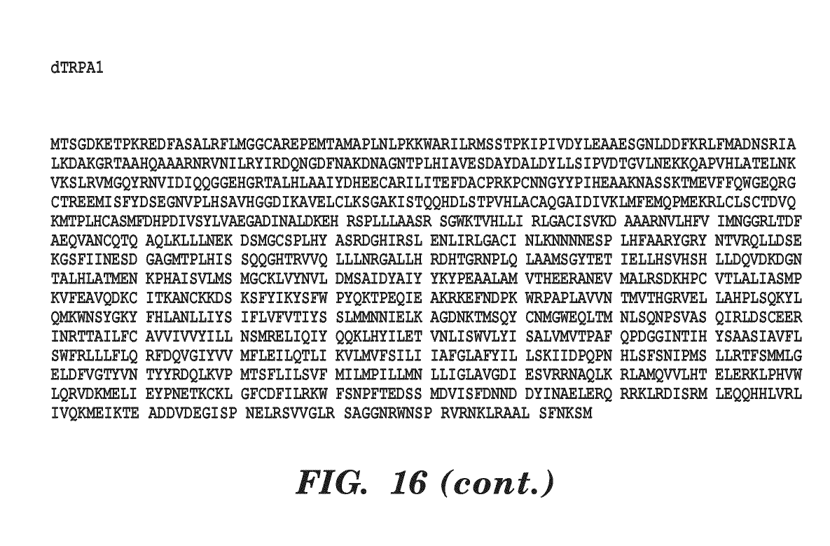

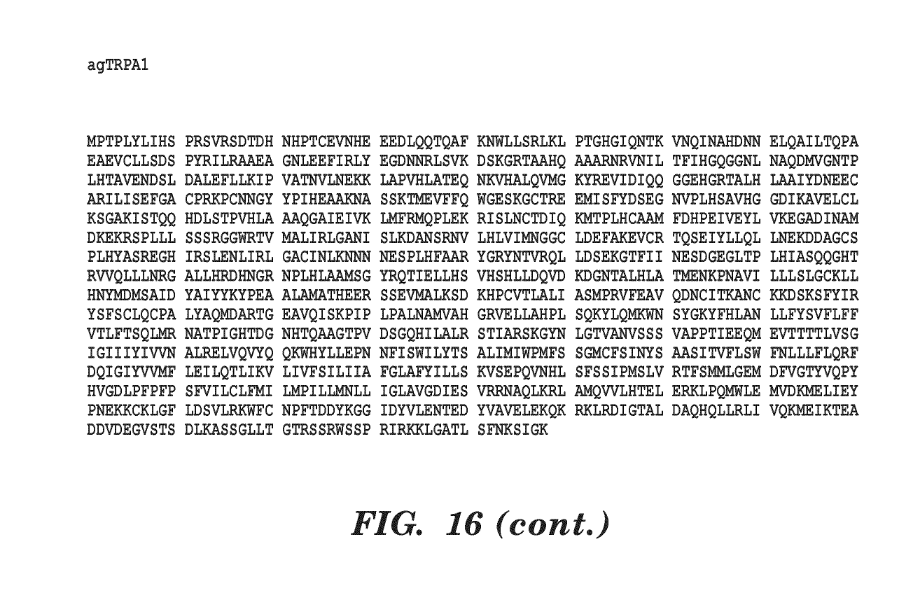

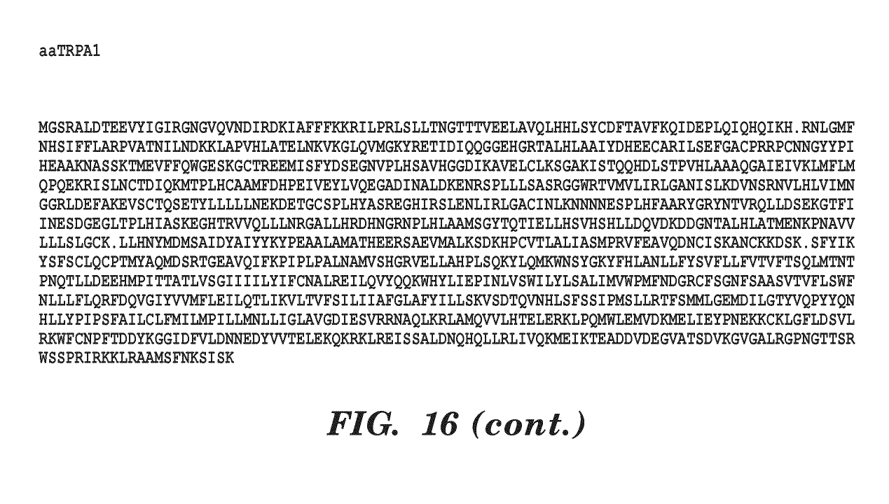

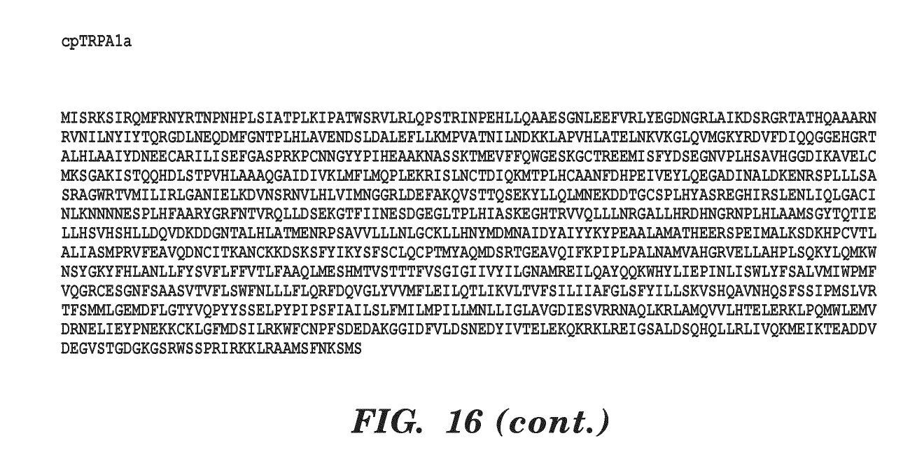

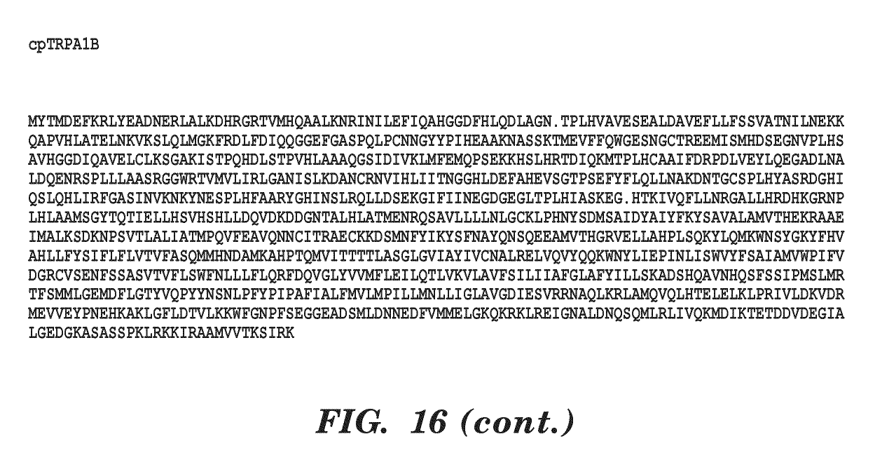

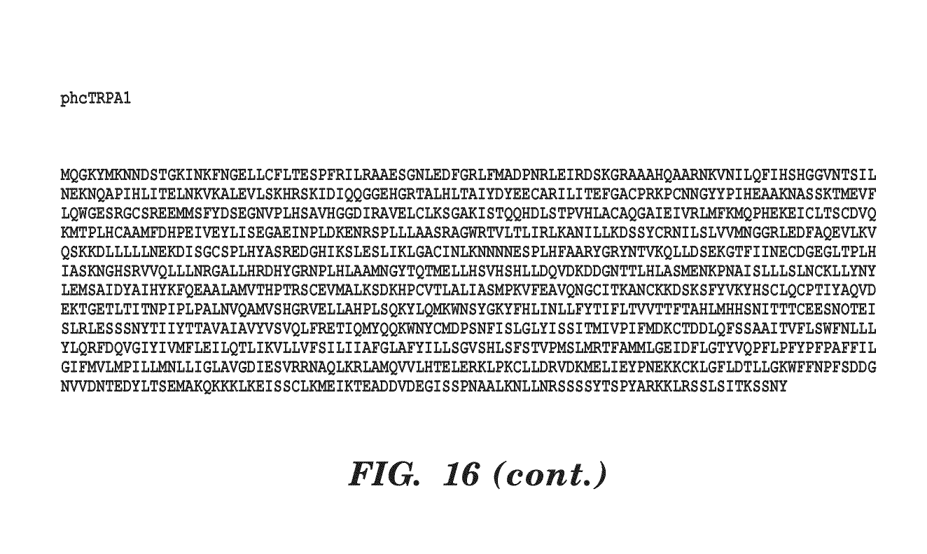

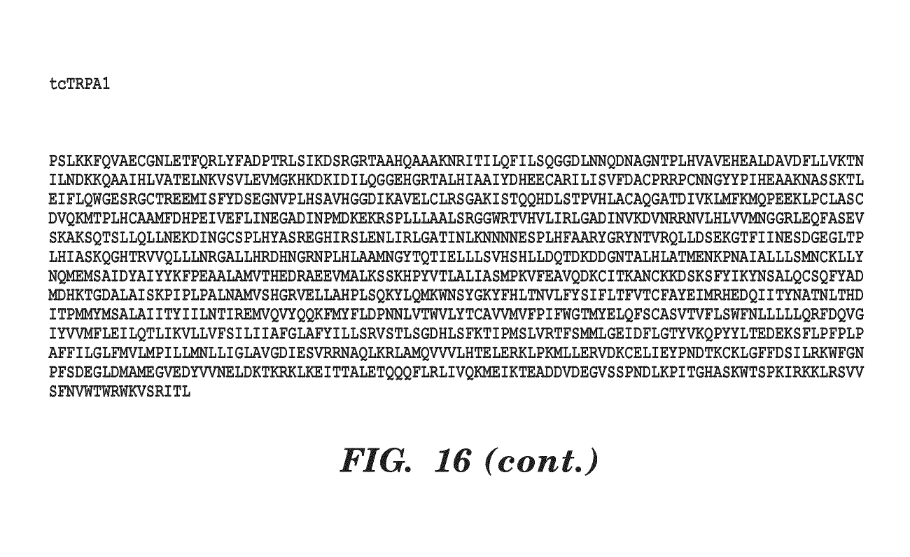

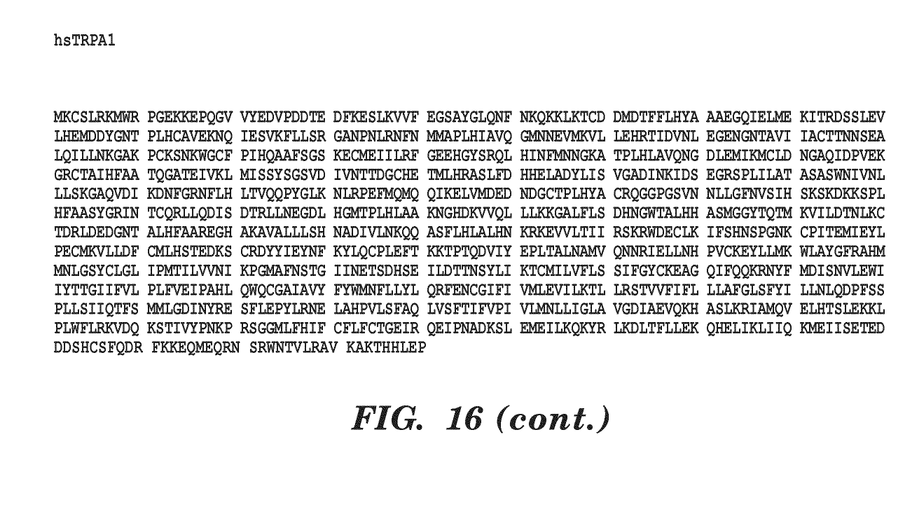

FIG. 16(a) an amino acid identity matrix and (b) sequence alignment of highly related dTRPA1 orthologs (aaTRPA1, cpTRPA1a, cpTRPA1b and phcTRPA1) in insects that act as disease vectors and agricultural pests. Culex pipiens contains a tandem array of TRPA1 orthologs, cpTRPA1a and cpTRPA1b. Human TRPA1 (hsTRPA1) is included for comparison. ANK=ankyrin repeat, TM=transmembrane region, P-loop=pore region. Location of H408 is noted with asterisk. FIG. 16 discloses SEQ ID NOS 24-31, respectively, in order of appearance)

### DETAILED DESCRIPTION OF THE INVENTION

Unless otherwise explained, all technical and scientific terms used herein have the same meaning as commonly understood by one of ordinary skill in the art to which this disclosure belongs. Definitions of common terms in neurobiology and molecular biology can be found in The Merck Manual of Diagnosis and Therapy, 18th Edition, published by Merck Research Laboratories, 2006 (ISBN 0-911910-18-2); Robert S. Porter et al. (eds.), The Encyclopedia of Molecular Biology, published by Blackwell Science Ltd., 1994 (ISBN 0-632-02182-9); and Robert A. Meyers (ed.), Molecular Biology and Biotechnology: a Comprehensive Desk Reference, published by VCH Publishers, Inc., 1995 (ISBN 1-56081-569-8); The ELISA guidebook (Methods in molecular biology 149) by Crowther J. R. (2000); Fundamentals of RIA and Other Ligand Assays by Jeffrey Travis, 1979, Scientific Newsletters; Immunology by Werner Luttmann, published by Elsevier, 2006. Definitions of common terms in molecular biology may be found in Benjamin Lewin, Genes IX, published by Jones & Bartlett Publishing, 2007 (ISBN-13: 9780763740634); Kendrew et al. (eds.), The Encyclopedia of Molecular Biology, published by Blackwell Science Ltd., 1994 (ISBN 0-632-02182-9); and Robert A. Meyers (ed.), Molecular Biology and Biotechnology: a Comprehensive Desk Reference, published by VCH Publishers, Inc., 1995 (ISBN 1-56081-569-8).

Unless otherwise stated, experiments detailed herein were performed using standard procedures, as described, for example in Maniatis et al., Molecular Cloning: A Laboratory Manual, Cold Spring Harbor Laboratory Press, Cold Spring Harbor, N.Y., USA (1982); Sambrook et al., Molecular Cloning: A Laboratory Manual (2 ed.), Cold Spring Harbor Laboratory Press, Cold Spring Harbor, N.Y., USA (1989); Davis et al., Basic Methods in Molecular Biology, Elsevier Science Publishing, Inc., New York, USA (1986); or Methods in Enzymology: Guide to Molecular Cloning Techniques Vol. 152, S. L. Berger and A. R. Kimmerl Eds., Academic Press Inc., San Diego, USA (1987)).

Current Protocols in Molecular Biology (CPMB) (Fred M. Ausubel, et al. ed., John Wiley and Sons, Inc.), Current Protocols in Protein Science (CPPS) (John E. Coligan, et. al., ed., John Wiley and Sons, Inc.) and Current Protocols in Immunology (CPI) (John E. Coligan, et. al., ed. John Wiley and Sons, Inc.), Current Protocols in Cell Biology (CPCB) (Juan S. Bonifacino et. al. ed., John Wiley and Sons, Inc.), Culture of Animal Cells: A Manual of Basic Technique by R. Ian Freshney, Publisher: Wiley-Liss; 5th edition (2005), Animal Cell Culture Methods (Methods in Cell Biology, Vol 57, Jennie P. Mather and David Barnes editors, Academic Press, 1st edition, 1998) which are all incorporated by reference herein in their entireties.

Methods for the production of antibodies are disclosed in PCT publication WO 97/40072 or U.S. Application. No. 2002/0182702, which are herein incorporated by reference. The processes of immunization to elicit antibody production in a mammal, the generation of hybridomas to produce monoclonal antibodies, and the purification of antibodies may be performed by described in “Current Protocols in Immunology” (CPI) (John Wiley and Sons, Inc.); Antibodies: A Laboratory Manual (Ed Harlow and David Lane editors, Cold Spring Harbor Laboratory Press 1988) and Brown, “Clinical Use of Monoclonal Antibodies,” in BIOTECHNOLOGY AND PHARMACY 227-49, Pezzuto et al. (eds.) (Chapman & Hall 1993) which are all incorporated by reference herein in their entireties.

It should be understood that this invention is not limited to the particular methodology, protocols, and reagents, etc., described herein and as such may vary. The terminology used herein is for the purpose of describing particular embodiments only, and is not intended to limit the scope of the present invention, which is defined solely by the claims.

Other than in the operating examples, or where otherwise indicated, all numbers expressing quantities of ingredients or reaction conditions used herein should be understood as modified in all instances by the term “about.” The term “about” when used in connection with percentages may mean±1%.

The singular terms “a,” “an,” and “the” include plural referents unless context clearly indicates otherwise. Similarly, the word “or” is intended to include “and” unless the context clearly indicates otherwise. It is further to be understood that all base sizes or amino acid sizes, and all molecular weight or molecular mass values, given for nucleic acids or polypeptides are approximate, and are provided for description. Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

All patents and other publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Animals from flies to humans are able to distinguish subtle gradations in temperature and exhibit strong temperature preferences¹⁻⁴. Animals move to environments of optimal temperature and some manipulate the temperature of their surroundings, as humans do using clothing and shelter. Despite the ubiquitous influence of environmental temperature on animal behavior, the neural circuits and strategies through which animals select a preferred temperature remain largely unknown.

Embodiments of the present invention are based on the discovery of a protein involved in sensing temperature changes in the environment around insects. The inventors identified a small set of warmth-activated neurons (AC neurons) located in the Drosophila brain whose function is critical for preferred temperature selection. AC neuron activation occurs just above the fly's preferred temperature and depends on dTRPA1, an ion channel that functions as a molecular sensor of warmth. Flies that selectively express dTRPA1 in the AC neurons select normal temperatures, while flies in which dTRPA1 function is reduced or eliminated choose warmer temperatures. This internal warmth-sensing pathway promotes avoidance of slightly elevated temperatures and acts together with a distinct pathway for cold avoidance to set the fly's preferred temperature. Thus, flies select a preferred temperature by using a thermal sensing pathway tuned to trigger avoidance of temperatures that deviate even slightly from the preferred temperature.

The inventors also found that the dTRPA1 is activated by an increase in ambient temperature. The dTRPA1 is necessary for sensing this temperature change but is also needed to elicit the fly avoidance behavior, avoidance of the non-preferred temperature and seeking or moving towards the preferred temperature.

In addition, the inventors have found that TRPA1 found in the mosquito Anopheles gambiae (agTRPA1) also functions similarly in increase temperature sensing; it is activated by an increase in ambient temperature. When agTRPA1 was expressed in Xenpus laevis oocytes, increase in ambient temperature activates the ion channel leading to channel opening and an influx of ions into the oocyte as measured by an increase in current (FIG. 4).

The inventors have also found that the D. melanogaster dTRPA1 is activated by reactive electrophiles, a class of noxious chemicals, and that dTRPA1 is also necessary for eliciting insect behavior of avoiding these noxious chemicals. This is contrary to what has been reported in the art. Both C. elegans and D. melanogaster TRPA1 channels had been reported to be insensitive to reactive electrophiles (45, 49).

Reactive electrophiles are a common class of toxic and potentially mutagenic chemicals that damage living organisms by covalently modifying proteins and nucleic acids (31-33). Reactive electrophiles include a variety of common chemicals that humans perceive as pungent and irritating such as allyl isothiocyanate (AITC), allicin, cinnamaldehyde, 1-chloroacetophenone, 2-chlorobenzylidene malononitrile, 1,5-dichloro3-thiapentane, and acrolein, chemicals present in wasabi, garlic, cinnamon, mace, tear gas, mustard gas, and cigarette smoke/engine exhaust, respectively (34-36). Invertebrates are also sensitive to reactive electrophiles. For example, AITC and acrolein are toxic and mutagenic to the fruit fly Drosophila melanogaster (37, 38). Invertebrate sensitivity to reactive electrophiles is often exploited for defensive purposes. Cruciferous plants and humans use electrophiles like AITC and cinnamaldehyde to control herbivorous insects (39-42), and insects themselves employ electrophiles for chemical defense, sometimes against other insects. For example, bombardier beetles spray electrophilic benzoquinones when threatened and cabbage aphids produce AITC when damaged (43, 44). Despite the shared responsiveness of invertebrates and vertebrates to reactive electrophiles and the ecological significance of their widespread use in chemical defense, whether vertebrates and invertebrates detect reactive electrophiles via similar mechanisms has been unclear.

In fish, rodents and humans, the ion gated channel TRPA1 acts as a receptor for reactive electrophiles, functioning in sensory neurons to mediate pain, irritation and inflammation (45-48). Both C. elegans and D. melanogaster encode TRPA1 orthologs, but these channels have been reported to be insensitive to reactive electrophiles (45, 49). The arthropod-specific TRP channel Painless has been implicated in AITC avoidance (50), but Painless channels do not respond to reactive electrophiles (51).

We have now demonstrated that these ion gated channels are responsive to reactive electrophiles in invertebrates such as arthropods. For examples, reactive electrophiles including allyl isothiocyanate (AITC) and acrolein activate the fruit fly and malaria mosquito orthologs of the TRPA1 ion channels and this mechanism has been rigorously conserved between insects and vertebrates. Without wishing to be bound by theory, we believe that activation of TRPA1 ion channel or family members leads the insect to avoid the current environment and seek out an optimal environment. As explained herein, the behavior elicited by these compounds can be used for insect control.

TRPA1 is a non-selective cation channel belonging to the larger family of TRP ion channels. The TRP channels constitute a large and important class of channels involved in modulating cellular homeostasis. TRP channels have been classified into at least six groups: TRPC (short), TRPV (vanilloid), TRPM (long, melastatin), TRPP (polycystins), TRPML (mucolipins), and TRPA (ANKTM1). The TRPC group can be divided into 4 subfamilies (TRPC1, TRPC4,5, TRPC3,6,7 and TRPC2) based on sequence homology and functional similarities. Currently the TRPV family has 6 members. TRP V5 and TRP V6 are more closely related to each other than to TRPV1, TRP V2, TRPV3, or TRPV4. TRPA1 is most closely related to TRPV3, and is more closely related to TRPV1 and TRPV2 than to TRPV5 and TRPV6. The TRPM family has 8 members. Constituents include the following: the founding member TRPM1 (Melastatin or LTRPC1), TRPM3 (KIAAl 616 or LTRPC3), TRPM7 (TRP-PLIK, ChaK(1), LTRPC7), TRPM6 (ChaK2), TRPM2 (TRPC7 or LTRPC2), TRPM8 (Trp-p8 or CMR1), TRPM5 (Mtrl or LTRPC5), and TRPM4 (FLJ20041 or LTRPC4). The sole mammalian member of the TRPA family is ANKTM1. The TRPML family consists of the mucolipins, which include TRPML1 (mucolipins 1), TRPML2 (mucolipins 2), and TRPML3 (mucolipin3). The TRPP family consists of two groups of channels: those predicted to have six transmembrane domains and those that have 11. TRPP2 (PKD2), TRPP3 (PKD2L1), TRPP5 (PKD2L2) are all predicted to have six transmembrane domains. TRPP1 (PKD13 PC1)5 PKD-REJ and PKD-IL1 are all thought to have 11 transmembrane domains.

The TRPA1 is expressed in a great number or organisms: mammals (humans, mice, rats, monkeys and chimpanzee), zebrafish, insects (Drosophila, Tribolium, Pediculus, Culex, Anopheles), and red jungle fowl to name a few.

While not wishing to be bound by theory, the activation of TRPA1 elicits a signaling pathway that brings forth motor neuron activation and movement of an insect towards a preferred ambient temperature and/or avoidance of noxious chemicals.

Accordingly, the invention provides a method of inhibiting thermosensing in an insect, the method comprising inhibiting a TRPA1 ion gated channel or family members. As used herein, the term “inhibiting thermosensing” means to reduce, block, and/or stop the ability of an organism to sense non-preferred ambient temperature and/or move away to avoid that non-preferred ambient temperature. For example, for the Drosophila fly, ambient temperatures of above 28° C. is non-preferred ambient temperature and the fly will seek to move to a lower temperature of around 25° C. if possible. When the fly's thermosensing is inhibited, the fly does not sense the non-preferred temperature nor does it react to temperature of above 28° C. by moving towards a lower temperature of around 25° C.

Since the TRPA1 ion channel is also associated with chemosensory, in another embodiment, the invention described herein provides a method of inhibiting chemosensing in an insect, the method comprising inhibiting a TRPA1 ion gated channel or family members in the insect. As used herein, the term “inhibiting chemosensing” means to reduce, block, and/or stop the ability of an organism to sense noxious agents and/or move away to avoid that noxious agent such as pungent natural compounds (e.g., allyl isothiocyanate (ITC), cinnamaldehyde, allicin, and gingerol) and environmental irritants (e.g., acrolein). For example, under normal circumstances, a Drosophila fly will seek to move away from mustard oil and cinnamaldehyde. When the fly's chemosensing is inhibited, the fly does not sense these noxious compounds and does not react to these noxious compounds by moving away.

In another aspect the invention provides methods of controlling insects and non-insects pests by controlling activation of dTRPA1 ion gated channel or family members. Without wishing to be bound by theory, interfering and/or inhibiting the TRPA1 activation can interfere with the motor neurons and effect the movement of insects. This effect on motor neurons of insects can then be exploited for controlling such insects. For example, interfering and/or inhibition of dTRPA1 activation can lead to a decrease in avoidance behavior thus limiting the movement from non optimal environments and/or noxious chemicals. Furthermore, by interfering with the thermosensing pathway, insect's ability to regulates its body temperature is also reduced.

On the other hand, again wishing not to be bound by theory, activation of the dTRPA1 ion gated channel or family members increases the avoidance behavior and an increased movement from the current location to a more optimal environment for the insect.

Thus, in one aspect, the invention provides methods of controlling insects and non-insect pests by interfering and/or inhibiting an environment sensing mechanism of insects and non-insect pests.

In one embodiment, the invention provides for a method of insect and non-insect pest control, the method comprising interfering with and/or inhibiting the thermo-sensing pathway of the insect or non-insect pest. As used herein, the term “thermo-sensing pathway” refers to signaling pathway involved in setting the preferred temperature in an insect or non-insect pest. Without wishing to be bound by theory, activation of the thermo-sensing pathway allows an insect or non-insect pest to move from a non-preferred temperature (hot or cold) to a preferred temperature. For example in Drosophila, an internal warmth-sensing pathway in conjunction with a cold-sensing pathway sets the fly's preferred temperature.

In another embodiment, the invention provides for a method of insect and non-insect pest control, the method comprising interfering with and/or inhibiting the chemo-sensing pathway of said insect or non-insect pest. As used herein, the term “chemo-sensing pathway” refers to signaling pathway involved making the insect or non-insect move away from a compound present in the environment.

In one embodiment, the invention provides for a method of insect and non-insect pest control, the method comprising interfering with and/or inhibiting at least one member of the TRP family of ion channels.

In one embodiment, the method comprises interfering with and/or inhibiting at least one member of the TRP family of ion channels and wherein said member is activated at a non-preferred environment, for example a non-preferred temperature.

In one embodiment, the method comprises interfering with and/or inhibiting at least one member of the TRP family of ion channels and wherein said member is a thermosensor. As used herein, the term “thermosensor” refers to a molecule which elicits a signaling pathway in response to a change in temperature (higher or lower) from the preferred temperature.

In one embodiment, the method comprises interfering with and/or inhibiting at least one member of the TRP family of ion channels and wherein said member is a chemosensor. As used herein, the term “chemosensor” refers to a molecule which elicits a signaling pathway in response to an agent, for example a compound, present in the environment. The agent may or may not be a noxious agent.

In another embodiment, the invention provides for a method of insect control comprising interfering with and/or inhibiting a TRPA1 ion gated channel or family members in the insect. It is envisioned that the method is also applicable to pest control, wherein the pests are not insects, e.g. nematodes, slugs and snails.

The environment sensing mechanism can be interfered and/or inhibited by a number of different mechanisms. In one aspect, the TRPA1 is inhibited by an agent that blocks the activation and subsequent opening of the ion channel, a TRPA1 inhibitor. In some aspect, the inhibitor can be an agent that binds to the channel pore and physically blocks the channel when the channel is open. In some aspect, the inhibitor can be an agent that binds the TRPA1 channel and blocks an agonist (e.g. an noxious agent) from interacting with TRPA1 protein by steric hindrance. In some other aspect, the inhibitor can be an agent that binds the TRPA1 channel and prevents the conformation change necessary for the ion channel to open. In yet another aspect, the inhibitor can be an agent that binds the TRPA1 channel and prevents the transduction of agonist binding to conformational change leading to channel opening. In yet another aspect, the inhibitor can be an agent that blocks the subsequent cellular signaling events (e.g. protein phosphorylation) after TRPA1 is activated. A number of TRAP1 inhibitors are known in the art. In one embodiment, the TRPA1 inhibitors include, but are not limited to, ruthenium red, AP18 ((Z)-4-(4-chlorophynyl)-3-methylbut-3-en-2-oxime, M. Petrus et. al, Mol. Pain. 2007; 3: 40), HC-030031 (2-(1,3-dimethyl-2,6-dioxo-1,2,3,6-tetrahydro-7H-purin-7-yl)-N-(4-isopropylphenyl)acetamid, Hydra BioScience, Cambridge, Mass., USA), cannabinoid agonists R-(+)-(2,3-dihydro-5-methyl-3-[(4-morpholinyl)methyl]pyrol[1,2,3-de]-1,4-benzoxazin-6-yl)-(1-naphthalenyl)methanone mesylate [WIN 55, 212-2 (WIN)] and (R,S)-3-(2-iodo-5-nitrobenzoyl)-1-(1-methyl-2-piperidinylmethyl)-1H-indole (AM1241), and salts thereof, particularly pharmaceutically acceptable salts. In one embodiment, the TRAP1inhibitor is selected from the group consisting of

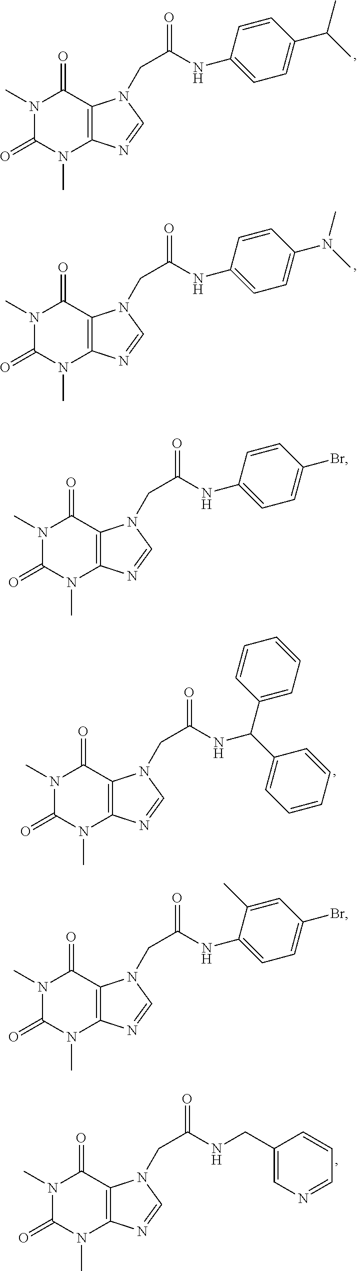

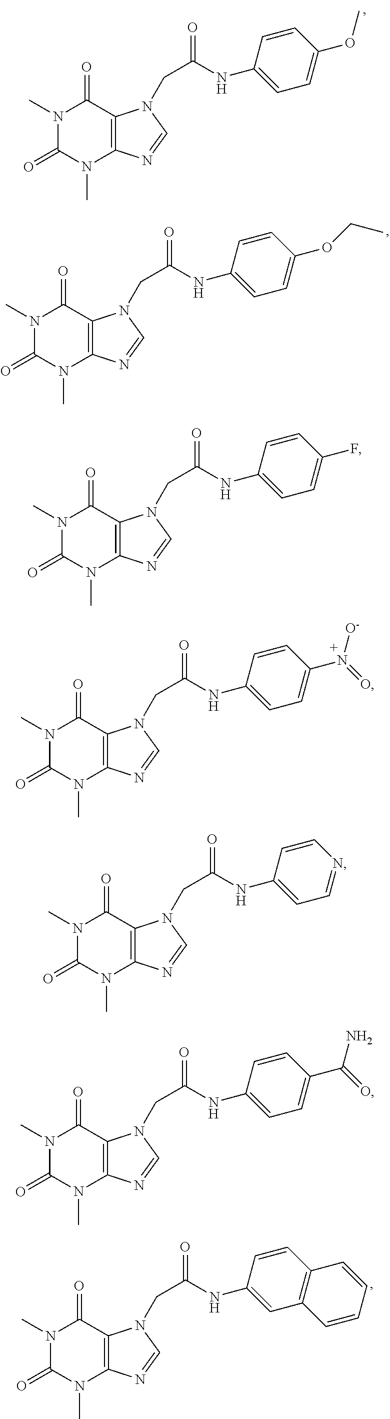

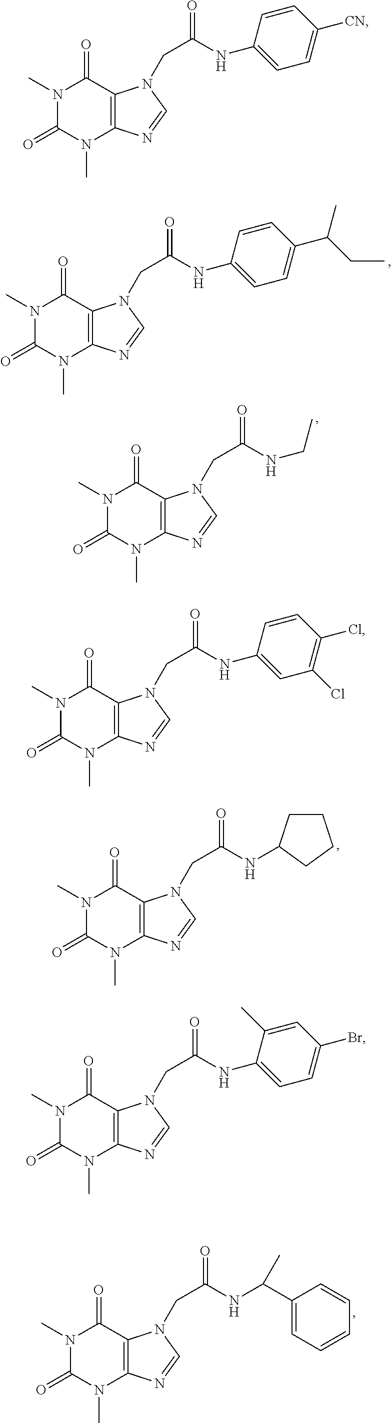

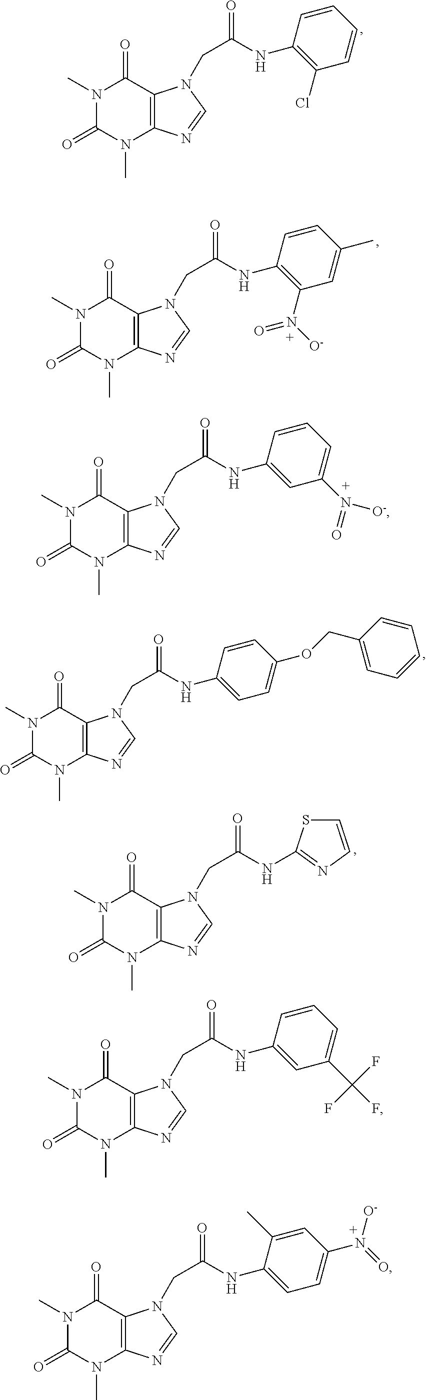

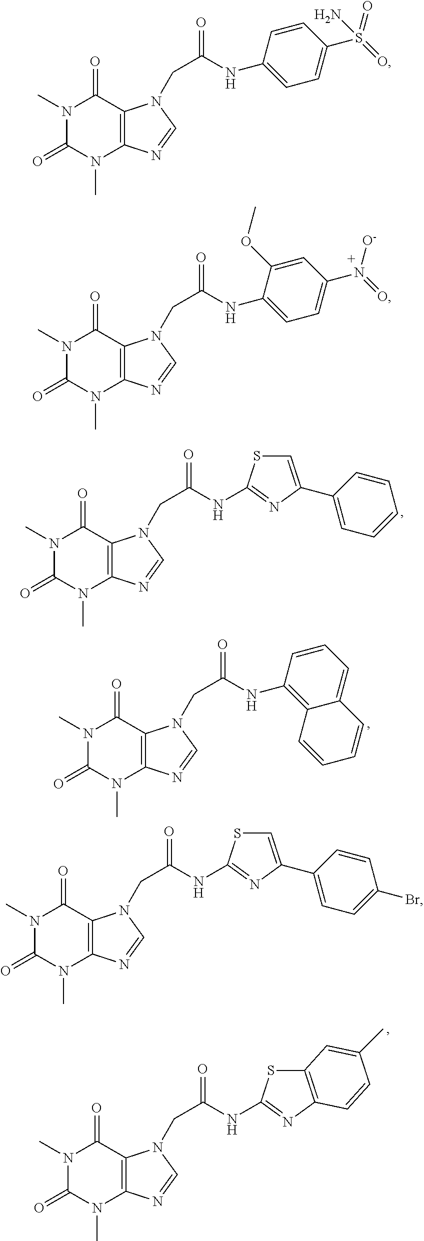

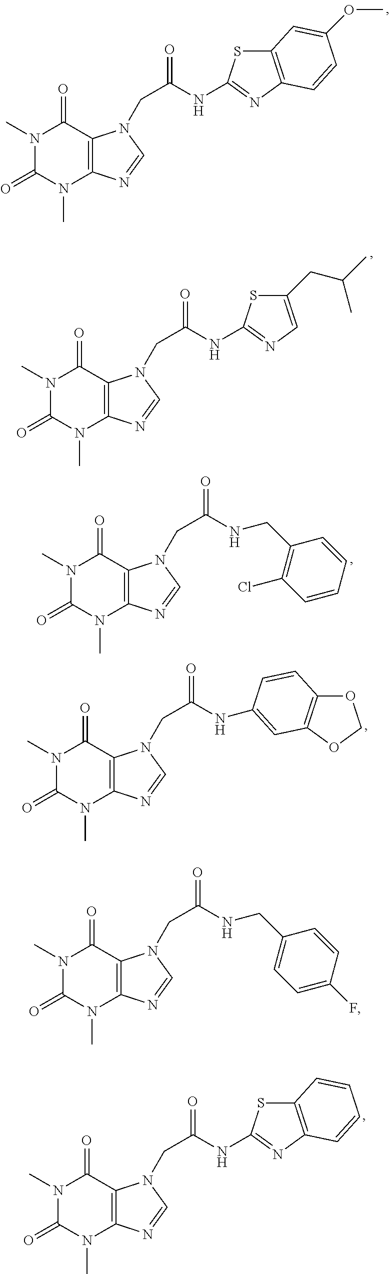

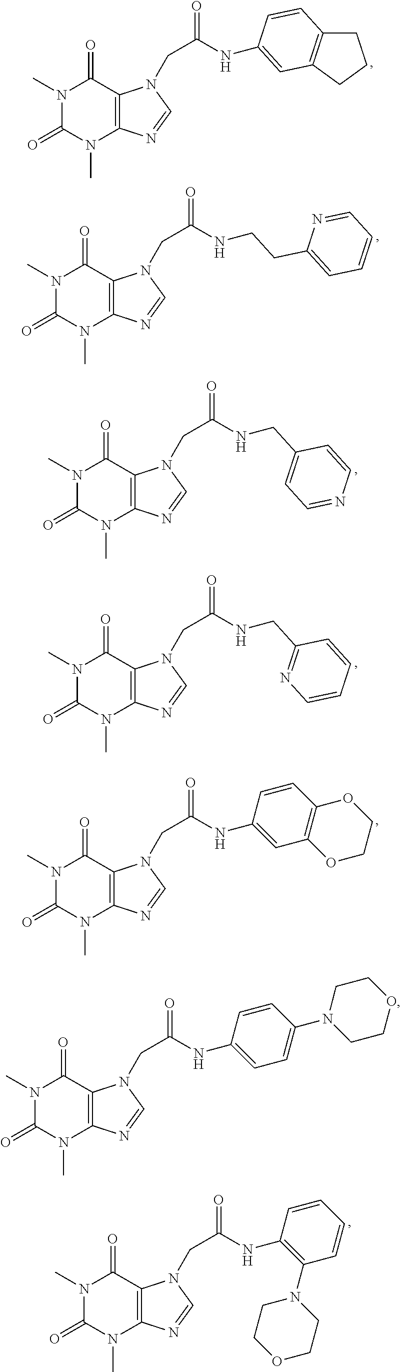

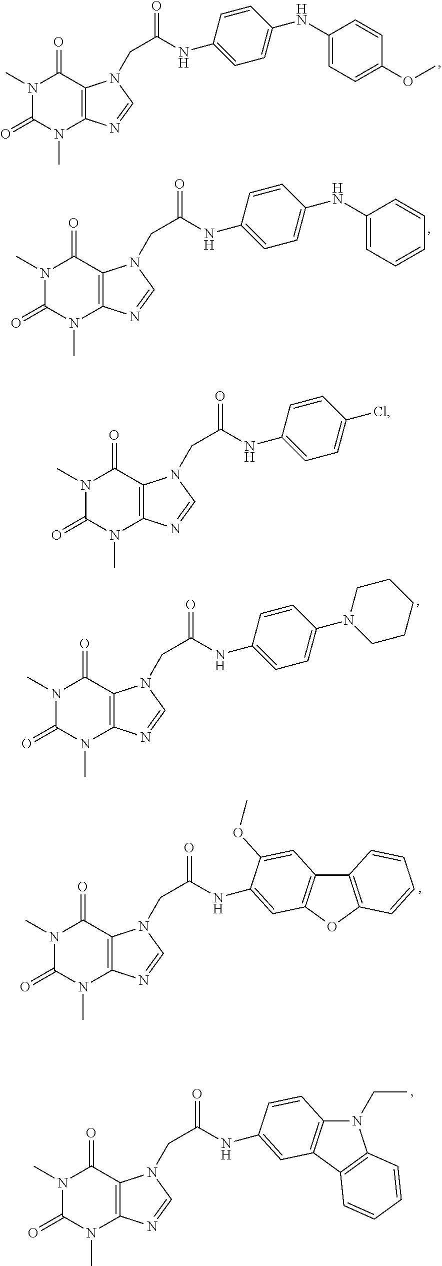

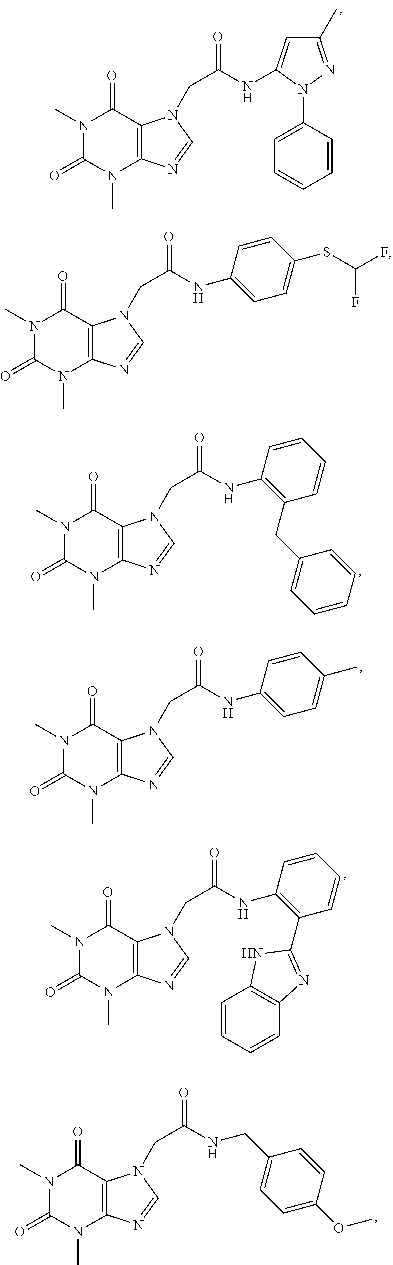

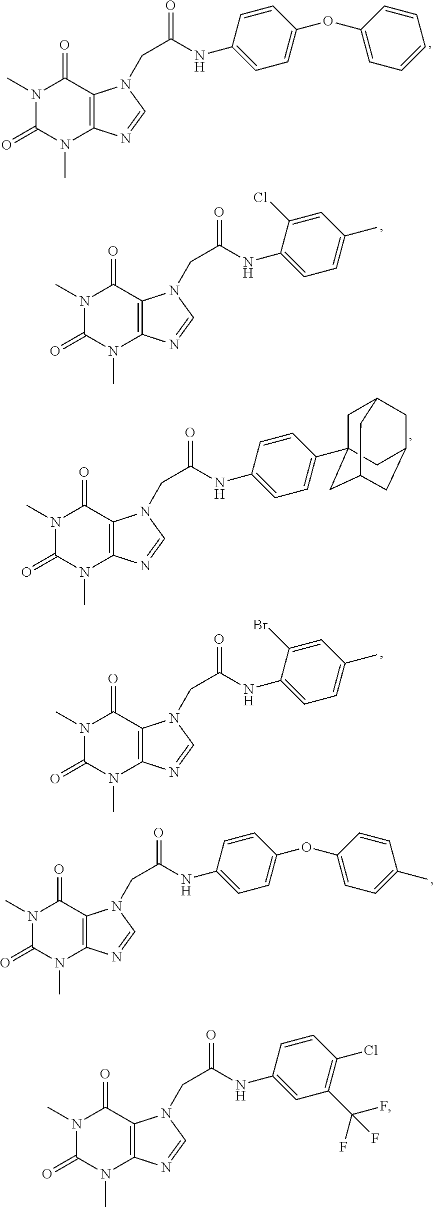

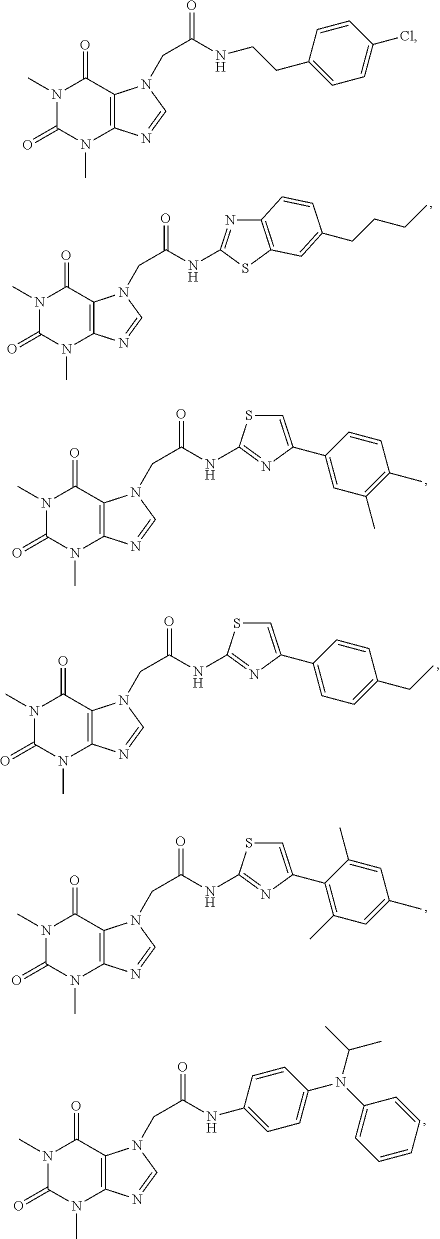

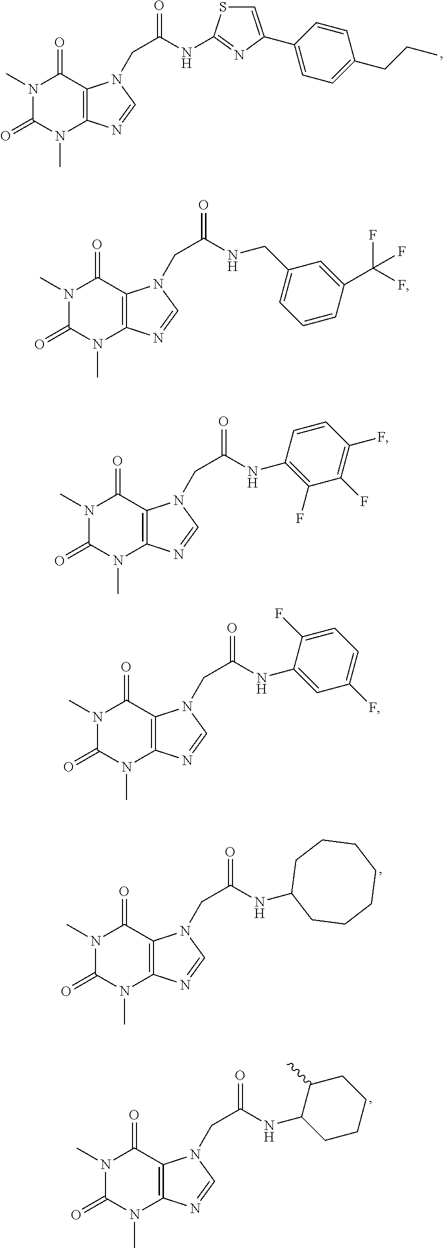

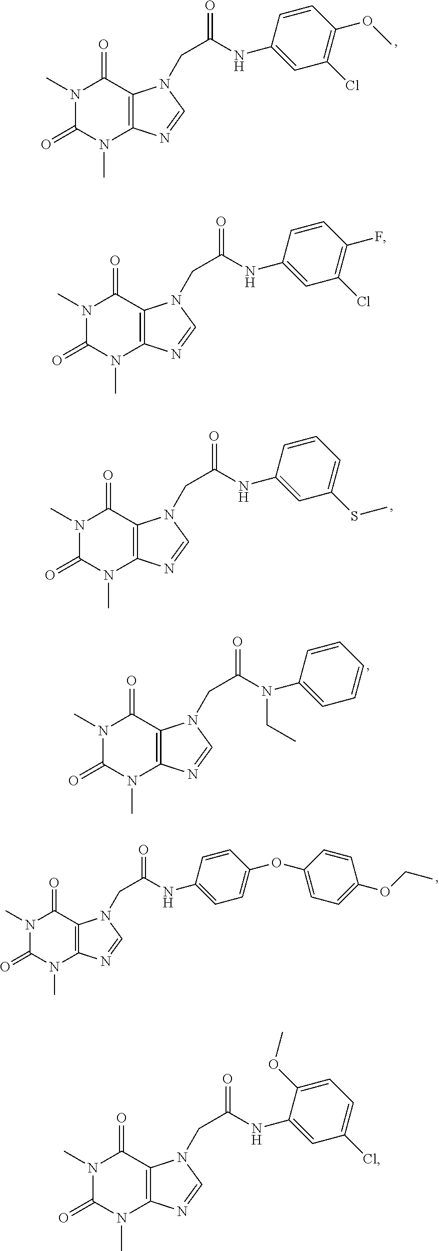

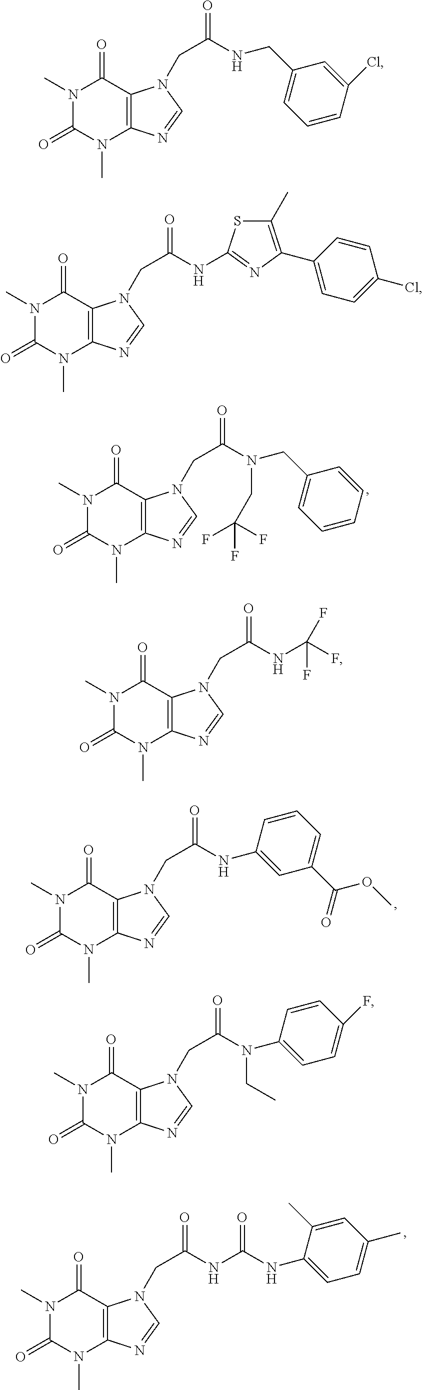

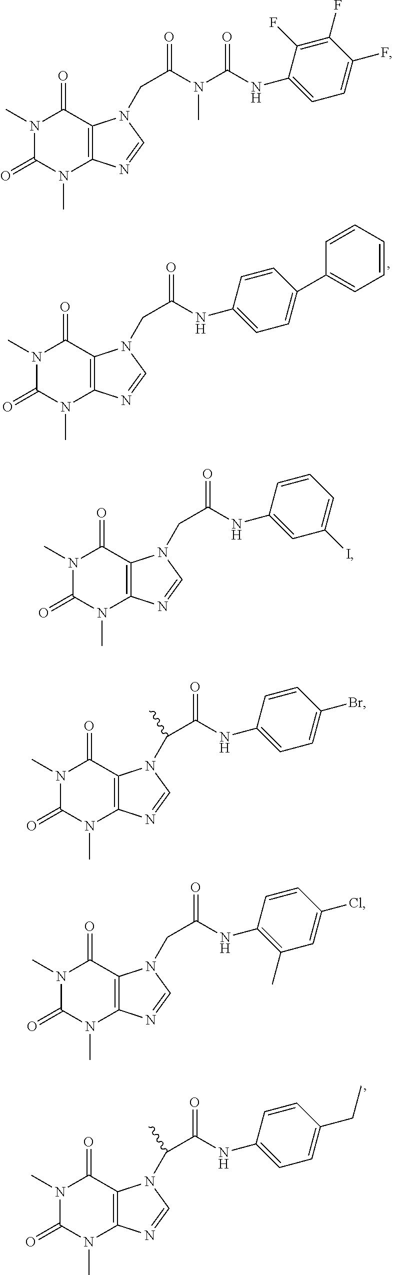

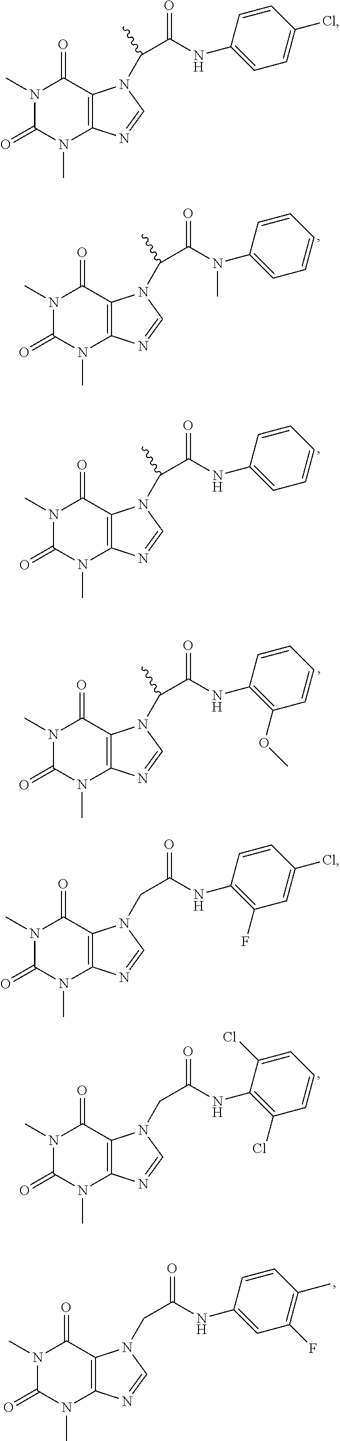

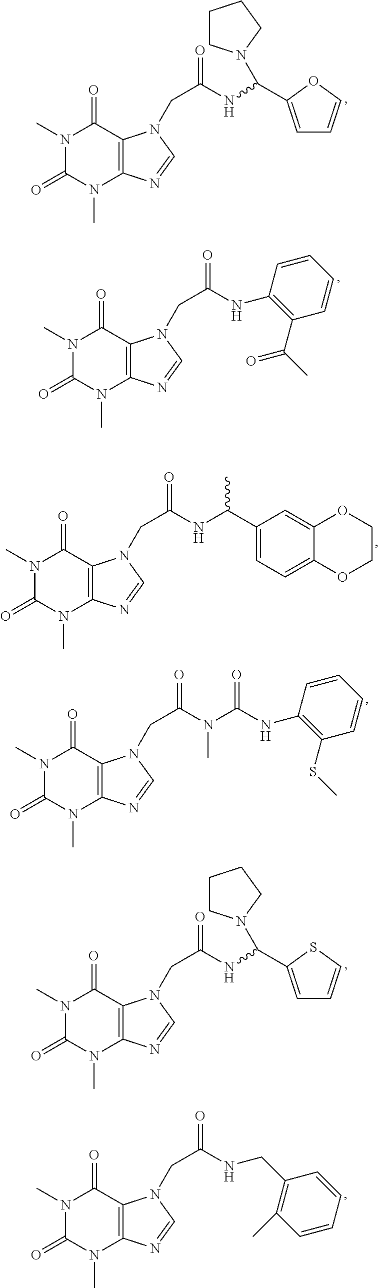

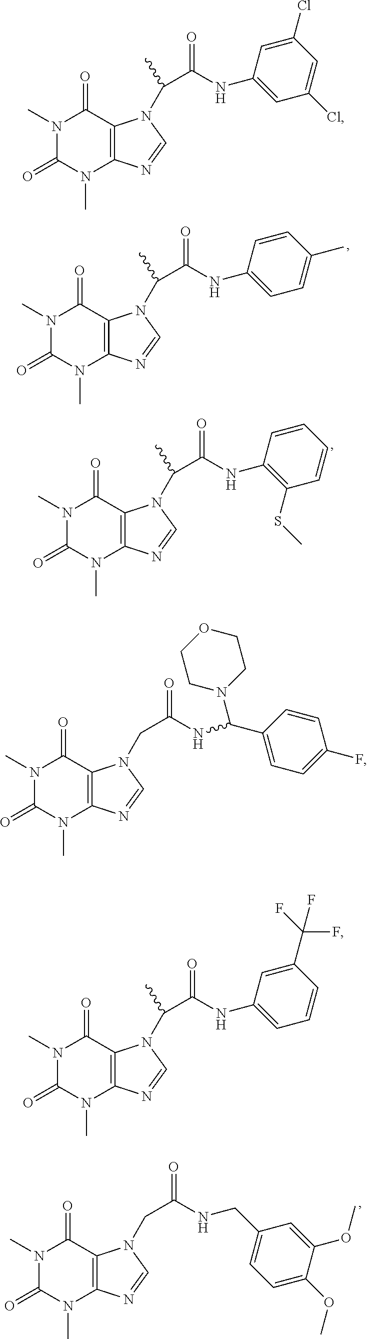

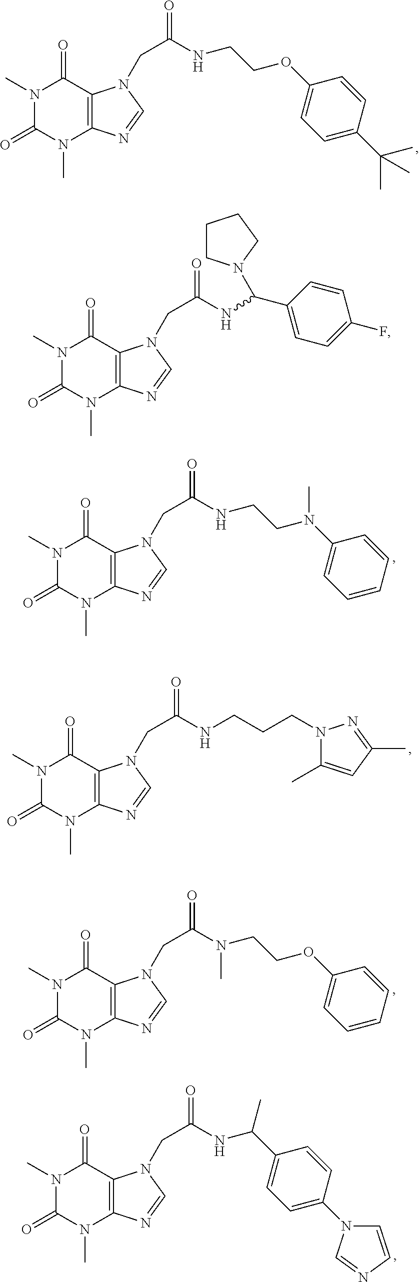

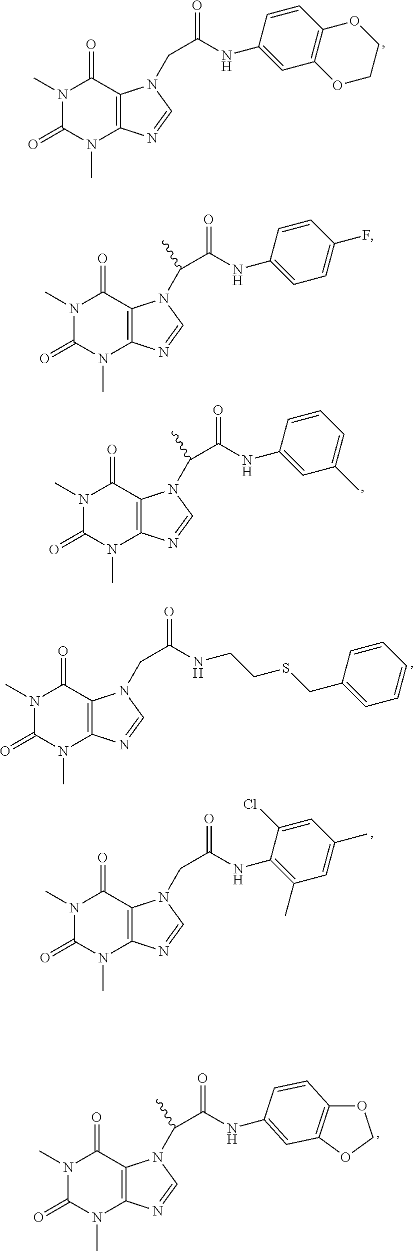

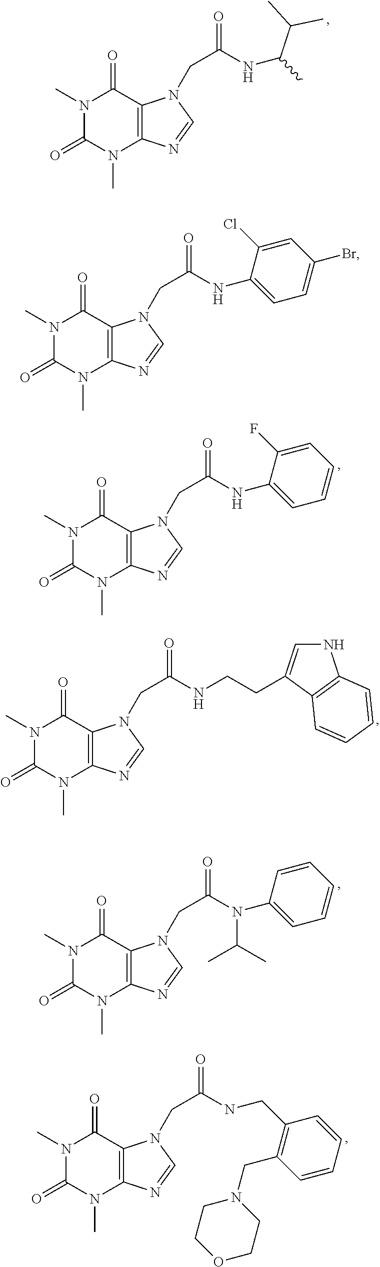

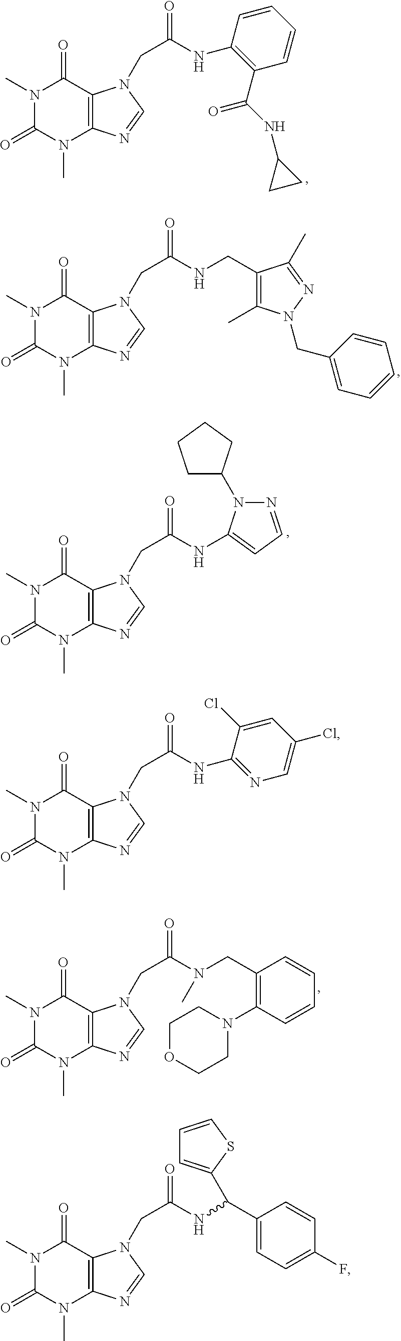

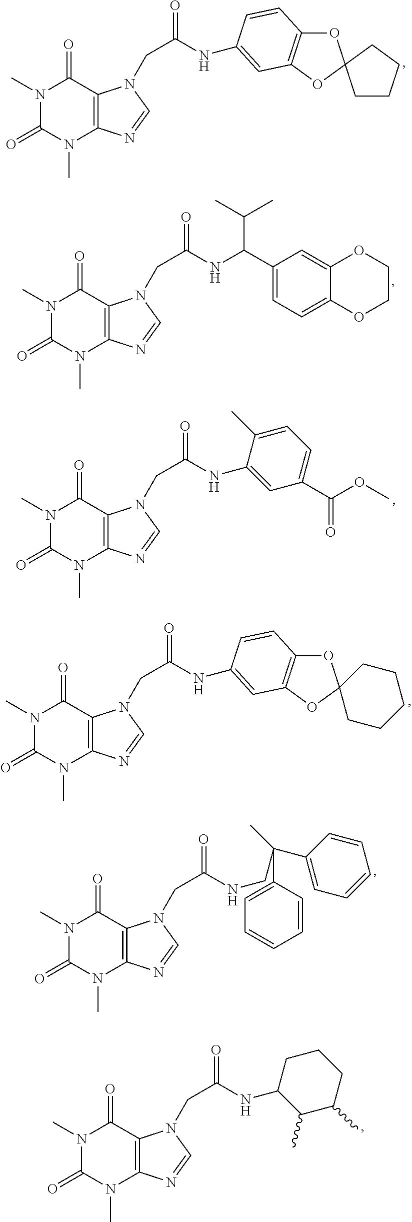

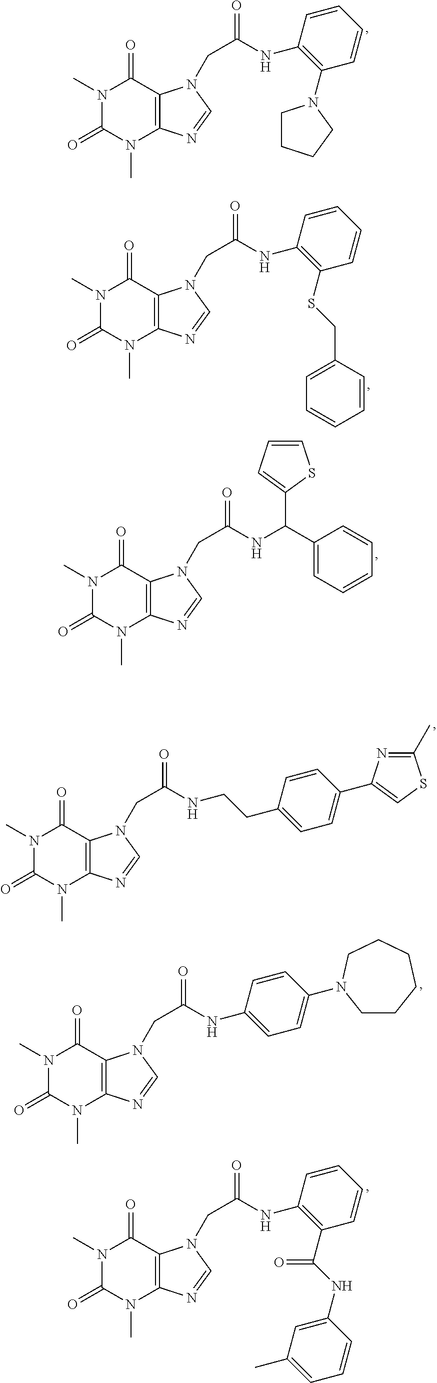

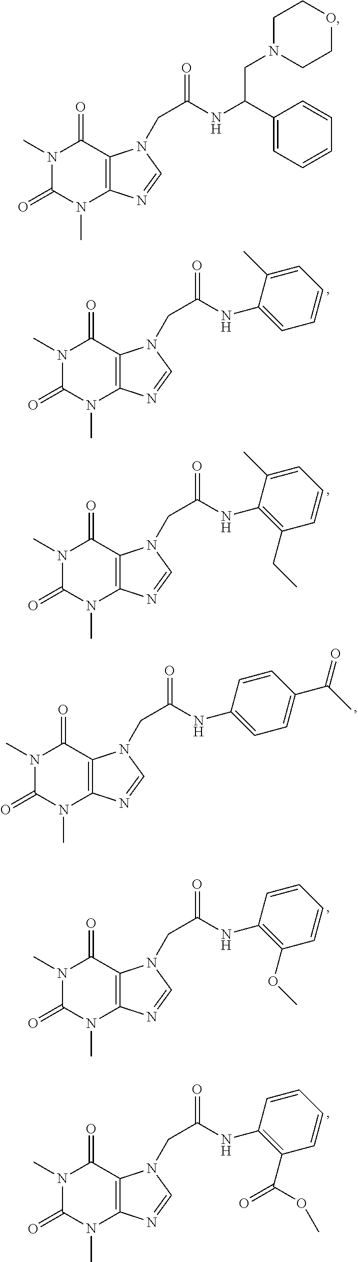

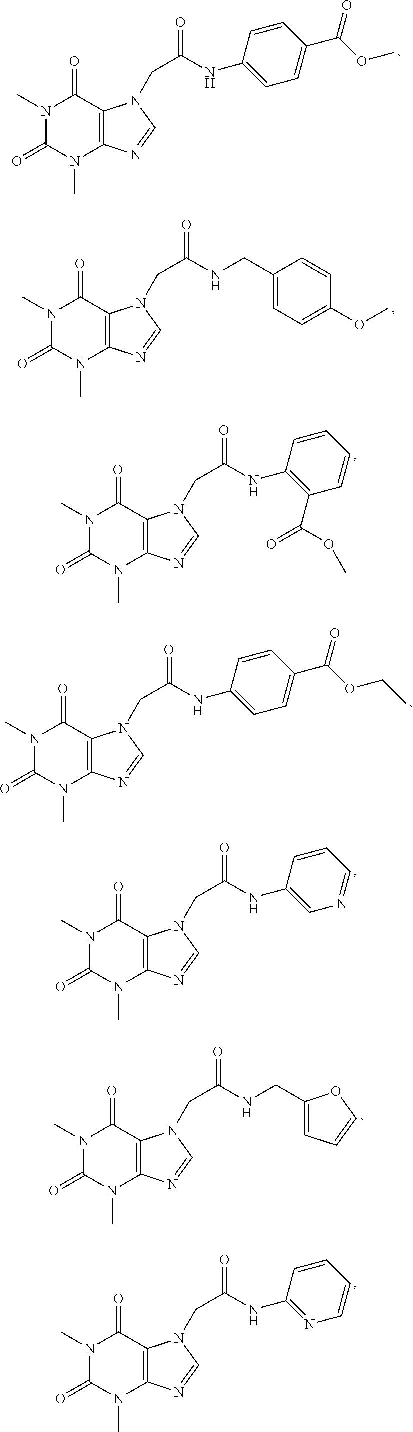

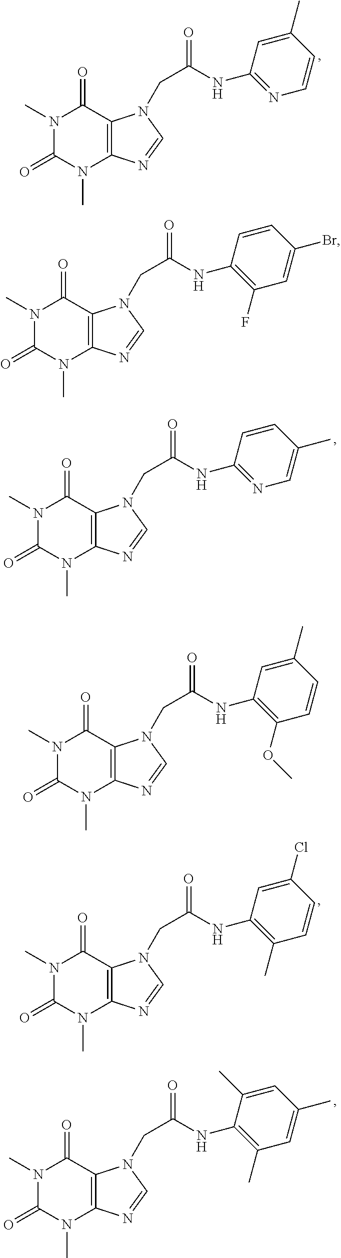

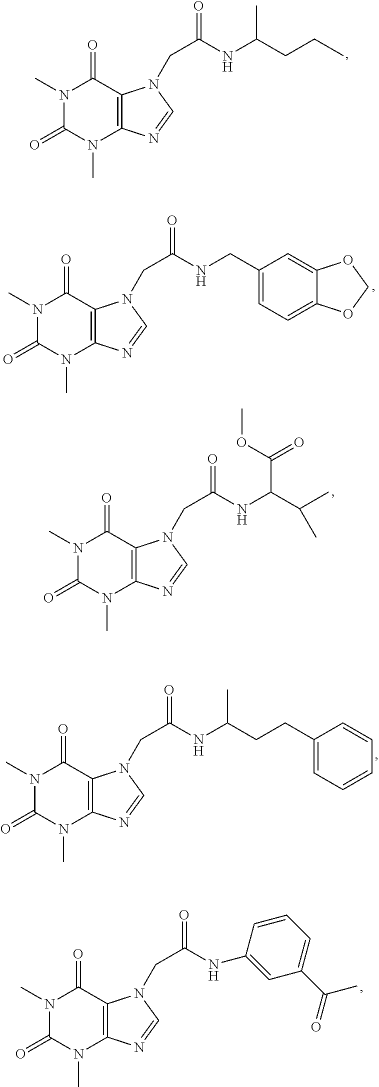

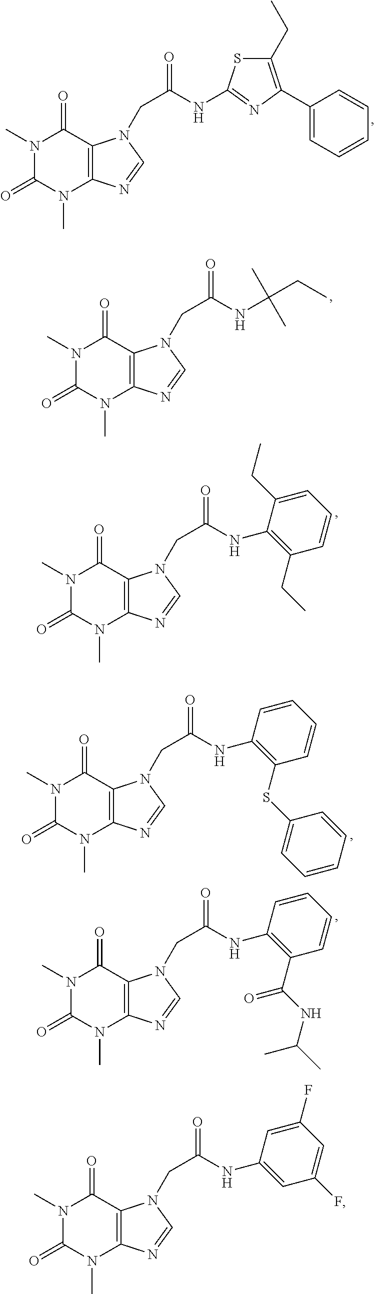

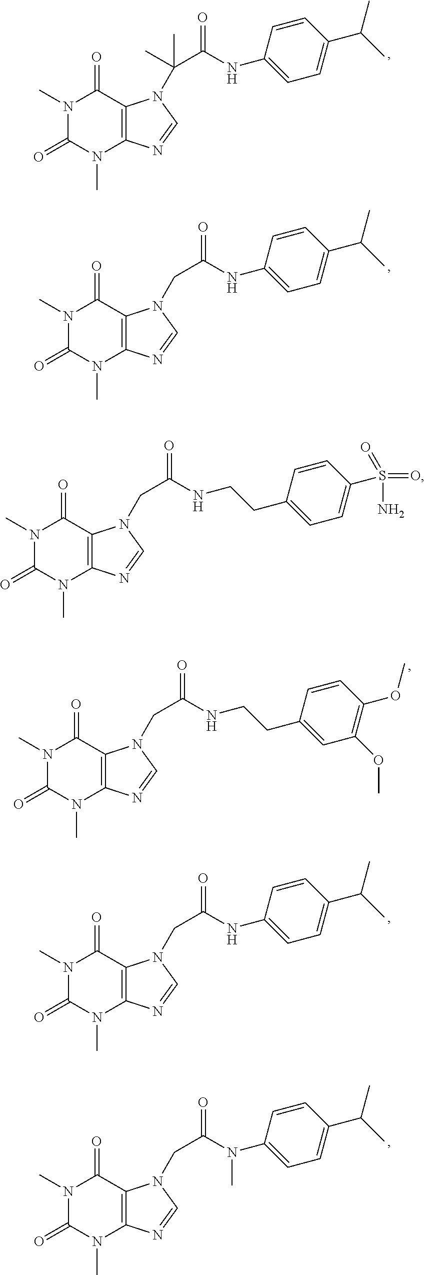

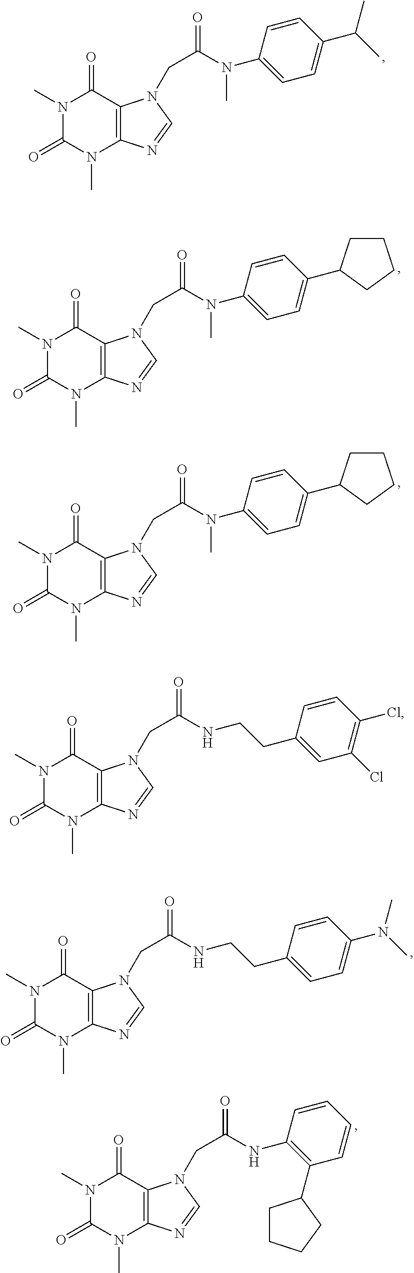

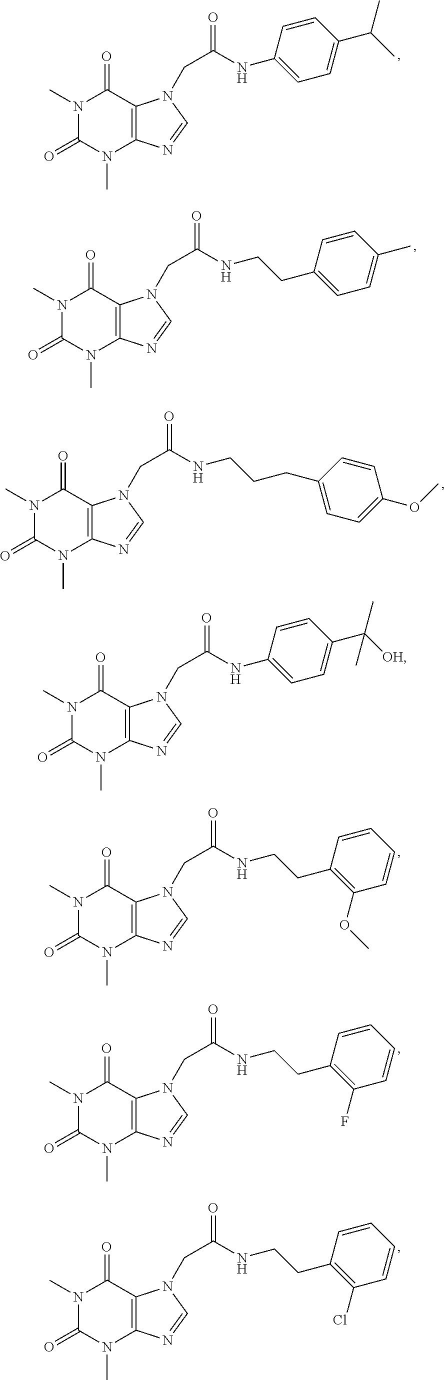

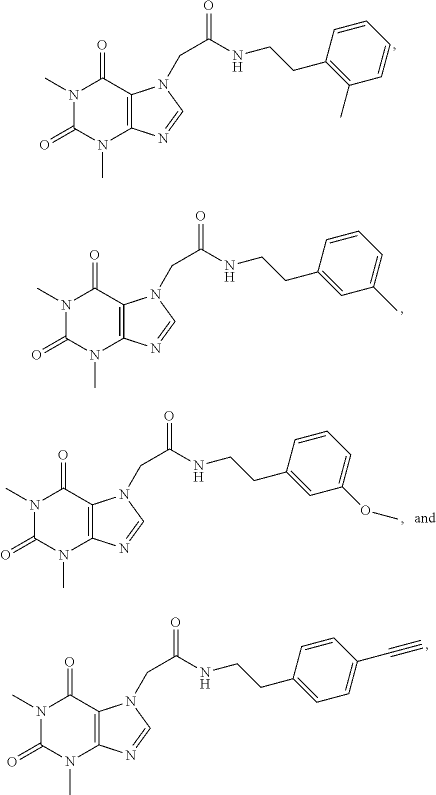

and pharmaceutically acceptable salts thereof. Synthetic details for these compounds is given in PCT Application WO/2007/073505, contents of which are hereby incorporated in their entirety. Other TRAP1 inhibitors amenable to the present invention are also described in PCT Application WO/2007/073505. In certain embodiments, the inhibitor can be derivatized and/or conjugated with other compounds for formulation purposes, e.g. to increase delivery to target, to increase water miscibility or UV protection.

In one embodiment, the TRPA1 ion gated channel is inhibited by at least two TRPA1 inhibitors described herein.

In another aspect, the invention provides methods of controlling insects pests by activation of an environment sensing mechanism of insects. It is envisioned that this method is also applicable to pest control, wherein the pest are not insects, e.g. nematodes, slugs and snails.

In one embodiment, the invention provides for a method of insect control, the method comprising activating the thermo-sensing pathway of the insect.

In another embodiment, the invention provides for a method of insect control, the method comprising activating the chemo-sensing pathway of said insect.

In one embodiment, the invention provides for a method of insect and non-insect pest control, the method comprising activating at least one member of the TRP family of ion channels.

In one embodiment, the method comprises activating at least one member of the TRP family of ion channels and wherein said member is activated at a non-preferred environment, for example a non-preferred temperature.

In one embodiment, the method comprises activating at least one member of the TRP family of ion channels and wherein said member is a thermosensor.

In one embodiment, the method comprises activating at least one member of the TRP family of ion channels and wherein said member is a chemosensor.

In another embodiment, the invention provides for a method of insect control comprising activating TRPA1 ion gated channel or family members in the insect.

The environment sensing mechanism can be activated by a number of different mechanisms. In one aspect, the TRPA1 ion gated channel is activated by an agent that activates the opening of the ion channel, a TRPA1 agonist. In some aspect, the agonist can be an agent that binds to the channel pore leading to conformational change necessary for the ion channel to open. In some aspect, the activator can be an agent that enhances the binding of a TRPA1 agonist to the channel. In yet another aspect, the activator can be an agent that increases the subsequent cellular signaling events (e.g. protein phosphorylation) after TRPA1 is activated.

In one embodiment, the method comprises activation of TRPA1 ion channel or family members in the insect.

In one embodiment, the TRPA1 ion channel is activated with a TRPA1 agonist.

In one embodiment, the TRPA1 agonist is a reactive electrophile.

In one embodiment, the method comprises activation of TRPA1 ion channel or family members with heat. Heat can be applied, for example, by blowing/pumping warm air in the area where insect control is required.

In another aspect the invention provides a method of insect control comprising activating a TRPA1 ion gated channel or family members in the insect. In another aspect the invention provides a method of insect control comprising activating TRPA1 ion gated channel or family members in the insect. Without wishing to be bound, activation of TRPA1 ion gated channel or family members in the insect leads to an increase in avoidance behavior of such insect. This increase in avoidance behavior can be used to repel insects away from a particular location and thus controlling such insects.

In one embodiment, the TRPA1 ion gated channel or family member is activated by an agent selected from the group consisting of 4-hydroxynonenal, capsaicin, 3′-carbamoylbiphenyl-3-yl-cyclohexyl carbamate, cinnamaldehyde, allicin, gingerol, 2-mercaptobenzoic acid, caffeine, quinine, benzoquinone, iodoacetamide, N-methyl maleimide, trinitrophenol, Carvacrol, Icilin, menthol, acrolein, 15-deoxy-Δ^{12,14}-prostaglandin J₂ (15d-PGH₂), allyl thiocyanate, and 4-methyl-N-[2,2,2-trichloro-1-(4-nitro-phenyl sulfanyl)-ethyl]benzamide, allyl isothiocyanate (AITC), acrolein, allicin, 1-cloroacetophenone, 2-chlorobenzyliden malonoitrile, 1,5-dichloro-3-thiapentane, and pharmaceutically acceptable salts thereof.

In one embodiment, the TRPA1 ion gated channel or family member is activated by at least two TRPA1 agonists described herein.

In one embodiment, the activity of TPRA1 ion channel is modulated with a TRPA1 inhibitor and a TRPA1 agonist at the same time. Without wishing to be bound, simultaneous inhibition and activation of TRPA1 leads to confusion in insects.

Because compounds incorporating hydrophobic moieties will penetrate the insect cuticle, active agent, e.g. TRPA1 inhibitor and TRPA1 agonist, may be conjugated with hydrophobic moieties. Hydrophobic moieties include, but are not limited to, lipids and sterols. These conjugated active agents can then be administered topically, such as by direct spraying on the insect or a substrate which is likely to be contacted by the insect. Alternatively, the active agents may also be administered either subcutaneously, percutaneously, or orally. When they are to be ingested, they should be applied with their carrier to the insect diet.

In one embodiment, the methods described herein are applicable to insects that are disease vectors. Vectors are organisms that can introduce a pathogen such as a bacterium or virus into a host organism to cause an infection or disease. Exemplary disease vector include, but are not limited to, Ticks, Siphonaptera (fleas), Diptera (flies), Phthiraptera (lice) and Hemiptera (true bugs).

Rat fleas, especially Xenopsylla cheopis (the Oriental rat flea), are the principle vectors of Pasturella pestis, the bacterial pathogen of bubonic plague. Fleas can also transmit murine typhus caused by Rickettsia mooseri.

Black flies spread Onchocerca volvulus, a parasitic roundworm. Onchoceriasis, the disease caused by infestation of these worms, may cause blindness in peoples of Africa, Mexico, and Central and South America. Sand flies in the genus Phlebotomus are vectors of a bacterium (Bartonella bacilliformis) that causes Carrion's disease (oroyo fever) in South America. In parts of Asia and North Africa, they spread a viral agent that causes sand fly fever (pappataci fever) as well as protozoan pathogens (Leishmania spp.) that cause Leishmaniasis. Mosquitoes in the genus Anopheles are the principle vectors of malaria, a disease caused by protozoa in the genus Trypanosoma. Aedes aegypti is the main vector of the viruses that cause yellow fever and dengue. Other viruses, the causal agents of various types of encephalitis, are also carried by Aedes spp. mosquitoes. Wuchereria bancrofti and Brugia malayi, parasitic roundworms that cause filariasis, are usually spread by mosquitoes in the genera Culex, Mansonia, and Anopheles. Horse flies and deer flies may transmit the bacterial pathogens of tularemia (Pasteurella tularensis) and anthrax (Bacillus anthracis), as well as a parasitic roundworm (Loa boa) that causes loiasis in tropical Africa. Eye gnats in the genus Hippelates can carry the spirochaete pathogen that causes yaws (Treponema pertenue), and may also spread conjunctivitis (pinkeye). House flies (family Muscidae), blow flies (family Calliphoridae), and flesh flies (family Sarcophagidae) often live among filth and garbage. They can carry the pathogens for dysentary (Shigella dysentariae), typhoid fever (Eberthella typhosa), and cholera (Vibrio comma) on their feet and mouthparts. They have also been suspected as vectors of the viral agent that causes poliomyelitis. Tsetse flies in the genus Glossina transmit the protozoan pathogens that cause African sleeping sickness (Trypanosoma gambiense and T. rhodesiense).

Human lice (Pediculus humanus and P. capitus) spread Borellia recurrentis, a spirochaete pathogen that causes epidemic relapsing fever. They also carry the rickettsial pathogens that cause epidemic typhus (Rickettsia prowazeki) and trench fever (R. quintana).

Assassin bugs (or kissing bugs) in the genera Triatoma and Rhodnius transmit a protozoan pathogen (Trypanosoma cruzi) that causes Chagas disease in South and Central America. In another embodiment, the methods described herein are applicable to arachnids that are disease vectors, such as spiders or ticks. As used herein, the term insect may be extended to include other members of the phylum anthropoda that are not scientifically classified as members of the class insecta.

In one embodiment, the methods described herein are applicable to insects that are agricultural or horticultural vectors or pest. Insects, mites, and nematode vectors focus the movement of plant pathogens among immobile plants. Many insects or other arthropods may contain plant pathogens but cannot transmit these to plants and thus are not vectors. Some of our most important plant diseases require mobile vectors. Almost all plant viruses and all wall-free, plant pathogenic bacteria known as mollicutes have recognized or suspected vectors. See elsewhere for insect vector transmission of bacterial plant pathogens. Examples of some of such plant pathogen vectors are Agromyzidae, Anthomyiidae, Aphid, Brevicoryne brassicae, Curculionidae, Eumetopina flavipes, Frankliniella occidentalis, Jumping plant louse, Leaf beetle, Leafhopper, Mealybug, Molytinae, Pissodes-Pissodes strobe, Pissodini, Planthopper Pseudococcus viburni, Scirtothrips dorsalis, Tephritidae, Thripidae, Tomicus piniperda Treehopper, Whitefly, and Bactrocera and Ceratitis species of fruit flies

In one embodiment, the methods described herein are applicable to insects that are parasites. Examples of some insect parasites are Braconid Wasps, family Braconidae; Ichneumonid Wasps, family Ichneumonidae; Chalcid Wasps, family Chalcidae; Tachinid Flies, family Tachonidae.

The active ingredient, or formulations comprising them, may be applied directly to the target insects (i.e., larvae, pupae and/or adults), or to the locus of the insects. In one embodiment, the active ingredient or a formulation containing the active ingredient is applied directly to the adult insect. In one embodiment, the active agent is applied directly to the larvae and/or pupae of the target insect. In another embodiment, the active ingredient is applied to the locus of the insects.

In another embodiment, after application of active ingredient, heat is applied to the target insects or to the locus of the insects.

In one embodiment, the active ingredient is applied as a spray. For example, the active ingredient is applied as an agricultural spray in aerial crop dusting, an environmental spray to control biting insects, or as a topical spray for localized control of biting insects. The active ingredient is formulated for the purpose for spray application such as an aerosol formulation. Spray application can be accomplished with a spray pump. The active ingredient can be also encapsulation within materials such as starch, flour and gluten in granular formulations.

In one embodiment, the active ingredient is applied topically, for example, as a lotion, a cream, or as a spray.

In one embodiment, the active ingredient is applied in conjunction with other insecticides and/or pesticides such as organo-phosphates, synthetic pyrethroids, carbamates, chlorinated hydrocarbons, when used in agricultural and/or environmental insect control.

In another embodiment, for topical application, the active ingredient is applied in conjunction with other compounds such as insect repellents and sunscreen. Insect repellents include, but are not limited to, DEET (N,N-diethyl-m-toluamide), essential oil of the lemon eucalyptus and its active ingredient p-menthane-3,8-diol (PMD), icaridin (also known as picaridin, Bayrepel, and KBR 3023), nepetalactone, also known as “catnip oil”, citronella oil, permethrin, soybean oil, neem oil and Bog Myrtle, Sunscreens include, but are not limited to, oxybenzone, titanium dioxide and zinc oxide.

The active ingredient is administered in an amount effective to induce the desired response as determined by routine testing. The actual effective amount will of course vary with the specific active ingredient, the target insect and its stage of development, the application technique, the desired effect, and the duration of the effect, and may be readily determined by the practitioner skilled in the art. An effective amount of active ingredient is the amount of active ingredient to modulate activation of TRPA1, e.g., themosensing and/or chemosensing in an insect.

### Formulation and Application

Methods of formulation are well known to one skilled in the art and are also found in Knowles, DA (1998) Chemistry and technology of agricultural formulations. Kluwer Academic, London, which is hereby incorporated by reference in its entirety. One skilled in the art will, of course, recognize that the formulation and mode of application may affect the activity of the active ingredient in a given application. Thus, for agricultural and/or horticultural use the TRAP1 inhibitors and/or agonists may be formulated as a granular of relatively large particle size (for example, 8/16 or 4/8 US Mesh), as water-soluble or water-dispersible granules, as powdery dusts, as wettable powders, as emulsifiable concentrates, as aqueous emulsions, as solutions, as suspension concentrate, as capsule suspensions, as soluble (liquid) concentrates, as soluble powders, or as any of other known types of agriculturally-useful formulations, depending on the desired mode of application. It is to be understood that the amounts specified in this specification are intended to be approximate only, as if the word “about” were placed in front of the amounts specified.

These formulations may be applied either as water-diluted sprays, or dusts, or granules in the areas in which insect control is desired. These formulations may contain as little as 0.1%, 0.2% or 0.5% to as much as 95% or more by weight of active ingredient, e.g. TRPA1 inhibitor.

Dusts are free flowing admixtures of the active ingredient with finely divided solids such as talc, natural clays, kieselguhr, flours such as walnut shell and cottonseed flours, and other organic and inorganic solids which act as dispersants and carriers for the toxicant; these finely divided solids have an average particle size of less than about 50 microns. A typical dust formulation useful herein is one containing 90 parts, 80 parts, 70 parts, 60 parts, 50 parts, 40 parts, 30 parts, 20 parts, preferably 10 parts, or less of the active ingredient, e.g. TRPA1 inhibitor or TRPA1 agonist. In one embodiment, the dust formulation comprises 1 part or less of the active ingredient and 99 parts or more of talc. As used herein, the terms “active ingredient” and “active agent” refer to a compound that modulate the activity of TRPA1 ion gated channel or family member. By the term “modulate” is meant either to inhibit TRPA1 or activate TRPA1.

Wettable powders, useful as formulations, are in the form of finely divided particles that disperse readily in water or other dispersant. The wettable powder is ultimately applied to the locus where insect control is needed either as a dry dust or as an emulsion in water or other liquid. Typical carriers for wettable powders include Fuller's earth, kaolin clays, silicas, and other highly absorbent, readily wet inorganic diluents. Wettable powders normally are prepared to contain about 5-80% of active ingredient, depending on the absorbency of the carrier, and usually also contain a small amount of a wetting, dispersing or emulsifying agent to facilitate dispersion. For example, a useful wettable powder formulation contains 80.0 parts of the active ingredient, 17.9 parts of Palmetto clay, and 1.0 part of sodium lignosulfonate and 0.3 part of sulfonated aliphatic polyester as wetting agents. Additional wetting agent and/or oil will frequently be added to a tank mix for to facilitate dispersion on the foliage of the plant.

Other useful formulations are emulsifiable concentrates (ECs) which are homogeneous liquid compositions dispersible in water or other dispersant, and may consist entirely of the active ingredient, and a liquid or solid emulsifying agent, or may also contain a liquid carrier, such as xylene, heavy aromatic naphthas, isophorone, or other non-volatile organic solvents. For insecticidal application these concentrates are dispersed in water or other liquid carrier and normally applied as a spray to the area to be treated. The percentage by weight of the essential active ingredient may vary according to the manner in which the composition is to be applied, but in general comprises 0.5 to 95% of active ingredient by weight of the insecticidal composition.

Flowable formulations are similar to ECs, except that the active ingredient is suspended in a liquid carrier, generally water. Flowables, like ECs, may include a small amount of a surfactant, and will typically contain active ingredients in the range of 0.5 to 95%, frequently from 10 to 50%, by weight of the composition. For application, flowables may be diluted in water or other liquid vehicle, and are normally applied as a spray to the area to be treated.

Typical wetting, dispersing or emulsifying agents used in agricultural and/or horticultural formulations include, but are not limited to, the alkyl and alkylaryl sulfonates and sulfates and their sodium salts; alkylaryl polyether alcohols; sulfated higher alcohols; polyethylene oxides; sulfonated animal and vegetable oils; sulfonated petroleum oils; fatty acid esters of polyhydric alcohols and the ethylene oxide addition products of such esters; and the addition product of long-chain mercaptans and ethylene oxide. Many other types of useful surface-active agents are available in commerce. Surface-active agents, when used, normally comprise 1 to 15% by weight of the composition.

Other useful formulations include suspensions of the active ingredient in a relatively non-volatile solvent such as water, corn oil, kerosene, propylene glycol, or other suitable solvents.

Still other useful formulations for insecticidal applications include simple solutions of the active ingredient in a solvent in which it is completely soluble at the desired concentration, such as acetone, alkylated naphthalenes, xylene, or other organic solvents. Granular formulations, wherein the active ingredient is carried on relative coarse particles, are of particular utility for aerial distribution or for penetration of cover crop canopy. Pressurized sprays, typically aerosols wherein the active ingredient is dispersed in finely divided form as a result of vaporization of a low-boiling dispersant solvent carrier may also be used. Water-soluble or water-dispersible granules are free flowing, non-dusty, and readily water-soluble or water-miscible. In use by the farmer on the field, the granular formulations, emulsifiable concentrates, flowable concentrates, aqueous emulsions, solutions, etc., may be diluted with water to give a concentration of active ingredient in the range of say 0.1% or 0.2% to 1.5% or 2%.

By far the most frequently used are water-miscible formulations for mixing with water then applying as sprays. Water miscible, older formulations include: emulsifiable concentrate, wettable powder, soluble (liquid) concentrate, and soluble powder. Newer, non-powdery formulations with reduced or no hazardous solvents and improved stability include: suspension concentrate, capsule suspensions, water dispersible granules. Such formulations are preferably solutions and suspension, e.g., aqueous suspension and solutions, ethanolic suspension and solutions, aqueous/ethanolic suspension and solutions, saline solutions, and colloidal suspensions.

Alternatively, a sprayable wax emulsion formulation can be used. The formulation contains the active ingredient, in an amount from about 0.01% to 75% by weight. The aqueous wax emulsions are broadly described in U.S. Pat. No. 6,001,346, which is hereby incorporated by reference in is entirety. The TRPA1 inhibitors of the methods described herein can have a viscosity appropriate for use in aerial or backpack spray applications.

The biodegradable wax carrier comprises at least about 10% by weight of the formulation. The biodegradable wax carrier is selected from the group consisting of paraffin, beeswax, vegetable based waxes such as soywax (soybean based), and hydrocarbon based waxes such as Gulf Wax Household Paraffin Wax; paraffin wax, avg. m.p. 53C (hexacosane), high molecular weight hydrocarbons). carnauba wax, lanolin, shellac wax, bayberry wax, sugar cane wax, microcrystalline, ozocerite, ceresin, montan, candelilla wax, and combinations thereof.

Formulations can contain an emulsifier in an amount from about 1% to about 10% by weight. Suitable emulsifiers include lecithin and modified lecithins, mono- and diglycerides, sorbitan monopalmitate, sorbitan monooleate, sorbitan monolaurate, polyoxyethylene-sorbitan monooleate, fatty acids, lipids, etc. The emulsifiers provide or improve emulsification properties of the composition. The emulsifier can be selected from many products which are well known in the art, including, but not limited to, sorbitan monolaurate (anhydrosorbitol stearate, molecular formula C₂₄H₄₆O₆), ARLACEL 60, ARMOTAN MS, CRILL 3, CRILL K3, DREWSORB 60, DURTAN 60, EMSORB 2505, GLYCOMUL S, HODAG SMS, IONET S 60, LIPOSORB S, LIPOSORB S-20, MONTANE 60, MS 33, MS33F, NEWCOL 60, NIKKOL SS 30, NISSAN NONION SP 60, NONION SP 60, NONION SP 60R, RIKEMAL S 250, sorbitan c, sorbitan stearate, SORBON 60, SORGEN 50, SPAN 55, AND SPAN 60; other sorbitan fatty acid ester that may be used include sorbitan monopalmitate, sorbitan monostearate, sorbitan tristearate, sorbitan monooleate, sorbitan sesquioleate, sorbitan trioleate, sorbitan monooleate, sorbitan trioleate. In certain embodiments, SPAN 60 is preferred.

In certain embodiments, formulations can includes a phagostimulant, such as corn oil, molasses, glycerol, or corn syrup, proteinaceous material (protein or hydrolyzed protein), sugars like sucrose, or food-based ingredients such as trimethylamine, putrescine, bacterial or yeast volatiles or metabolites, ammonium acetate, ammonium carbonate or other ammonia-emitting compounds. Acetic acid vapor can be provided by compounds that produce volatilized acetic acid, for example, aqueous acetic acid, glacial acetic acid, glacial (concentrated) acetic acid, or ammonium producing compounds such as but not restricted to ammonium hydroxide, ammonium carbonate, ammonium bicarbonate, ammonium acetate, etc. Ammonium acetate is most preferred for providing acetic acid and ammonia vapors.

The active ingredient, may be formulated and/or applied with one or more second compounds. Various combinations TRPA1 inhibitors and TRPA1 agonists can be used to obtain greater advantage. Fro example both a TRPA1 inhibitor and TRPA1 agonist are applied at the same time. In one embodiment, a formulation described herein comprises both a TRPA1 inhibitor and a TRPA1 agonist. In one embodiment, two or more active agents are formulated together. In one embodiment, two or more active agents formulated together are all either TRPA1 inhibitors or are all TRPA1 agonists. Such combinations may provide certain advantages, such as, without limitation, exhibiting synergistic effects for greater control of insects or non-insect pests, reducing rates of application thereby minimizing any impact to the environment and to worker safety, controlling a broader spectrum of insects and non-insect pests, and improving tolerance by non-pest species, such as mammals and fish. Other second compounds include, without limitation, insecticides, pesticides, plant growth regulators, fertilizers, soil conditioners, or other agricultural and horticultural chemicals. The formulation may include such second compounds in an amount from about 0.002% to about 25%.

Insecticides include, but are not limited to, organophosphate insecticides, such as chlorpyrifos, diazinon, dimethoate, malathion, parathion-methyl, naled, and terbufos; nicotinic insecticides such as imidacloprid and thiacloprid; pyrethroid insecticides, such as fenvalerate, delta-methrin, fenpropathrin, cyfluthrin, flucythrinate, alpha-cypermethrin, biphenthrin, resolved cyhalothrin, etofenprox, esfenvalerate, tralomethrin, tefluthrin, cycloprothrin, betacyfluthrin, and acrinathrin; carbamate insecticides, such as aldecarb, carbaryl, carbofuran, and methomyl; organochlorine insecticides, such as endosulfan, endrin, heptachlor, and lindane; benzoylurea insecticides, such as diflubenuron, triflumuron, teflubenzuron, chlorfluazuron, flucycloxuron, hexaflumuron, flufenoxuron, dimlin, novaluron, and lufenuron; diacylhydrazines such as methoxyfenozide; phenylpyrazoles such as fipronil or ethiprole, chlorfenapyr, diafenthiuron, indoxacarb, metaflumazone, emamectin benzoate, abamectin, pyridalyl, flubendiamide, rynaxypyr; and other insecticides, such as amitraz, clofentezine, fenpyroximate, hexythiazox, spinosad, and imidacloprid.

Pesiticide include, but are not limited to, benzimidazine fungicides, such as benomyl, carbendazim, thia-bendazine, and thiophanate-methyl; 1,2,4-triazine fungicides, such as epoxyconazine, cyproconazine, flusilazine, flutriafol, propiconazine, tebuconazine, triadimefon, and tri-adimenol; substituted anilide fungicides, such as metalaxyl, oxadixyl, procymidone, and vinclozolin; organophosphorus fungicides, such as fosetyl, iprobenfos, pyrazophos, edifen-phos, and tolclofos-methyl; morpholine fungicides, such as fenpropimorph, tridemorph, and dodemorph; other systemic fungicides, such as fenarimol, imazalil, prochloraz, tricycla-zine, and triforine; dithiocarbamate fungicides, such as mancozeb, maneb, propineb, zineb, and ziram; non-systemic fungicides, such as chlorothalonil, dichlorofluanid, dithianon, and iprodione, captan, dinocap, dodine, fluazinam, gluazatine, PCNB, pencycuron, quintozene, tricylamide, and validamycin; inorganic fungicides, such as copper and sulphur products, and other fungicides; nematicides such as carbofuran, carbosulfan, turbufos, aldecarb, ethoprop, fenamphos, oxamyl, isazofos, cadusafos, and other nematicides.

Formulations can contain visual attractants, e.g. food coloring.

A variety of additives may be incorporated into the formulation. These additives typically change and/or enhance the physical characteristics of the carrier material and are, therefore, suitable for designing compositions having specific requirements as to the release rate and amount of the active ingredient, protection of the wax composition from weather conditions, etc. These additives are, among others, plasticizers, volatility suppressants, antioxidants, lipids, various ultraviolet blockers and absorbers, or antimicrobials, typically added in amounts from about 0.001% to about 10%, more typically between 1-6%, by weight.

Plasticizers, such as glycerin or soy oil affect physical properties of the composition and may extend its resistance to environmental destruction.

Antioxidants, such as vitamin E, BHA (butylated hydroxyanisole), BHT (butylated hydroxytoluene), and other antioxidants which protect the bioactive agent from degradation, may be added in amounts from about 0.1% to about 3%, by weight.

Ultraviolet blockers, such as beta-carotene, lignin or p-aminobenzoic acid protect the bioactive agents from light degradation may be added in amounts from about 1% to about 3%, by weight.

Antimicrobials, such as potassium sorbate, nitrates, nitrites, and propylene oxide, protect the bioactive agents from microbial destruction may be added in amounts from 0.1% to about 2% by weight.

Adjuvants can also be added to the formulation. An adjuvant is broadly defined as any substance added to the spray tank, separate from the pesticide formulation, that will improve the performance of the pesticide. These includes but are not limited to wetter-spreaders, stickers, penetrants, compatibility agents, buffers, and so on.

Other compounds and materials can be added provided they do not substantially interfere with the activity of active ingredient. Whether or not an additive substantially interferes with the active ingredient's activity can be determined by standard test formats, involving direct comparisons of efficacy of the composition of the active ingredient without an added compound and the composition of the active ingredient with an added compound.

In one embodiment, the active ingredient is preferably applied topically on a subject at risk of insect bites. The active ingredient is applied in therapeutically effective amount in admixture with pharmaceutical carriers, in the form of topical pharmaceutical compositions. Such compositions include solutions, suspensions, lotions, gels, creams, ointments, emulsions, sprays, etc. All of these dosage forms, along with methods for their preparation, are well known in the pharmaceutical and cosmetic art: Harry's Cosmeticology (Chemical Publishing, 7th ed. 1982); Remington's Pharmaceutical Sciences (Mack Publishing Co., 18th ed. 1990). Typically, such topical formulations contain the active ingredient in a concentration range of 0.001 to 10 mg/ml, in admixture with suitable vehicles. Other desirable ingredients that can be added to the topical preparations include preservatives, co-solvents, viscosity building agents, carriers, etc.

Penetration enhancers may, for example, be surface active agents; certain organic solvents, such as di-methylsulfoxide and other sulfoxides, dimethyl-acetamide and pyrrolidone; certain amides of heterocyclic amines, glycols (e.g. propylene glycol); propylene carbonate; oleic acid; alkyl amines and derivatives; various cationic, anionic, nonionic, and amphoteric surface active agents; and the like.

Frequently used carriers or auxiliaries include magnesium carbonate, titanium dioxide, lactose, mannitol and other sugars, talc, milk protein, gelatin, starch, vitamins, cellulose and its derivatives, animal and vegetable oils, polyethylene glycols and solvents, such as sterile water, alcohols, glycerol and polyhydric alcohols.

Preservatives include antimicrobial, anti-oxidants, chelating agents and inert gases. Other pharmaceutically acceptable carriers include aqueous solutions, non-toxic excipients, including salts, preservatives, buffers and the like, as described, for instance, in Remington's Pharmaceutical Sciences, 18th ed., Mack Publishing Co. (1990). The pH and exact concentration of the various components of the pharmaceutical composition are adjusted according to routine skills in the art. See Goodman and Gilman's The Pharmacological Basis for Therapeutics, 10 th ed., McGraw-Hill Professional (2001).

Inventors have demonstrated that an insect will stop eating after ingesting an active agent. For example ingesting a TRPA1 ion gated channel agonist will cause an insect to stop eating. Thus, in one embodiment, the active agents are formulated with a food source for insects, e.g., formulated with compounds in insect diet. In another embodiment, the active agents are formulated with sucrose. The insect will then feed on such mixtures and stop eating.

In one embodiment, the active agent can be applied to breeding locus of insects. Without wishing to be bound by theory, application of active agent to breeding locus inhibits insects from breeding by either repelling them from that locus or preventing laying of eggs at that locus, or both.

In another embodiment, the active agent is applied to feeding locus of insects. This inhibits insect feeding leading to starvation of insects.

In yet another embodiment, the active agent is applied to both breeding and feeding locus of insects.

In one embodiment, the active agent is applied as a spray to locus of insects, e.g., breeding locus, feeding locus.

In one embodiment, the active agent is applied to insect traps. For example, the trap may be coated with the active agent or trap may be loaded with insect food comprising an active agent.

In one embodiment, the active agent is applied to clothing, such as a shirt, hat, pants, shorts, outer garment, etc . . . of a subject. In one embodiment, the active agent is applied to clothing by soaking the clothing in a solution comprising the active agent. In another embodiment, the active agent is applied to clothing by spraying the clothing with a formulation comprising the active agent.

### INCORPORATION BY REFERENCE

All publications and patents mentioned herein, are hereby incorporated by reference in their entirety as if each individual publication or patent was specifically and individually indicated to be incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

This invention is further illustrated by the following examples which should not be construed as limiting. The contents of all references cited throughout this application, as well as the figures and table are incorporated herein by reference.

The present invention may be defined in any one of the following numbered paragraphs:
1. A method of inhibiting thermosensing in an insect, the method comprising inhibiting TRPA1 ion gated channel or family members.
2. A method of inhibiting the chemosensing in an insect, the method comprising inhibiting a TRPA1 ion gated channel and/or family members in the insect.
3. The methods of paragraphs 1 or 2, wherein the TRPA1 is inhibited by an agent selected from the group consisting of ruthenium red, (Z)-4-(4-chlorophynyl)-3-methylbut-3-en-2-oxime, 2-(1,3-dimethyl-2,6-dioxo-1,2,3,6-tetrahydro-7H-purin-7-yl)-N-(4-isopropylphenyl)acetamid, cannabinoid agonists R-(+)-(2,3-dihydro-5-methyl-3-[(4-morpholinyl)methyl]pyrol[1,2,3-de]-1,4-benzoxazin-6-yl)-(1-naphthalenyl)methanone mesylate and (R,S)-3-(2-iodo-5-nitrobenzoyl)-1-(1-methyl-2-piperidinylmethyl)-1H-indole,

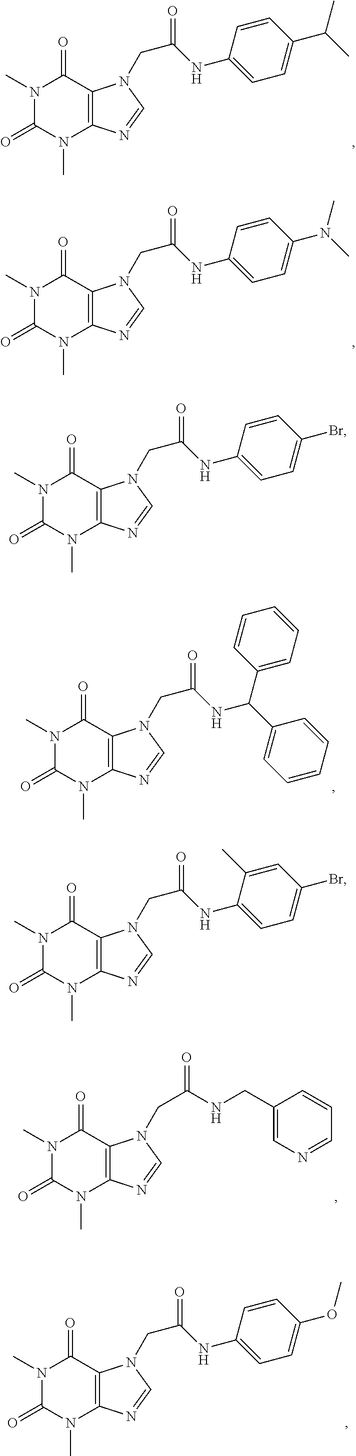

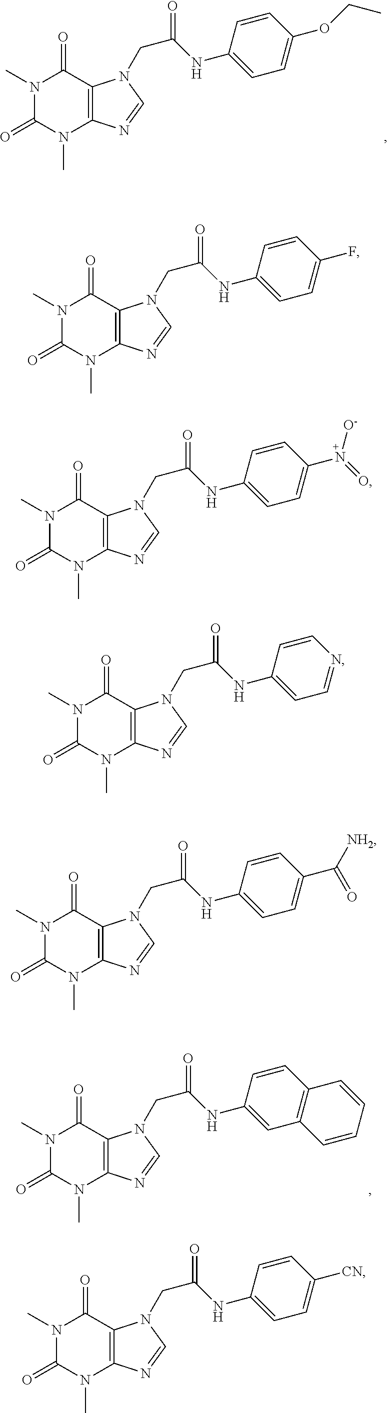

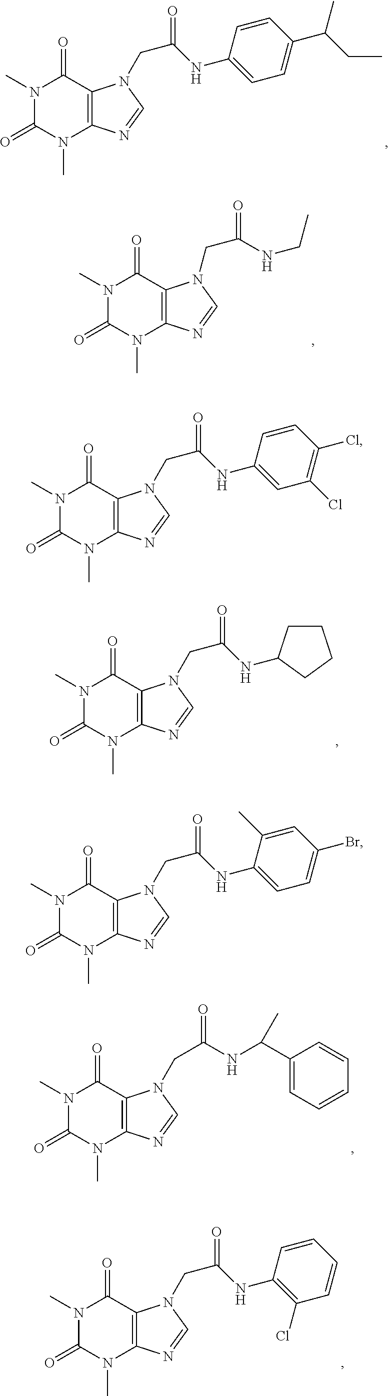

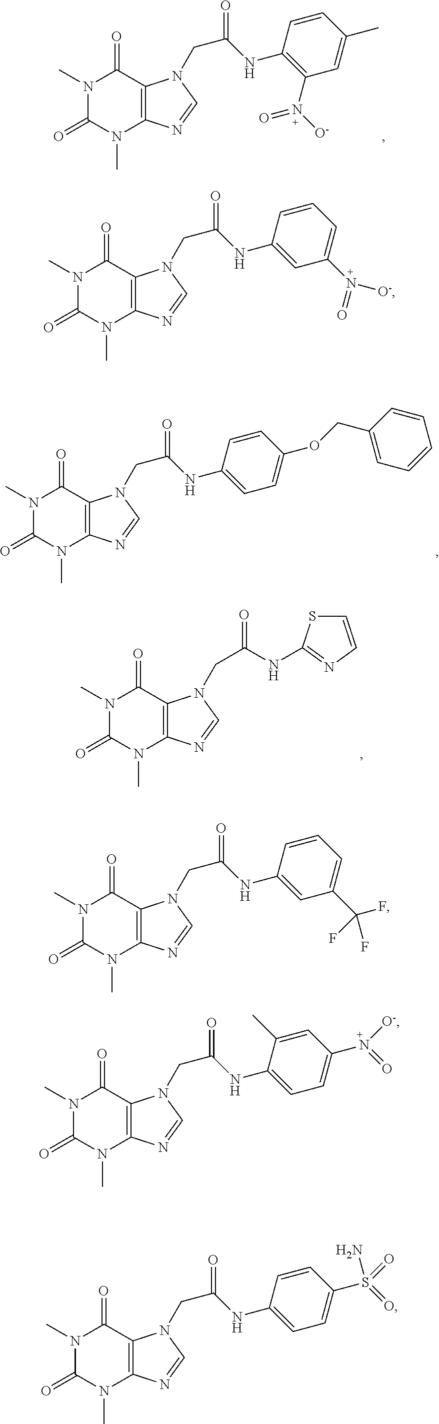

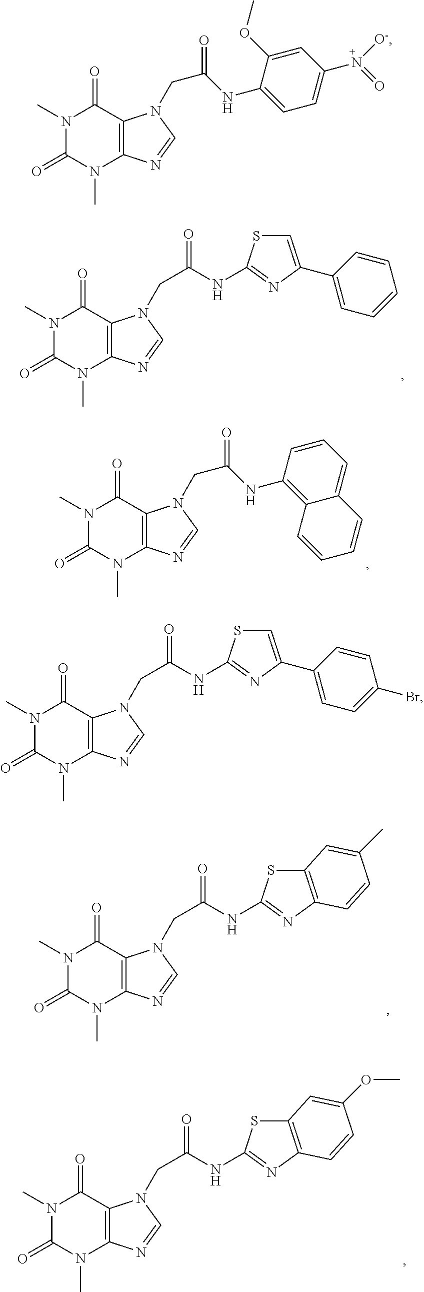

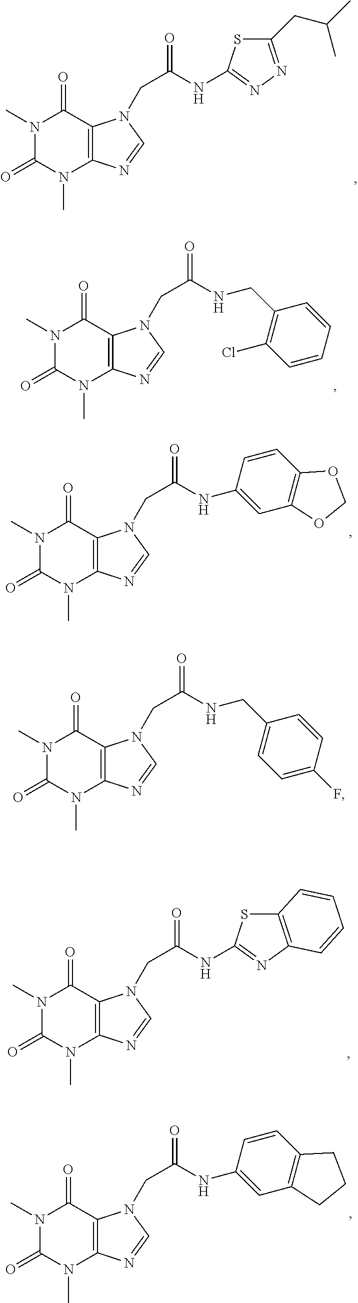

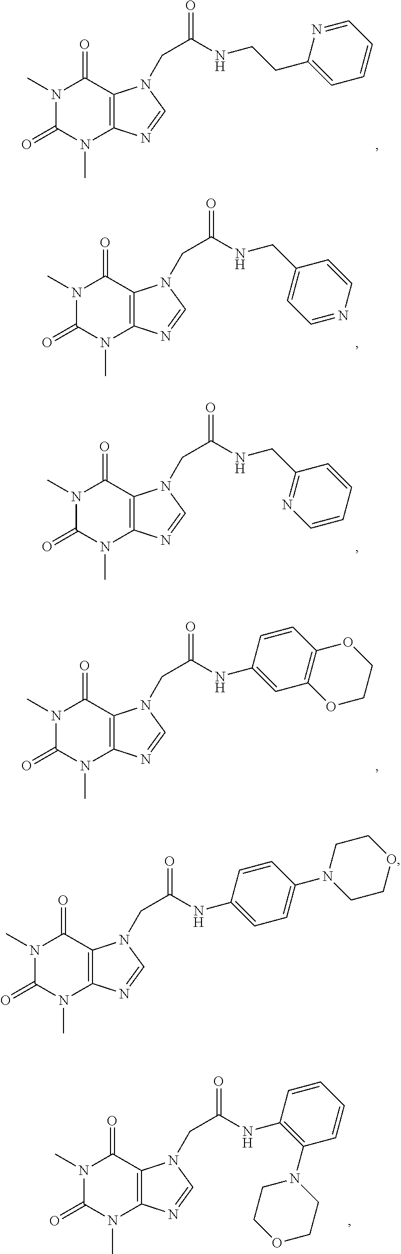

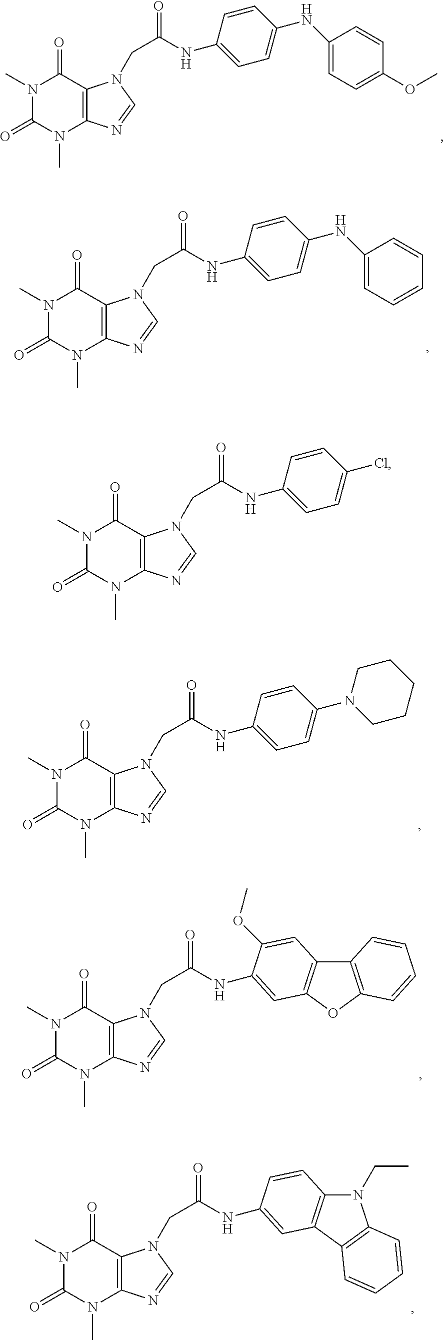

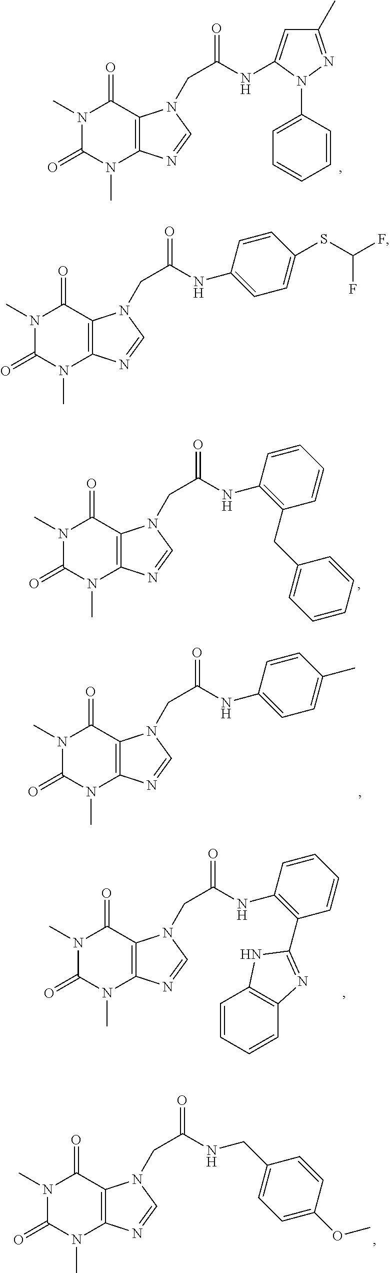

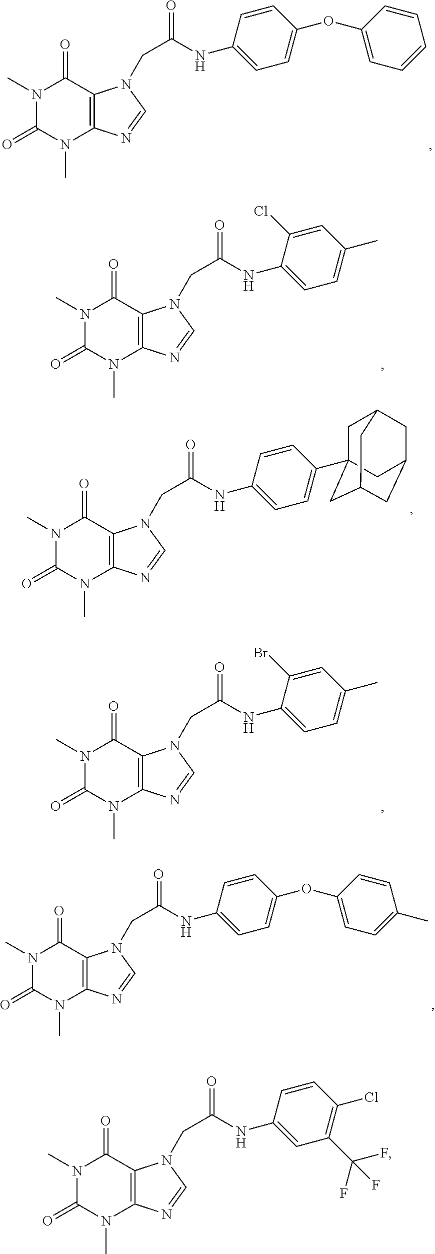

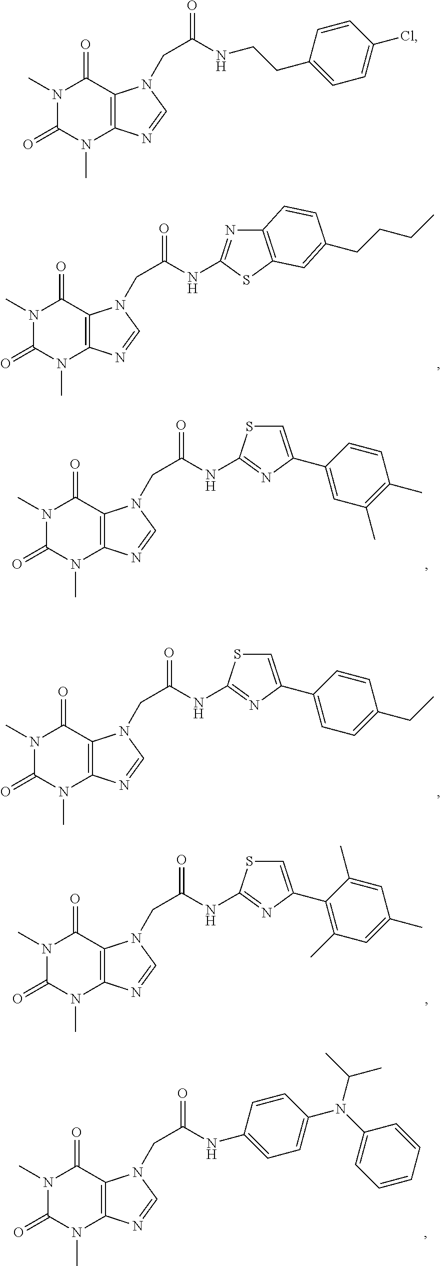

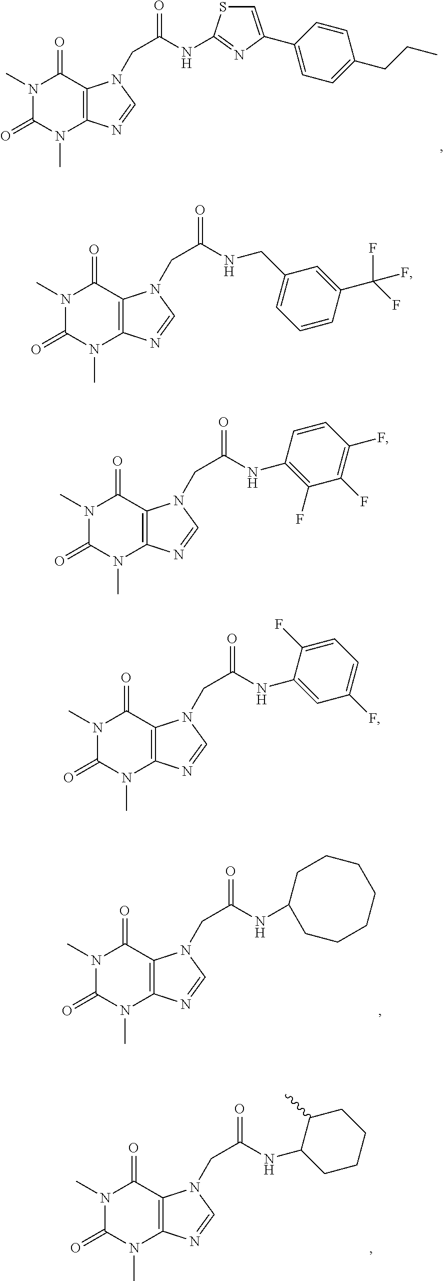

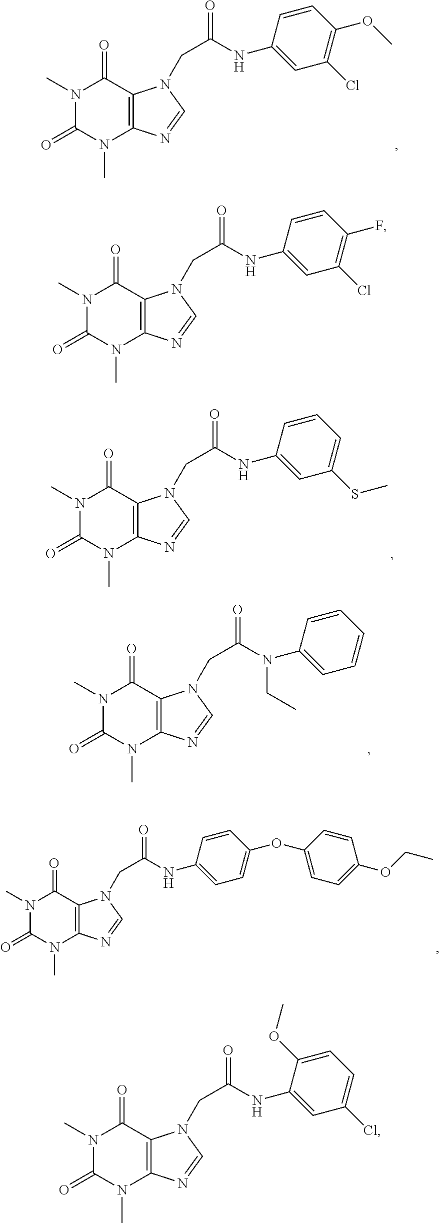

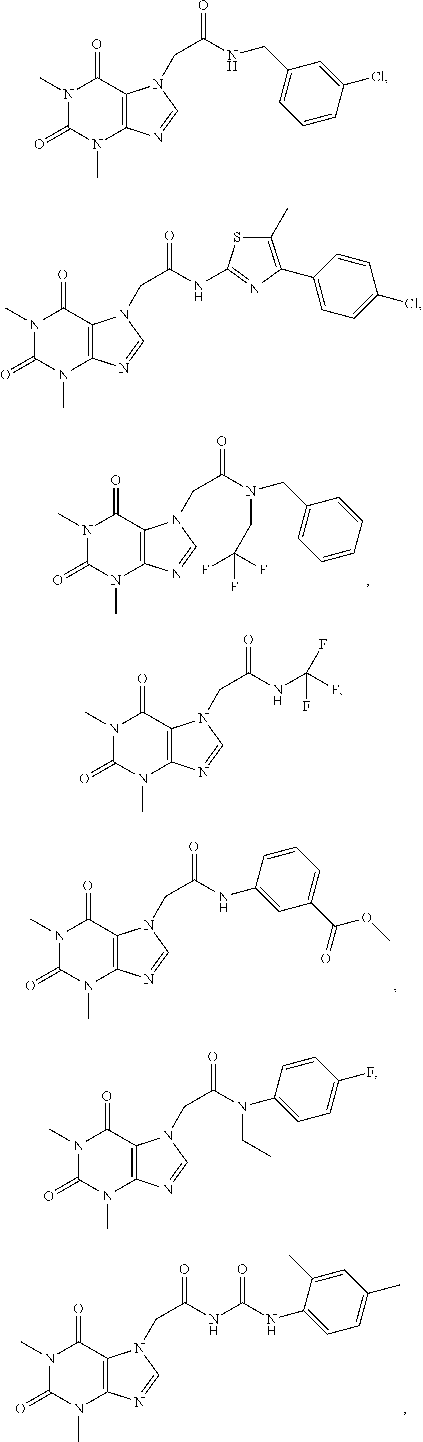

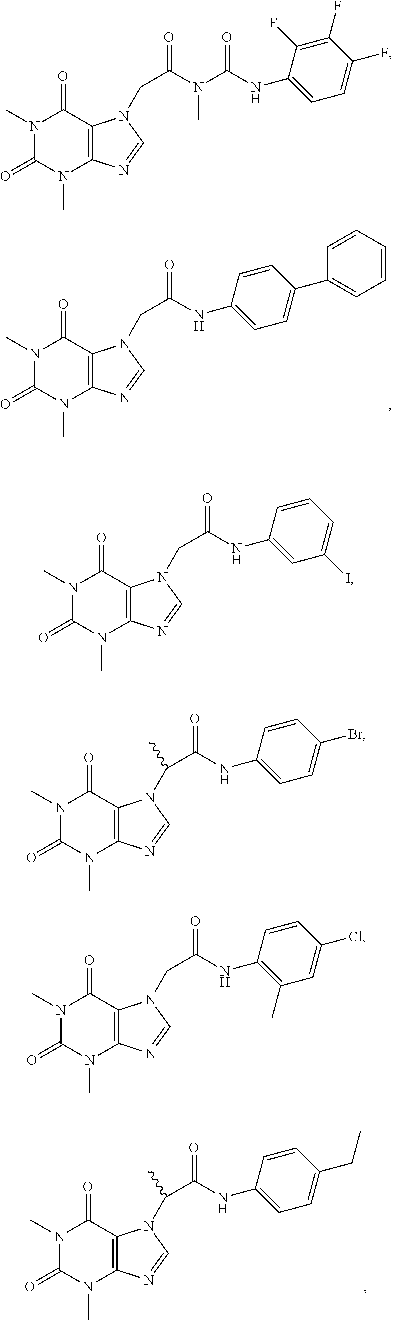

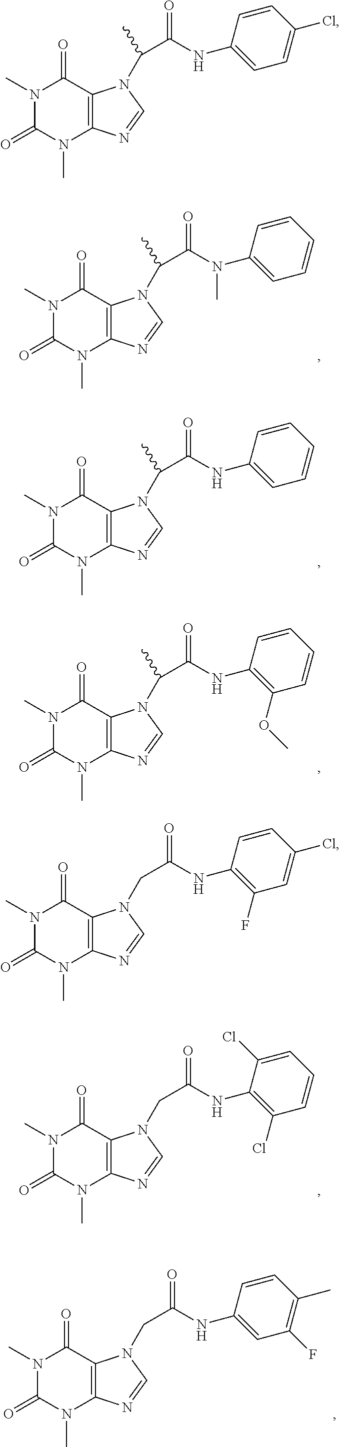

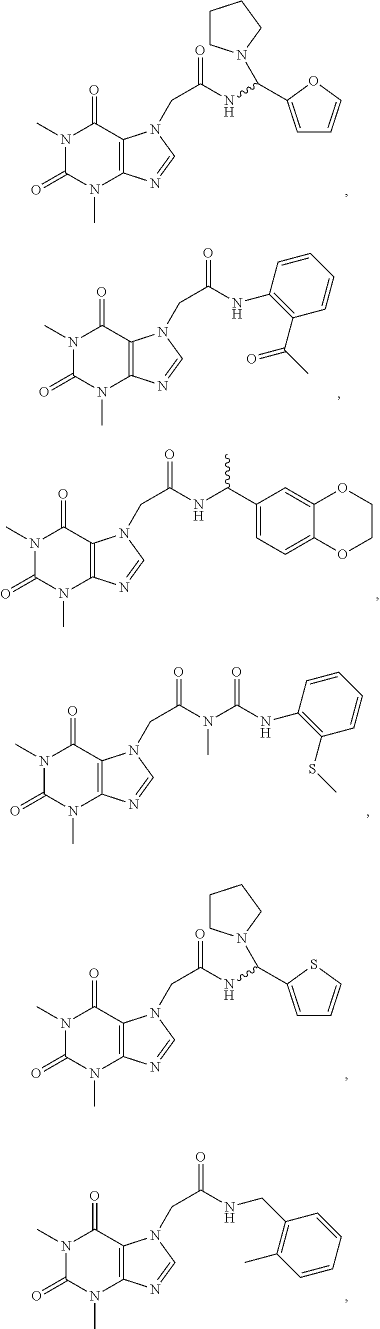

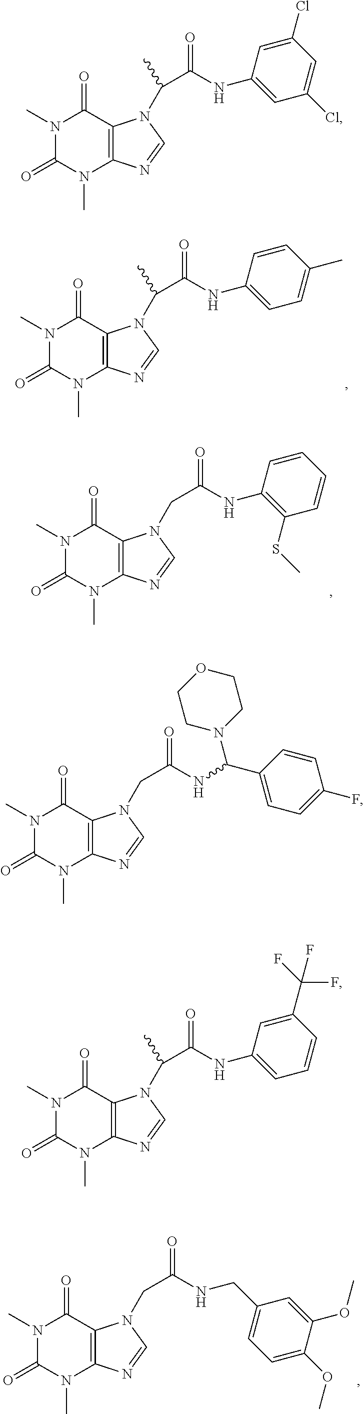

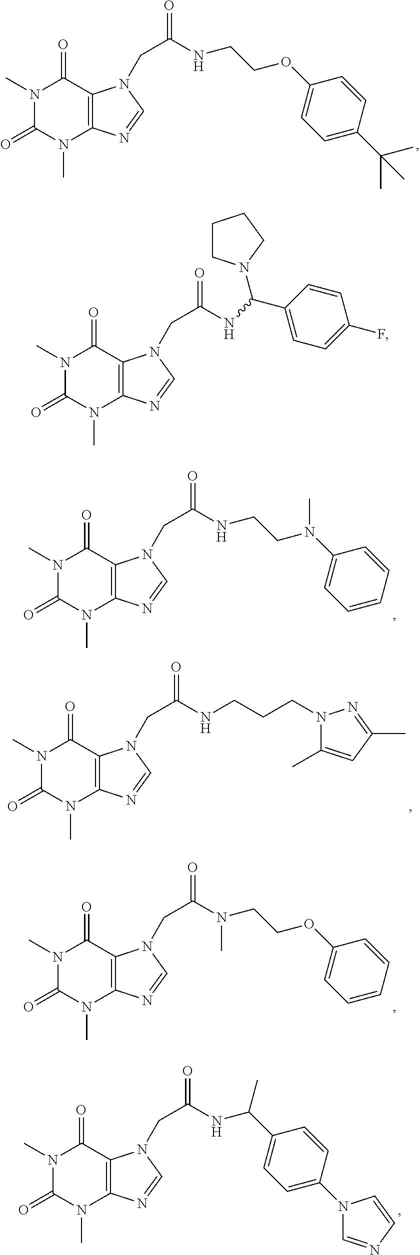

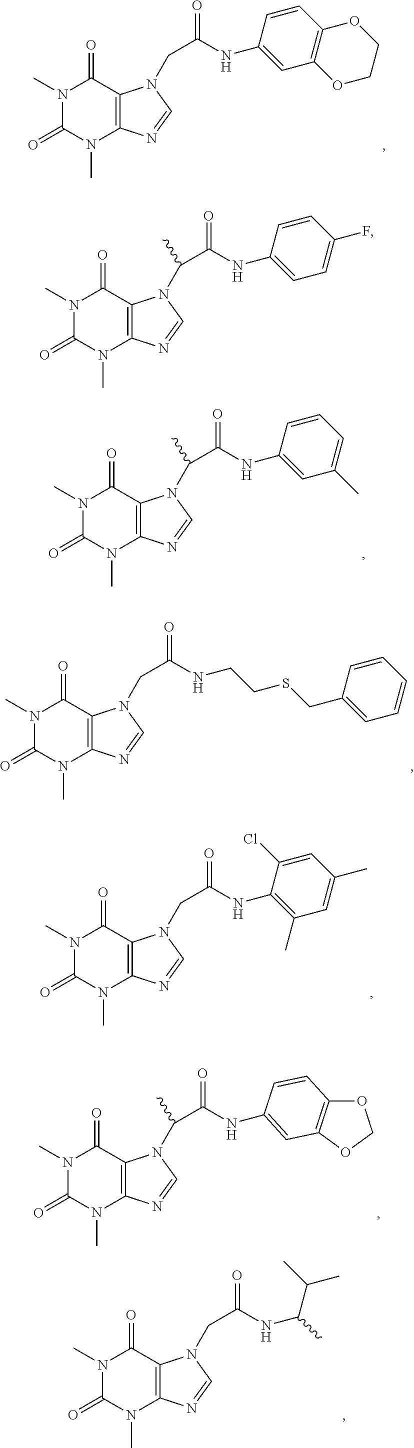

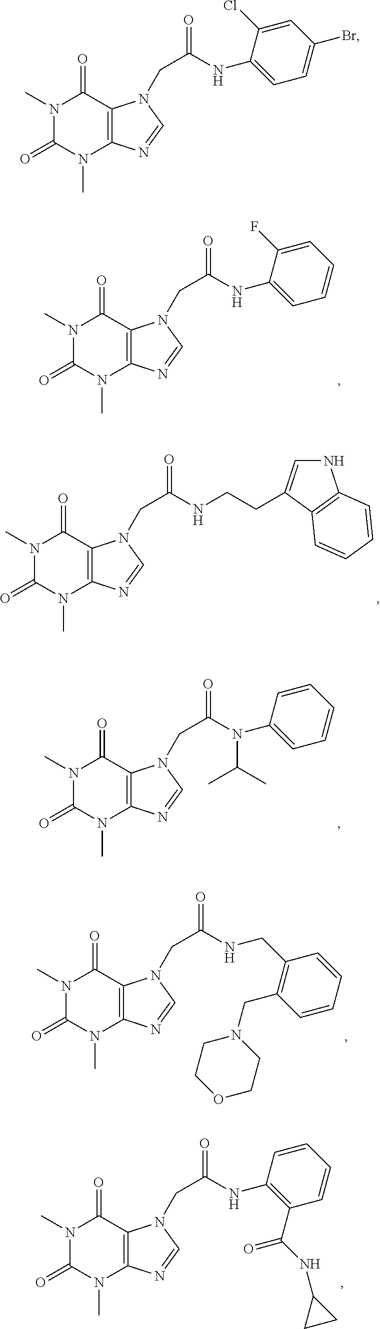

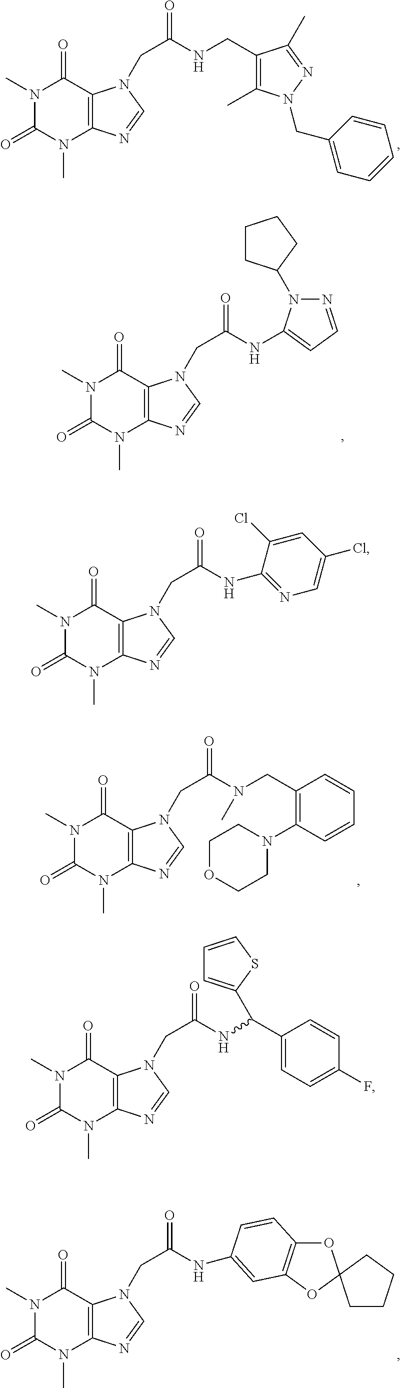

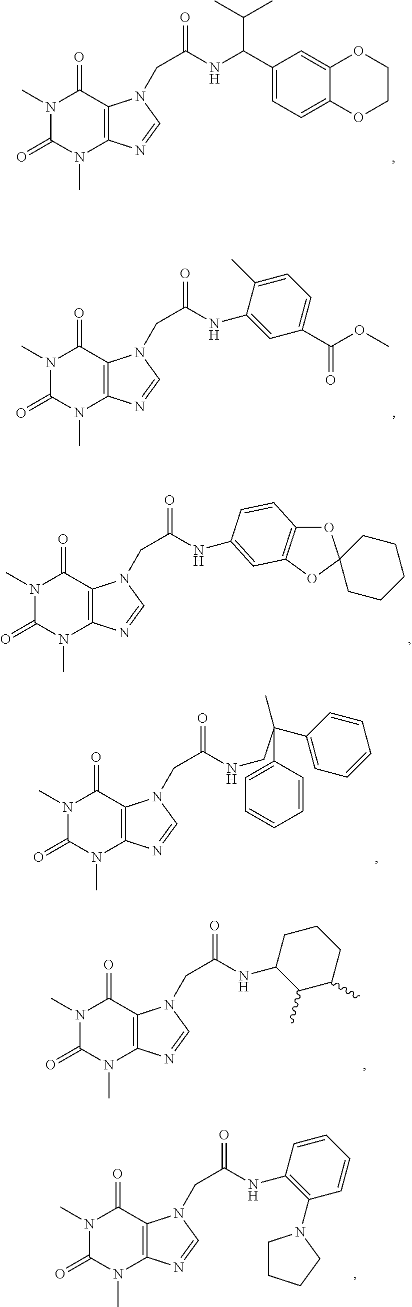

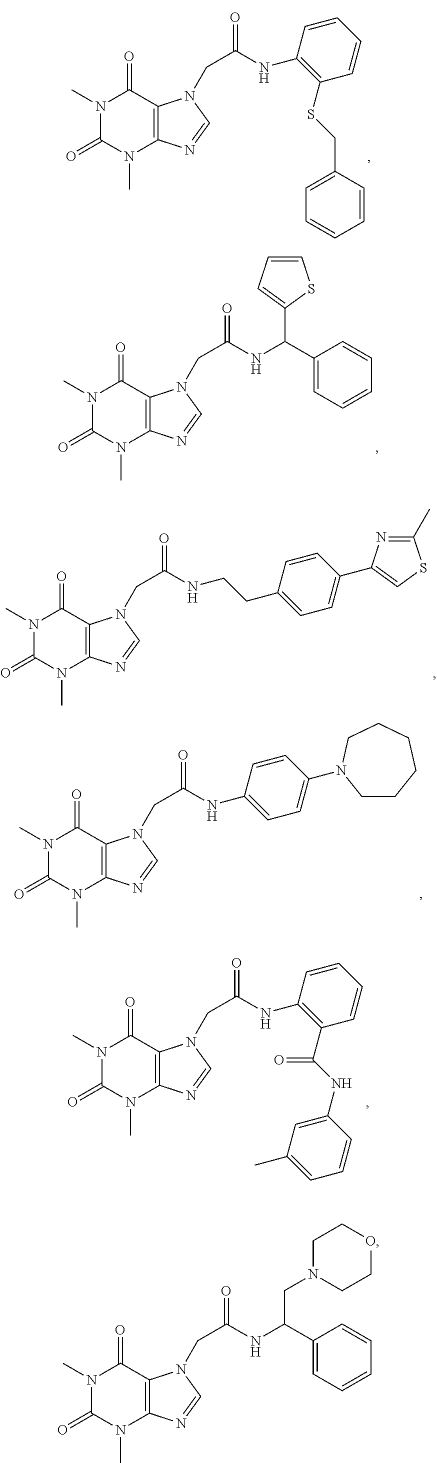

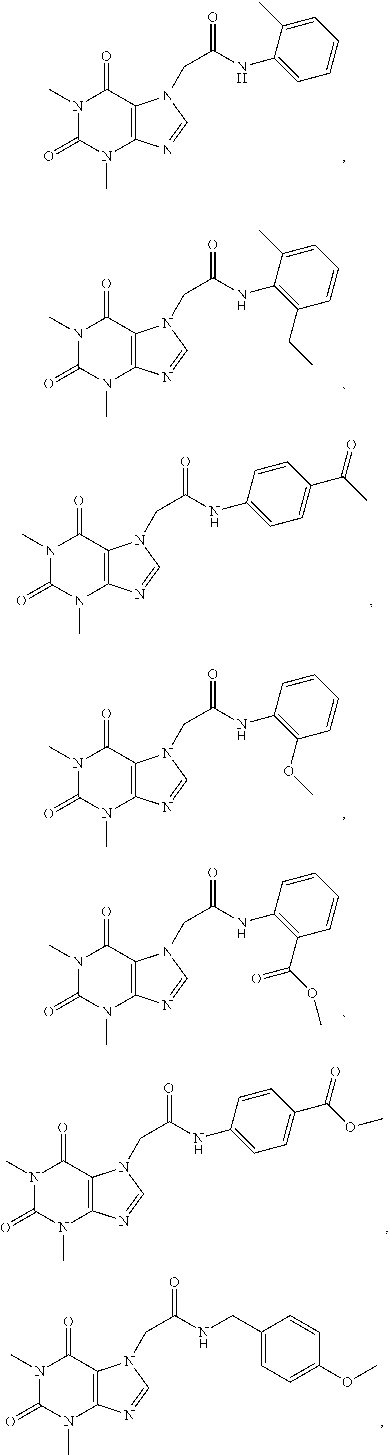

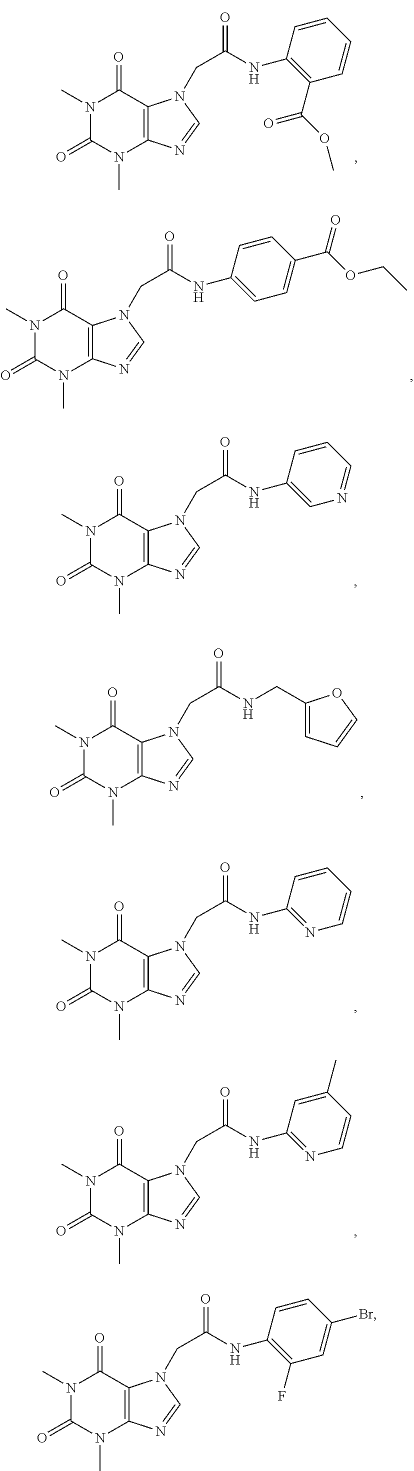

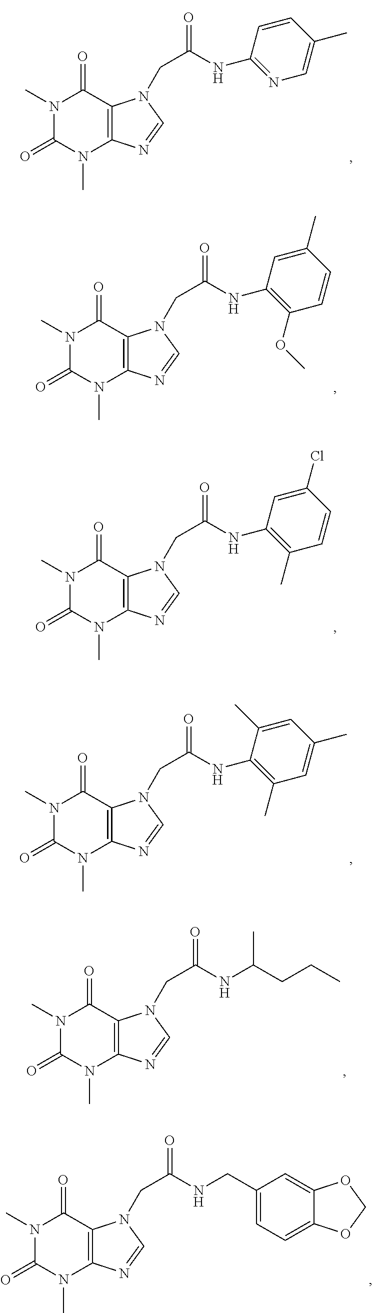

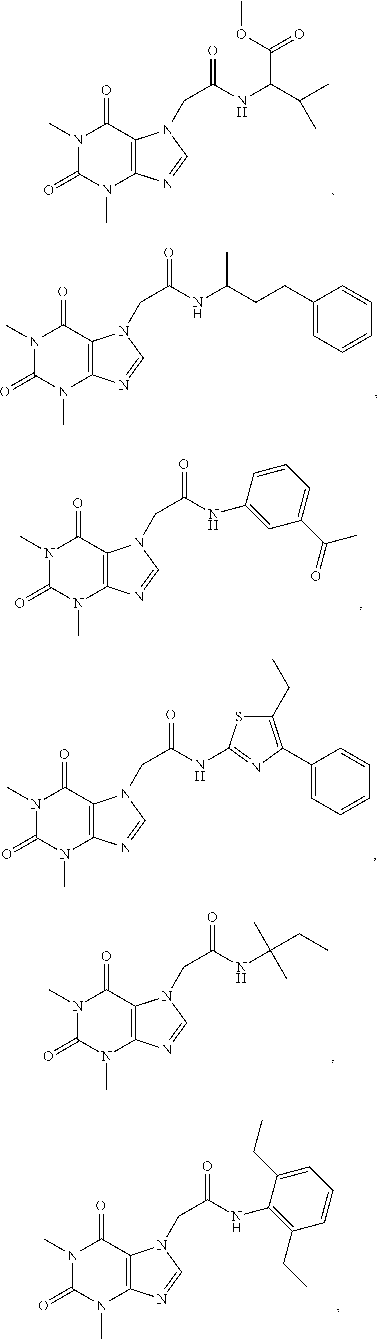

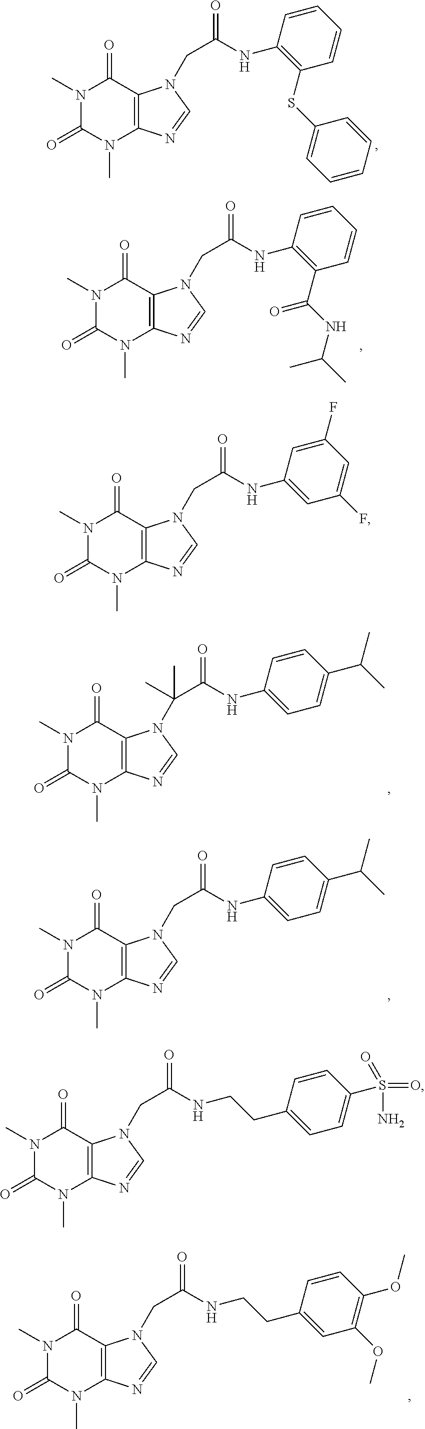

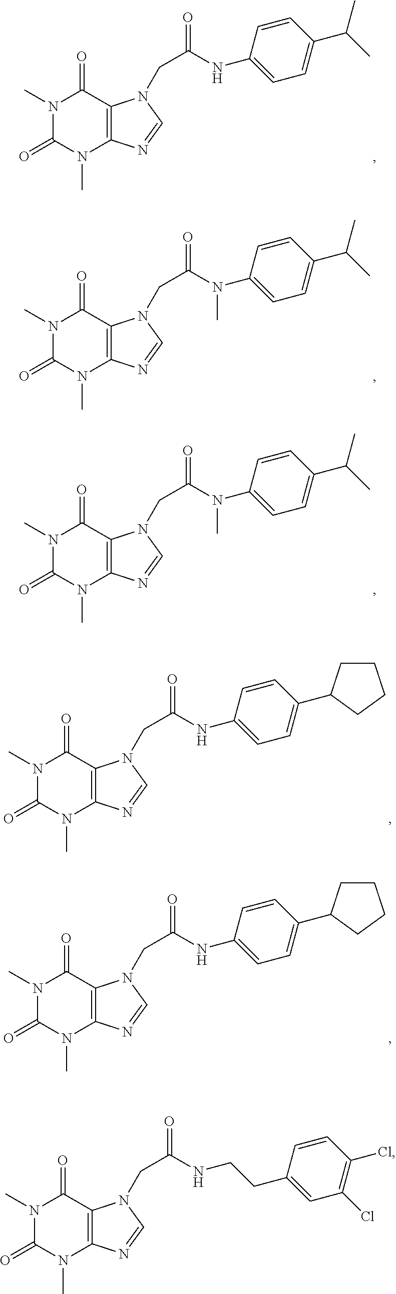

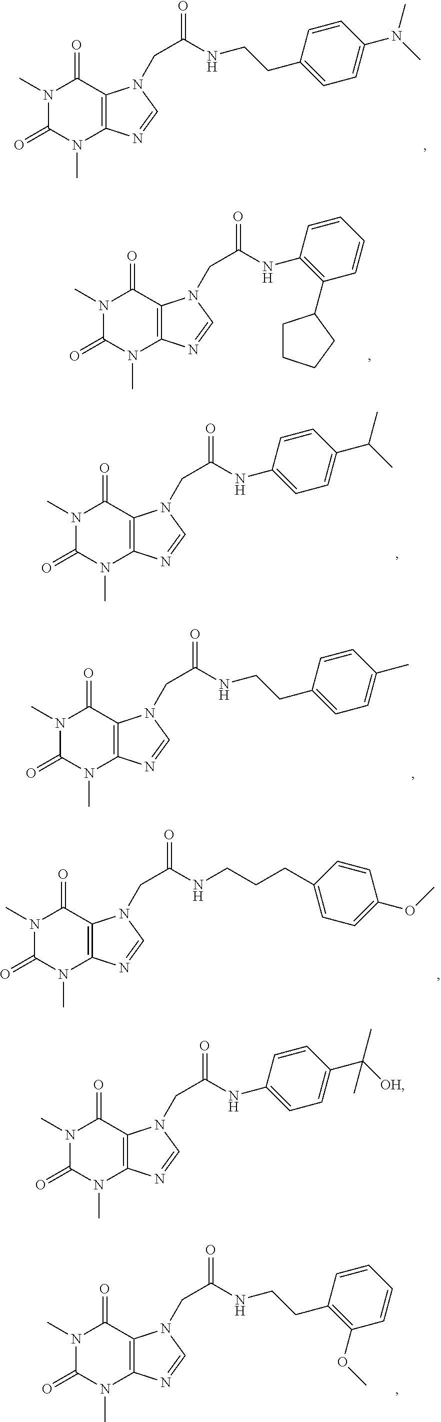

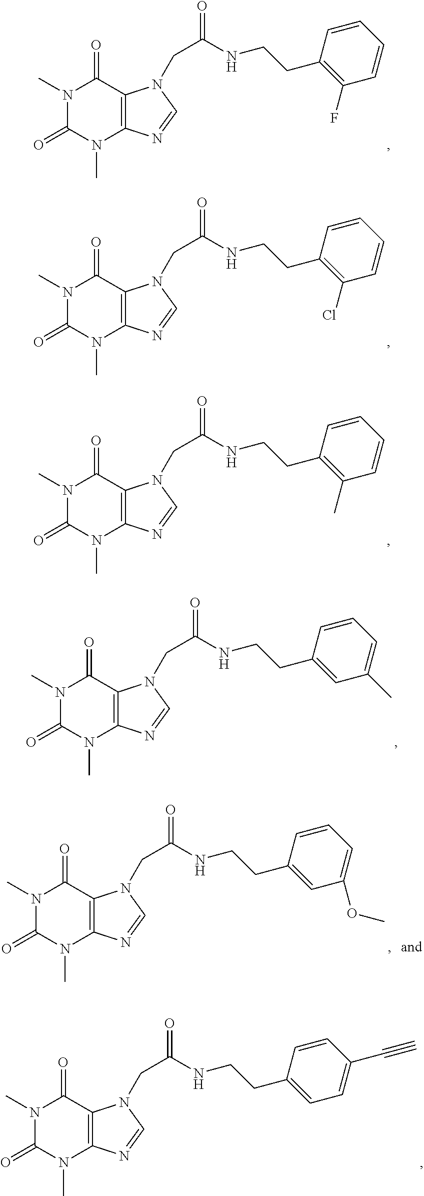

and pharmaceutically acceptable salts thereof.
4. The methods of paragraphs 1 or 2, wherein the insects are fleas, rat fleas, oriental rat fleas, flies, black flies, sand flies, mosquitoes, horse flies, deer flies, eye gnats, house flies, blow flies, flesh flies, tsetse flies, lice, human lice, true bugs, assassin bugs, or kissing bugs.
5. The methods of paragraphs 1, 2, 3, or 4, wherein the insects are disease vectors.
6. The methods of paragraphs 1, 2, 3, or 4, wherein the insects are agricultural horticultural pest.
7. The methods of paragraphs 1, 2, 3, or 4, wherein the insects are parasites.
8. The methods of paragraphs 1-6, wherein the agent is applied as a spray.
9. The methods of paragraphs 1-6, wherein the agent is applied topically.
10. A method of insect control comprising modulating activity of TRPA1 ion gated channel or family members in the insect.
11. The method of paragraph 10, wherein TRPA1 is inhibited by an agent selected from the group consisting of ruthenium red, (Z)-4-(4-chlorophynyl)-3-methylbut-3-en-2-oxime, 2-(1,3-dimethyl-2,6-dioxo-1,2,3,6-tetrahydro-7H-purin-7-yl)-N-(4-isopropylphenyl)acetamid, cannabinoid agonists R-(+)-(2,3-dihydro-5-methyl-3-[(4-morpholinyl)methyl]pyrol[1,2,3-de]-1,4-benzoxazin-6-yl)-(1-naphthalenyl)methanone mesylate and (R,S)-3-(2-iodo-5-nitrobenzoyl)-1-(1-methyl-2-piperidinylmethyl)-1H-indole,

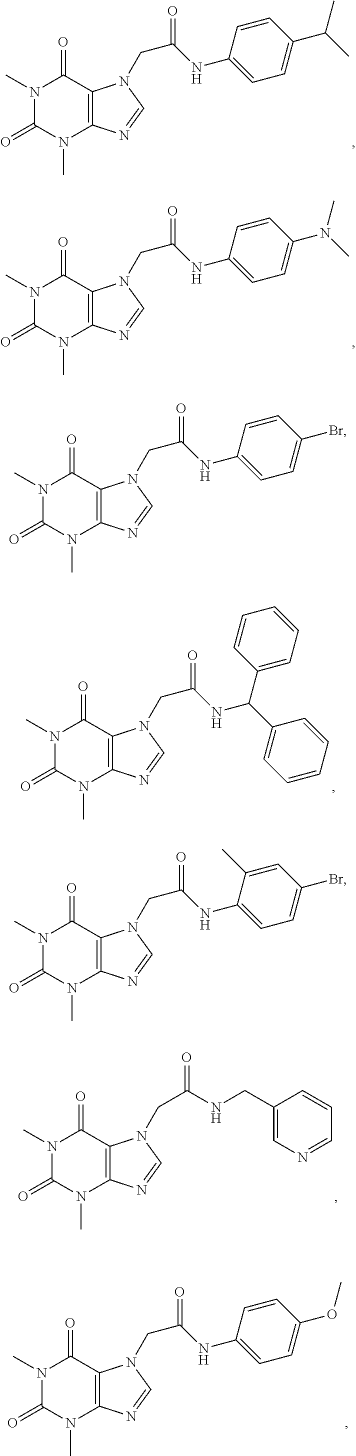

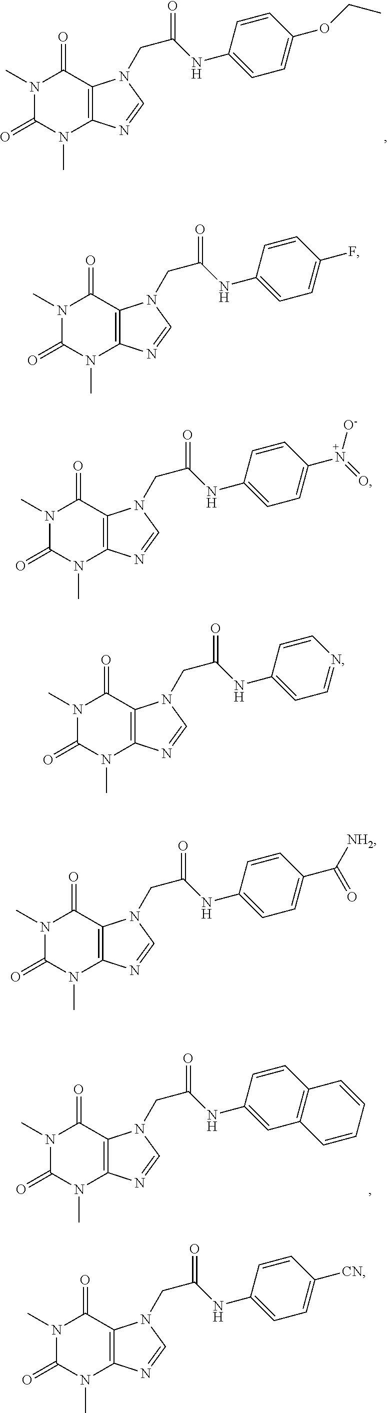

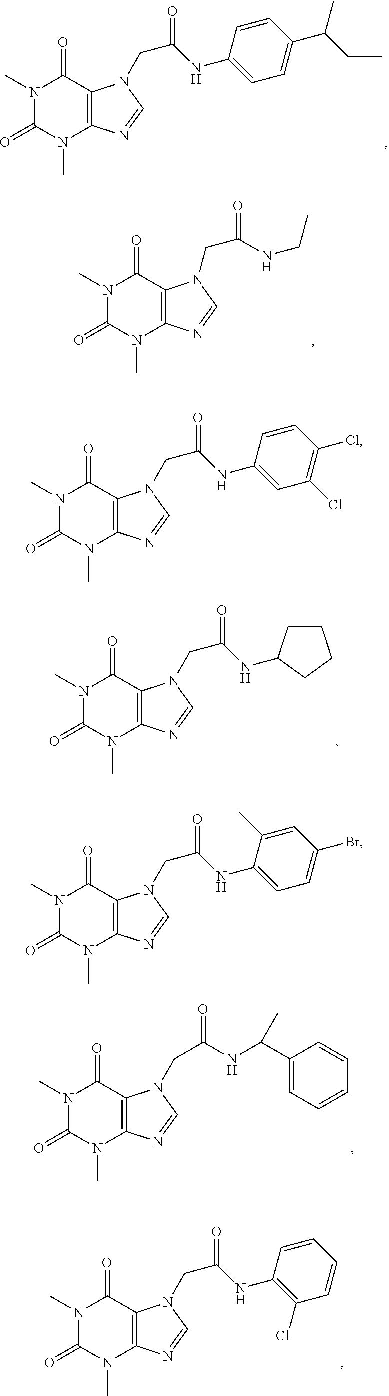

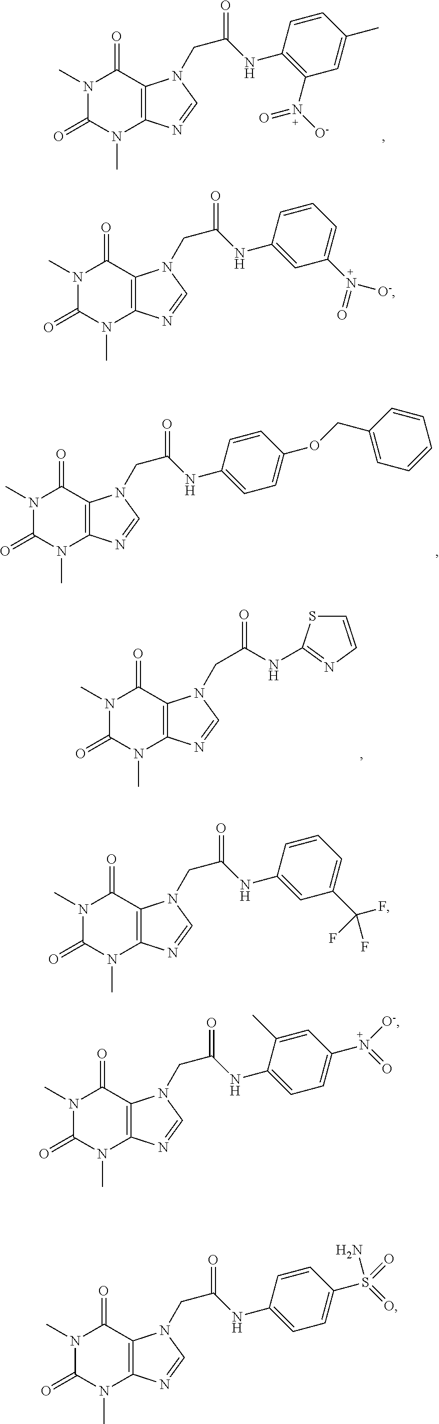

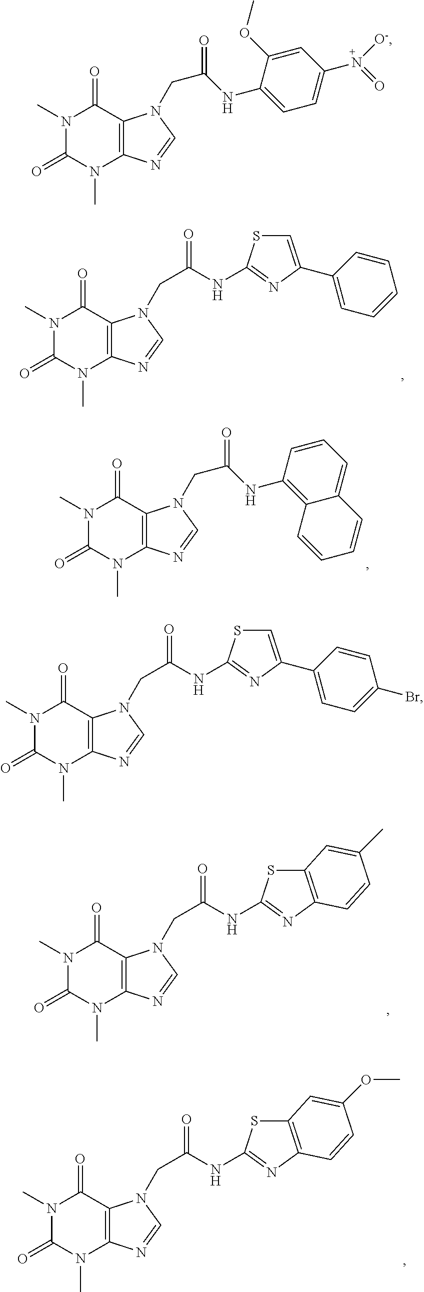

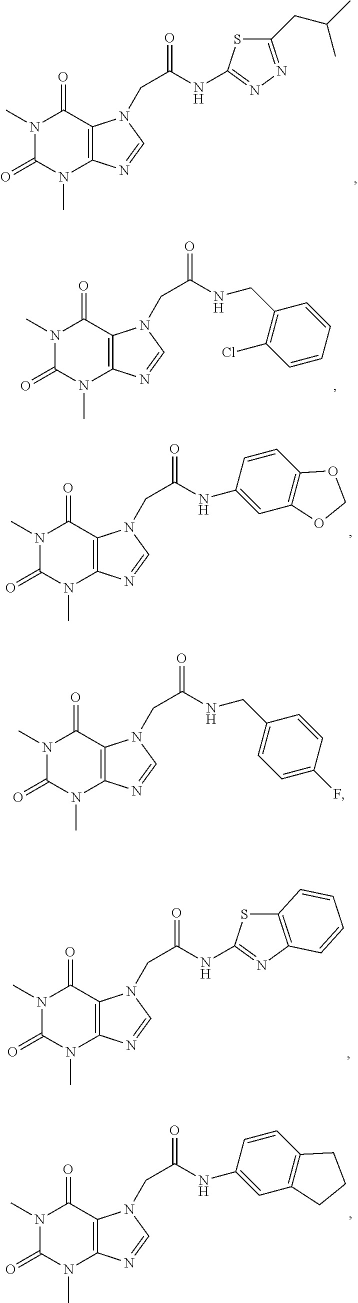

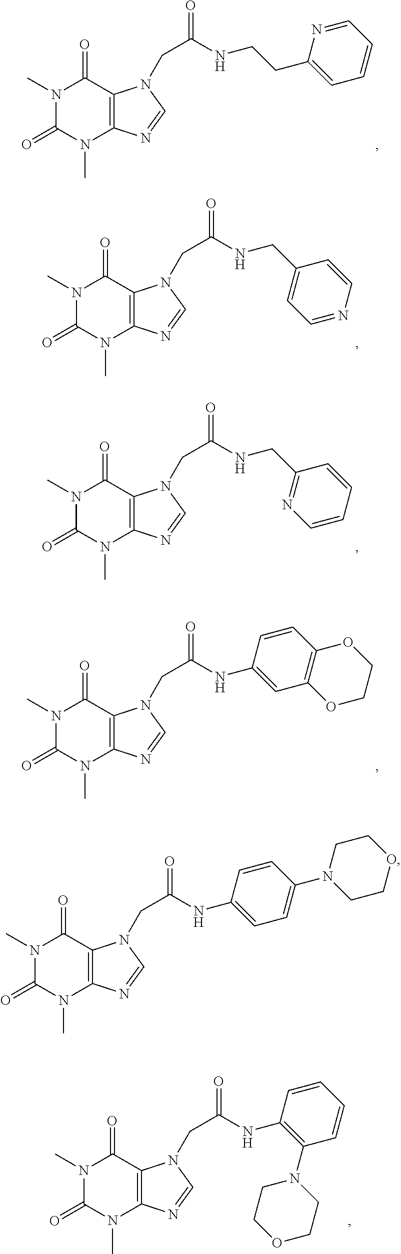

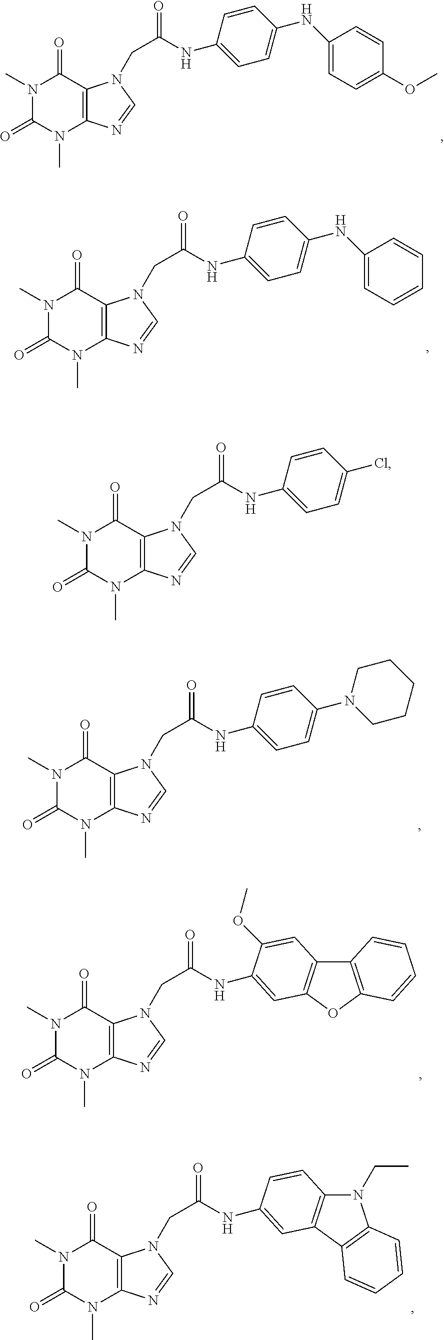

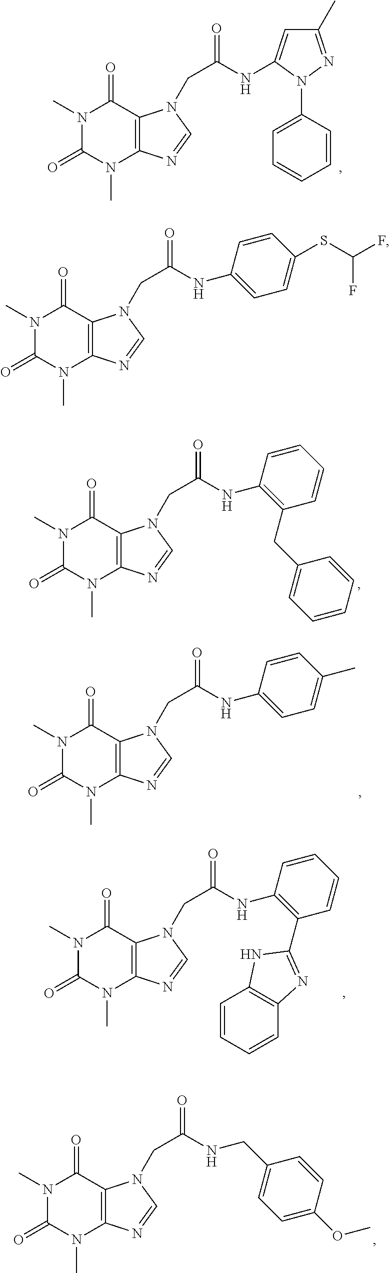

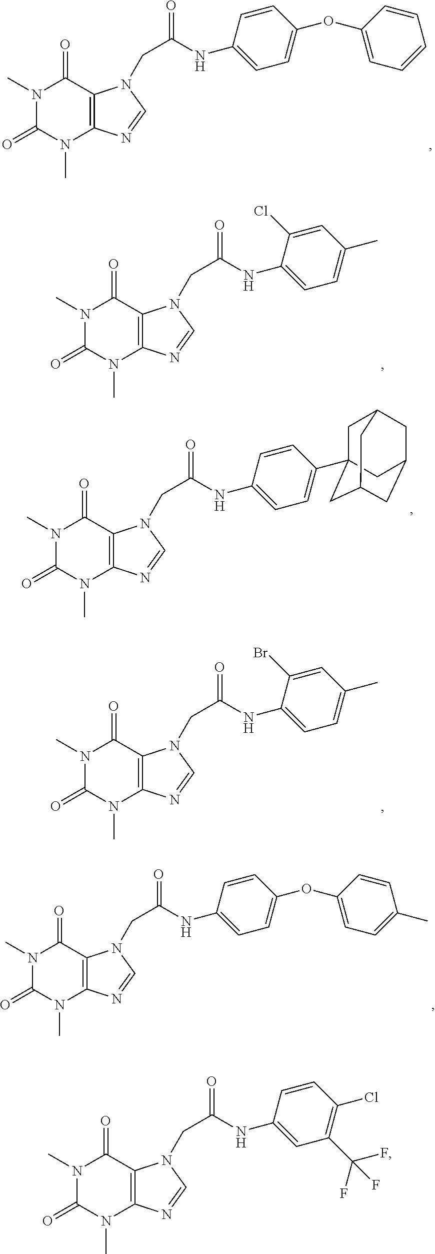

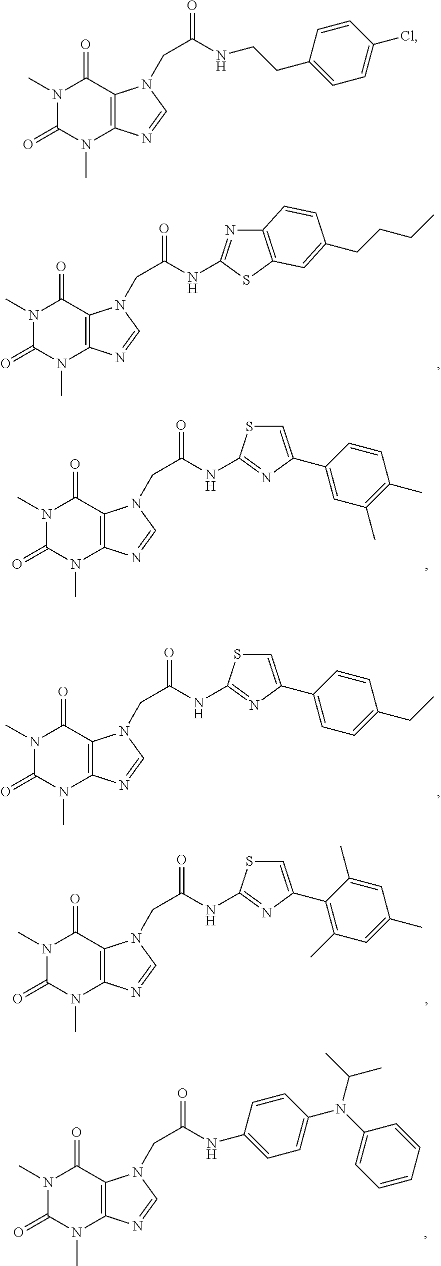

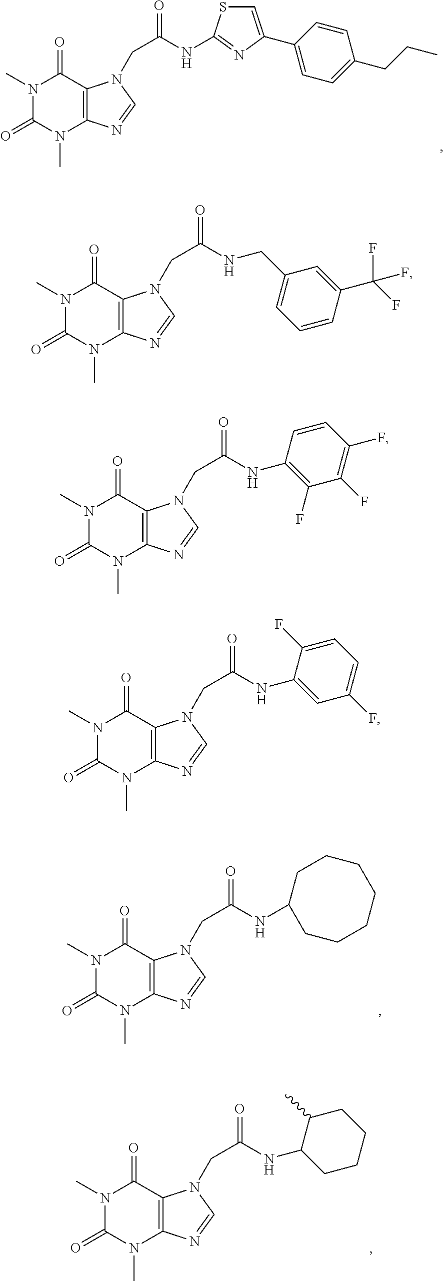

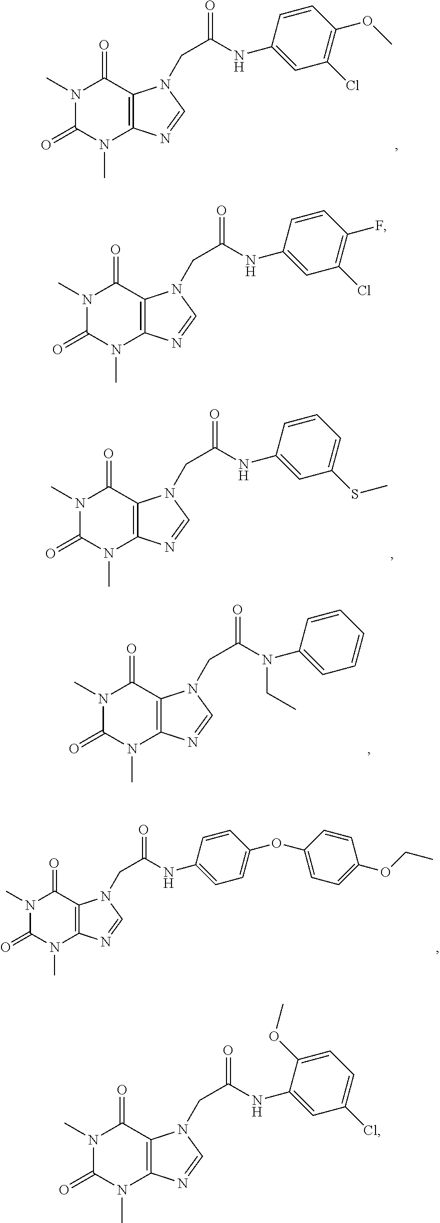

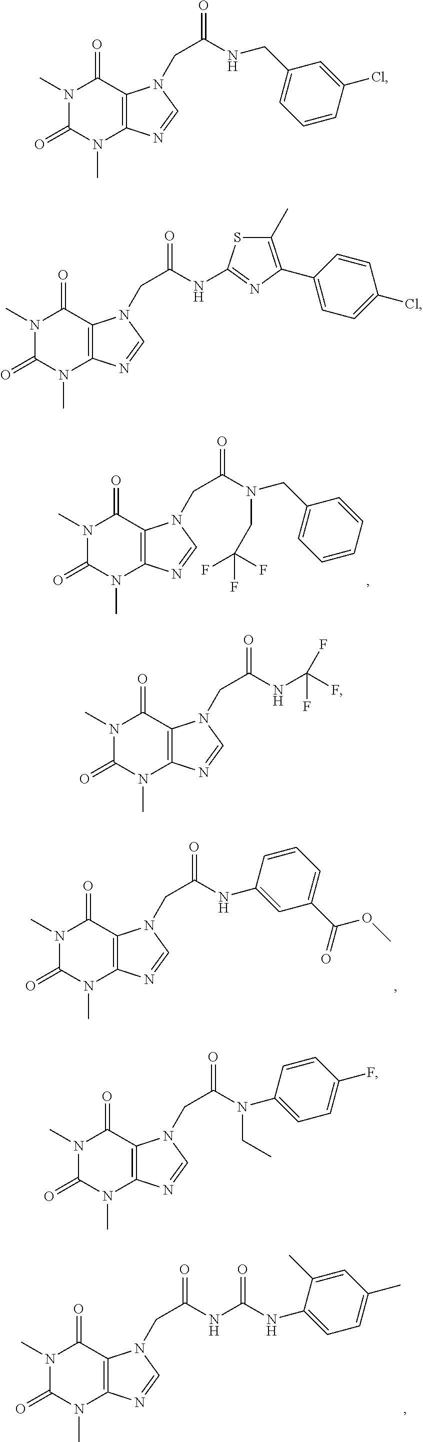

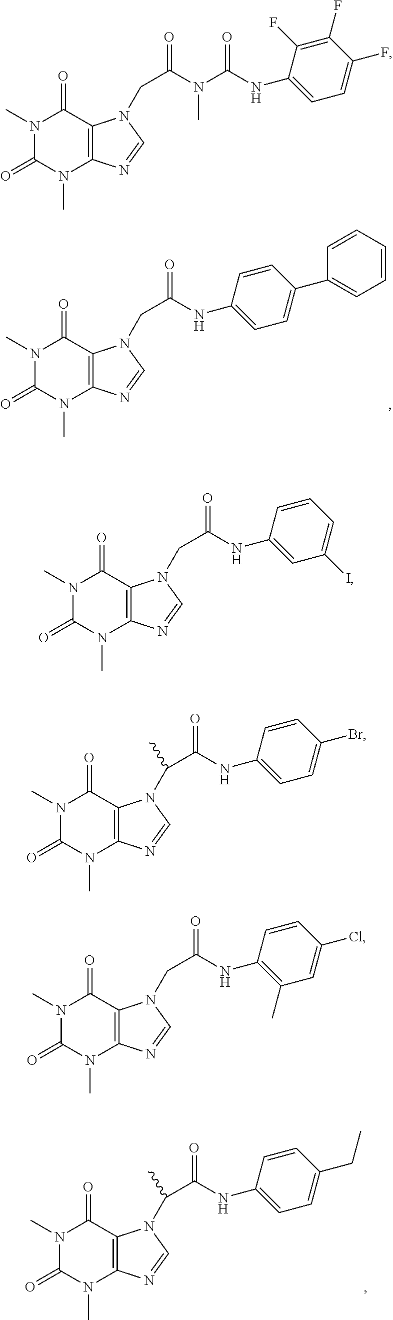

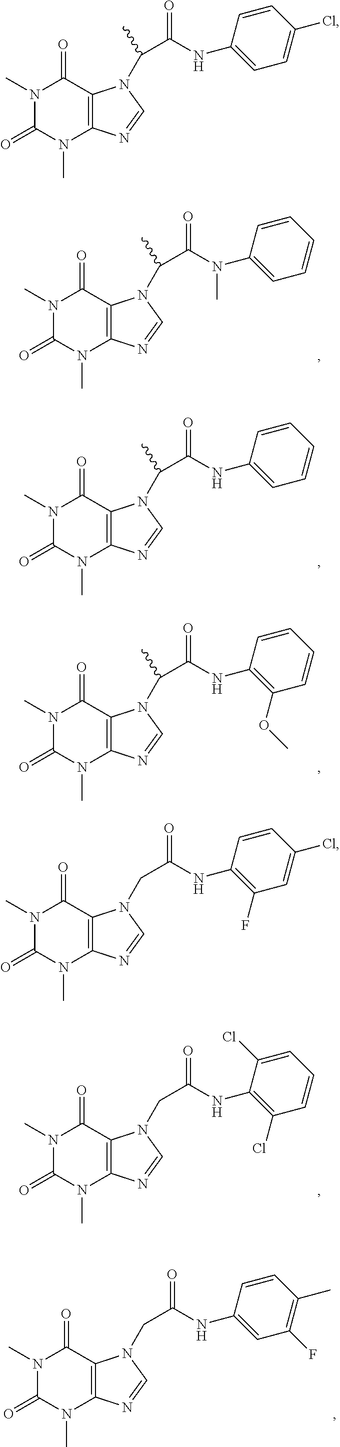

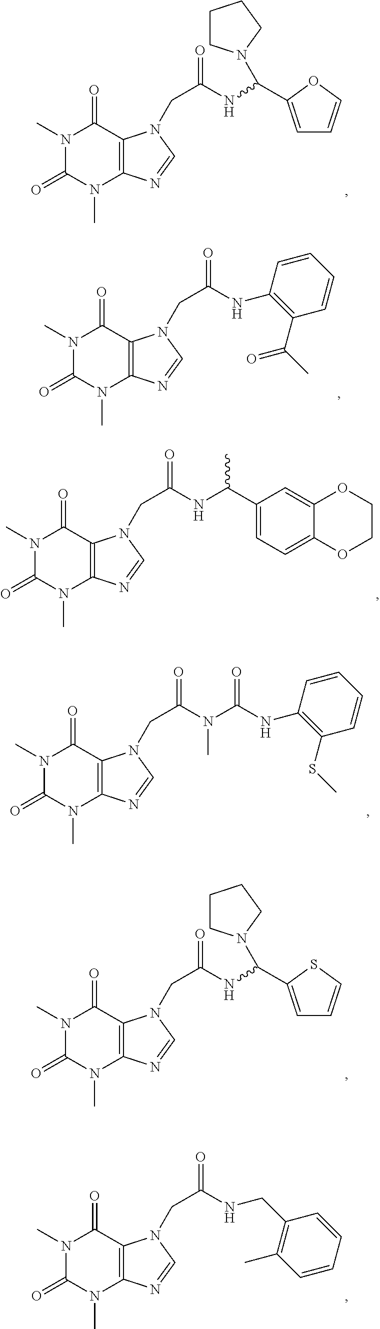

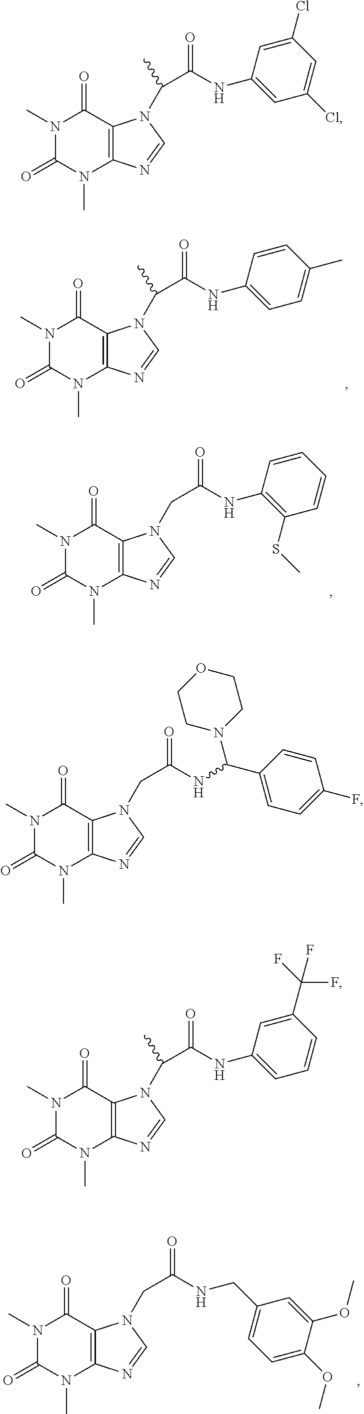

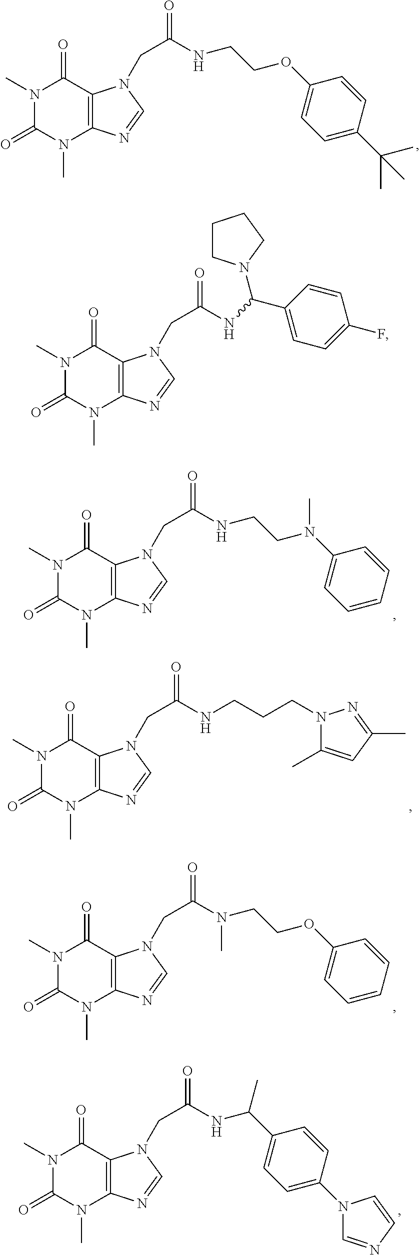

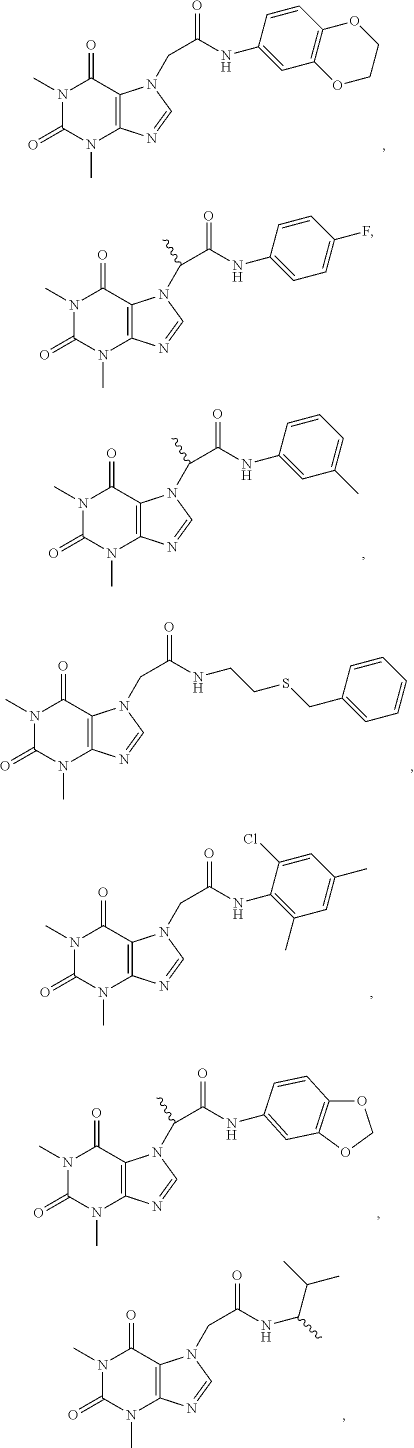

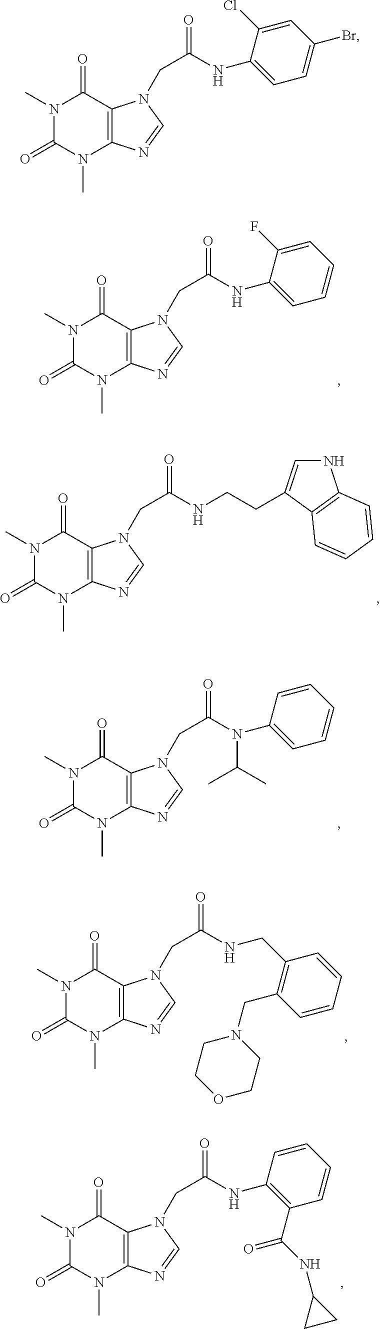

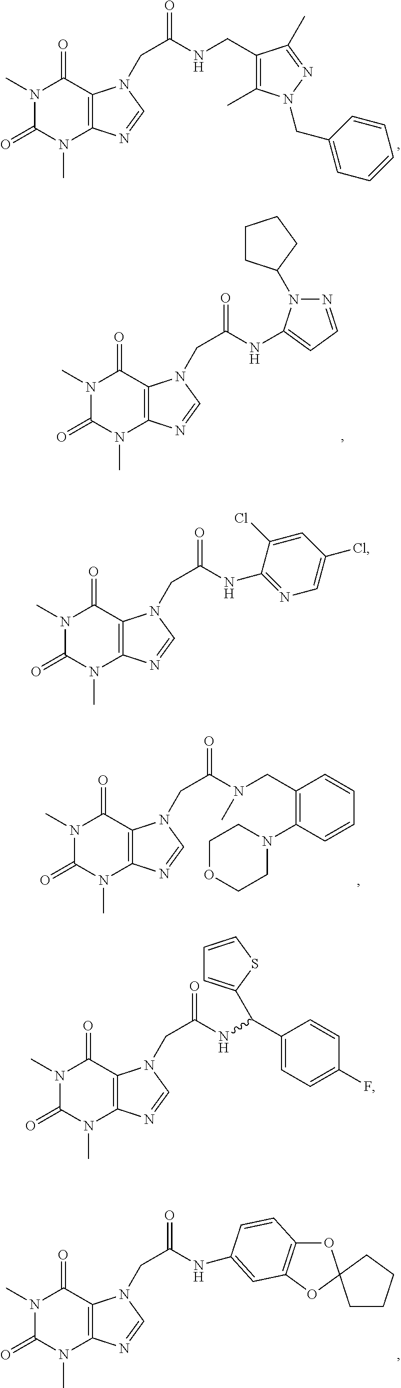

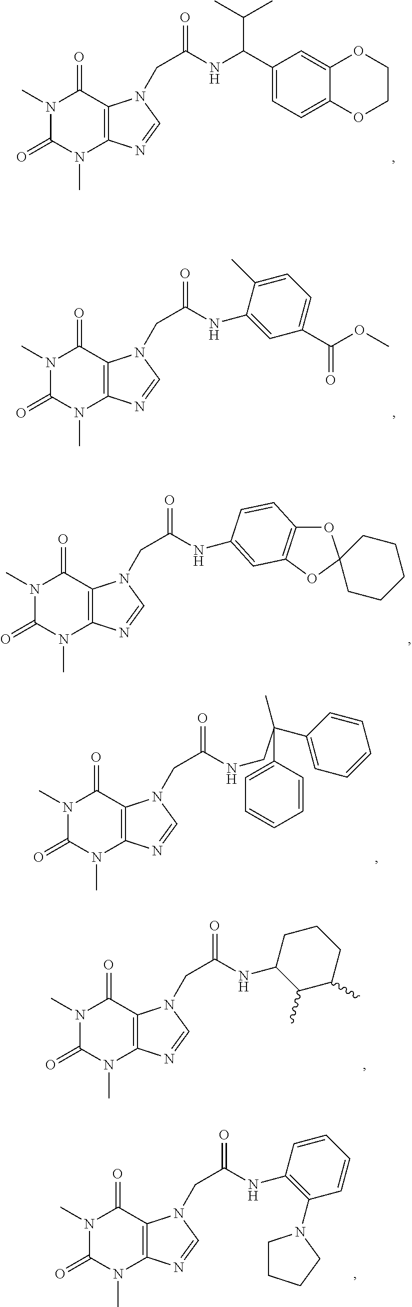

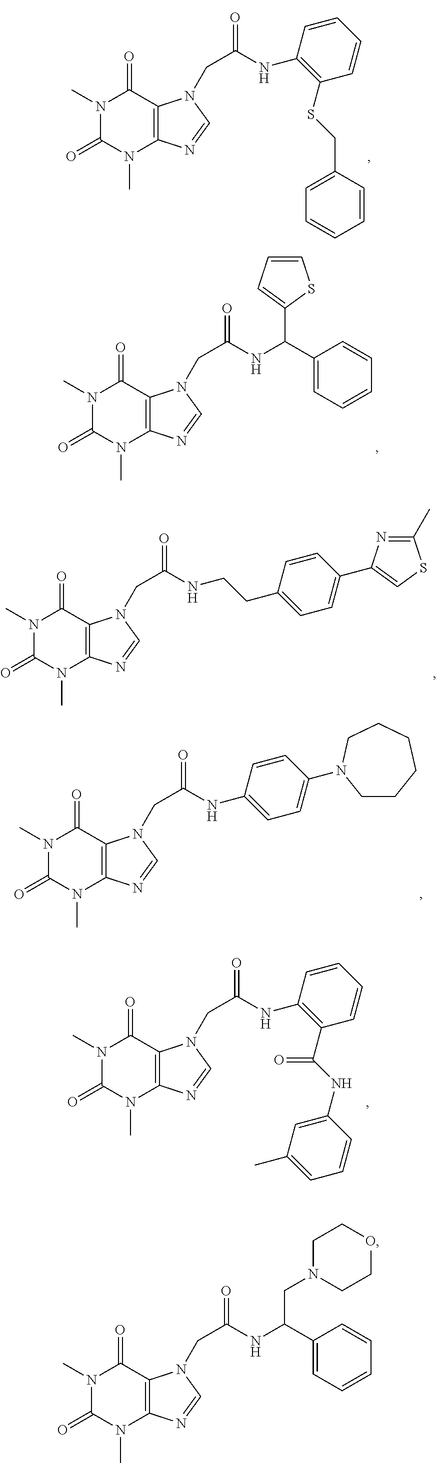

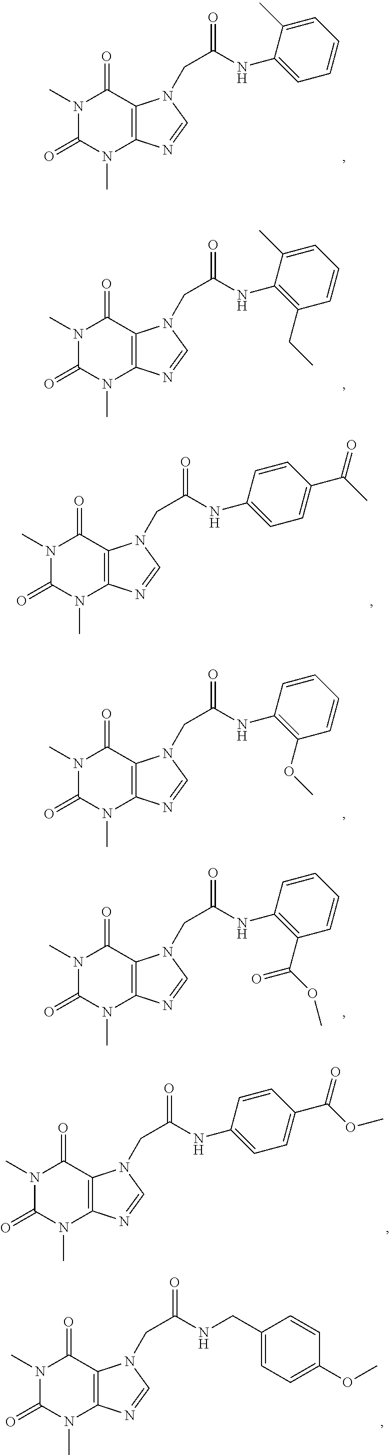

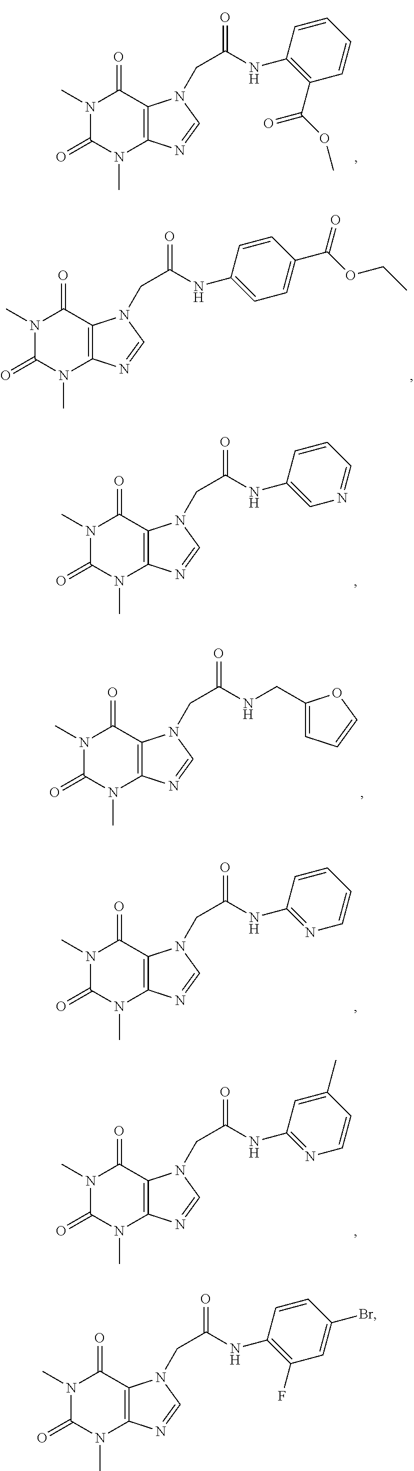

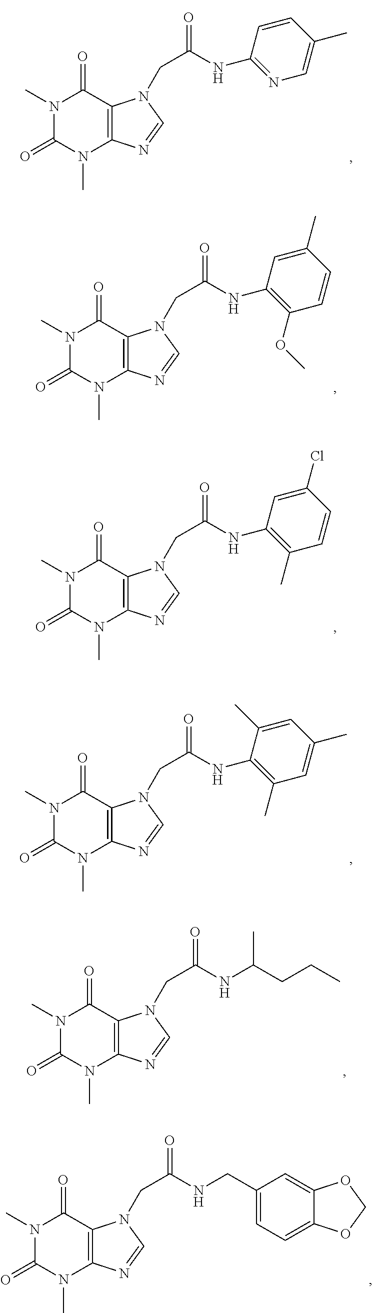

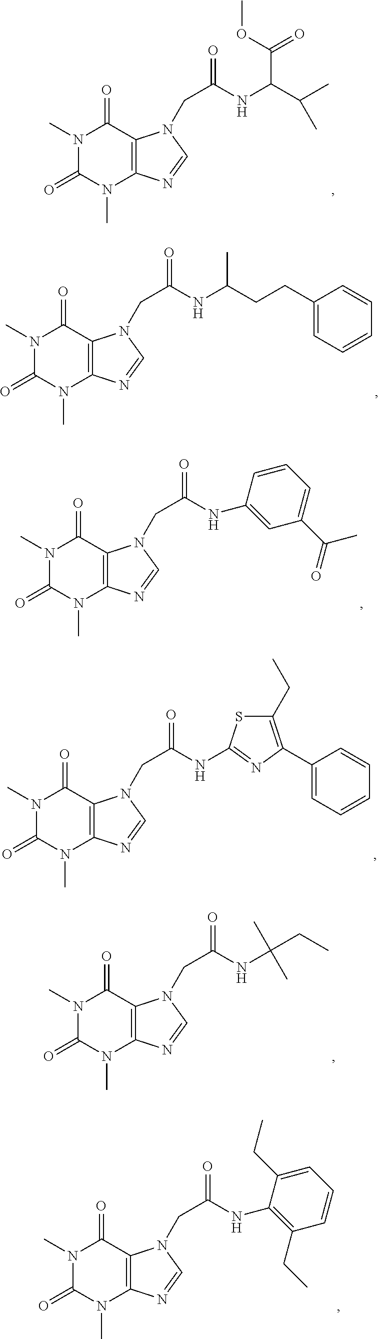

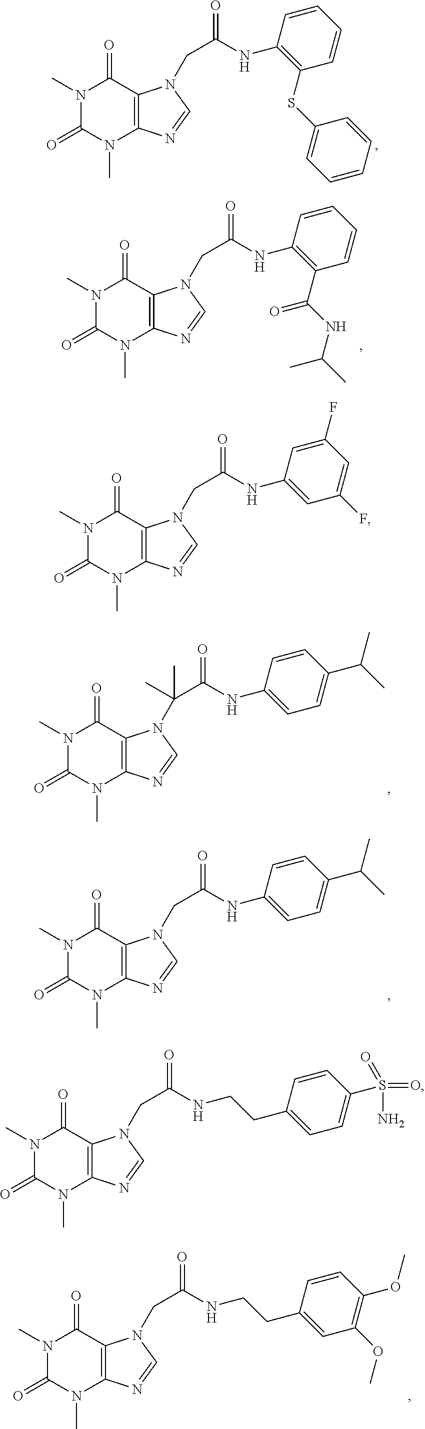

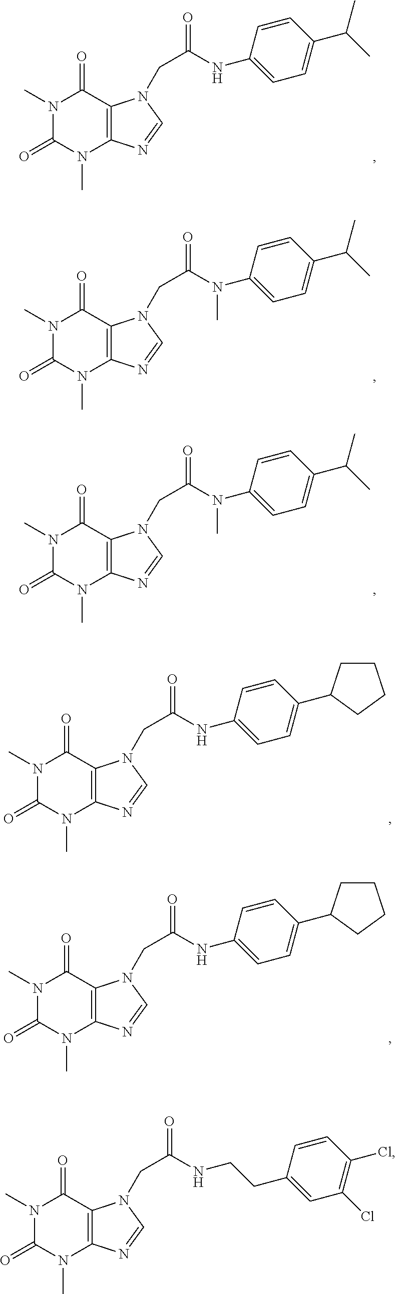

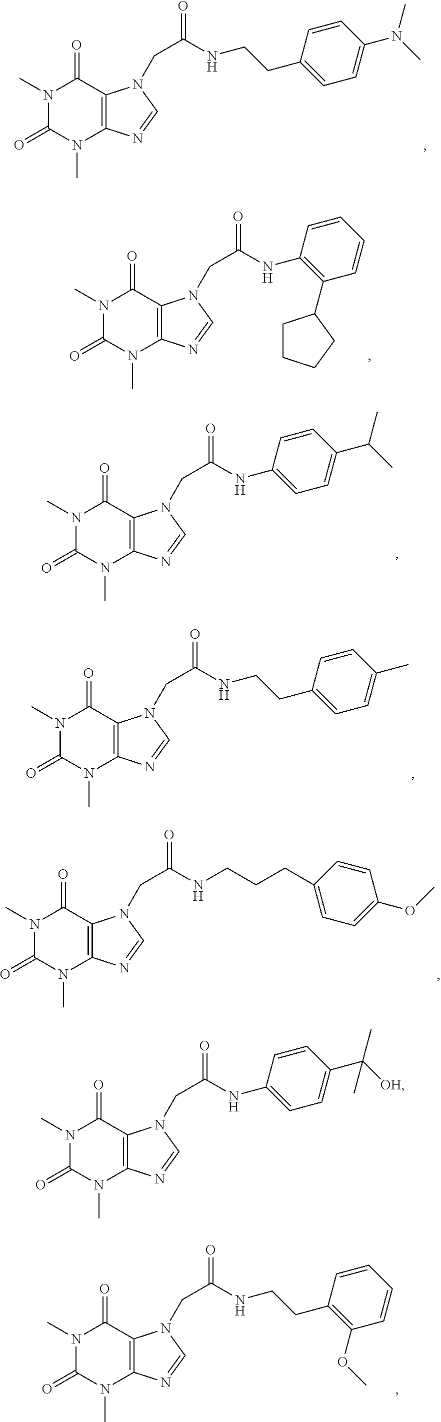

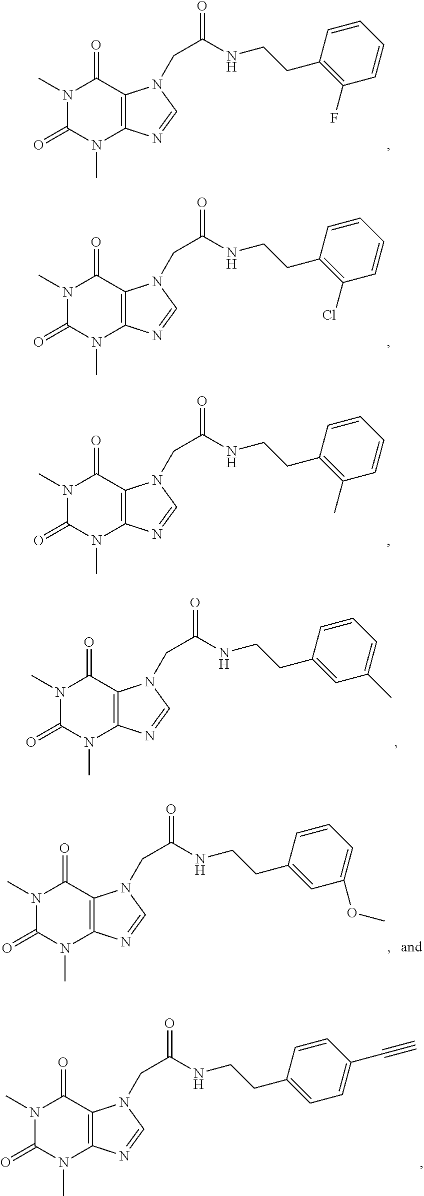

and pharmaceutically acceptable salts thereof.
12. The method of paragraph 10, wherein the TRPA1 is activated by an agent selected from the group consisting of 4-hydroxynonenal, capsaicin, 3′-carbamoylbiphenyl-3-yl-cyclohexyl carbamate, cinnamaldehyde, allicin, gingerol, 2-mercapto benzoic acid, caffeine, iodoacetamide, N-methyl maleimide, trinitrophenol, Carvacrol, Icilin, menthol, acrolein, 15-deoxy-Δ^{12,14}-prostaglandin J₂ (15d-PGJ₂), allyl thiocyanate, and 4-methyl-N-[2,2,2-trichloro-1-(4-nitro-phenyl sulfanyl)-ethyl]-benzamide and pharmaceutically acceptable salts thereof.
13. The methods of paragraphs 10-12, wherein the insects are fleas, rat fleas, oriental rat fleas, flies, black flies, sand flies, mosquitoes, horse flies, deer flies, eye gnats, house flies, blow flies, flesh flies, tsetse flies, lice, human lice, true bugs, assassin bugs, or kissing bugs.
14. The methods of paragraphs 10-13, wherein the insects are disease vectors.
15. The methods of paragraphs 10-13, wherein the insects are agricultural/horticultural pest.
16. The methods of paragraphs 10-13, wherein the insects are parasites.
17. The methods of paragraphs 10-13, wherein the agent is applied as a spray.
18. The methods of paragraphs 10-13, wherein the agent is applied topically.
19. The methods of paragraphs 10-13, wherein the agent is applied directly to adult insects.
20. The methods of paragraphs 10-13, wherein the agent is applied to locus of insects.
21. The methods of paragraphs 12-21, wherein the TRPA1 ion gated channel or family members is activated by heat.
22. The methods of paragraphs 1-21, wherein the agent is applied to breeding locus of insects.
23. The methods of paragraphs 1-21, wherein the agent is applied to feeding locus of insects.
24. The methods of paragraphs 1-21, wherein the agent is formulated with a food source of insects.
25. The methods of paragraphs 1-21, wherein the agent is formulated with sucrose.
26. The method of paragraphs 1-21, wherein the activity of TRPA1 ion gated channel or family member is modulated by a TRPA1 inhibitor and a TRPA1 agonist simultaneously

### EXAMPLES

### Example 1

### Methods

### Fly Strains

The dTrpA1 rescue transgene contains an NheI-XhoI genomic sequence fragment (extending from 2.5 kb upstream of the dTRPA1 start codon to 1.2 kb downstream of the stop codon) inserted into a pPelican vector containing Su(Hw) insulator sequences²⁴. dTrpA1SH-Gal4 contains a Gal4 coding region flanked 5′ by 2.5 kb upstream of the dTRPA1 start codon and 3′ by 1.7 kb of dTrpA1 sequences from exon 1 to the fourth intron and inserted into pPelican. Please note that dTrpA1 SH-Gal4 differs from the previously described dTrpA1-Gal4⁶ as it contains more dTrpA1 sequences as well as flanking Su(Hw) insulator sequences, and the two drivers overlap distinct subsets of dTRPA1-expressing cells. The dTrpA1ins mutant was generated by ends-in homologous recombination-mediated gene targeting²⁵ and contains a tandem array of two mutated copies of dTrpA1: one copy lacks DNA encoding the predicted sixth transmembrane domain and the C-terminus, while the other copy lacks DNA sequences containing the putative promoter region and predicted start codon and carries an insertion creating a translational stop prior to the transmembrane domains. The targeting construct was generated by cloning a BglI-KpnI dTRPA1 genomic DNA fragment from BAC RP98-10P9 (Open Biosystems) into pBluescriptII. An I-SceI site was inserted into the BamHI site in exon 8 of dTRPA1 and a ClaI site in exon 4 was filled in to generate the engineered frameshift mutation), and the construct was cloned into NotI/KpnI digested pTV2 for targeting as described²⁵. The organization of the dTrpA1ins mutant locus is described in FIG. 5. Df(3L)-4415 is a chromosomal deficiency that completely removes the dTrpA1 locus. dTRPA1 RNAi constructs were designed using the strategy of Kalidas and Smith²⁶ and generated as described²⁷. UAS-dTRPA1RNAi flies contain two copies each of UAS-dTRPA1RNAi-A and UAS-dTRPA1RNAI-B. PCR primers used to create UAS-dTRPA1RNAi-A were: genomic fragment 5′-ATAACTGAGTTCGATGCATGCCCACG (SEQ ID NO: 1) and 5′-GCCTCGAGACTAGTCTGGAAAAATGGAAAGCCAAGT (SEQ ID NO: 2); cDNA fragment 5′-GCTCTAGAATAACTGAGTTCGATGCATGCCCACG (SEQ ID NO: 3) and 5′-CACTCGAGACTAGTCTGTTTTCCAACCGCTACGAG (SEQ ID NO: 4). PCR primers used to create UAS-dTRPA1RNAi-B were: genomic fragment 5′-AGGAGCGGGCCAACGAGGTGATG (SEQ ID NO: 5) and 5′-GCCTCGAGACTAGTCTGAAAAATGGAGGTGTTGCTATATG (SEQ ID NO: 6); cDNA fragment 5′-ATTCTAGAAGGAGCGGGCCAACGAGGTGATG (SEQ ID NO: 7) and 5′-GCCTCGAGACTAGTCCCATATTGCAGTATTGACTCATC (SEQ ID NO: 8).

Additional fly strains were obtained from Bloomington Drosphila Stock Center (Bloomington, Ind., USA), except for Cha(7.4)-Gal4 and Cha(1.2)-Gal4 from P. Salvaterra, Appl-Gal4 from T. Tayler, Dll-Gal4 from G. Boekh, UAS-G-CaMP from R. Axel.

### Temperature Preference Behavior

Temperature preference behavior assay was designed according to Sayeed et al.³, but with a larger temperature range. Air temperatures inside the apparatus were determined using a Fluke 5211 thermometer with multiple temperature probes. The apparatus was coated with Rain-X to prevent flies from escaping the temperature gradient. Rain-X does not disturb the normal temperature preference (data not shown). For each assay, ˜20-30 adult flies (0-3 days old) were blown into the apparatus through a hole at the midpoint of the gradient and exposed to the gradient for 30 min in darkness prior to data collection. All experiments were performed in an environmental room maintained at 25° C./70% RH.

Performance as a function of the air temperature within the behavioral chamber was plotted. Both air and apparatus surface temperatures were measured, but it was found that relying on air temperature significantly decreased variation in behavior between experiments, suggesting this parameter was more relevant to the fly (data not shown). As the surface temperature gradient is steeper than the air temperature gradient (data not shown), the thermal gradients extended to both warmer and cooler temperatures than the Sayeed and Benzer gradients (˜31.5° C. in surface temperature is ˜29° C. in air temperature). Observation that adults lacking third antennal segments avoid warm regions of the thermal gradient was initially unexpected, as Sayeed and Benzer reported that removal of the third antennal segment eliminated temperature preference³. However, these authors did note that the distribution of ablated flies fell off significantly at higher temperatures, approaching zero near 31.5° C. The apparent differences in results may reflect, in part, subtle differences in assay environment including the monitoring of only surface temperature in the previous study³. Irrespective of subtle differences in the present data sets, ablation data together with dTrpA1 mutant analysis clearly demonstrate that avoidance of warm temperatures persists in the absence of the third antennal segment. Contrary to conclusion of Sayeed and Benzer that an unilateral ablation had no effect³, a partial decrease in cold avidnace was seen here. Sayend and Benzer's published data show that they had also observed a significant (>3-fold) increase in the fraction of flies in the 18-22.5° C. region (from ˜15% to ˜50%).

### Immunostaining

Immunostaining was performed as described⁶ except 5% normal goat serum and 1% BSA in PBST (1% Triton X-100) were used for blocking and antibody incubations. PBST (1% Triton X-100) were used for washing. Antibodies used were: rat anti-dTRPA1 6, at 1:1000; rabbit anti-RFP (Chemicon), at 1:200; mouse nc82 (Developmental Studies Hybridoma Bank), at 1:40;goat anti-rat Cy3 (Jackson ImmunoResearch), at 1:4000; goat anti-rat Cy5 (Jackson ImmunoResearch), at 1:200; goat anti-rabbit Cy3 (Jackson ImmunoResearch) at 1:200; goat anti-mouse Cy5 (Jackson ImmunoResearch) at 1:200.

### Calcium Imaging: Fly Preparation and Imaging

Brains from live dTrpA1SH-Gal4, UAS-G-CaMP (WT) and dTrpA1SH-Gal4, UAS-G [symbol] iCaMP,dTRPAlins flies were dissected in Modified Standard Solution F (5 mM Na [symbol] HEPES, 115 mM NaCl, 5 mM KCl, 6 mM CaCl₂, 1 mM MgCl₂, 4 mM NaHCO₃, 5 mM trehalose, 10 mM glucose, 65 mM sucrose, pH 7.5)²⁸ by removing the cuticle from the head and trachea using fine forceps. The brain was severed from the body and placed onto Sylgard-coated coverslips, anterior side facing up. The brain was then glued to the slide by applying small amounts of Vetbond™ (3M) between the external edge of the optic lobes and the slide using a pulled glass capillary. The slide was mounted on a laminar flow perfusion chamber (˜500 μl volume) beneath a 40× or 60× water immersion objective of a fixed stage upright microscope (Olympus BX51W1), illuminated using a 75W xenon Apo lamp with a 490 nm excitation filter and visualized through a 528 emission filter (Olympus). During experiments, the preparation was constantly perfused with Modified Standard Solution F via gravity flow at a rate of ˜3 ml/min. The solution temperature was gradually increased from room temperature (˜22° C.) to 33° C. using a CL-100 Bipolar Temperature Controller equipped with a SC-20 Dual In-line Solution Heater/Cooler (Warner Instruments). Optical images of the preparation were acquired during the temperature shift using a digital CCD camera (Hamamatsu C4742-80-12AG) at 4 frames per second with 512×512 pixel resolution. The image data was digitized and analyzed using Volocity software (Improvision). For analysis, areas representing G-CaMP expressing cell bodies were circumscribed and the mean fluorescent intensity was calculated for each region of interest at every frame. Background fluorescence (calculated from the average fluorescence of two randomly chosen non-G-CaMP expressing areas) was subtracted from the mean fluorescent intensity of the regions of interest. Background-subtracted values were then expressed as % ΔF/F, where F is the mean fluorescence intensity in the 10 seconds prior to stimulation. The solution temperature was simultaneously recorded and digitized using PowerLab 4/30 and Chart software (AD Instruments) and synchronized with the image acquisition through an Orbit II Controller (Improvision). Bleaching corrections were done by plotting a least-squares fit line in Excel using the first 10 seconds of imaging and extrapolating this bleaching rate for the duration of the experiment. Pseudo-color images were generated in Adobe Photoshop from pixel grayscale values by setting black level values to 40 and converting to pseudo-color using the Spectrum tool.

### Oocyte Electrophysiology

Oocyte-positive Xenopus laevis females were obtained from Nasco (Ft. Atkinson, Wis.), and maintained at ˜19° C. with 12 h/12 h dark/light cycles. Ovaries were surgically isolated, and treated with 1.5 mg/ml of collagenase type II (Worthington, Lakewood, N.J.) for 90 min, and individual oocytes were defolliculated with a pair of forceps. cRNA was transcribed by mMessage mMachine T3 kit (Ambion, Austin, Tex.) from each cDNA construct, and 50 nl aliquot per oocyte was injected using an automatic Drummond microinjector. (agTRPA1 sequence deposited as Genbank #108 1610.) Membrane potential was maintained at −60 mV by two electrode voltage clamping (TEVC) during warm-activated current recording. Resistance of pulled glass capillary electrodes filled with 3 M KCl was between 0.5 and 1.5 MΩ. Typical resting membrane potentials of oocytes used for current recording were between −25 and -60 mV. Current was recorded at 2 kHz and filtered to 1 kHz with the output filter of the amplifier (OC-725B, Warner instruments, Hamden, Conn.). Temperature of the oocyte perfusion buffer (96 mM NaCl, 1 mM MgCl₂, 4 mM KCl, and 5 mM HEPES, pH 7.6) was changed by SC-20 in-line heater/cooler (Warner Instruments) under the control of CL-100 Bipolar Temperature Controller (Warner Instruments). Where indicated 50 nl of 20 mM BAPTA was injected to oocytes 30 min before recording to minimize elevations in cytosolic Ca⁺⁺ concentration. pClamp 8.0 and Sigmaplot 8.0 were used in order to acquire and analyze the data. Voltage steps (−140 mV to 100 mV) were applied to assess I-V relationship of dTRPA1- or AgTRPA1-expressing oocytes. Each voltage step lasted 100 ms following 10 ms holding at −60 mV, and the recorded current in the last 40 ms was averaged to determine the current amplitude at a given voltage.

### Larval Electrophysiology

All larval dissections and physiological recordings were performed in HL3.1 physiological saline containing (in mM) 70 NaCl, 5 KCl, 0.8 CaCl₂, 4 MgCl₂, 10 NaHCO₃, 5 trehalose, 115 sucrose, 5 HEPES, pH 7.1-7.2, osmolarity was ˜309 mmol/kg.

Female third instar larvae were first filleted and pinned dorsal side up in a Sylgard lined Petri dish (Dow Corning, Midland, Mich., USA). The gut and trachea were removed with fine forceps, exposing the larval body wall muscles. The anterior lobes of the larval brain were removed, but the rest of the ventral ganglion was left undisturbed, preserving the cell bodies of motor neurons innervating body wall muscles.

Larval preparations were mounted on the stage of a BX5 0WI compound microscope (Olympus, Center Valley, Pa., USA) and continuously superfused with HL3.1using a custom built gravity fed perfusion system. Temperature ramps were performed by circulating hot, then cold water past coils of perfusion tubing sealed in a PVC pipe on the way to the prep. Bath temperature was ramped from 23° C. to 29° C. then back to 23° C. in every experiment. Ramp time was typically 3-5 minutes each way. Bath temperatures were monitored with a Physitemp (Clifton, N.J., USA) model BAT-12 thermometer with thermocouple probe or alternatively using an SC-20 in-line heater/cooler (Warner Instruments, Hamden, Conn., USA) under the control of CL-100 Bipolar Temperature Controller (Warner Instruments).

Larval muscle⁶ was targeted for intracellular work. EJP frequency in m6 was monitored in control and experimental animals as bath temperatures rose and fell.

Recordings from m6 were performed with sharp glass electrodes (12-18 Mohms) filled with 3 M KCl. Voltage signals were amplified with either an Axoclamp 2A or Axopatch 200B (Axon Instruments, Foster City, Calif., USA) and digitized with a Powerlab 4/30 data acquisition system (ADinstruments, Colorado Springs, Colo., USA). Voltage traces were recorded in Chart 5.1 (ADinstruments). The data were analyzed using scripts in Spike 2 (version 5, CED, Cambridge, UK) and standard features in Microsoft Excel (Redmond, Wash.).

### Fly Strains and Immunohistochemistry

The dTrpA1 rescue transgene contains an NheI-XhoI genomic fragment (from 2.5 kb upstream to 1.2 kb downstream of the dTRPA1 open reading frame) in pPelican containing Su(Hw) insulators 24. dTrpA1SH-Gal4 contains a Gal4 coding region flanked 5′ by 2.5 kb upstream of dTRPA1 start codon and 3′ by 1.7 kb of dTrpA1 sequences from exon 1 to the fourth intron and inserted into pPelican. dTrpA1SH-Gal4 differs from the previously described dTrpA1-Gal4 6, and the two drivers overlap distinct subsets of dTRPA1-expressing cells. dTrpA1ins was generated by ends-in gene targeting²⁵ and contains a tandem array of two mutated copies of dTrpA1 as shown in FIG. 5. One copy is deleted for the sixth transmembrane domain and C-terminus, while the other copy is deleted for the promoter region and start codon and contains a translational stop prior to the transmembrane domains. Df(3L)ED4415 is a chromosomal deficiency that completely removes the dTrpA1 locus. dTRPA1 RNAi constructs were designed using the strategy of Kalidas and Smith²⁶ and generated as described²⁷. Additional details are provided in Methods section.

### Temperature Preference Behavior

Temperature preference behavior assay was modified from Sayeed et al.³ as detailed in Methods section.

### Physiology

For G-CaMP imaging, brains from live dTrpA1SH-Gal4;UAS-G-CaMP (WT) or dTrpA1SH-Gal4,UAS-G-CaMP,dTRPA1ins flies were dissected in Modified Standard Solution F (5 mM Na-HEPES, 115 mM NaCl, 5 mM KCl, 6 mM CaCl₂, 1 mM MgCl₂, 4 mM NaHCO3, 5 mM trehalose, 10 mM glucose, 65 mM sucrose, pH 7.5)²⁸ by removing the cuticule from the head and trachea using fine forceps. The brain was severed from the body and placed onto Sylgard-coated coverslips, anterior side facing up. Brains were imaged as detailed in Methods section. Oocyte physiology and larval recordings were performed as detailed in Methods section.

### Results

While the physiology of all cells is affected by temperature, the expression of temperature-activated members of the Transient Receptor Potential (TRP) family (thermoTRPs) can make cell excitability highly temperature-responsive⁵. ThermoTRPs are cation channels with highly temperature-dependent conductances that participate in thermosensation from insects to humans⁵. The Drosophila melanogaster TRP channel dTRPA1 promotes larval heat avoidance⁶ and can be activated by warming in ooctyes⁷. We asked whether dTrpA1 contributes to the selection of a preferred temperature in the adult fly. When allowed to distribute along a thermal gradient for 30 minutes, wild-type Drosophila melanogaster adults prefer ˜25° C.3, their optimal growth temperature8. Compared to wild-type controls, dTrpA1 loss-of-function mutant animals exhibited increased accumulation in the warmest (28-32° C.) regions of the gradient (P<0.0001), but not in the coolest (18-22° C.) regions (P=0.5) (FIGS. 1a, 1b and 5). A dTrpA1 genomic minigene rescued the phenotype (FIGS. 1a and 1b). Animals heterozygous for dTrpA1 loss-of-function mutations also preferred slightly elevated temperatures (FIG. 6a). Thus, dTrpA1 function is important for determining thermal preference and specifically contributes to avoidance of warm regions.

If dTRPA1 were involved in thermotransduction, dTRPA1 should regulate the warmth-responsiveness of thermosensors. As the identity of the adult Drosophila thermosensors was unknown, dTRPA1 protein expression was examined using anti-dTRPA1 antisera⁶. dTRPA1 expression was detected in three sets of previously uncharacterized cells in the brain: LC (lateral cell), VC (ventral cell), and AC (anterior cell) neurons (FIG. 2a). dTRPA1 was also detected in the proboscis, but ablation studies detected no contribution of the proboscis to warmth avoidance (FIG. 7). To focus on neurons most likely to contribute to thermal preference, dTRPA1 expression was restored by the rescuing dTrpA1 minigene. The minigene restored dTRPA1 expression specifically within AC neurons, but not LC or VC (FIG. 2b). This suggested dTRPA1 expression in AC neurons, two pairs of neurons at the brain's anterior, sufficed to restore thermal preference, and that AC's might be thermosensors.

Temperature-responsiveness of AC neurons was examined using the calcium indicator G-CaMP⁹ (FIGS. 2a and 2c). When exposed to increasing temperature, AC neurons exhibited robust increases in G-CaMP fluorescence, reflecting warmth-responsive increases in intracellular calcium (FIGS. 2h-k). 10 of 27 AC neurons imaged had fluorescence increases between 4% and 39%, with a mean increase over baseline (ΔF/F) among these cells of 15% (+/−4% SEM, n=10) (FIG. 2m). The mean temperature at which fluorescence increases were initially observed was 24.9° C. (+/−0.6, n=10), compatible with AC activation as temperatures rise above preferred. In contrast, no dTrpA1 mutant AC neurons imaged exhibited fluorescence increases (n=21) (FIGS. 2j-m) (P<0.003 compared with wild type, Fisher's exact test). As a control that mutant AC neurons remained physiologically active, we confirmed that they showed robust ΔF/F responses upon KCl addition (FIG. 8). Importantly, AC responses did not depend on an intact periphery, as all G-CaMP studies were performed using isolated brains from which peripheral tissues had been removed. These observations identify AC neurons as warmth-activated, dTRPA1-dependent thermosensors.

AC neurons project toward several brain regions, including the Antennal Lobe (AL) (FIGS. 2d-g). The AL is implicated in cockroach thermosensation10, but has been studied exclusively for olfaction in Drosophila. To date, 11 of ˜50 AL glomeruli remain unassociated with identified olfactory receptors¹¹. AC neurites elaborated within two such “mystery” glomeruli, VL2a and VL2p (FIG. 2e). Thus the Drosophila AL receives both thermosensory and olfactory neuron innervation. VL2a is also innervated by Fruitless-expressing neurons implicated in pheromone transduction¹¹, suggesting that even individual glomeruli receive multi-modal sensory information. AC processes also branched within the Subesophageal Ganglion (SOG) and Superior Lateral Protocerebrum (SLRP), although these target regions are less defined than in the AL. The SOG and SLRP have been previously implicated in processing olfactory and gustatory input'².

As dTRPA1 expression in AC neurons appeared sufficient to restore normal thermal preference, we examined whether it was also necessary. dTRPA1 was knocked down selectively in AC neurons using tissue-specific anti-dTRPA1 RNAi controlled by dTrpA1SH-Gal4 (FIG. 3a), a promoter expressed in AC but not LC or VC neurons. Consistent with the importance of dTRPA1 expression in AC neurons in thermal preference, AC-knockdown increased the fraction of animals present in the 28-32° C. region compared to controls (P<0.0001) (FIGS. 3b-c). Similar results were obtained when dTRPA1 expression was knocked down using a broad neuronal promoter (Appl-Gal4) (FIGS. 3c and 6b). (All knockdowns were assessed with dTRPA1 immunohistochemistry.) dTRPA1 knockdown with the general cholinergic neuron promoter Cha(7.4)-Gal4 eliminated detectable dTRPA1 expression in AC neurons (and in VC and LC) and decreased warmth avoidance (FIGS. 3c and 6c). In contrast, dTRPA1 RNAi expressed using Cha(1.2)-Gal4 (which is expressed in many brain cholinergic neurons¹³, but not the AC's) did not disrupt warmth avoidance (FIGS. 3c and 6d). Taken together, this data suggests that dTRPA1 expression in AC neurons (but not LC or VC) is both necessary and sufficient for normal thermal preference behavior. Whether LC and VC neurons participate in other warmth-activated responses is unknown.

The identification of an internal sensor controlling temperature preference conflicts with the established view that Drosophila sense moderate warming using thermosensors in the third antennal segment³. Effects of surgically removing either one third antennal segment and arista (unilateral ablation) or both (bilateral ablation) were examined. Both unilateral and bilateral ablation increased the fraction of animals in cool (18-22° C.), but not warm (28-32° C.) regions (FIGS. 3d and 3f). Thus these tissues were dispensable for warmth avoidance, but essential for cool avoidance. When dTrpA1 mutants were subjected to bilateral ablation, such “dTrpA1 ab” animals accumulated in both cool and warm regions (FIG. 3e): the fraction between 18-22° C. did not differ from wild-type ablation animals (P=1.0), and the fraction between 28-32° C. did not differ from non-ablated dTrpA1 mutants (P=0.9) (FIG. 3f). Thus dTRPA1-expressing cells and antennal cells function additively to set preferred temperature, promoting avoidance of elevated and reduced temperatures, respectively.

These data are consistent with warmth activation of dTRPA1 serving as the molecular basis for AC neuron function. As thermal activation of mammalian TRPA1 proteins is controversial, we tested whether dTRPA1 could act as a molecular sensor of warming in the fly. Indeed, mis-expression of dTRPA1 throughout the fly nervous system (using c155-Gal4) caused a dramatic phenotype not observed in controls: heating these flies to 35° C. for 60 seconds caused incapacitation, an effect reversed upon return to 23° C. (FIG. 4a). Similar effects were observed using electrophysiology, with moderate warming (above ˜25° C.) triggering a barrage of excitatory junction potentials (EJP's) at the neuromuscular junction (FIGS. 4b-c and 9). These data strongly support dTRPA1 acting as a molecular sensor of warming. The ability of dTRPA1 mis-expression to confer warmth-activation also suggests dTRPA1 can be used as a genetically encoded tool for cell-specific, inducible neuronal activation. dTRPA1 might be particularly useful in tissues like the fly brain where thermal stimulation is easier to deliver than the chemical or optical stimulation that controls other tools for modulating neuronal activity.

To test whether warmth activation is a property of other insect TRPA1s, the malaria mosquito Anopheles gambiae TRPA1 (agTRPA1) was examined. As previously reported, dTRPA1 is warmth-activated when expressed in Xenopus laevis oocytes (FIGS. 4d and 4f). It was observed that agTRPA1 also exhibited robust warmth activation (FIGS. 4e and 4g). These currents were specific; they were not observed in uninjected oocytes (FIG. 10) and were inhibited by Ruthenium Red (which antagonizes other TRPs) Like mammalian thermoTRPs, both dTRPA1 and agTRPA1 exhibited outward rectification (FIGS. 4f-g). Closely related TRPA1s are present in the flour beetle Tribolium and in disease vectors like Pediculus humanus corporis (body lice), Culex pipiens (common house mosquito), and Anopheles aedes (yellow and dengue fever mosquito) which use warmth-sensing for host location and habitat selection^{14, 15} (FIG. 11). Such insect TRPA1s constitute potential targets for disrupting thermal preference and other thermosensory behaviors in agricultural pests and disease vectors.

Environmental temperature affects the physiology of all animals. Increasing temperatures associated with climate change are linked to pole-ward redistributions of hundreds of species including insects, fish, birds and mammals²³. While previously identified ambient thermoreceptors are peripheral^{4, 16-19} AC neurons are internal. As an ˜1 mg fly is readily penetrated by ambient temperature variations^{20, 21}, such an internal sensor should monitor environmental temperature effectively. dTRPA1 activation appears critical for AC neuron activation, suggesting dTRPA1 threshold and expression changes could modulate thermal preferences. Without wishing to be boud by theory, changes in insect TRPA1 function and expression can facilitate movements into novel environments or development of novel behaviors like host seeking.

Although effects of environmental temperature on behavior are ubiquitous, the mechanisms animals use to seek out optimal temperatures are largely unknown. The AC's become active as temperatures rise above preferred, suggesting they may function as “discomfort” receptors that, together with putative antennal cool receptors (like those found in other insect antennae¹⁸), repel the fly from all but the most optimal temperatures. Interestingly, mice lacking the cool-activated channel TRPM8 prefer abnormally cool temperatures, while mice lacking heat-activated TRPV4 prefer warmer temperatures²², suggesting similar strategies may act in mammals.

### Example 2

### Methods

### Behavioral Assays

Attempts to repeat previously reported behavioral assays for AITC sensitivity in Drosophila (50) were unsuccessful. We were unable to detect AITC-mediated reduction in PER mediated via the legs. In addition, attempts to monitor ingestion of AITC-laden food over a 60 minute period were inconclusive, as exposure of flies to AITC under the reported conditions incapacitated all flies well before the end of the assay, precluding reliable assessment of long-term consumption (data not shown).

Vapor avoidance assay: One to three day-old flies were collected, knocked out by CO2, and kept on a fresh food at least 24 hrs before use. Choice apparatus was as previously described (3). ˜200 mM AITC was prepared daily by diluting 1 part of 99% AITC (Sigma) in 49 parts of DMSO. 1 microliter of diluted AITC was placed on the tip of 16-gauge needle (plugged by bending), inserted in bottom of a capped 14-ml polypropylene tube and allowed to diffuse for 2 min prior to use. 1 microliter of DMSO alone was placed on a needle tip inserted into the other 14-ml tube. During diffusion period, flies were transferred to the apparatus held within the fly elevator. After diffusion period, AITC tube was uncapped and inserted one opening of the choice chamber, other opening contained vehicle only tube. The elevator was immediately lowered and flies were released to choose between tubes for 2 min in the dark. AITC and vehicle only sides were alternated to offset any bias caused by possible asymmetric condition. Avoidance index was calculated by subtracting the fraction of flies in AITC tube from fraction in vehicle alone tube.

FIG. 11a shows, when given a choice between tubes containing AITC vapor and vapor from the vehicle (DMSO) alone, wild-type D. melanogaster adults (w; Canton-S) robustly avoided the AITC tube by ˜4:1. Painless had no detectable role in this response, as painless mutants avoided AITC similar to controls. However, mutant animals lacking the function of the D. melanogaster TRPA1 ortholog, dTrpA1, were strongly defective in AITC avoidance, showing significantly reduced AITC avoidance compared to control (P<0.0001, Tukey HSD test). The dTrpA1 mutant defect could be rescued by expression of a wild-type dTrpA1 cDNA in peripheral tissues under control of Dll-Gal4, confirming the requirement for dTRPA1 function in AITC vapor avoidance.

Consistent with dTRPA1 acting in neurons, tissue-specific knockdown of dTRPA1 expression using the general neuronal promoter ApplGal4 strongly reduced AITC avoidance (FIG. 11b). TRPA1 has previously been shown to mediate warmth avoidance by acting in AC thermosensory neurons located inside the fly head (52). However, knocking down dTRPA1 in peripheral tissues with tissue-specific RNAi using Dll-Gal4, a manipulation that does not affect warmth sensing (52), strongly reduced AITC avoidance (FIG. 11b), consistent with a peripheral requirement for dTRPA1 in AITC vapor avoidance.

Proboscis extension response (PER) assay: As reactive electrophiles are commonly encountered as defensive agents present in food sources, we also examined AITC sensing in the context of fly feeding. Flies aged two to seven days were starved on wet Kim wipes overnight, knocked out on ice, and glued (Elmer's glue) by their wings on a glass slide. Flies recovered in a humidified chamber at least for 2 hrs at room temperature prior to assay. At the beginning of PER assay, the fly was satiated with water. Next, solution containing tastants was presented to the fly as a liquid ball on a pipette tip, touching the forelegs only. When the proboscis was extended and maintained the contact for 2-3 sec with the presented food, it was scored as 1. If the contact is only brief or proboscis stuttered on the tastant, 0.5 was given as the score. When the proboscis never made contact within 5 sec, 0 was given. Each fly was offered five times per experiment, and between offerings water was given to satiation. As AITC was always accepted on first offering, frequency of PER was calculated as a fraction obtained from the second through fourth offerings (sum of four scores divided by 4). For leg only PER assays, the procedures are same as above except that the flies tested were not allowed to contact with the offered food with proboscis, with either 12% sucrose or a mixture of 2 mM AITC/12% sucrose was offered ten times.

The presence of AITC had no detectable effects on the proboscis extension response (PER) elicited by contact of a 12% sucrose solution with the legs (FIG. 12a). Thus, whether AITC might alter gustatory responses if provided directly to the labellum was examined. As shown in FIG. 12b, when offered a droplet of 12% sucrose touched to their labellum, all control flies extended their proboscis (exhibited a proboscis extension response, or PER) upon the first offering and in response to 95% of four subsequent offerings. All flies also exhibited a PER upon the first offering of 12% sucrose containing 2 mM AITC. However, a PER was triggered by only 33% of the four subsequent offerings of AITC-spiked food. dTrpA1 mutants responded similarly to controls when offered sucrose alone, but when offered sucrose containing AITC these mutants showed no reduction in PER in response to multiple offerings. This defect was specific, as it could be rescued by transgenic expression of dTRPA1 under the control of the dTrpA1 genomic minigene. In addition, the inhibition of the PER mediated by caffeine was indistinguishable between dTrpA1 mutants and controls, indicating that dTrpA1 mutants are not simply defective in their ability to modulate the PER. Painless had no detectable role in this response, as painless mutants behaved similarly to control in response to AITC in sucrose. Together, these data indicate that dTRPA1 is required for flies to detect the presence of AITC in food. Consistent with the genetic results, dTRPA1 protein expression was detected in two bilateral pairs of neurons inside the proboscis. The expression was specific, as it was absent in dTrpA1 mutants and was restored by the genomic minigene. These neurons are associated with hairless sensilla (#8 and #9) within the labral sensory organ that contain pores opening into the lumen of the esophagus, a location that would provide dTRPA1-expressing dendrites with access to chemicals within recently ingested food. The behavioral data are consistent with an internal location for AITC sensing; the initial offering of AITC-spiked food triggered a PER in all animals, but subsequent offerings showed reduced PER (data not shown).

### Physiology:

The requirement for dTRPA1 in mediating AITC avoidance suggested dTRPA1 might act as a receptor for AITC. While dTRPA1 was thought not to respond to reactive electrophiles, it was recently found that initial studies of dTRPA1 used a functionally altered mutant channel (52). Two-electrode voltage clamping on Xenopus laevis oocytes: Agonist-evoked dTRPA1 currents were recorded as previously described (52), with the following modifications. Agonists of interest were added to the oocyte perfusion buffer (96 mM NaCl, 1 mM MgCl₂, 4 mM KCl, and 5 mM HEPES, pH 7.6). Voltage was initially held at −60 mV, and each 300-ms voltage ramp (−60 mV to 60 mV) per sec was applied to dTRPA1- or AgTRPA1-expressing oocytes during perfusion of agonist-containing buffer. Typical resting membrane potentials of oocytes used were between −25 and −60 mV.

Larval neuromuscular junction electrophysiology: dTRPA1 was expressed in larval motor neurons using OK371-GAL4, a driver specific for glutamatergic neurons (Aberle et al., 2006) as described (61). In all preparations, the ventral ganglion was dissected away, leaving only motor axons and terminals. Larval muscle 6 (m6) was impaled with a sharp electrode (10-20 MO) containing 3M KCl. Resting membrane potentials were typically between −40 and −50 mV. Saline was perfused over the preparation, then increasing concentrations of cinnemaldehyde applied using a custom built gravity perfusion system. EJP frequency was measured-30 sec after application of each concentration using analysis scripts in Spike 2 (Cambridge Electronic Design, Cambridge, UK).

Consistent with dTRPA1 acting as an electrophile detector, wild-type dTRPA1 channels were robustly activated by AITC exposure when expressed in Xenopus oocytes (FIG. 13a). As vertebrate TRPA1s are activated by a spectrum of reactive electrophiles of widely differing chemical structure, we also tested whether structurally unrelated electrophiles also activated dTRPA1. As in the vertebrates TRPA1, dTRPA1 was robustly activated by diverse electrophiles like cinnamaldehyde and acrolein (FIGS. 13b-c). In all cases the currents were due to the presence of dTRPA1, as they were not observed in uninjected oocytes, were inhibited by ruthenium red (an inhibitor of other TRPs), and exhibited the outward rectification characteristic of dTRPA1 (52). To further generalize these findings chemical responsiveness of another insect TRPA1, the malaria mosquito Anopheles gamibiae agTRPA1 was also examined. Similar to dTRPA1, when expressed in Xenopus oocytes agTRPA1 exhibited robust responses to reactive electrophiles like AITC (FIG. 13d). To confirm that dTRPA1 expression was sufficient to make fly neurons sensitive to electrophiles in vivo, chemical responsiveness of D. melanogaster motor neurons engineered to express dTRPAlectopically was examined. While control motor neurons were unresponsive to treatment with the reactive electrophile cinnamaldehyde, motor neurons expressing dTRPA1 were robustly activated by cinnamaldehyde, leading to barrages of excitatory junction potentials in target muscles (FIG. 13e). Together these data all demonstrate that insect TRPA1s, like vertebrate TRPA1s, act as electrophile sensors.

### Site-Directed Mutagenesis

Prior studies had identified a combination of five cysteine residues and one lysine residue within the mammalian TRPA1 that promote reactive electrophile activation of the channel by forming covalent bonds with chemical agonists (34, 35). Consistent with conservation of this mechanism of activation, four of the five cysteines and the lysine are conserved in insect TRPA1s (FIG. 15). To test whether these conserved residues contribute to insect TRPA1 function, properties of dTRPA1 channels in which these residues were altered were examined.

Substitutions of cysteine/lysine residues in dTrpA1 were made by swapping a region of wild type cDNA sequence including codons of cysteine or lysine with mutated cassettes. A pair of mutually complemetary oligonucleotide primers with a desired mutation were prepared, and each of them was paired with upstream or downstream primers for the first two PCR reactions. The resulting two PCR fragments overlap in the mutant primer-annealing region that contains the replaced codons, and served as template for the second PCR reaction amplified only with the upstream and down stream primers. The upstream and down stream primers were designed to be just outside of specific restriction endonuclease target sites that were used to clone the second PCR products back in the wild type dTrpA1 cDNA background sequence. The fragments amplified by PCR were confirmed by sequencing after cloning to make sure that only desired mutations were introduced in the final cDNA constructs.

In dTRPA1, simultaneous mutation of the lysine (K744R) and the three adjacent cysteines (C650S, C670S, and C694S) eliminated dTRPA1 channel activation in response to all stimuli examined including chemicals, heat and voltage (data not shown). However, mutating two cysteines (C650 and C760) to serine decreased, but did not abolish electrophile sensitivity of the channel. This dTRPA1-2C channel exhibited significantly decreased AITC sensitivity compared to wild type dTRPA1, as the relative responsiveness of dTRPA1-2C to low doses of AITC was significantly reduced compared to wild type dTRPA1 (FIG. 14b). The decreased responsiveness of dTRPA1-2C to AITC indicates that these residues are not only conserved in sequence between fly and mammalian TRPA1, but also in functional relevance. These data support a conserved basis of reactive electrophile detection by TRPA1 channels from insects and mammals.

### Sequence Comparison

To assess how broad the conservation this mechanism of electrophile detection may be, TRPA1 sequences from diverse vertebrates and invertebrates were assembled and compared (FIG. 15). At least five of the six residues implicated in electrophile detection are conserved in TRPA1 orthologs from a wide range of vertebrates, including fish, birds, marsupials, monotremes and mammals, and from invertebrates like arthropods and molluscs. Consistent with a conserved role in electrophile detection, all seven TRPA1 channels from this group tested to date show robust responses to electrophiles, including three mammalian (rat, mouse and human (34, 45, 46)), two zebrafish (53), and two insect TRPA1s (present study). However, only one of the five cysteine residues is conserved in the TRPA1 ortholog from the nematode C. elegans and in the Drosophila TRPA Painless, and neither of these channels respond to electrophiles (49, 51). The strong conservation of the putative electrophile sensing residues in electrophile-activated TRPA1 proteins from diverse organisms supports a common molecular mechanism, and likely a common volutionary origin, for electrophile detection in both vertebrates and invertebrates.

Together these findings indicate that the fundamental mechanism of reactive electrophile detection is conserved in molecular detail between organisms whose last common ancestor existed >500 million years ago. The most parsimonious interpretation of our data is that a TRPA1-based mechanism of reactive electrophile sensing was present in this last common ancestor and has been maintained in similar form over the last half a billion years. At the behavioral level, while the responses to TRPA1 activation in flies and humans are clearly distinct, TRPA1 has been put to analogous uses in these different organisms. In the fly, TRPA1-expressing neurons limit intake after encountering food spiked with AITC and promote behavioral avoidance of AITC vapor. In humans, the presence of agents like AITC and cinnamaldehyde can limit the intake of pungent foods and exposure to vapor containing TRPA1 agonists, such as mace and tear gas, promotes protective behaviors like coughing, crying and fleeing. Thus, reactive electrophile detection is a critical and conserved element of animal defense against damaging chemicals.

The conservation of this type of chemical nociception, reactive electrophile detection, is articularly striking given the limited conservation observed for the many other known families of gustatory and olfactory chemoreceptors. These other chemoreceptors are drawn from diverse gene families, and act variously as G-protein coupled receptors or ion channels (29, 30, 54). What might explain the greater evolutionary conservation of reactive electrophile sensing at the molecular level? One interesting possibility is that it is linked to the fact that reactive electrophiles target critical macromolecules used by all animals, including DNA, RNA and protein, and that they can have both cytotoxic and mutagenic effects. Acrolein, for example, forms chemical adducts with DNA and proteins (55-57) and has been reported toxic and mutagenic to animals ranging from D. melganogaster (38) to mammals (55, 58-60). Without wishing to be bound, the exceptional conservation of TRPA1-dependent chemical nociception over the course of animal evolution is that reactive electrophiles pose a threat to all animals and have done so since their evolutionary origin.

### REFERENCES

1. Fraenkel, G. & Gunn, D. The Orientation of Animals. Kineses, Taxes and Compass Relations. (Clarendon Press, Oxford, 1940).
2. Fanger, P. O., Ostberg, O., Nicholl, A., Breum, N. O. & Jerking, E. Thermal comfort conditions during day and night. European Journal of Applied Physiology 33, 255-263 (1974).
3. Sayeed, 0. & Benzer, S. Behavioral genetics of thermosensation and hygrosensation in Drosophila. Proc Natl Acad Sci USA 93, 6079-6084 (1996).
4. Mori, I. Genetics of chemotaxis and thermotaxis in the nematode Caenorhabditis elegans. Annu Rev Genet. 33, 399-422 (1999).
5. Dhaka, A., Viswanath, V. & Patapoutian, A. TRP Ion Channels and Temperature Sensation. Annu Rev Neurosci 29, 135-161 (2006).
6. Rosenzweig, M., et al. The Drosophila ortholog of vertebrate TRPA1 regulates thermotaxis. Genes Dev 19, 419-424 (2005).
7. Viswanath, V., et al. Opposite thermosensor in fruitfly and mouse. Nature 423, 822-823 (2003).
8. Siddiqui, W. H. & Barlow, C.A. Population growth of Drosophila melanogaster (Dipetera:Drosophilidae) at constant and alternating temperatures. Ann. Entomol. Soc. Amer. 65, 993-1001 (1972).
9. Nakai, J., Ohkura, M. & Imoto, K. A high signal-to-noise Ca(2+) probe composed of a single green fluorescent protein. Nat Biotechnol 19, 137-141 (2001).
10. Fischer, H. & Tichy, H. Cold-receptor cells supply both cold- and warm-responsive projection neurons in the antennal lobe of the cockroach. J Comp Physiol A Neuroethol Sens Neural Behav Physiol 188, 643-648 (2002).
11. Vosshall, L. B. & Stocker, R. F. Molecular architecture of smell and taste in Drosophila. Annu Rev Neurosci 30, 505-533 (2007).
12. Ito, K., et al. The organization of extrinsic neurons and their implications in the functional roles of the mushroom bodies in Drosophila melanogaster Meigen. Learn Mem 5, 52-77. (1998).
13. Kitamoto, T., Ikeda, K. & Salvaterra, P.M. Regulation of choline acetyltransferase/lacZ fusion gene expression in putative cholinergic neurons of Drosophila melanogaster. J Neurobiol 28, 70-81 (1995).
14. Brown, A. W. A. Factors in the attractives of bodies for mosquitoes. Nature 167, 202 (1951).
15. Friend, W. G. & Smith, J. J. B. Factors affecting feeding by bloodsucking insects. Ann. Rev. Entomol 22, 309-331 (1977).
16. Patapoutian, A., Peier, A. M., Story, G. M. & Viswanath, V. ThermoTRP channels and beyond: mechanisms of temperature sensation. Nat Rev Neurosci 4, 529-539 (2003).
17. Tominaga, M. & Caterina, M. J. Thermosensation and pain. J Neurobiol 61, 3-12 (2004).
18. Tichy, H. & Gingl, E. Problems in hygro- and thermoreception. in The ecology of sensing (ed. F. G. Barth & A. Schimd) 271-287 (Springer, N.Y., 2001).
19. Liu, L., Yermolaieva, 0., Johnson, W. A., Abboud, F. M. & Welsh, M. J. Identification and function of thermosensory neurons in Drosophila larvae. Nat Neurosci 6, 267-273 (2003).
20. Stevenson, R. D. Body size and limits to the daily range of body temperature in terrestrial ectotherms. American Naturalist 125, 102-117 (1985).
21. Heinrich, B. The Hot-Blooded Insects: Strategies and Mechanisms of Thermoregulation (Harvard University Press, 1993).
22. Caterina, M. J. Transient receptor potential ion channels as participants in thermosensation and thermoregulation. American journal of physiology 292, R64-76 (2007).
23. Parmesan, C. & Yohe, G. A globally coherent fingerprint of climate change impacts across natural systems. Nature 421, 37-42 (2003).
24. Barolo, S., Castro, B. & Posakony, J. W. New Drosophila transgenic reporters: insulated P-element vectors expressing fast-maturing RFP. BioTechniques 36, 436-440, 442 (2004).
25. Rong, Y. S. & Golic, K. G. Gene targeting by homologous recombination in Drosophila. Science 288, 2013-2018. (2000).
26. Kalidas, S. & Smith, D. P. Novel genomic cDNA hybrids produce effective RNA interference in adult Drosophila. Neuron 33, 177-184 (2002).
27. Tayler, T. D., Robichaux, M. B. & Garrity, P. A. Compartmentalization of visual centers in the Drosophila brain requires Slit and Robo proteins. Development 131, 5935-5945 (2004).
28. Ng, M., et al. Transmission of olfactory information between three populations of neurons in the antennal lobe of the fly. Neuron 36, 463-474 (2002).
29. C. I. Bargmann, Nature 444, 295 (2006).
30. A. Chesler, S. Firestein, Nature 452, 944 (2008).
31. G. N. Wogan, S. S. Hecht, J. S. Felton, A. H. Conney, L. A. Loeb, Semin Cancer Biol 14, 473 (2004).
32. D. Leibler, Chem Res Toxicol 21, 1170128 (2008).
33. B. N. Ames, Science 221, 1256 (1983).
34. A. Hinman, H. H. Chuang, D. M. Bautista, D. Julius, Proc Natl Acad Sci USA 103, 19564 (2006).
35. L. J. Macpherson et al., Nature 445, 541 (2007).
36. B. F. Bessac, S. E. Jordt, Physiology (Bethesda) 23, 360 (2008).
37. C. Auerbach, J. M. Robson, Nature 154, 81 (1944).
38. L. M. Sierra, A. R. Banos, M. Garcia, J. A. Ferreiro, M. A. Comendador, Mutat Res 260, 247 (1991).
39. L. Rask et al., Plant Molecular Biology 42, 93 (2000).
40.1. K. Park et al., Pest Manag Sci 62, 723 (2006).
41. A. A. Pourmirza, Pak J Biol Sci 10, 2213 (2007).
42. E. J. Lee, J. R. Kim, D. R. Choi, Y. J. Ahn, J Econ Entomol 101, 1960 (2008).
43. T. Eisner, in Chemical Ecology E. Sondheimer, J. B. Simeone, Eds. (New York, 1970), vol. Academic Press.
44. E. Kazana et al., Proc Biol Sci 274, 2271 (2007).
45. M. Bandell et al., Neuron 41, 849 (2004).
46. S. E. Jordt et al., Nature 427, 260 (2004).
47. D. M. Bautista et al., Cell 124, 1269 (2006).
48. K. Y. Kwan et al., Neuron 50, 277 (2006).
49. K. S. Kindt et al., Nat Neurosci 10, 568 (2007).
50. B. Al-Anzi, W. D. Tracey, Jr., S. Benzer, Curr Biol 16, 1034 (2006).
51. T. Sokabe, S. Tsujiuchi, T. Kadowaki, M. Tominaga, J Neurosci 28, 9929 (2008).
52. F. N. Hamada et al., Nature 454, 217 (2008).
53. D. A. Prober et al., J Neurosci 28, 10102 (2008).
54. R. Benton, K. S. Vannice, C. Gomez-Diaz, L. B. Vosshall, Cell 136, 149 (2009).
55. R. M. LoPachin, D. S. Barber, T. Gavin, Toxicol Sci 104, 235 (2008).
56. D. Arikketh, S, Niranjali, H. Devaraj, Arch Toxicol 78, 397 (2004).
57. T. Nakamura, Y. Kawai, N. Kitamoto, T. Osawa, Y. Kato, Chem Res Toxicol (2009).
58. F. Kassie, S. Knasmuller, Chem Biol Interact 127, 163 (2000).
59. H. T. Wang, S. Zhang, Y. Hu, M. S. Tang, Chem Res Toxicol (2009).
60. Z. Feng, W. Hu, Y. Hu, M. S. Tang, Proc Natl Acad Sci USA 103, 15404 (2006).
61. S. R. Pulver, S. L. Pashkovski, N. J. Hornstein, P. A. Garrity, L. C. Griffith, J. Neurophysiology In press (2009).

All references described herein are incorporated herein by reference.

What is claimed:

1. A method of inhibiting chemosensing or thermosensing in an insect, the method comprising inhibiting TRPA1 ion gated channel or family members.

2. The method of claim 1, wherein the TRPA1 is inhibited by an agent selected from the group consisting of ruthenium red, (Z)-4-(4-chlorophynyl)-3-methylbut-3-en-2-oxime, 2-(1,3-dimethyl-2,6-dioxo-1,2,3,6-tetrahydro-7H-purin-7-yl)-N-(4-isopropylphenyl)acetamid, cannabinoid agonists R-(+)-(2,3-dihydro-5-methyl-3-[(4-morpholinyl)methyl]pyrol[1,2,3-de]-1,4-benzoxazin-6-yl)-(1-naphthalenyl)methanone mesylate and (R,S)-3-(2-iodo-5-nitrobenzoyl)-1-(1-methyl-2-piperidinylmethyl)-1H-indole, 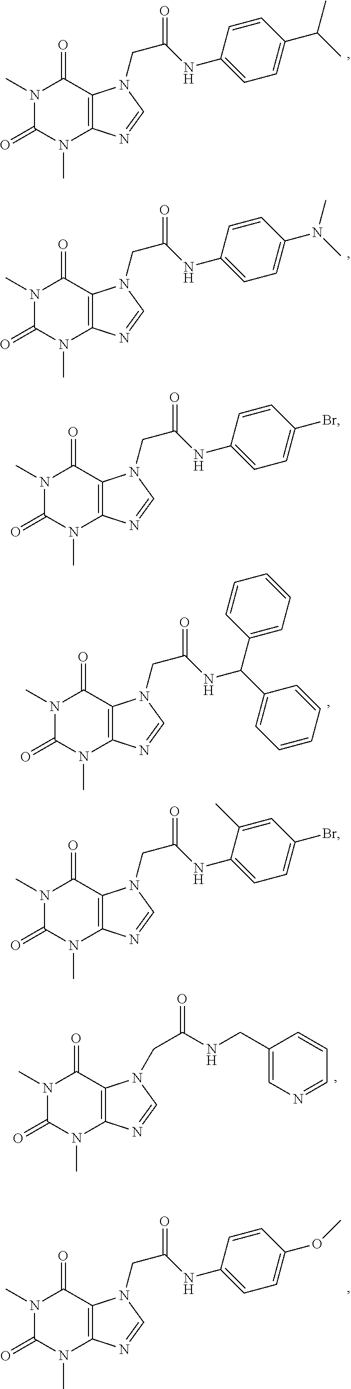 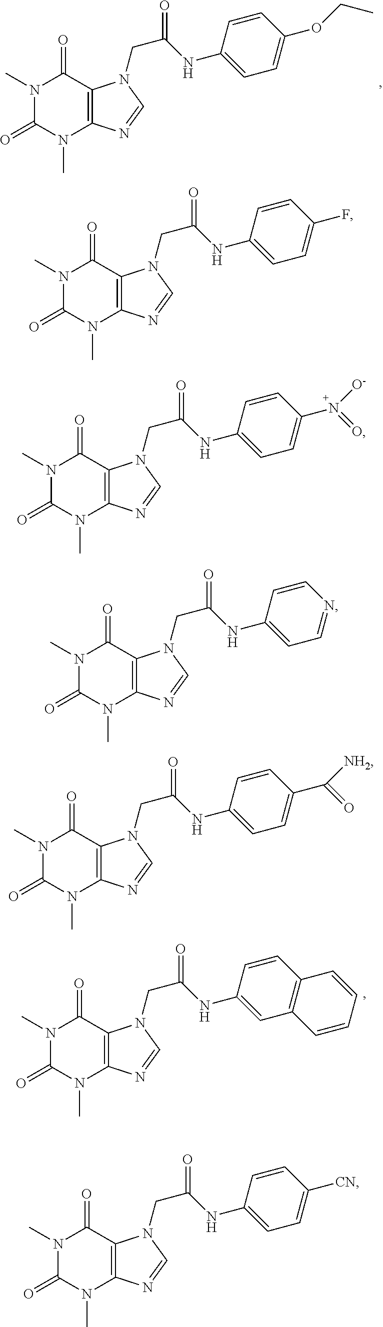 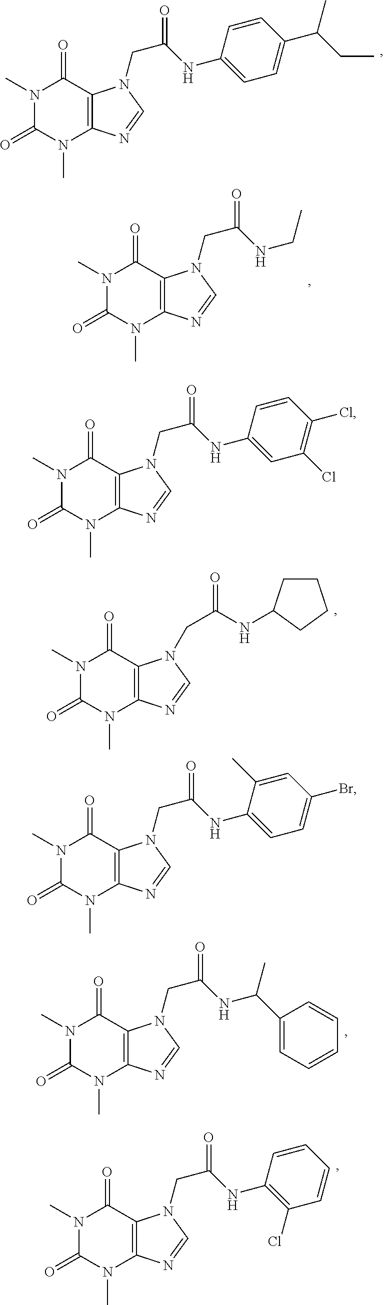 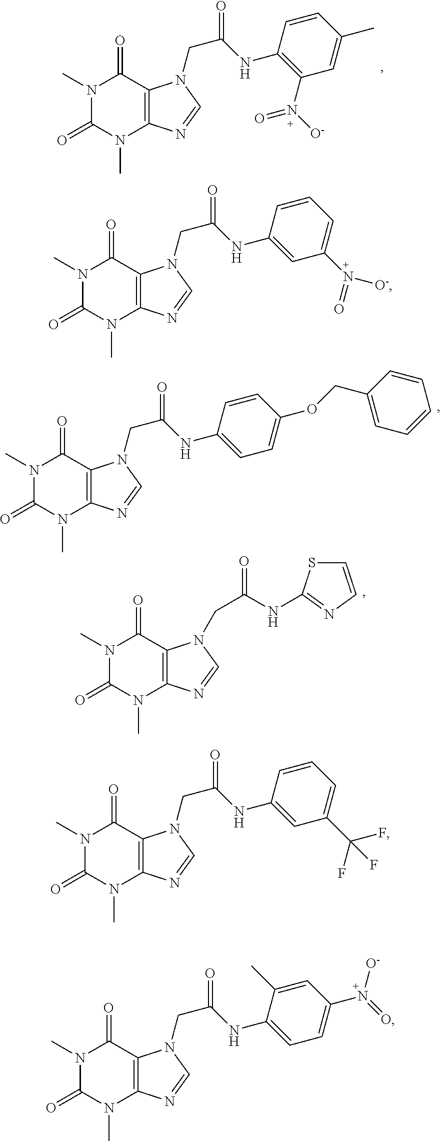 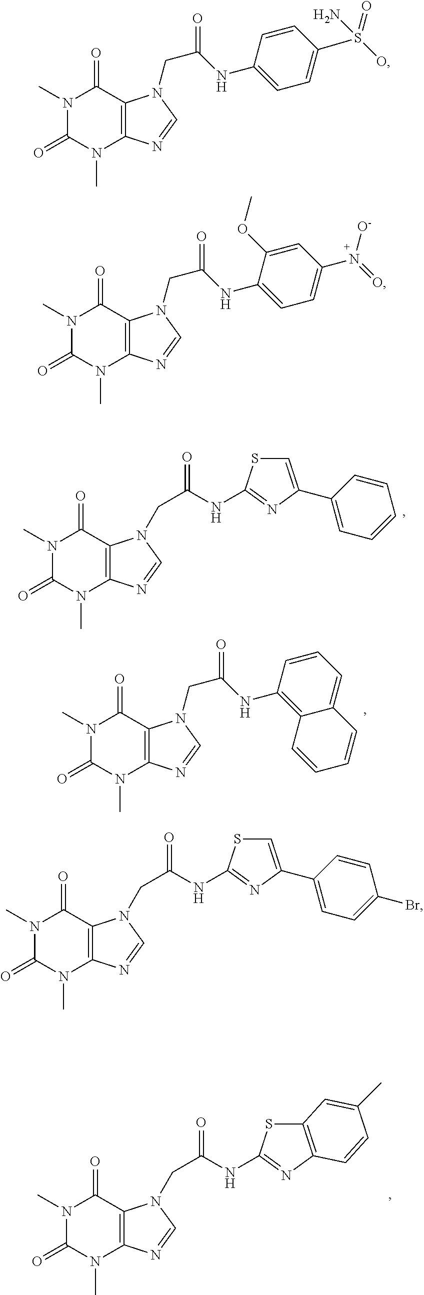 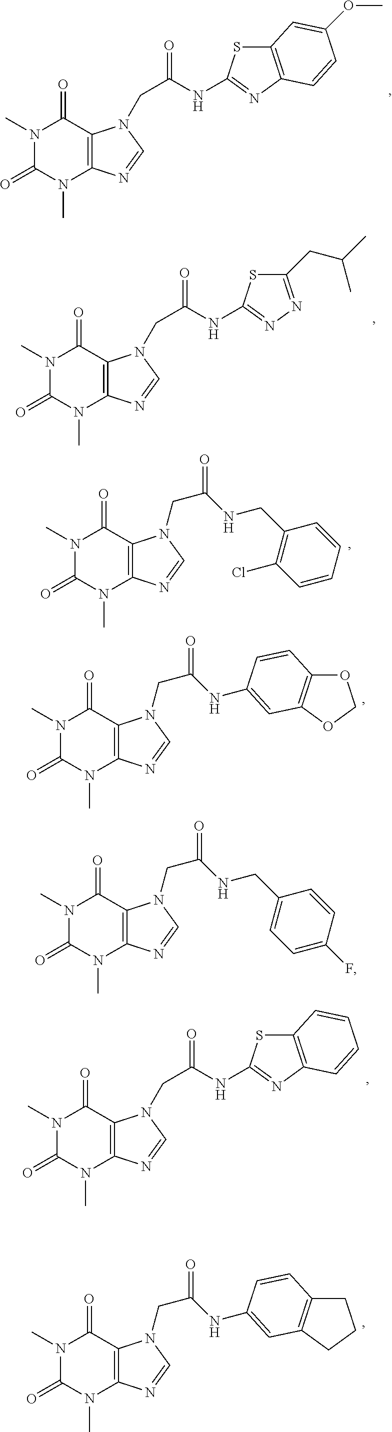 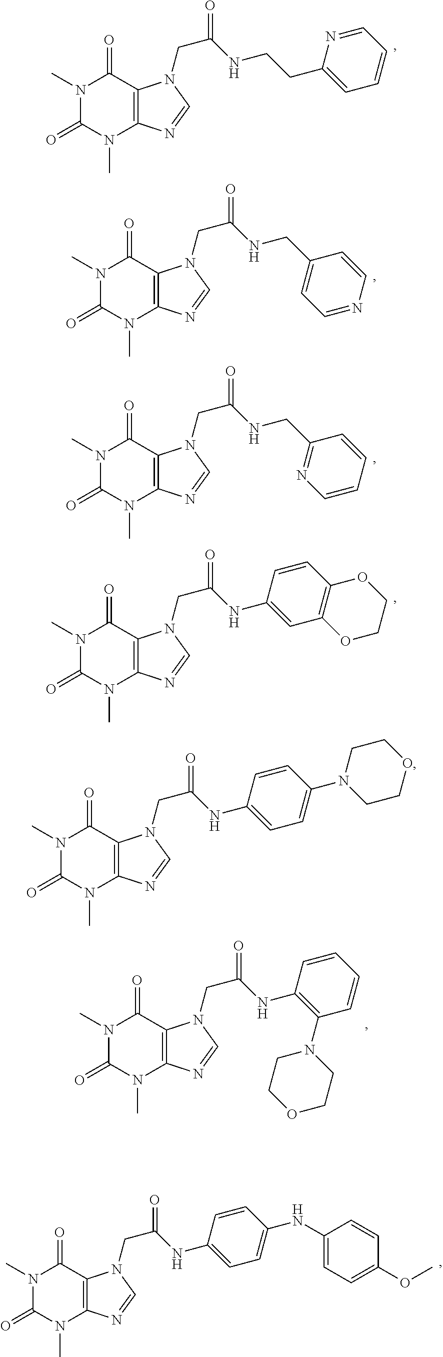 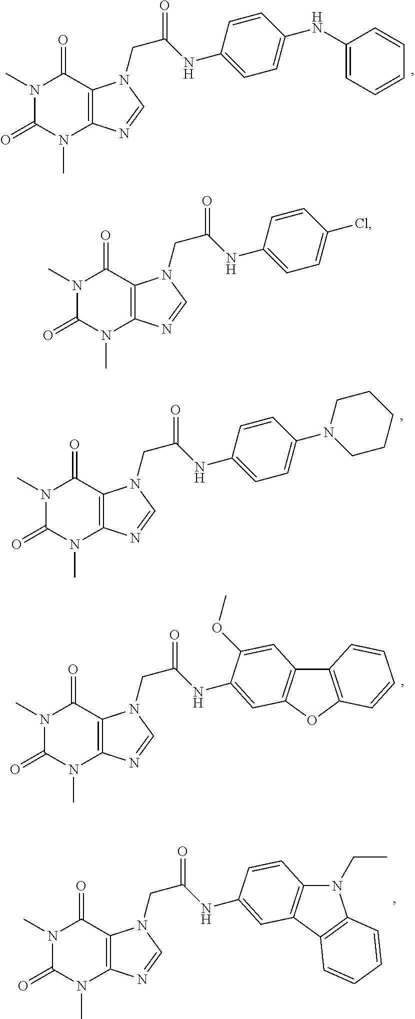 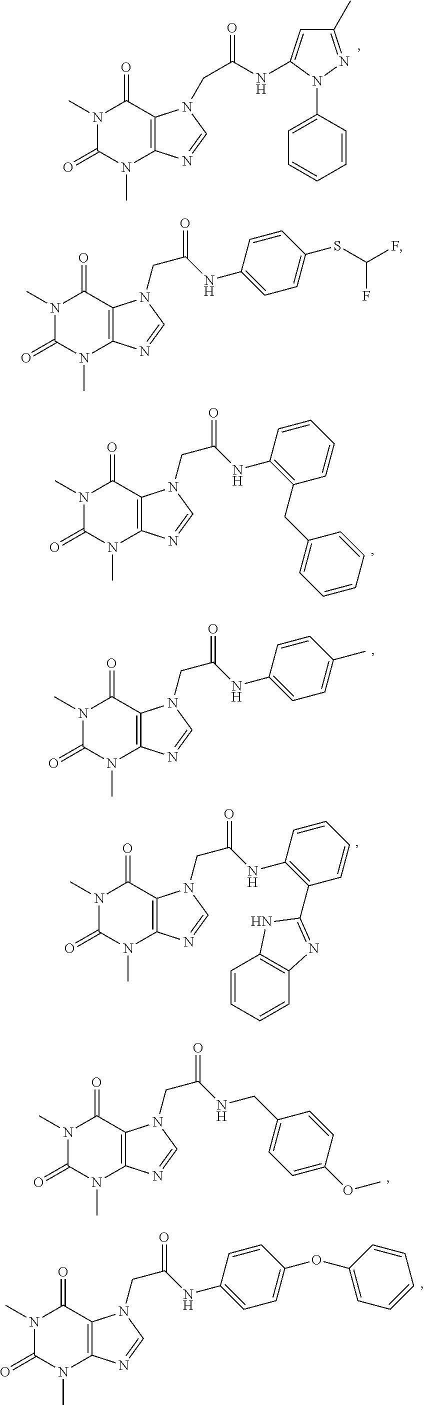 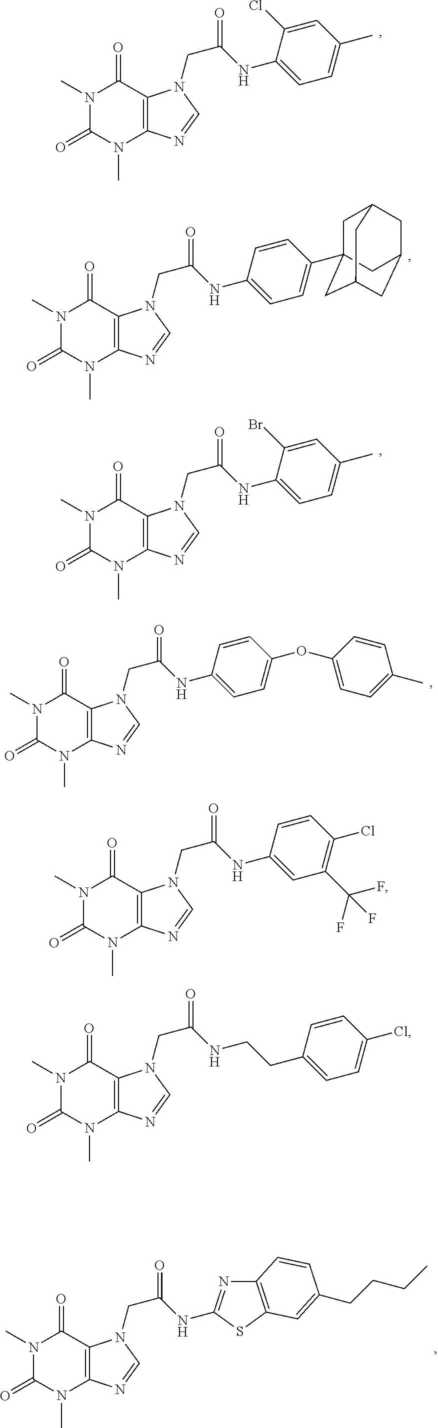 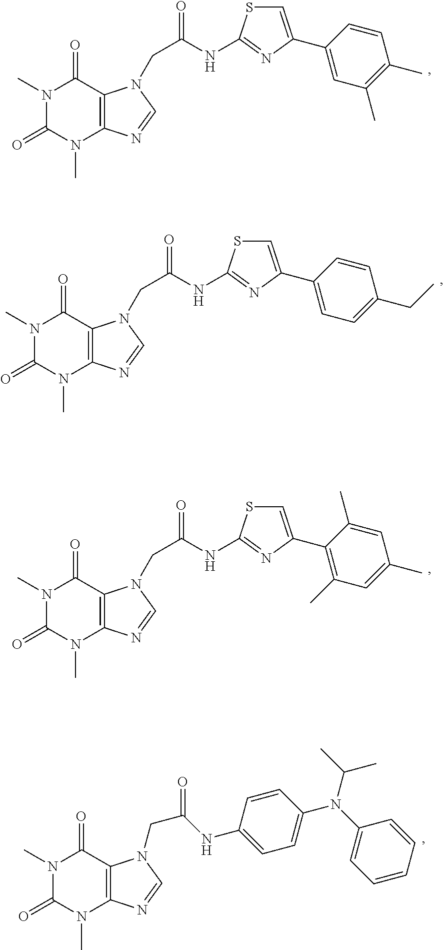 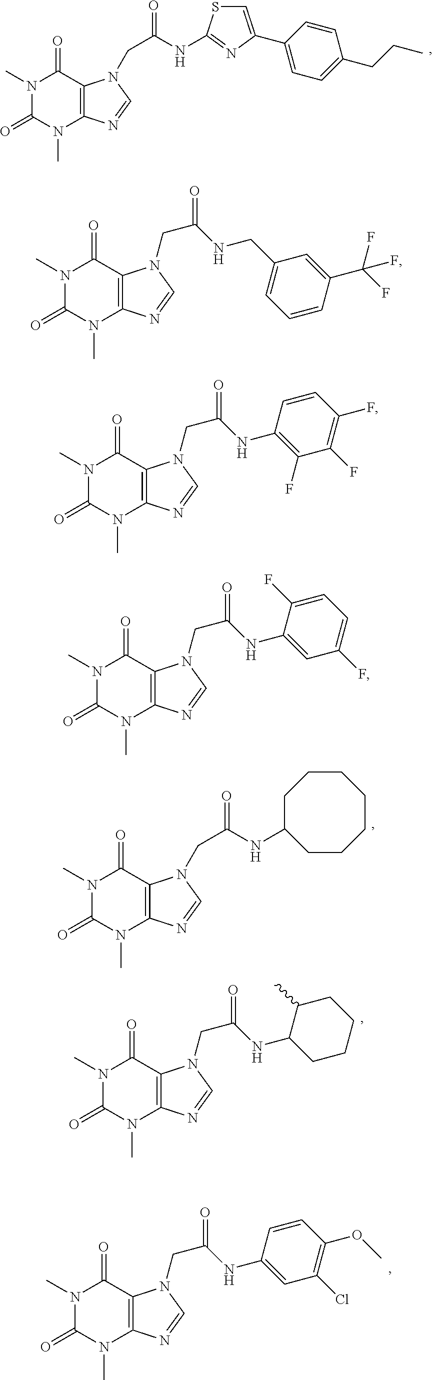 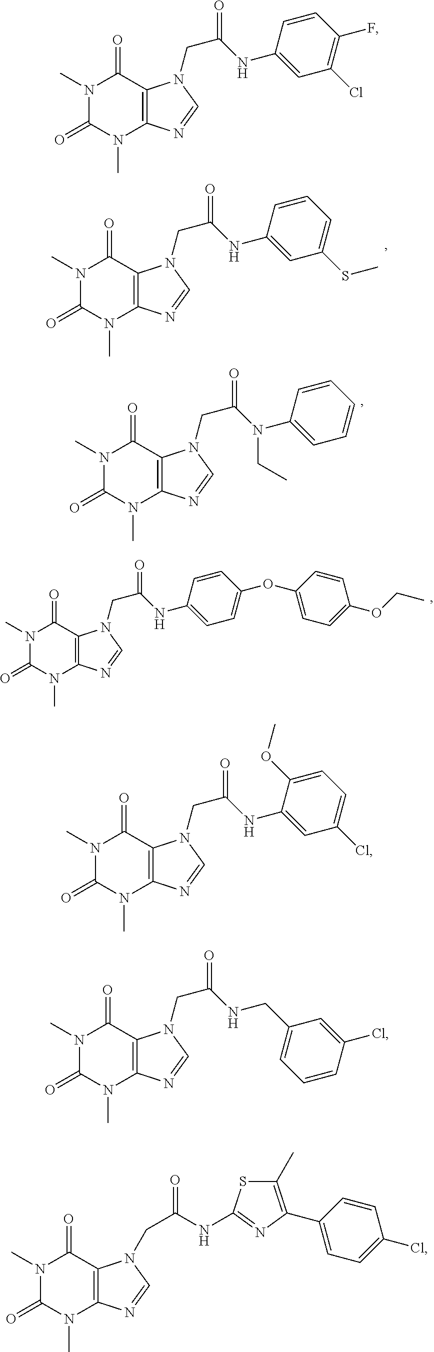 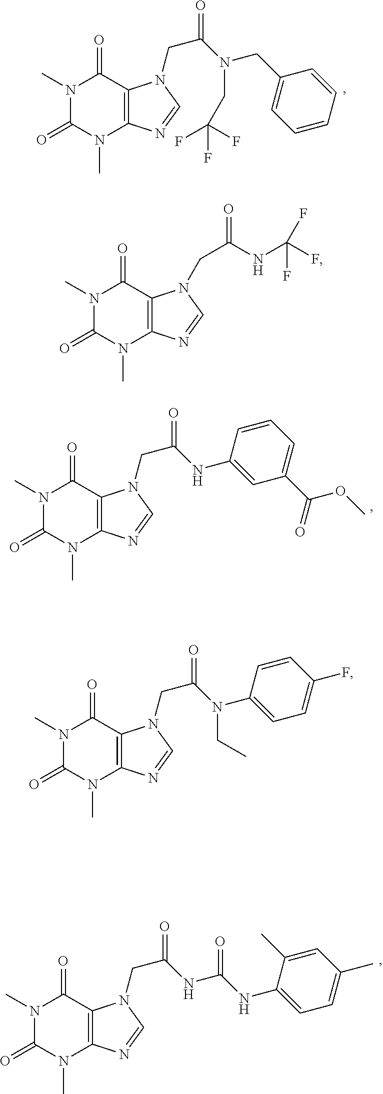 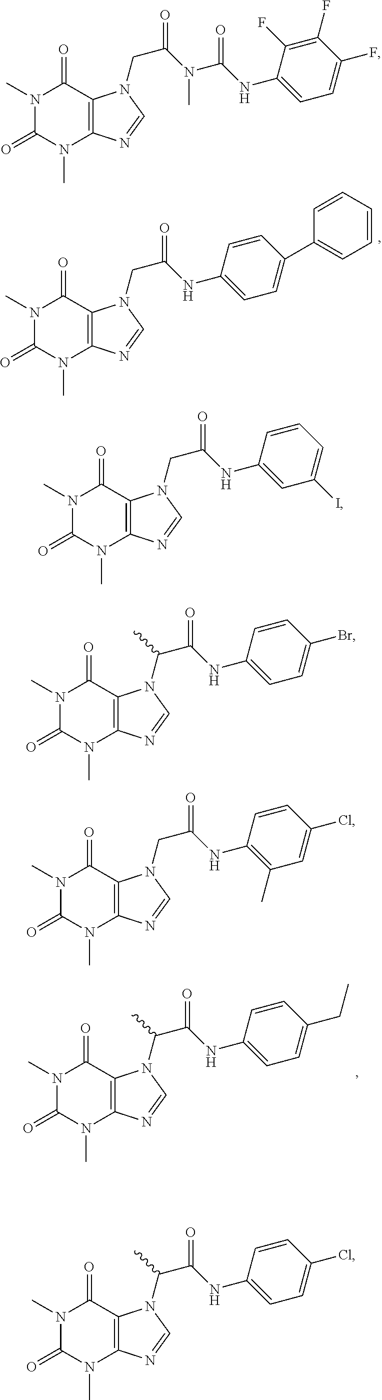 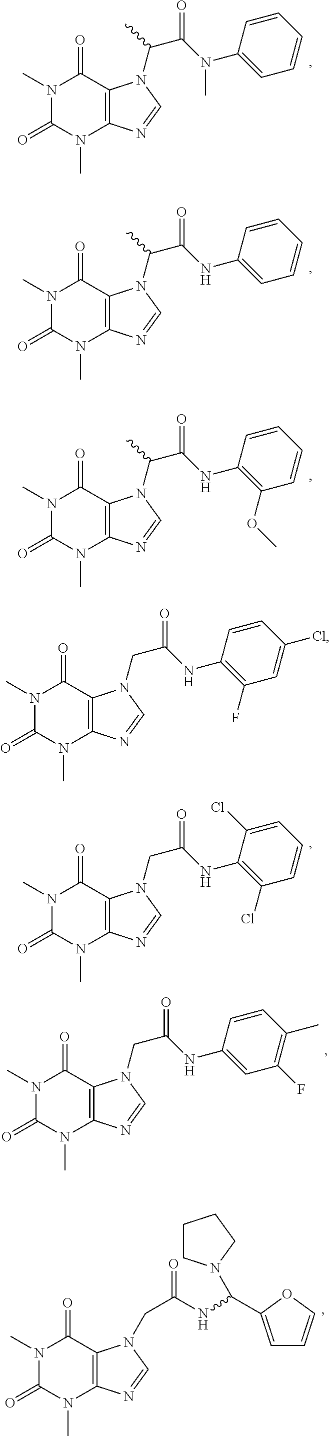 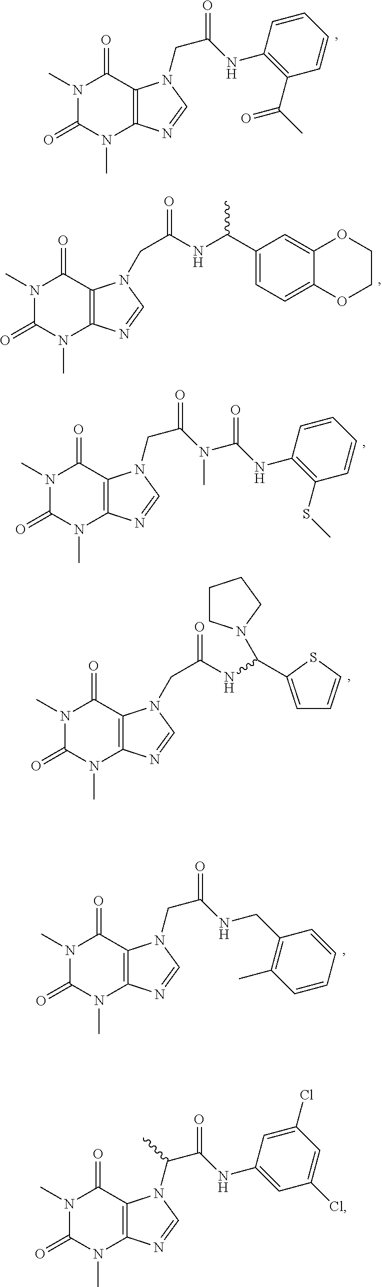 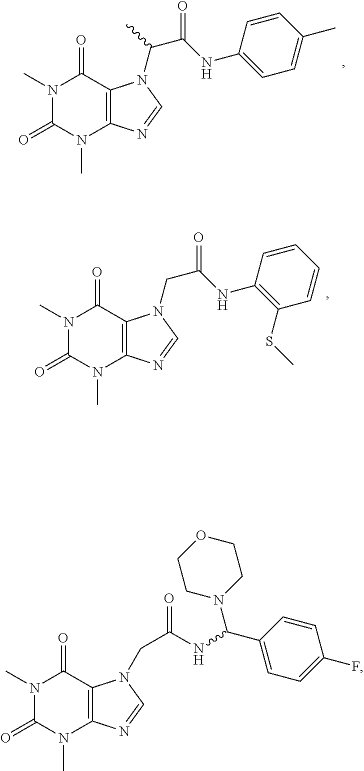 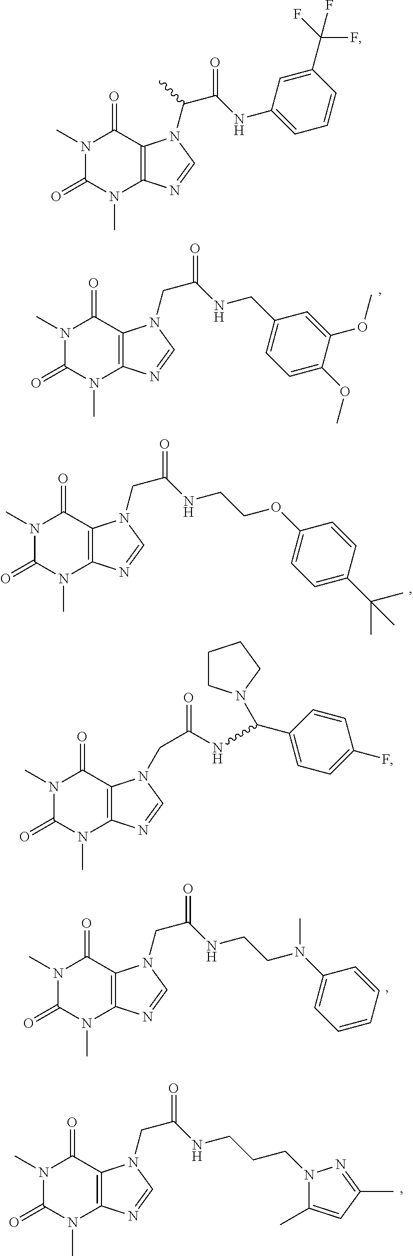 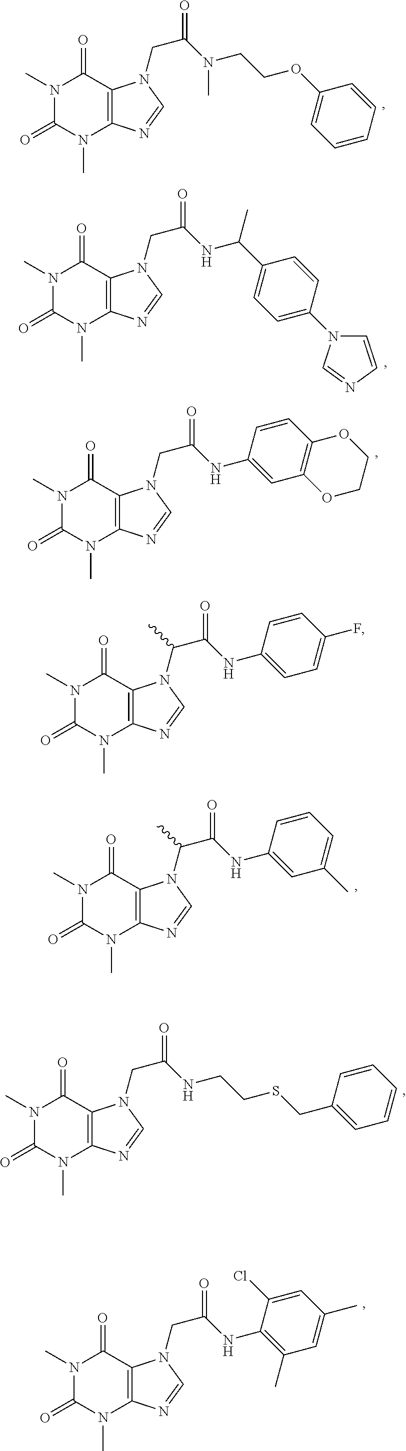 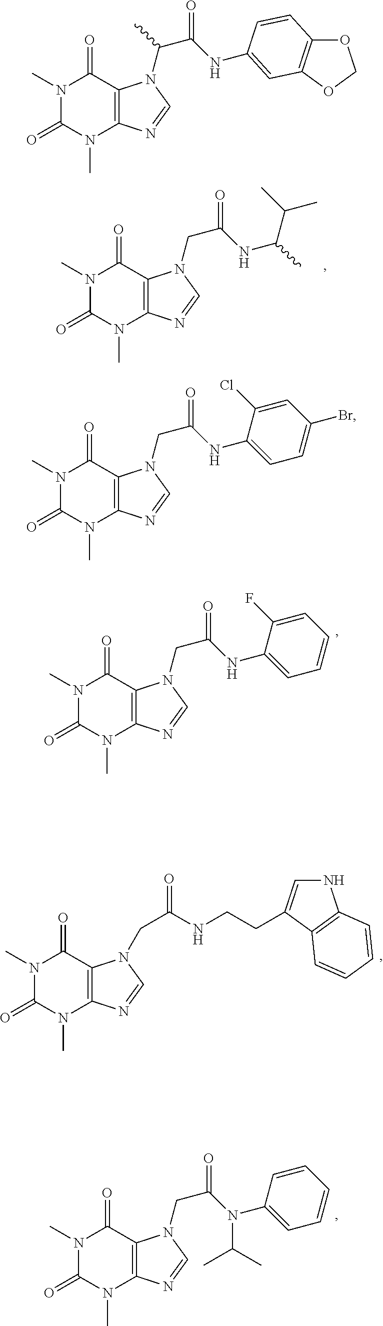 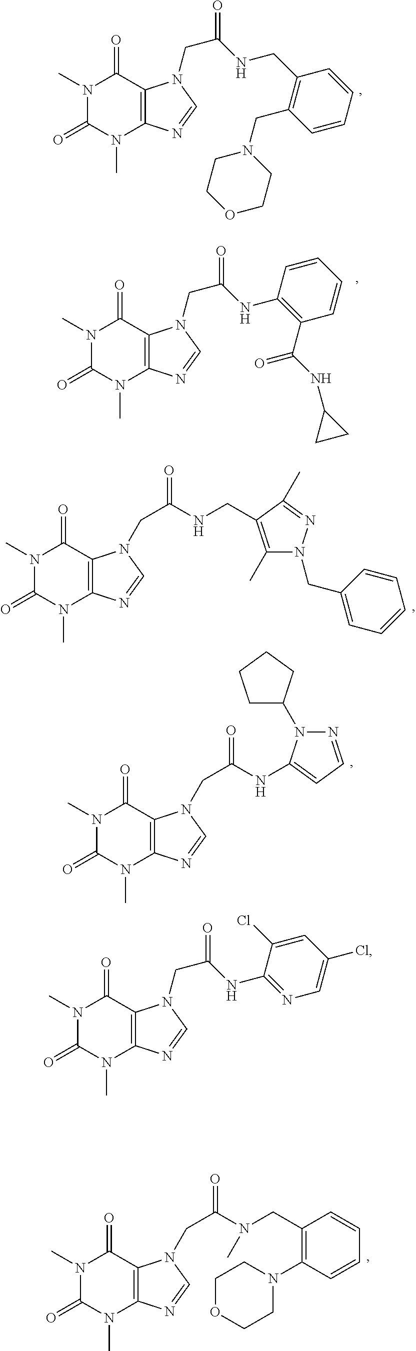 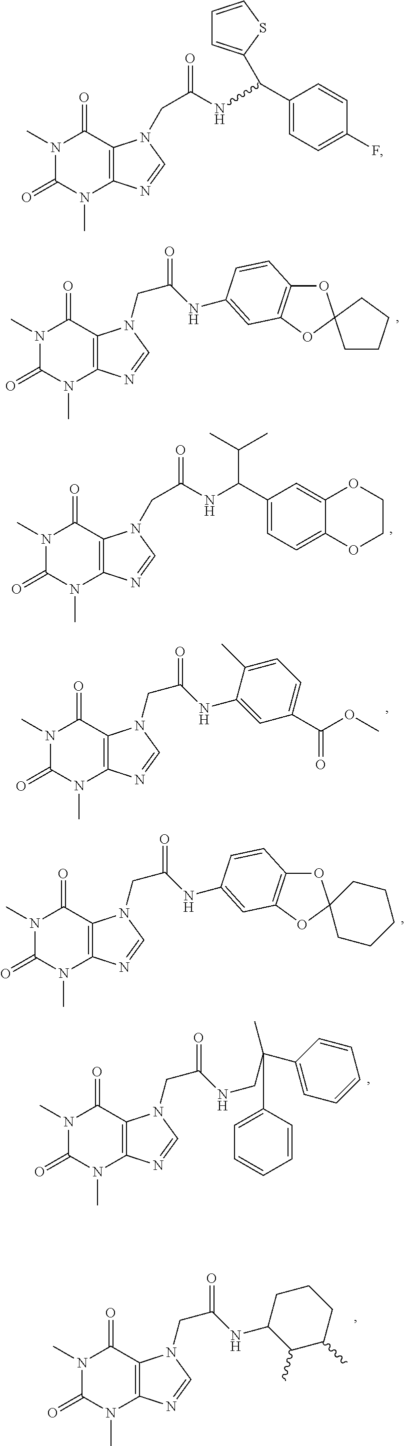 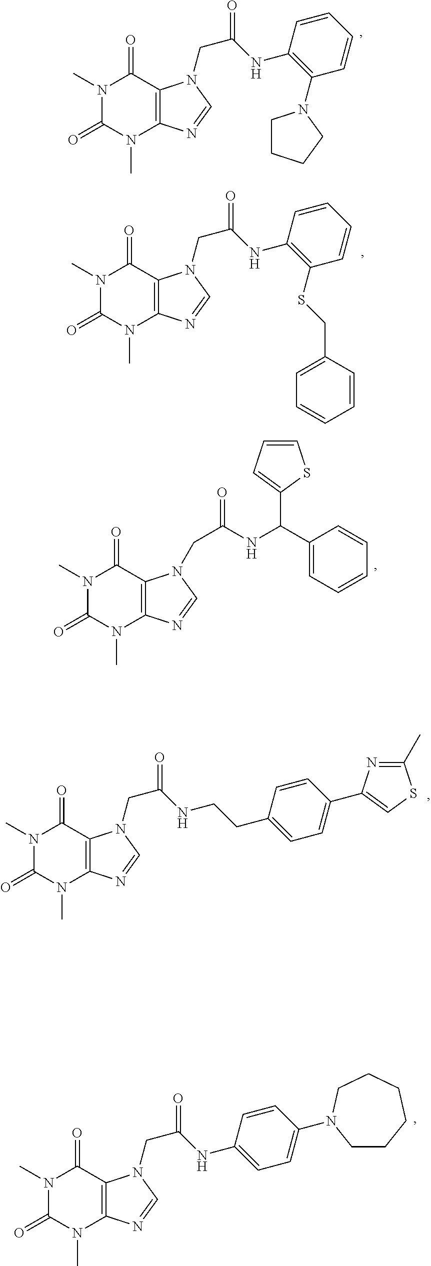 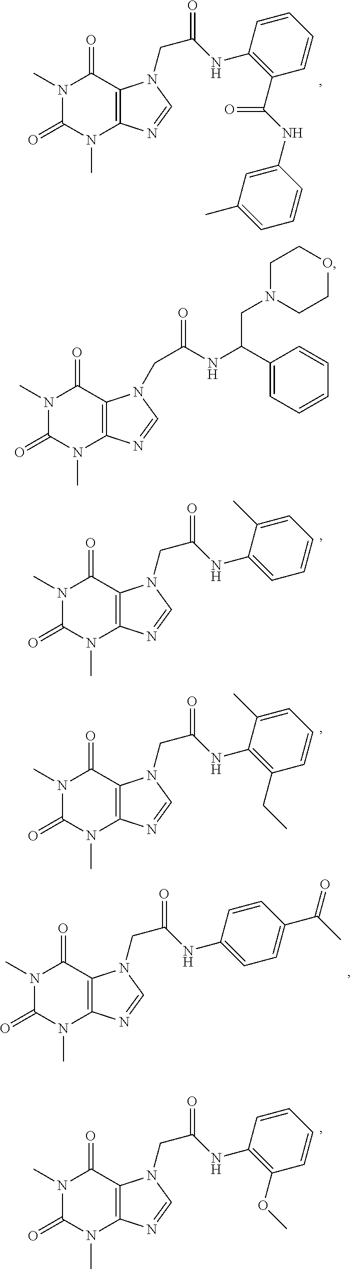 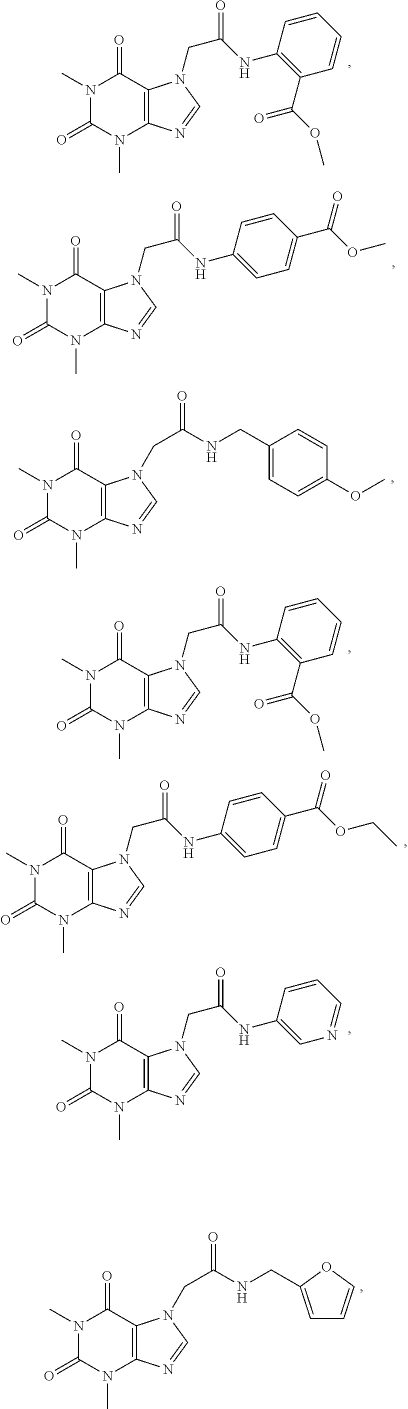 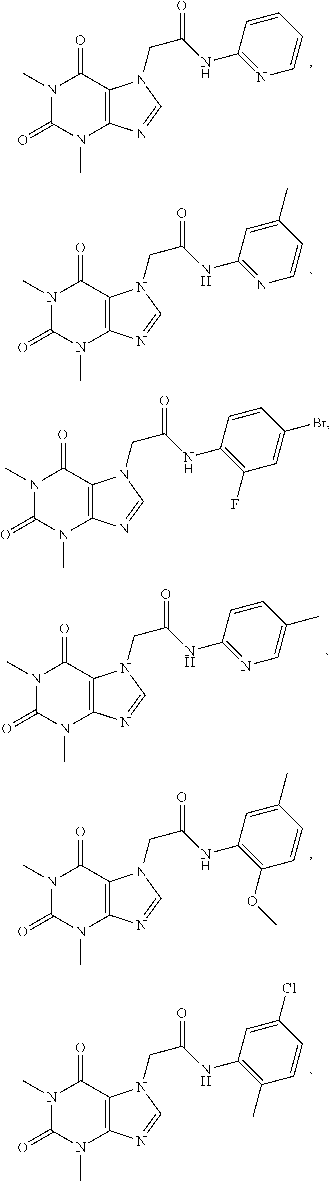 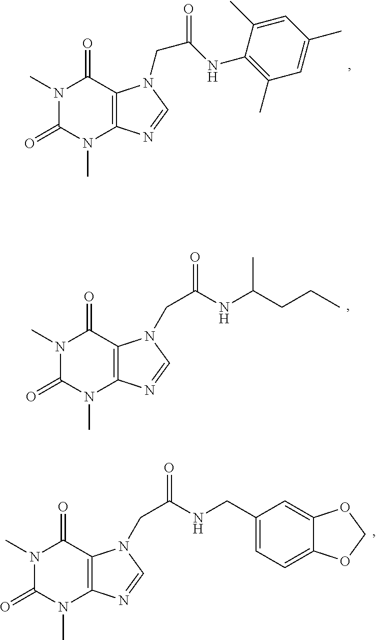 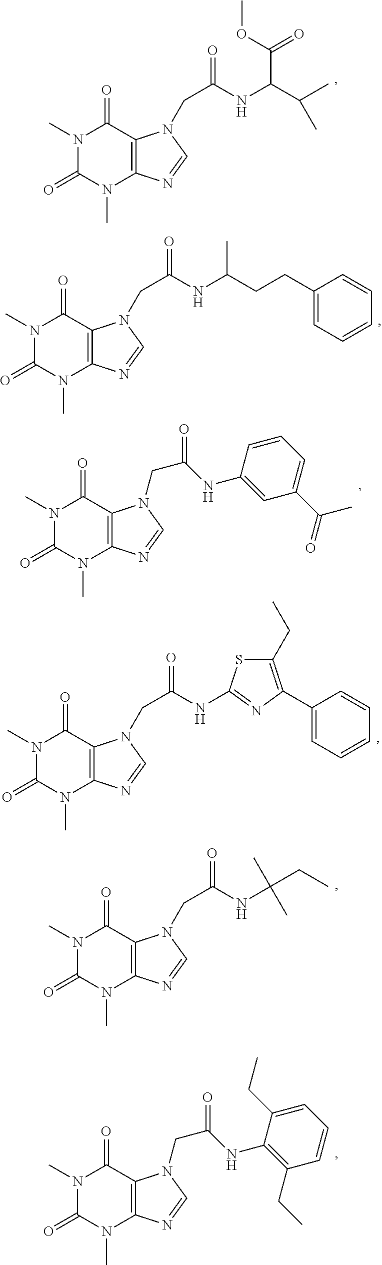 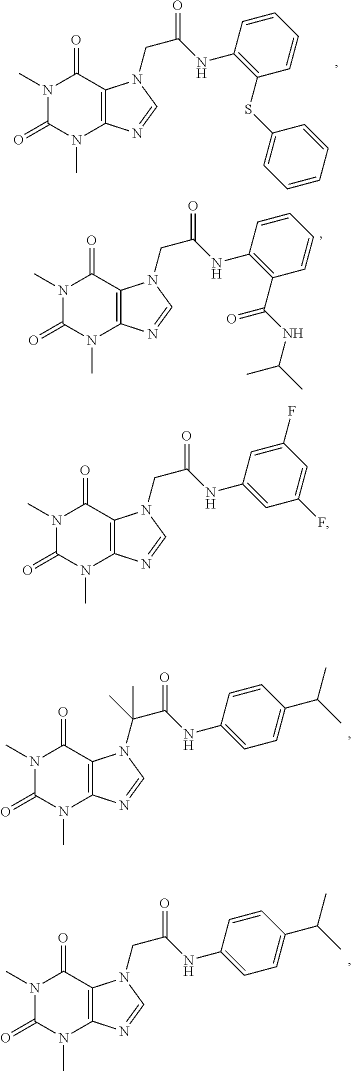 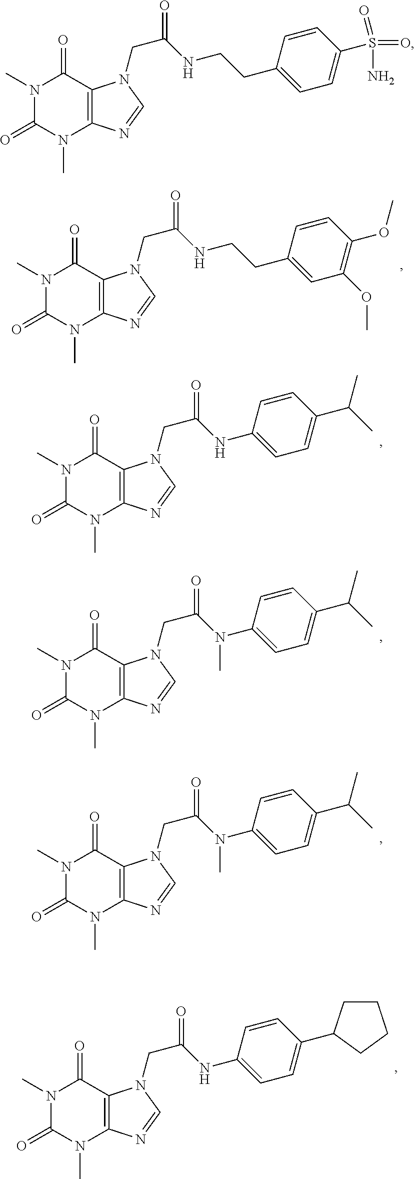 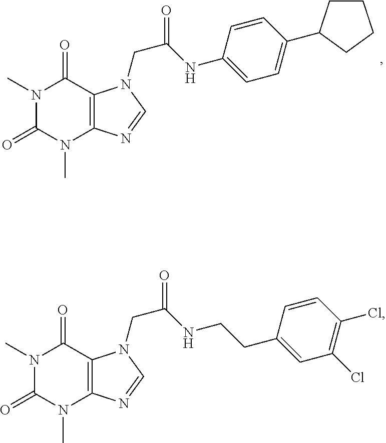 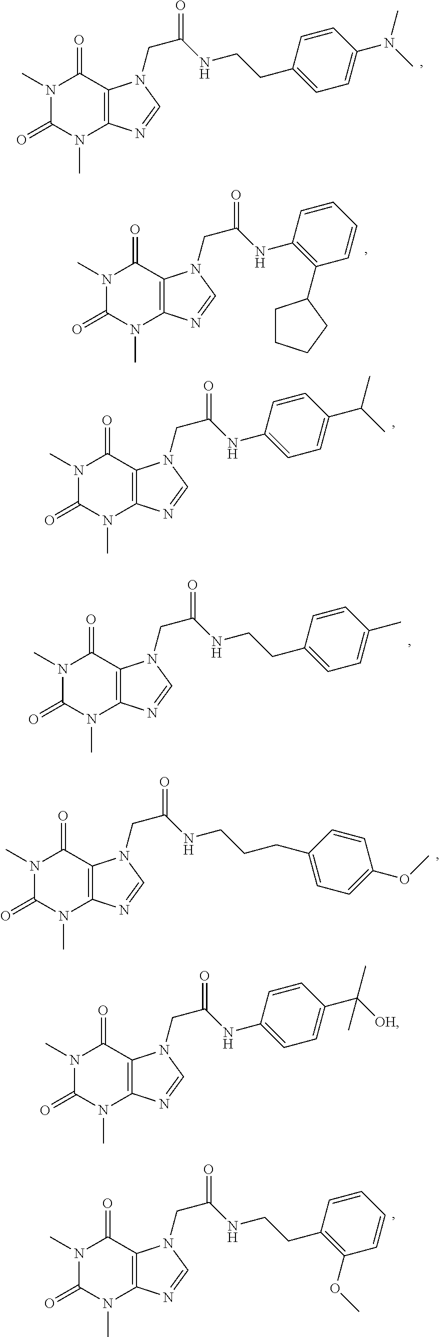 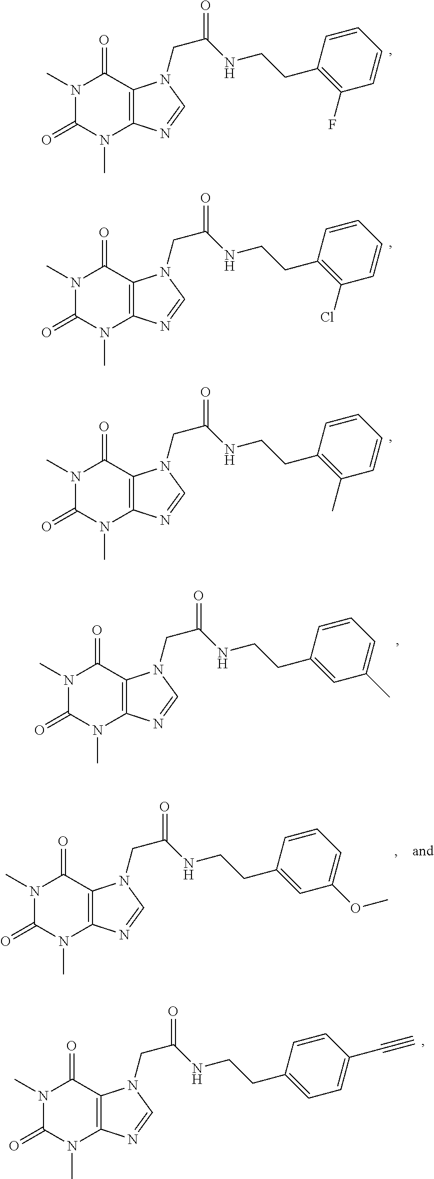
and pharmaceutically acceptable salts thereof.

3. The method of claim 2, wherein the agent is applied as a spray.

4. The method of claim 2, wherein the agent is applied topically.

5. The method of claim 1, wherein the insect is selected from the group consisting of fleas, rat fleas, oriental rat fleas, flies, black flies, sand flies, mosquitoes, horse flies, deer flies, eye gnats, house flies, blow flies, flesh flies, tsetse flies, lice, human lice, true bugs, assassin bugs, and kissing bugs.

6. The method of claim 1, wherein the insect is a disease vector, an agricultural or a horticultural pest, or a parasite.

7. A method of insect control comprising modulating activity of TRPA1 ion gated channel or family members in the insect.

8. The method of claim 7, wherein activity of TRPA1 is modulated by heat or an agent selected from the group consisting of ruthenium red, (Z)-4-(4-chlorophynyl)-3-methylbut-3-en-2-oxime, 2-(1,3-dimethyl-2,6-dioxo-1,2,3,6-tetrahydro-7H-purin-7-yl)-N-(4-isopropylphenyl)acetamid, cannabinoid agonists R-(+)-(2,3-dihydro-5-methyl-3-[(4-morpholinyl)methyl]pyrol[1,2,3-de]-1,4-benzoxazin-6-yl)-(1-naphthalenyl)methanone mesylate and (R,S)-3-(2-iodo-5-nitrobenzoyl)-1-(1-methyl-2-piperidinylmethyl)-1H-indole, 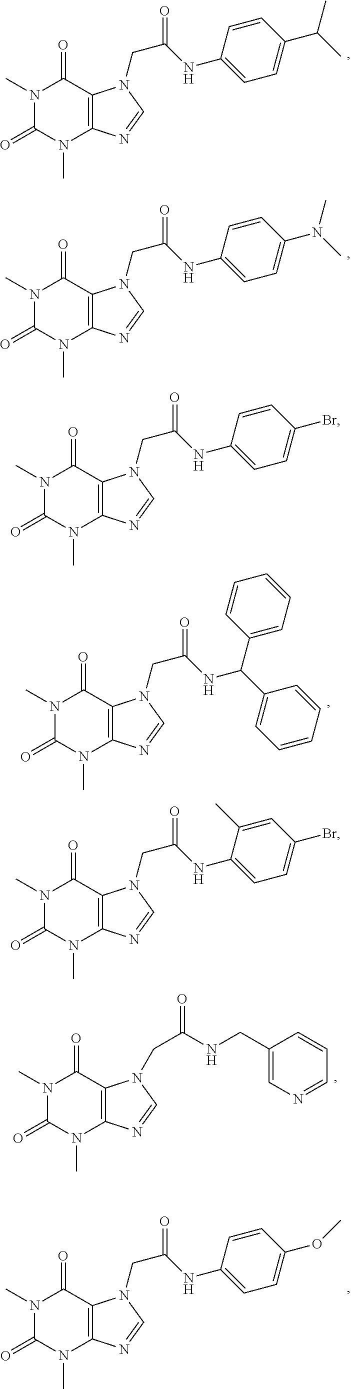 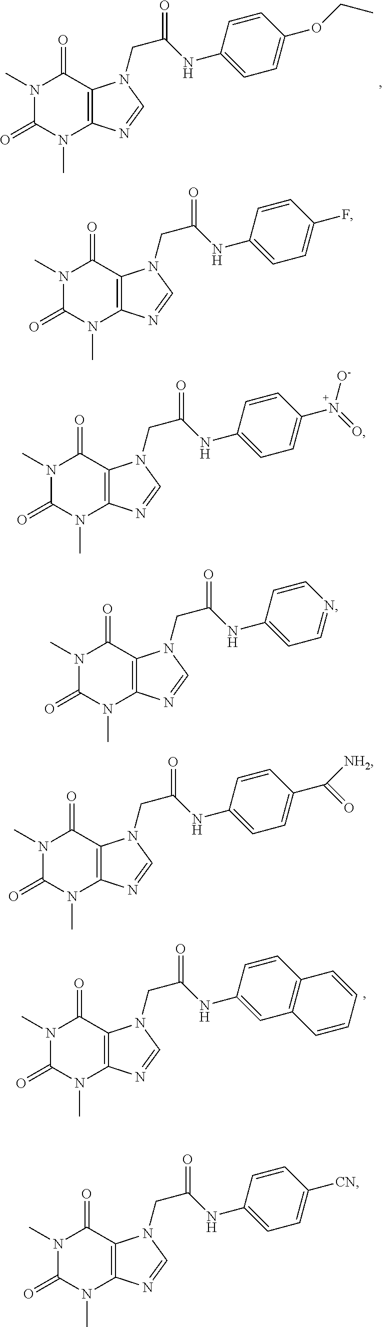 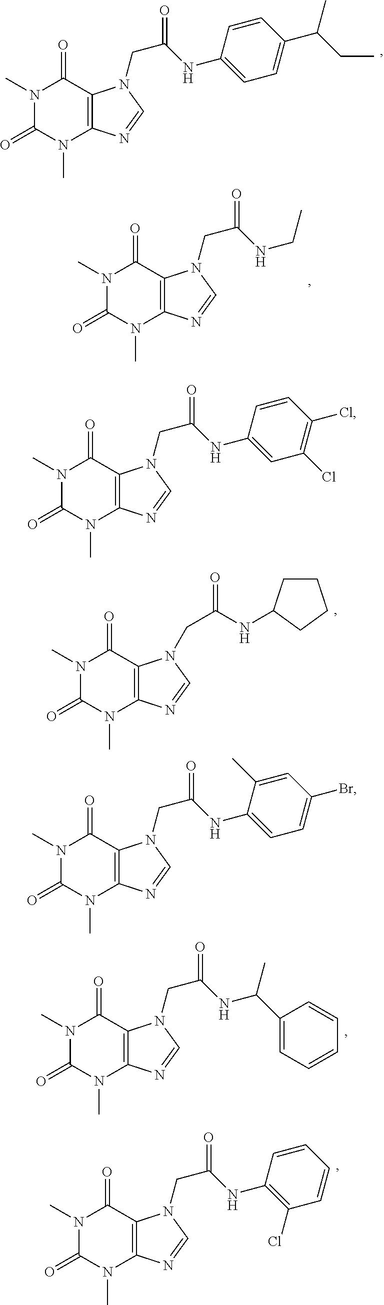 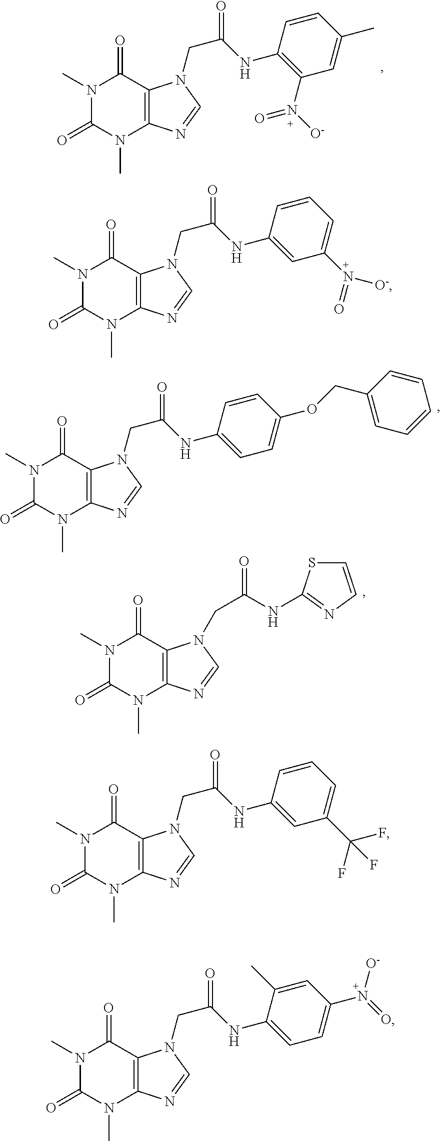 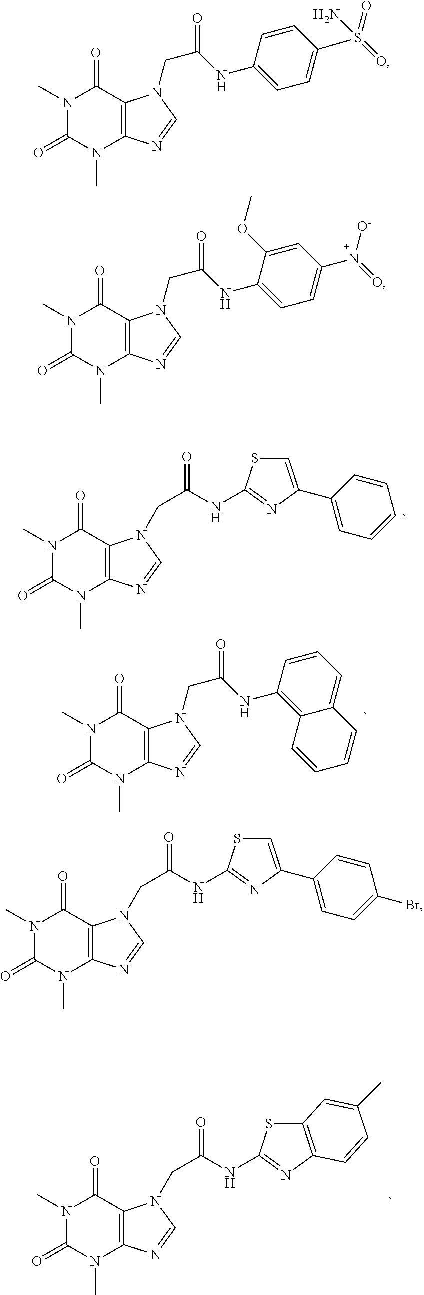 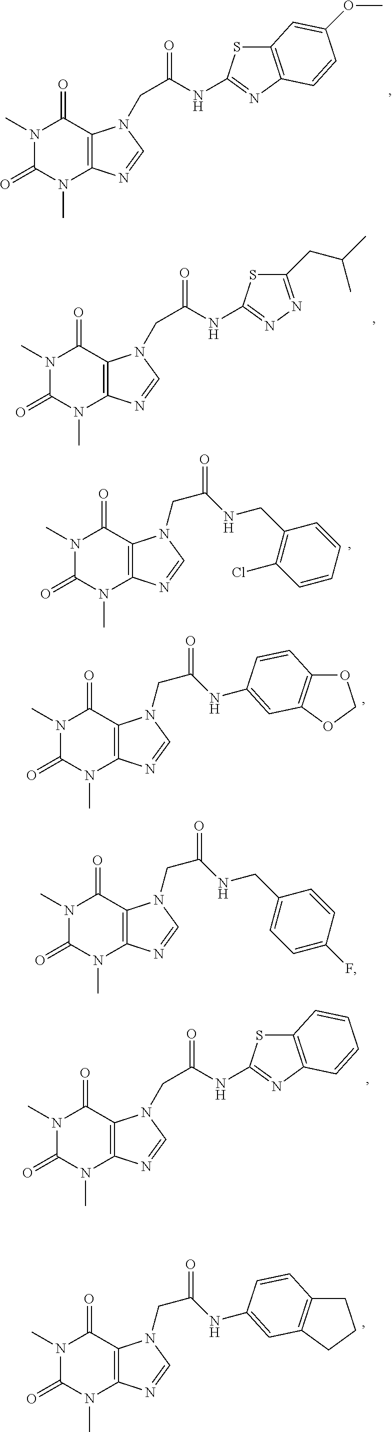 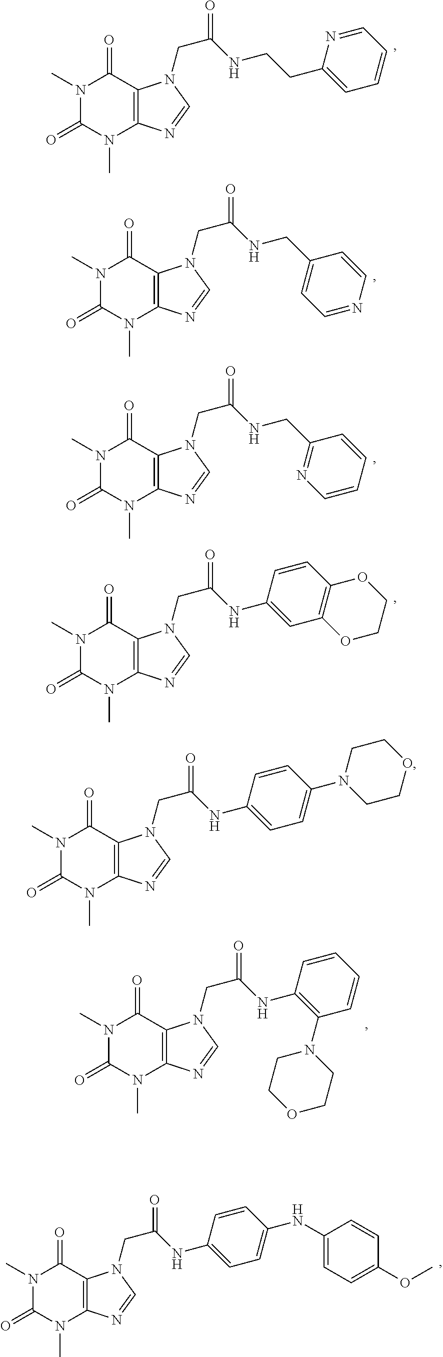 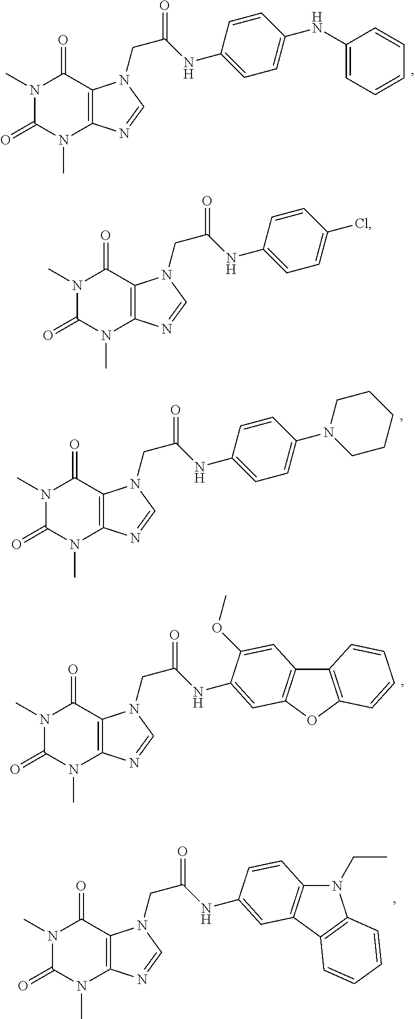 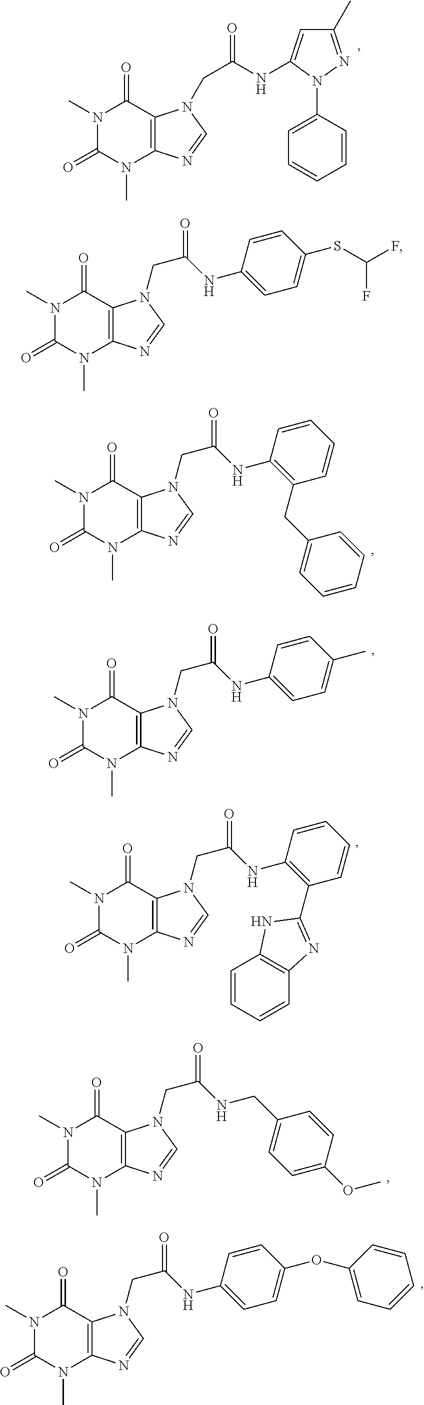 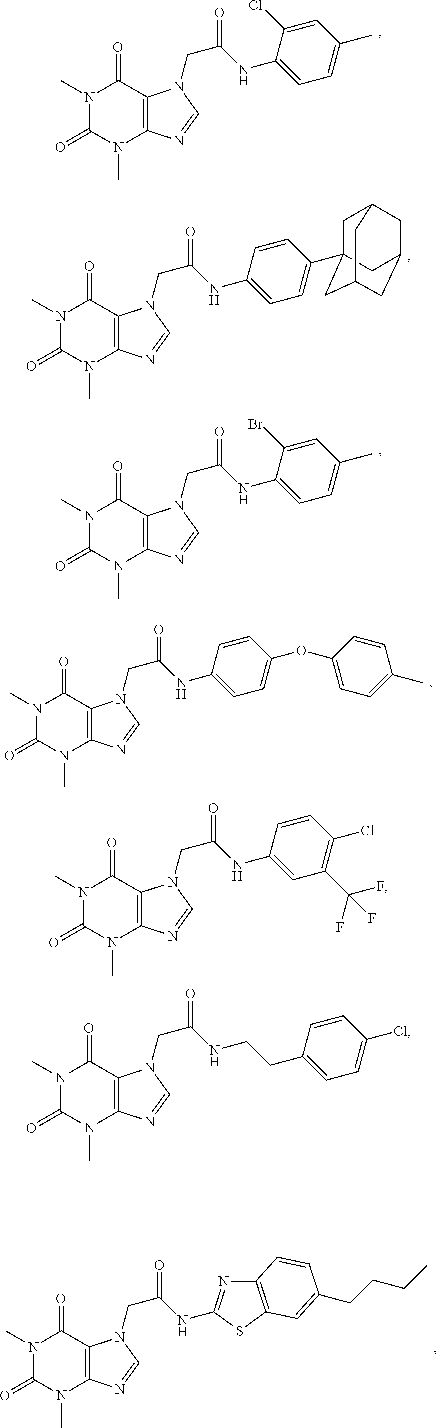 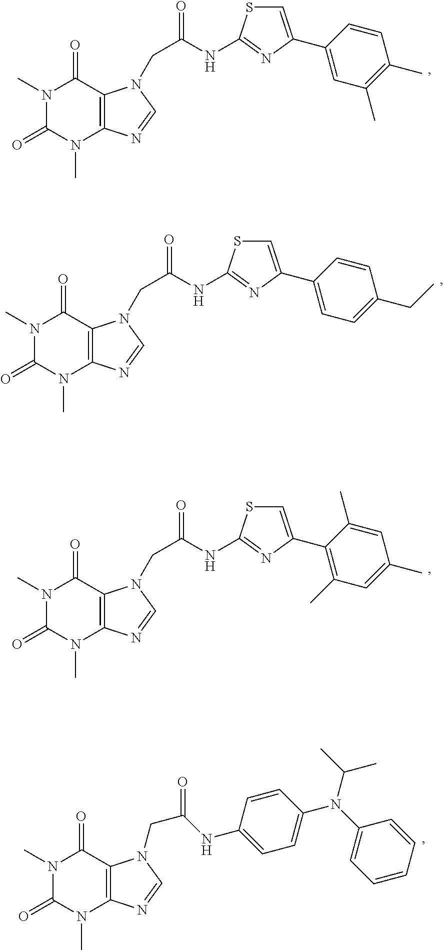 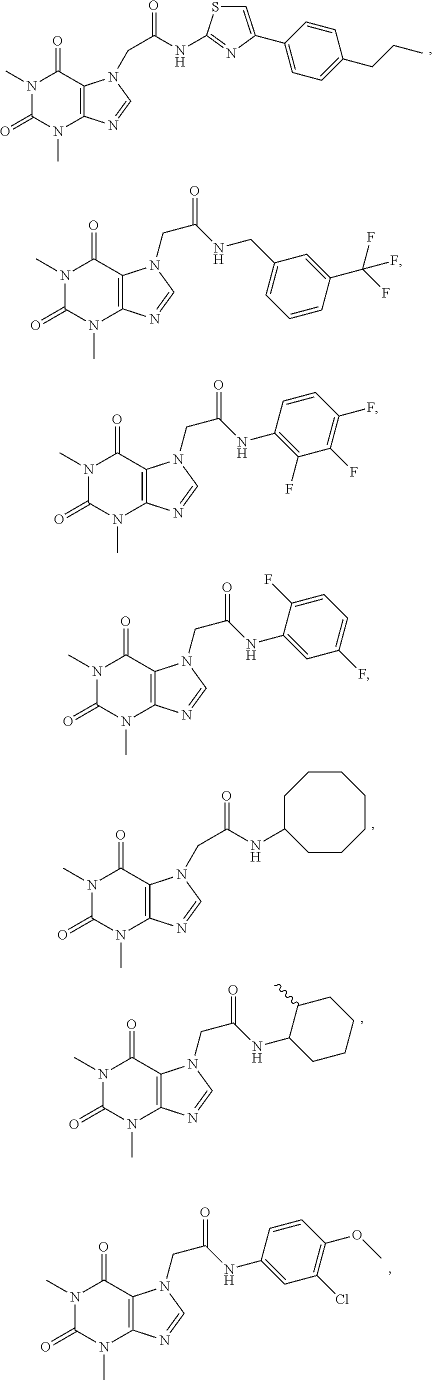 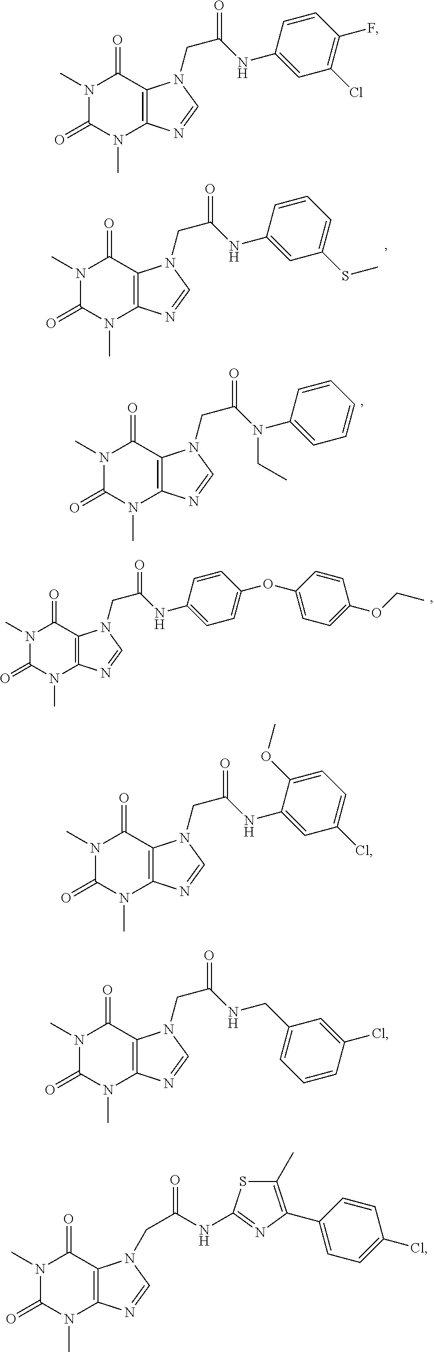 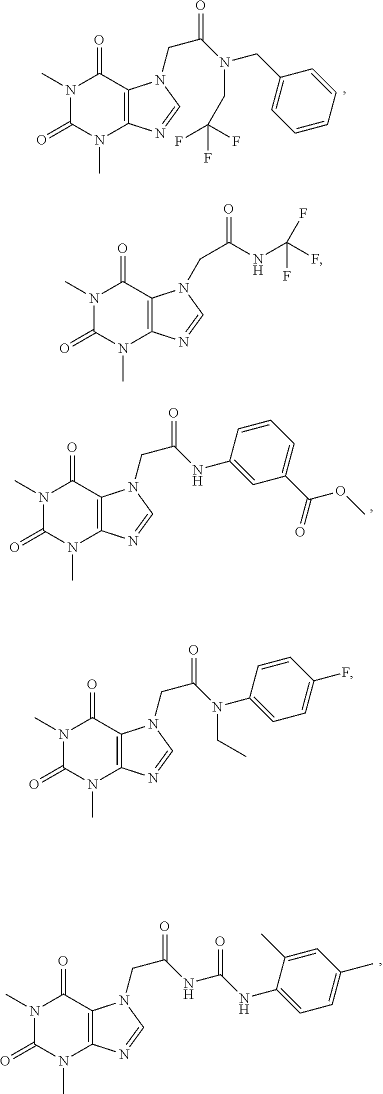 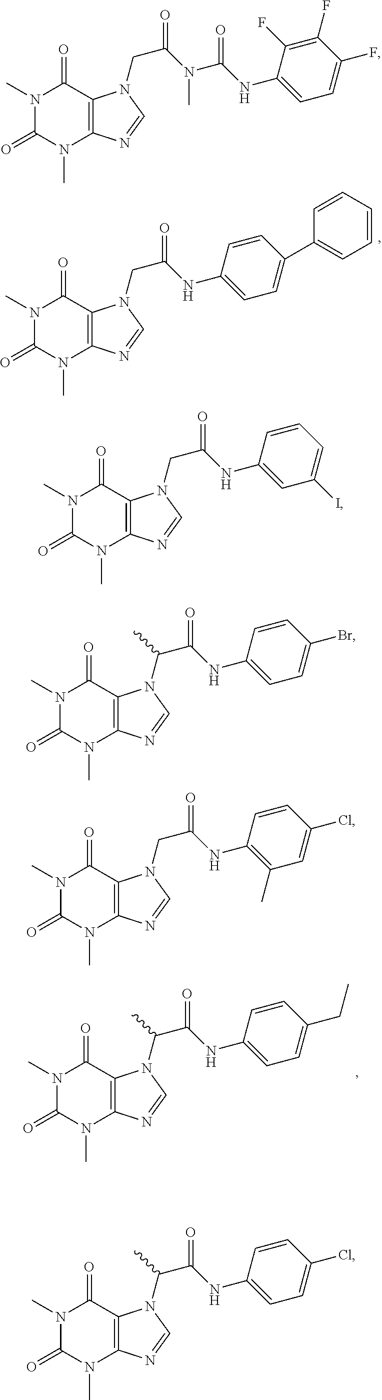 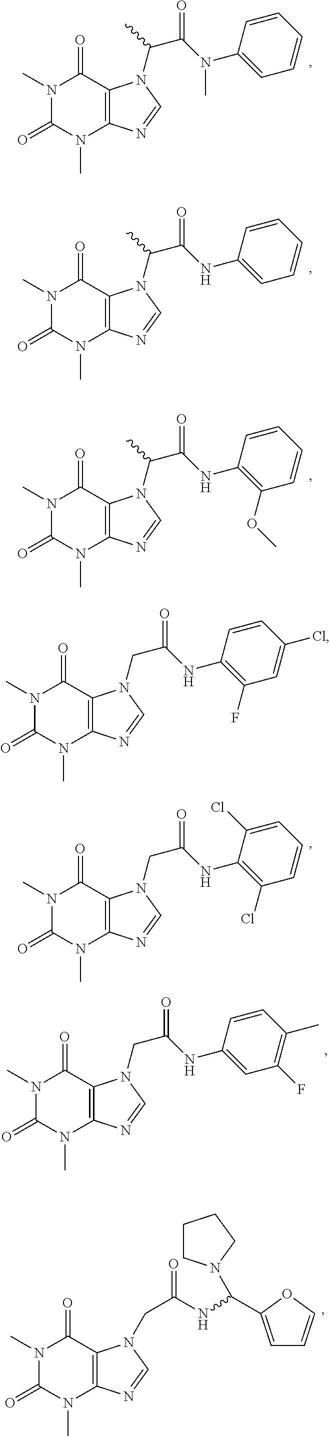 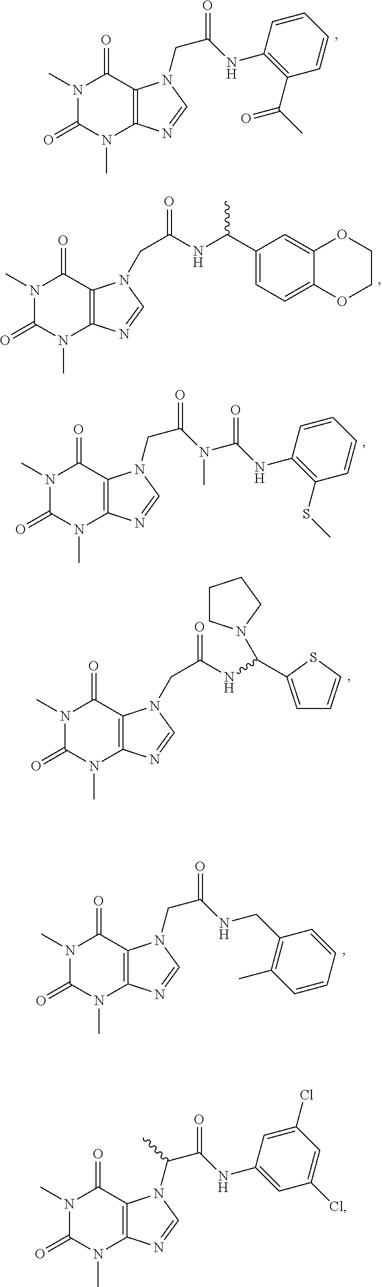 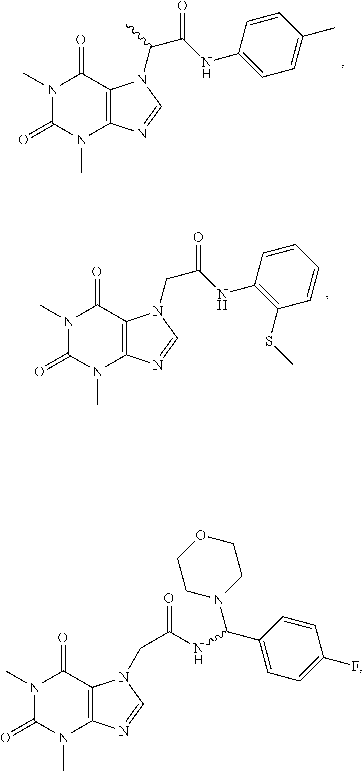 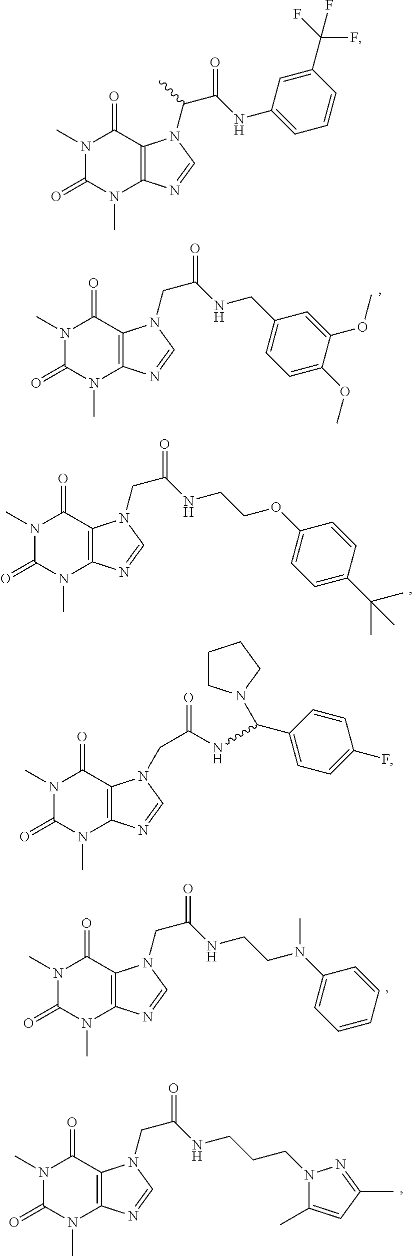 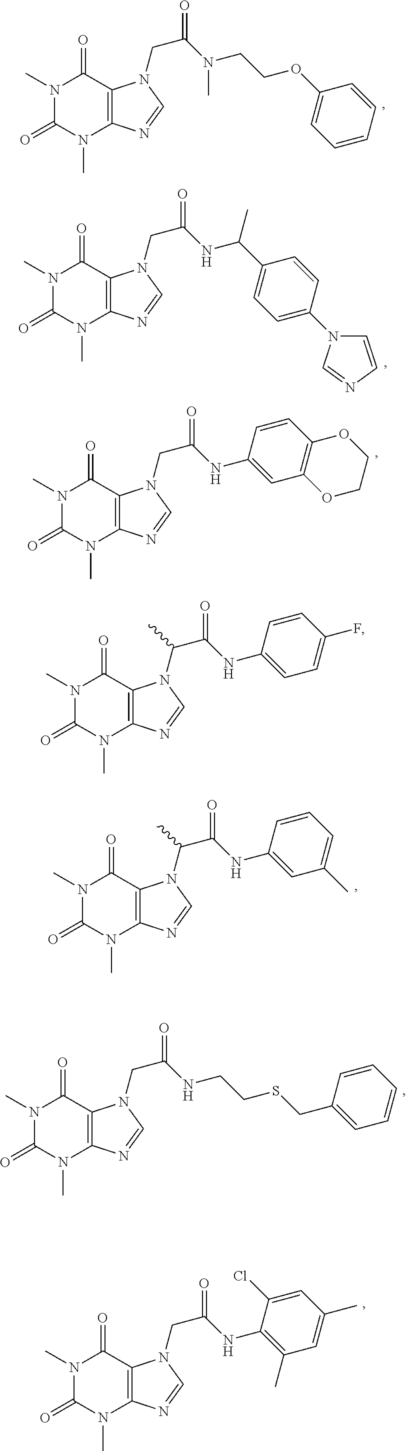 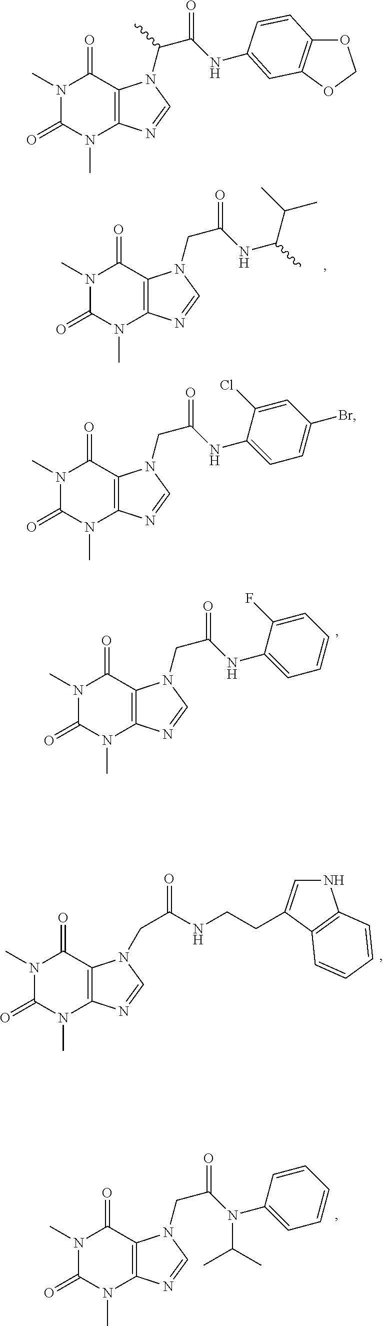 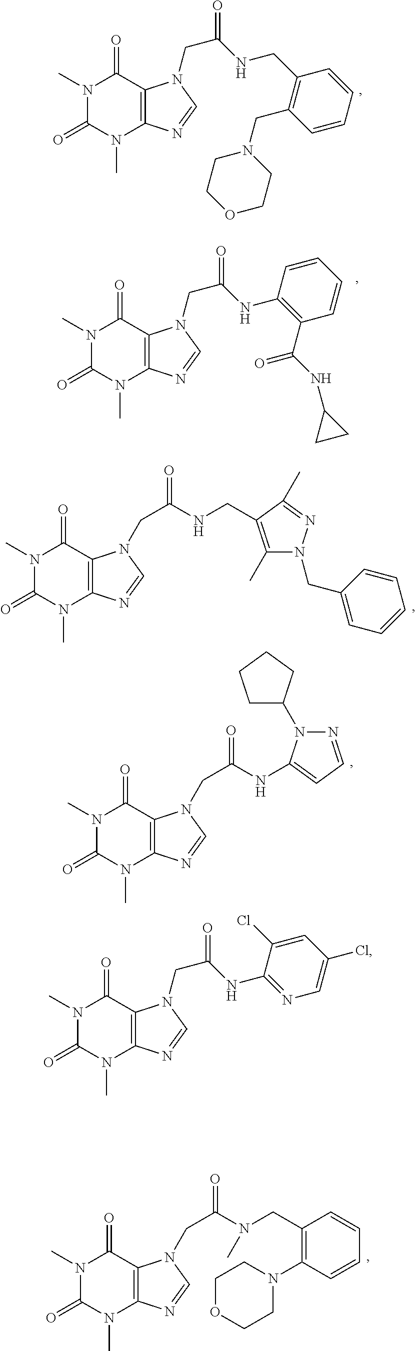 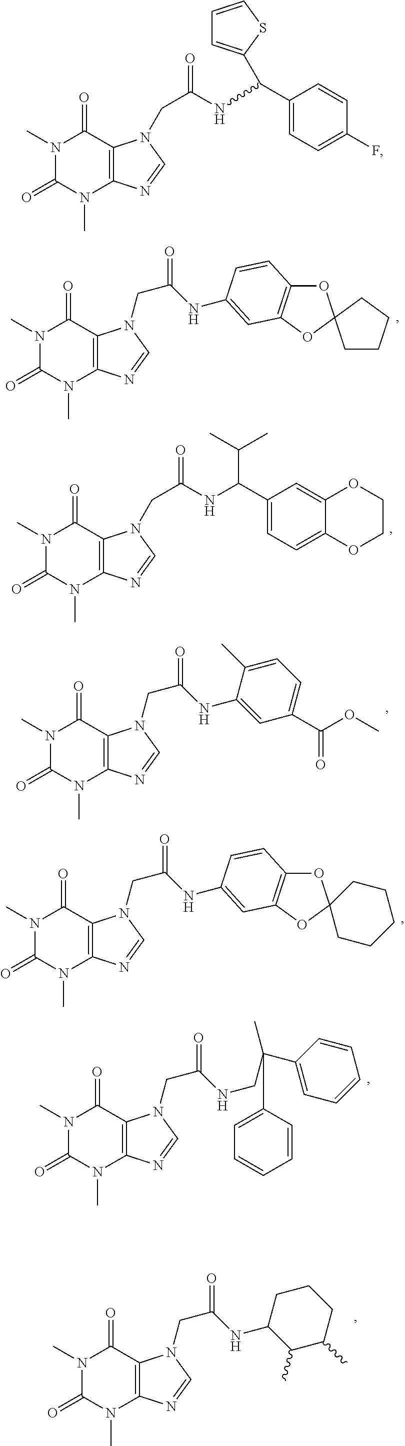 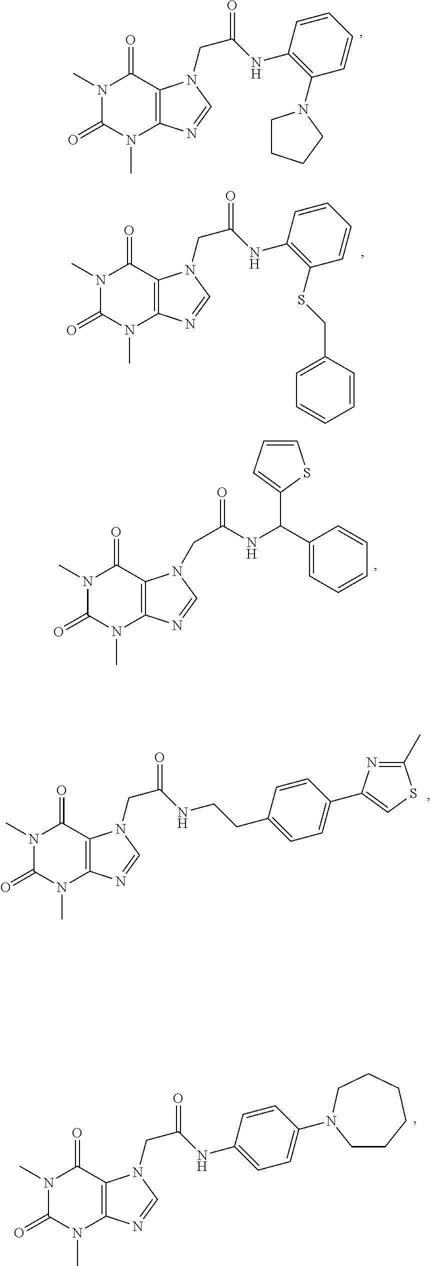 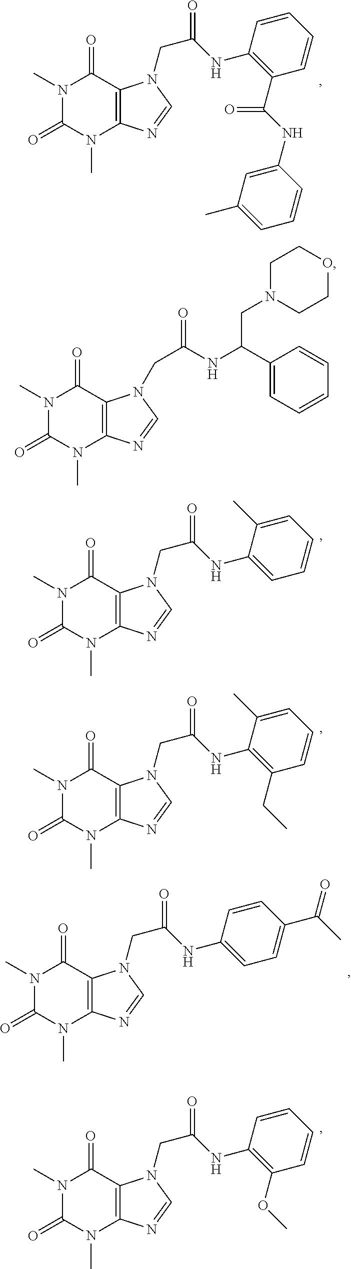 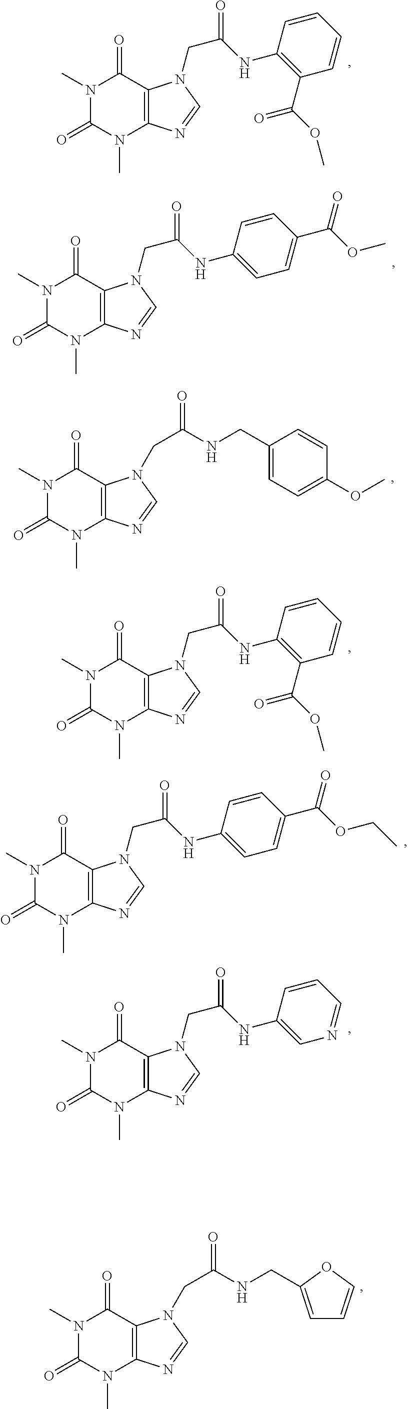 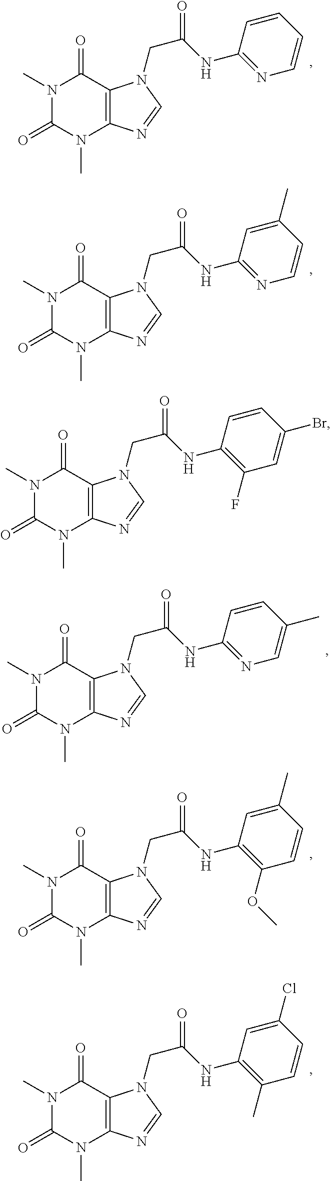 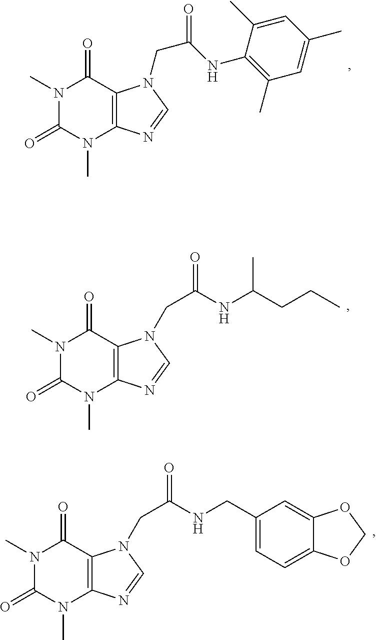 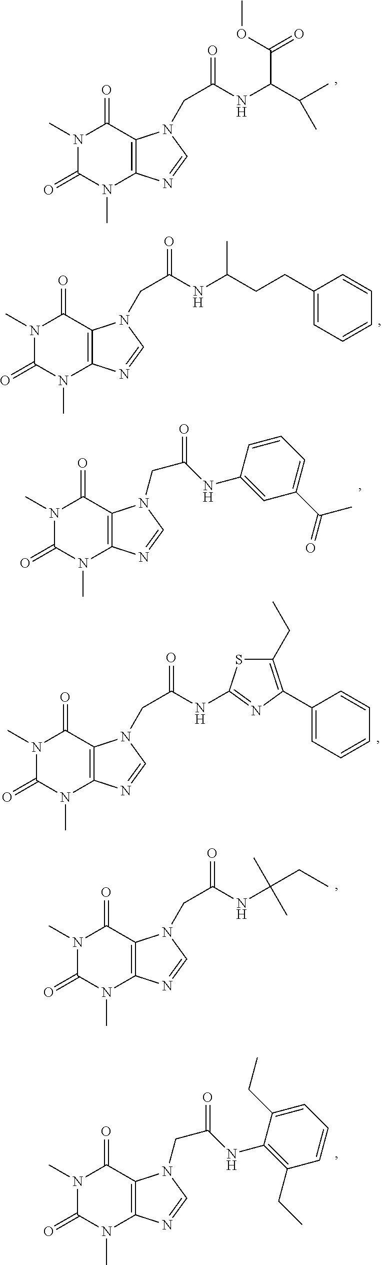 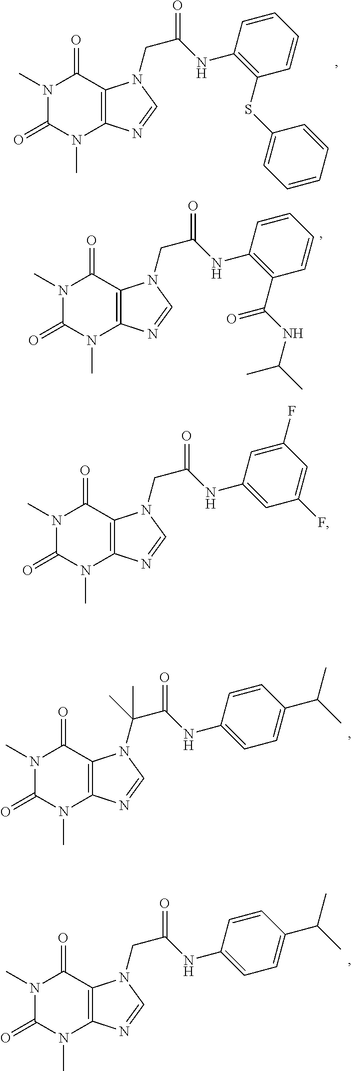 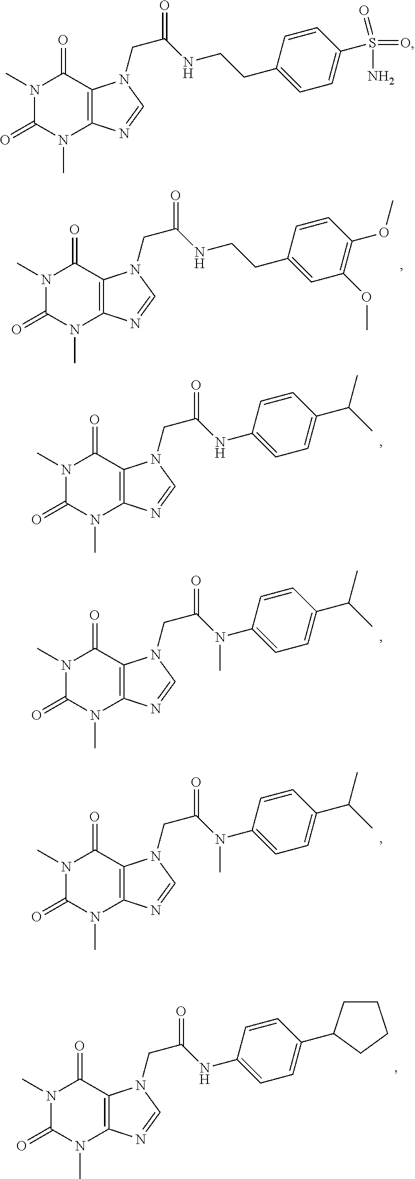 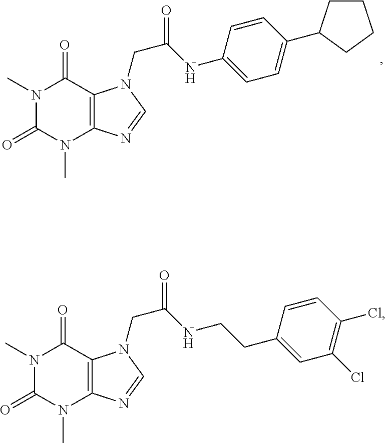 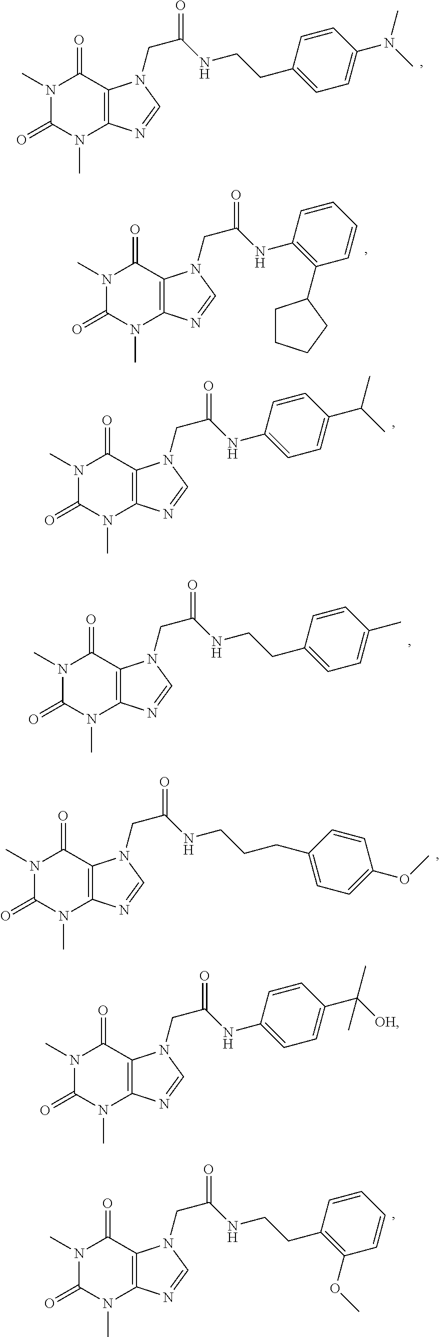 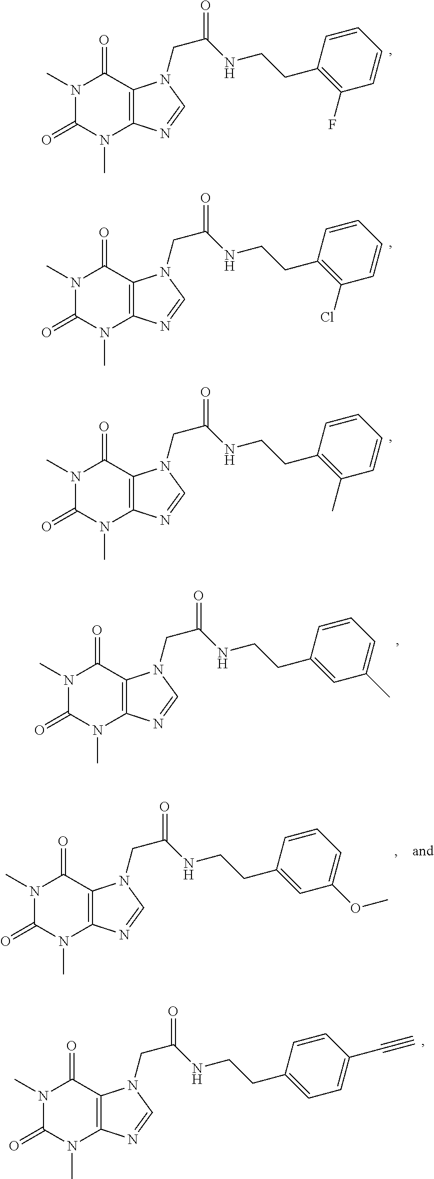
4-hydroxynonenal, capsaicin, 3′-carbamoylbiphenyl-3-yl-cyclohexyl carbamate, cinnamaldehyde, allicin, gingerol, 2-mercapto benzoic acid, caffeine, iodoacetamide, N-methyl maleimide, trinitrophenol, Carvacrol, Icilin, menthol, acrolein, 15-deoxy-Δ12,14-prostaglandin J2 (15d-PGJ2), allyl thiocyanate, and 4-methyl-N-[2,2,2-trichloro-1-(4-nitro-phenyl sulfanyl)-ethyl]-benzamide, and pharmaceutically acceptable salts thereof.

9. The method of claim 7, wherein the insect is selected from the group consisting of fleas, rat fleas, oriental rat fleas, flies, black flies, sand flies, mosquitoes, horse flies, deer flies, eye gnats, house flies, blow flies, flesh flies, tsetse flies, lice, human lice, true bugs, assassin bugs, or kissing bugs.

10. The method of claim 7, wherein the insect is a disease vector, agricultural or horticultural pest, or a parasite.

11. The method of claim 7, wherein TRAP1 is inhibited.

12. The method of claim 7, wherein TRAP1 is activated.

13. The method of claim 8, wherein the agent is applied as a spray.

14. The method of claim 8, wherein the agent is applied topically.

15. The method of claim 8, wherein the agent is applied directly to adult insects.

16. The method of claim 8, wherein the agent is applied to a locus of insects.

17. The method of claim 16, wherein the locus of insects is a breeding locus of insects or a feeding locus of insects.

18. The method of claim 8, wherein the agent is formulated with a food source of insects.

19. The method of claim 8, wherein the agent is formulated with sucrose.

20. The method of claim 7, wherein the activity of TRPA1 ion gated channel or family member is modulated by a TRPA1 inhibitor and a TRPA1 agonist simultaneously.
